(19) United States
(12) Patent Application Publication
(10) Pub. No.: US 2011/0142316 A1
(43) Pub. Date: Jun. 16, 2011

(54) Tomography-Based and MRI-Based Imaging Systems

(76) Inventors: Ge Wang, Blacksburg, VA (US); Hengyong Yu, Winston-Salem, NC (US); Otto Zhou, Chapel Hill, NC (US); Guohuo Cao, Chapel Hill, NC (US); Erik Ritman, Rochester, MN (US); Michael Vannier, Crete, IL (US)

(21) Appl. No.: 12/916,458

(22) Filed: Oct. 29, 2010

Related U.S. Application Data
(60) Provisional application No. 61/256,099, filed on Oct. 29, 2009.
(60) Provisional application No. 61/260,242, filed on Nov. 11, 2009.
(60) Provisional application No. 61/260,577, filed on Nov. 12, 2009.

(51) Int. Cl. G06K 9/00

(52) U.S. Cl. 382/131

(57) ABSTRACT

Tomography limitations in vivo due to incomplete, inconsistent and intricate measurements require solution of inverse problems. The new strategies disclosed in this application are capable of providing faster data acquisition, higher image quality, lower radiation dose, greater flexibility, and lower system cost. Such benefits can be used to advance research in cardiovascular diseases, regenerative medicine, inflammation, and nanotechnology. The present invention relates to the field of medical imaging. More particularly, embodiments of the invention relate to methods, systems, and devices for imaging, including tomography-based and MRI-based applications. For example, included in embodiments of the invention are compressive sampling based tomosynthesis methods, which have great potential to reduce the overall x-ray radiation dose for a patient. To name a few, compressive sensing based carbon nano-tube based interior tomosynthesis systems, tomography-based dynamic cardiac elastography systems, cardiac elastodynamic biomarkers from interior MR imaging, exact and stable interior ROI reconstructions for radial MRI, and interior reconstruction based ultrafast tomography systems are provided.

### CROSS-REFERENCE TO RELATED APPLICATIONS

This application relies on the disclosure of and claims the benefit of the filing date of U.S. Provisional Application Nos. 61/256,099, filed Oct. 29, 2009; 61/260,242, filed Nov. 11, 2009; and 61/260,577, filed Nov. 12, 2009; the disclosures of each of which are incorporated by reference herein in their entireties.

### STATEMENT OF GOVERNMENT INTEREST

This work was partially supported by the National Institutes of Health under NIH/NIBIB Grants RO1HL098912, EB011785, EB002667, EB004287 and EB00728A; NIH/NHLBI Grant HL098912; NSF Grant DMS0811254; and NIH/NCI Grant CA135151. The U.S. Government has certain rights in this invention.

### BACKGROUND OF THE INVENTION

1. Field of the Invention

The present invention relates to the field of medical imaging. More particularly, embodiments of the invention relate to methods, systems, and devices for imaging, including tomography-based and MRI-based applications.

2. Description of the Related Art

Recent advancement in the computed tomography (CT) field has increased its applicability significantly. The ionizing nature of x-rays has now become a major concern, especially for high dose procedures like cardiac CT examinations. The latest estimate suggests that CT radiation may account for 1.5-2% of all cancers in US. Current CT scanners require that an entire cross-section of the patient body must be covered by the system field of view even if we are only interested a small interior region of interest (ROI), such as the heart or the cochlea.

Modern biomedical imaging demands innovative solutions to inverse problems, since the key is to noninvasively obtain information about internal biomedical features. Imaging should avoid harm to the subject and maintain the biological processes under investigation intact. A wide portion of the electrical and magnetic spectrum is utilized by various biomedical imaging modalities. Among them, there are fairly direct means such as ultrasound B scan, but in most cases inverse problems must be solved where all we can acquire are projected, diffused or otherwise convoluted signals, with x-ray and optical data being two well-known examples. X-ray computed tomography (CT) and optical molecular tomography (bioluminescence tomography and fluorescence tomography) are respectively classical and emerging modalities utilizing x-ray and infrared photons. They have important applications and share challenges in deriving innovative solutions to a set of linear inverse problems which are highly ill-posed due to incomplete, inconsistent and intricate measurements. These modalities would be enhanced by cutting-edge inverse technologies, leading to faster data acquisition, lower radiation dose, higher image quality, greater flexibility, lower system cost, better and more applications.

Clinical X-ray CT. X-ray CT has a central role in clinical imaging, often as the first and only imaging study before definitive intervention for a wide variety of conditions in the head, chest, abdomen, pelvis and extremities. The acceptance of x-ray CT in clinical practice is a result of numerous technical innovations including faster data acquisition, higher image quality and lower radiation dose. In 1991, a spiral/helical cone-beam scanning mode was conceptualized to solve the long object problem [1]A. In 1990s, single-slice spiral CT became the standard mode [2]A. In 1998, multi-slice spiral CT was introduced [3, 4]A. Despite the importance of CT and efforts devoted so far, there are well-recognized challenges [3]A.

First, scanning speed should be increased for cardiac imaging, dynamic contrast enhanced studies, and image guided inventions. Even with the state-of-the-art Siemens dual-source CT scanner, temporal resolution of 83 ms is only achievable with aid of ECG gating around stable phases (around 30% or 70% of the R-R period) [4-8]A. Since the mean velocity of the right coronary artery in a healthy adult is 69.5 mm/s, and higher/irregular heart rates are often encountered in pediatric/injured patients, a greater temporal resolution of <20-80 ms is needed. Cardiac imaging of animals with rapid heart rates, that serve as human disease models, also requires much higher temporal resolution. Second, radiation dose must be minimized especially for children. CT is a radiation-intensive procedure, yet the cone-beam technology continues increasing the usage of CT. A British study quantified the cancer risk from diagnostic x-rays, causing ˜700 cases of cancer per year in Britain and >5,600 cases in US [9]A. In the case of cardiac CT, the clinical dose benchmark is 5 mSv. With other conditions fixed, to cut image noise by half, the dose will be increased by 4 folds; to improve spatial resolution by 50% in 3D, the dose must be boosted by 16 times; and for a cardiac CT perfusion study, the dose is proportional to the imaging time. Therefore, dynamic volumetric cardiac CT appears impossible at <5 mSv.

Optical Molecular Tomography. Molecular imaging is being rapidly developed for diagnostics, drug discovery, and individualized adaptive therapies [10-13]A as part of the NIH roadmap. Small animal molecular imaging was developed to investigate inflammation processes, cardiac diseases, cancer, cystic fibrosis, and many other biological questions. The use of bioluminescent and fluorescent proteins as reporters, in particular, has enabled powerful and flexible strategies to understand biological building blocks and pathways at the cellular and sub-cellular levels. The 2008 Nobel Prize for the discovery of green fluorescent protein (GFP) [14-18]A underlines the critical role of optical molecular imaging using fluorescence and bioluminescence. Among optical molecular imaging techniques, optical molecular tomography (OMT) (fluorescence molecular tomography (FMT) and bioluminescence tomography (BLT)) is most promising [19]A.

The introduction of OMT relative to popular planar fluorescent and bioluminescent imaging can be likened to the development of x-ray CT from radiography. Without OMT, in vivo fluorescent or bioluminescent imaging is primarily qualitative. With OMT, quantitative and localized analyses become feasible on fluorescent or bioluminescent source/probe distributions.

BLT and FMT are highly ill-posed inverse problems. Although FMT of small animals has seen significant progress over past years [20]A, BLT is currently emerging. We rigorously showed the illposedness of BLT in the very first paper on BLT and subsequent analyses [21]A. Specifically, there are two issues behind this illposedness.

First, the diffusion approximation (DA), which is almost exclusively used, is not sufficiently accurate for optical imaging over the whole spectrum of bioluminescent (and fluorescent) probes. Since 2D multi-probe fluorescent imaging were reported [22-24]A, it would be invaluable to distinguish multiple probe tomographically in living mice for visualization of complex cellular processes [25]A. Second, diffuse optical tomography techniques can often fail to produce accurate maps of optical attenuation coefficients. Without such in vivo knowledge of optical properties, an individualized mouse model cannot be established to compensate for the optical heterogeneity, and the imaging process would be too uncertain to be inverted. Clearly, innovative solutions to these two issues will significantly improve not only BLT but also FMT.

Multi-scale/parameter X-ray CT. Biology and medicine are intrinsically multi-scale and multi-dimensional scientific endeavors that require systematic approaches. In this context, multi-scale x-ray CT may serve as a common platform allowing compatible staining and imaging techniques from cm to nm scale, which cannot be done by any other imaging modality. However, dissection into ever smaller samples can change morphology, hydration and other physiological/pathological statuses. Fortunately, interior tomography the PI's group has pioneered [26-31]A allows a sample to be much larger than the field of view of a CT system. Early this year, we received an NIH grant and acquired a high-end micro-CT scanner. Last month, we received an NSF grant and will develop a state of the art nano-CT scanner. Coupled with our existing CT scanners, we will have a most comprehensive multi-scale x-ray CT facility to seamlessly cover over six orders of magnitude in length scale and sample size.

Current biomedical x-ray imaging is restricted by the attenuation contrast mechanism. On the other hand, phase shift and dark field x-ray imaging promise 1-3 orders of magnitude improvement in soft tissue contrast or reduction in radiation dose [32]A. X-ray phase-contrast imaging can be implemented using interferometry, diffractometry or in-line holography. Because interferometry and diffractometry require monochromatic x-rays and high precision crystals, they are limited to synchrotron radiation. Alternatively, the in-line method is feasible with a polychromatic micro-focus x-ray tube, but such a source is expensive and rather weak in photon flux [33]A. Since 2006, Pfeiffer et al. have been developing grating-based imaging methods [34-36]A, capturing both refractive (phase-contrast) and Rayleigh scattering (dark-field) signals at cellular levels.

Although grating-based phase-contrast and dark-field imaging open new doors to physiological and pathological information, there is no major program in the USA, and the field faces two obstacles towards biomedical applications. First, data collection for grating-based tomography is time consuming. The working principle is to utilize interferometer based on the Talbot effect, a periodic self-imaging phenomenon, to extract phase shift and Raleigh scattering information via a time-consuming correlation process. The data will be then preprocessed into line integrals for tomography. The higher resolution, the longer imaging time, which is usually in an order of hours or days. Second, gratings of large sizes and high slit aspects are difficult to fabricate and model. According to the published procedure [37]A, the gratings can be made from photolithography masks using a nano-fabrication facility. For example, the analyzer grating consists of Au pillars encased in epoxy and bounded using a frame. This process is prone to errors that are hard to control in the case of gratings of large sizes and high aspects. Even if large gratings are made to the specifications, the resultant imaging model can be challenging for a point x-ray source.

Thus, there exists an immediate need for innovative solutions of inverse problems in x-ray computed tomography (CT) and optical molecular tomography (bioluminescence and fluorescence tomography). These imaging modalities are limited by highly ill-posed linear inverse problems due to incomplete, inconsistent and intricate measurements. The biomedical value and impact of the modalities would be enhanced by cutting-edge inverse technologies, leading to faster data acquisition, higher image quality, lower radiation dose, greater flexibility, lower system cost, and improved, more widespread application in the life sciences.

For example, while the interior problem (to reconstruct an internal region of interest (ROI) only with x-rays through the ROI) has been considered to have no unique solution for decades, interior tomography offers an exact and stable solution, given practical prior knowledge. While the Nyquist/Shannon sampling rate imposes a fundamental limit on resolution, compressive sensing unlocks hidden signal sparsity and requires much less data for recovery of an underlying signal. Over past years, our team and collaborators have made significant theoretical and technical progress in spiral cone-beam CT, exact cone-beam reconstruction, interior tomography, compressive sensing, multi-scale CT, dynamic spatial reconstruction, carbon nanotube based distributed x-ray source array, bioluminescence tomography and fluorescence tomography. Building on the emerging theories, the inventors have created x-ray and optical imaging tools which provide practical solutions to fundamental linear inverse problems for biomedical imaging in vivo and in vitro.

Further, for example, the dynamic cardiac elastography (DCE) approach is based on the fact that impaired myocardium undergoes changes in the passive properties, typically becoming stiffer, and/or decreased in active contractility, and thus changes the deformation characteristics of the heart. In other words, material parameters that describe the passive properties and active contractility can be extracted from the time-varying cardiac image sequences of the heart. Previous parametric extraction methods make approximations including small strain, quasi-static deformation and linear elastic properties of myocardium, which lead to inaccurate and sometimes misleading description of myocardium, and make it impossible to address the highly nonlinear and dynamic properties, in particular the active contraction of myocardium. This invention provides a highly efficient and robust DCE approach and system, based on a dynamic nonlinear adjoint gradient, for accurate quantification of the nonlinear viscoelastic passive properties and active contractility of healthy myocardium and in diseases. For direct clinical applications, the output of DCE, including passive/active material parameters of healthy and impaired myocardium and dynamic stress and strain maps, can serve as novel quantitative indices for detecting and monitoring heart diseases. The output can also have important applications for patient-specific design and application of cardiac equipments, implants and surgeries like coronary artery bypass grafting, surgical ventricular restoration, and cardiac resynchronization therapy devices (CRT).

Dynamic Cardiac Elastography. Heart disease is growingly pervasive with high morbidity and mortality at tremendous social and healthcare costs. 70% of heart failure is due to ischemia where myocardium is damaged. Current diagnostic methods include blood test, chest X-Rays, electrocardiogram, echocardiogram, cardiac catheterization, CT and MRI imaging, etc. However, the obtained global/geometric measurements are not adequate for quantitative detection and evaluation of regional myocardial abnormalities, and for predicting the progression, especially at the early stage when the size of the impaired regions is small. Surgical treatments, like coronary artery bypass grafting and surgical ventricular restoration, have been proved to be therapy methods for heart failure. It is well recognized that optimal designs of surgical equipments, implants and surgical procedures highly depend on the knowledge of mechanical properties of the patient heart, i.e., the myocardial passive viscoelastic properties and active contractility. The current diagnostic methods and image processing algorithms do not provide quantitative knowledge of such mechanical properties. Thus, what is needed is a novel cardiac imaging processing method, such as tomography-based dynamic cardiac elastography (DCE) for in vivo identification of the passive nonlinear viscoelastic properties and active contractility of myocardium of individual heart.

The ability to evaluate dynamic elastic properties of myocardial tissue is clinically important to assess risk of heart diseases and monitor their treatment. To date, this line of investigation has been greatly limited by the lack of non-invasive imaging methods. The inventors have developed image-based cardiac elastodynamic biomarkers for prevention and treatment of human heart diseases. Further, the inventors have developed and applied a novel imaging modality to extract cardiac elastodynamic characteristics tomographically. Myocardial elastodynamic properties are the phenomenological manifestation of underlying cellular activity and connectivity. This information is presented through myocardial deformation and can reveal the pathological status of the heart. In the absence of such information, false treatment may be initiated for suspected patients with one or more symptoms, meanwhile treatment may be neglected for some patients with developing heart disease without exhibiting any symptoms thus likely leading to sudden death or heart failure. Elastodynamic biomarkers of myocardium have the potential to enable better prevention and treatment of heart diseases.

The techniques developed by the inventors uses the state-of-the-art techniques to solve a highly ill-posed complicated inverse problem. Embodiments of the invention may be used to image the heart within one breath-hold, which will overturn common perception of long examination time of cardiac MRI; and 2) it can extract elastodynamic features from myocardium, which enables new understanding of progressive deterioration of heart muscle and improve diagnosis and treatment of cardiac diseases.

Exact and Stable Interior ROI Reconstruction for Radial MRI. A number of magnetic resonance imaging (MRI) applications require high spatial and/or temporal resolution. With technological advances in MRI hardware systems and development of multiple echo data acquisition [1-4]D and image reconstruction [5-11]D strategies, fast MRI has increasingly become feasible. However, the current achievable temporal resolution may still not satisfy the requirements of many specific applications, such as MR-guidance biopsies/intravascular procedures, visualization of cardiac motion, study of brain function, cancer metastases, MRI perfusion, etc. In addition, the existing techniques to improve temporal resolution cannot be generally and simultaneously used to improve spatial resolution, due to k-space sampling that obeys the Nyquist theorem. This limits MRI applications in certain areas such as functional MRI with high desires for both temporal and spatial resolution.

Tomography limitations in vivo due to incomplete, inconsistent and intricate measurements require solution of inverse problems. The new strategies disclosed in this application are capable of providing faster data acquisition, higher image quality, lower radiation dose, greater flexibility, and lower system cost. Such benefits can be used to advance research in cardiovascular diseases, regenerative medicine, inflammation, and nanotechnology.

### SUMMARY OF THE INVENTION

The inventors have defined and solved some of the ill-posed inverse problems presented in the fields of x-ray CT and optical molecular tomography, and have validated and optimized the resultant systems, and have established and supported state-of-the-art infrastructure for their fast, routine and widespread applications in clinical and preclinical settings. The inventors have developed an interior tomosynthesis system, an integrated optical molecular tomography platform, and a multi-scale/parameter CT facility in the interior tomography and compressive sensing framework for diagnosis and intervention of cardiovascular diseases, regenerative medicine, and inflammation research.

In embodiments of the invention, the inventors use a system referred to as interior tomography, which can accurately reconstruct a ROI only from the x-rays passing through it when precise knowledge of a sub-region in the ROI is known. As illustrated in FIG. 1, unlike current CT scanners which require entire object to be irradiated by the x-ray source, this interior reconstruction method reconstructs a local region of interest (ROI) utilizing only the projections for the x-rays passing through it.

Reconstruction algorithms are provided for compressive sampling based tomosynthesis which involve: chord averaging, SART-based integral constraint, and total variation regularization which are sequentially repeated. The inventors have shown that interior tomography is a very effective way of reducing x-ray dose for local imaging applications like cardiac CT. It is complimentary to other dose reduction techniques like prospective gating, tube-current modulation, reduction in geometry of the scanner, etc. Existing interior tomography reconstruction algorithms suffer from image artifacts like a drop in image intensity.

The inventive method of projection onto convex sets based interior-tomography reconstruction algorithm is an improved method over existing systems. The exemplary algorithm described herein can provide comparable image quality even in the absence of known sub-region and using only one filtering direction. These methods were applied to real projection data thus demonstrating the suitability of our methods for practical applications.

Objects of embodiments of the invention further provide for interior MR imaging of the heart with significantly improved temporal, spatial and contrast resolution. One solution is to provide interior MR imaging of the heart in the compressed sensing framework. Specifically, embodiments of the invention involve combining a newly developed 3D radial MRI method (called UTE-GRE)[2-3], compressed sensing techniques [4-5], and interior tomography principles [6-7]. Using 2D radial MR data acquisition with the aid of a digital filter, a ROI-focused MR image of a phantom has already been successfully reconstructed using the interior tomography approach by our team [8], and can be enhanced using 3D radial data acquisition and the compressed sensing approach described in this disclosure. It is expected that interior MRI of the heart will decrease examination time and increase spatial resolution by at least a factor of 2 or more, and with enhanced contrast resolution to describe the deformation of the myocardium, compared to the state-of-the-art 2D multi-slice techniques for cine MRI such as radial k-t FOCUSS[9]E. Such an improvement is significant for extraction of cardiac elastodynamic biomarkers as well as for the clinical applications of cardiac MRI.

The present invention further provides a tomography-based nonlinear dynamic cardiac elastography (DCE) framework for characterization of the mechanical properties of myocardium based on blood pressure and heart deformation measured with biomedical imaging techniques. The nonlinear DCE estimates the mechanical parameters by optimally minimizing the difference between computed dynamic epi- and endocardial displacement and the corresponding experimental measurement. A dynamic nonlinear adjoint method can be used to calculate the gradients of the objective function. Investigated. The nonlinear DCE may prove indispensable for identification of the viscoelastic properties of myocardium.

Additionally, both temporal and spatial resolution can be significantly improved using a region of interest (ROI)-focused MRI data acquisition scheme. In many practical MRI applications, i.e., cardiac imaging, only a small portion of the field of view (FOV) may be of clinical interest. To image a ROI may still provide sufficient clinical information. However, in radial MRI, there is no such an acquisition-based solution available. The present invention provides an interior MRI methodology to perform ROI reconstruction without artifacts, or with a reduced amount of artifacts.

Interior tomography has been recently proposed as an exact and stable solution to this long-standing problem. Embodiments of the invention include interior MRI methodologies to perform ROI reconstruction without creating any artifacts, or reducing the number of artifacts. This method is based on radial projection data acquisition and interior tomography reconstruction technique. The interior tomography reconstruction technique was recently developed by Wang's group [12D]. This technique provides an exact and stable solution to the interior problem (reconstruction of an interior ROI from line integrals associated with only paths through the ROI), which, in conventional wisdom, does not have a unique solution. Though it was originally proposed for image reconstruction of computed tomography (CT), the technique can be directly extended to other tomographic modalities, such as MRI, PET, SPECT, and so on.

The interior MRI methodology provides a general MRI ROI reconstruction approach using a truly truncated Hilbert transform [12D] along with a digital filter [13D]. Aided by partial knowledge on one neighboring intervals of a line-segment inside the ROI, the ROI imaging was successfully reconstructed.

Specific embodiments of the invention include methods, systems, and devices for interior tomography reconstruction comprising performing projection onto one or more convex sets (POCS) according to:

fₙ=Tⁿf,

where n indicates an iteration number;

T=P₁P₂ . . . P_{M};

P₁, . . . , P_{M} are operator to project onto respective convex sets C₁, . . . , C_{M}; and

wherein the convex sets are chosen from Hilbert transform, integral constraint, minimum value, maximum value, and known-information convex sets.

Such methods, systems, and devices can be configured such that the convex sets are chosen from Hilbert transform, integral constraint, and minimum value. Preferred are embodiments, further comprising performing simultaneous algebraic reconstructive technique based (SART-based) integral constraint. Even further preferred are embodiments, further comprising performing total variation regularization. Embodiments can optionally further comprise sequentially repeating one or more method step or function of the processing module.

Other specific embodiments comprise a system for interior tomography reconstruction comprising: a processing module operably configured for: receiving information relating to a region of interest (ROI) of a scanned object; reconstructing the ROI into an image by performing projection onto one or more convex sets (POCS) to generate image data according to: fₙ=Tⁿf, where n indicates an iteration number; T=P₁ P₂ . . . P_{M}; P₁, . . . ; P_{M} are operator to project onto respective convex sets C₁, . . . , C_{M}; and wherein the convex sets are chosen from Hilbert transform, integral constraint, minimum value, maximum value, and known-information convex sets; and comprising a processor for executing the processing module.

A multi-source interior tomography system is also included within the scopr of the invention comprising: 1) a processing module operably configured for: a) analyzing an individualized prior CT scan of a subject; and b) defining a corresponding high order TV (HOT) objective using a set of projection data measured in the CT scan and expressed as: a 1D vector Y with elements Yᵢ^{meas}, i=1, . . . , N_{Y}, where N_{Y} is the product of the number of detector elements and the number of projection views; wherein each measurement is a realization of a random variable:

$${Y}_{i}^{meas} = {G}_{i} {\sum }_{m = 1}^{M} {E}_{m} Poisson \{ {\sum }_{j = 1}^{{N}_{Y}} {b}_{ij} {I}_{j} {λ}_{m}^{( j )} \times exp [ - {\int }_{{L}_{j}} μ ( x , {E}_{m} ) d l ] + {s}_{m}^{( i )} \} + Gaussian \{ {d}_{i} , {σ}_{i}^{2} \}$$

wherein: μ(x,E) is the energy-dependent linear attenuation coefficient; sₘ⁽ⁱ⁾ the number of scattered photons, and the ith measurement not only reflects the signal from the path Lᵢ but also other paths Lⱼ, j≠i, with weight bᵢⱼ to take off-focal radiation into account to reconstruct μ(x,Eᵣ) at a reference energy Eᵣ; c) reducing to a discrete model:

$${Y}_{i}^{meas} ∼ Poisson \{ {I}_{i} exp [ - {\sum }_{j = 1}^{{N}_{p}} {a}_{ij} {μ}_{j} ] + {r}_{i} \} ,$$

where an object consists of Nₚ pixels with attenuation coefficients μ=[μ₁, μ₂, . . . , μ_{N}]^{T}, aᵢⱼ denotes the length of a ray path in a pixel, and rᵢ a known constant which compensates for measurement noise and may be ignored especially in initial analyses; d) converting to an optimization problem: μ̅=arg min(HOT(μ))subject to Y^{meas}=Y(μ), where HOT(μ) is an objective function including the HOT and other constraints such as the prior CT scan and tomosynthetic data; and comprising 2) a processor for executing the processing module.

Further included in embodiments of the invention is an ultra-fast tomography system comprising: 1) a processing module operably configured for: aligning and averaging multiple independently acquired datasets of the same ROI, after image registration, in a common coordinate system; 2) and comprising a processor for executing the processing module.

Such systems are also encompasses, wherein the processing module is further operably configured for processing datasets acquired by way of symmetric data acquisition. Additionally, systems of the invention can be configured wherein the processing module is further operably configured for processing datasets acquired using source-multiplexing.

A tomography-based dynamic cardiac elastography system is included in embodiments, which comprise: 1) a processing module operably configured for: performing tomography-based DCE reconstruction a ROI of an object by: extracting material parameters of heart tissues (set p) from a measurement of endo-epicardial displacement U_{I}^{m} chamber pressures, and ECG record; minimizing overall difference between U_{I}^{m} and computed displacement u_{I}(p); calculating heart wall complete dynamic strain/stress fields; computing endo/epicardial surfaces at all time points; and calculating overall distance from the N sets of guide points to the computed endo/epicardial surfaces and if the distance is too large, updating U_{I}^{m} according to the currently computed endo/epicardial surfaces until a desired criterion is met; and 2) a processor for executing the processing module.

Other embodiments may include methods for extracting cardiac elastodynamic biomarkers comprising: reconstructing passive stiffness parameters C in W (nonlinear potential energy) of myocardium from biomedical imaging measurements by: performing an optimization-based method combined with compressed sensing; finding distribution C, T such that the computed displacement u_{P}(X,t;C,T) matches the best with the displacement measurement U_{M}(X,t) taken with MR imaging techniques subject to the minimization of the weighted TV [w·TV(C)] in the parameter distribution; minimizing the objective function: Φ(C)=∫₀^{τ}(∫_{V}h·χ(X,t)·hdV)dt+w·TV(C); h=h(X,t;C)=u_{P}(X,t;C)−U_{M}(X,t), where the time interval [0,τ] represents one cardiac cycle, and the weight function χ(X,t) equals zero if the displacement is not measured at point X and t; once measurements are obtained on the displacement u_{M}(X,t) in part of the myocardial ROI, and on chamber blood pressure p_{M}(X,t), performing inverse computation to reconstruct the passive stiffness C and active contractility T of myocardium; and optionally solving governing PDEs and adjoint PDEs by way of finite element (FE) format.

A system for exact/quasi-exact interior reconstruction of radial MRI comprising: 1) a processing module operably configured for: performing a projection onto convex set (POCS) algorithm or singular value decomposition (SVD) technique from constraints of truncated Hilbert Transform:

$$g ( x ) = \frac{1}{π} PV {\int }_{{c}_{1}}^{{c}_{2}} f ( y ) \frac{d y}{x - y} = ( {H}_{L} f ) ( x ) , x ∈ ( {c}_{3} , {c}_{4} ) ;$$

and 2) a processor for executing the processing module, are encompassed by the invention as well.

Embodiments of the present invention further include: an imaging system comprising: 1) a processing module operably configured for performing Gaussian-based computations using bioluminescence tomography type data and for reconstructing into image form a region of interest (ROI) of an object from which the data was acquired; and 2) a processor for executing the processing module.

It is noted that although only specific embodiments or methods, systems, and devices are listed in this summary, these embodiments can be expanded to cover methods, systems, and/or devices regardless of the type of embodiment is listed. For example, when referring to only a method, such disclosure should be construed to include devices and systems comprising the same elements. Further, these specific embodiments can be altered or modified by omitting one or more elements specifically listed and/or by combining elements of another listed embodiment therewith. For example, if a method embodiment refers to having two method steps, that embodiment can be construed as a system capable of performing only one of those functions and/or as a system capable of performing both of the listed functions and any other function listed for another embodiment. It is within the capabilities of those of ordinary skill in the art to modify this disclosure in this way.

### BRIEF DESCRIPTION OF THE DRAWINGS

FIGS. 1A-B are schematic diagrams demonstrating differences between conventional CT and interior CT, respectively.

FIGS. 2A-F are images showing CS-based tomosynthesis reconstructions.

FIG. 3 is a schematic diagram demonstrating accurate interior reconstruction.

FIG. 4 is a schematic diagram showing a chord-averaging method.

FIGS. 5A-B are images identifying a ROI for reconstruction.

FIGS. 6A-M are images showing reconstructed ROIs.

FIGS. 7A-L are graphs identifying row profiles for reconstructed ROIs.

FIGS. 8A-L are graphs identifying column profiles for reconstructed ROIs.

FIG. 9A is an image of a reconstructed ROI.

FIGS. 9B-C are graphs of row and column profiles, respectively corresponding to the reconstructed ROI of FIG. 9A.

FIG. 9D is an image of a reconstructed ROI.

FIGS. 9E-F are graphs of row and column profiles, respectively corresponding to the reconstructed ROI of FIG. 9D.

FIGS. 10A-E are images of various reconstructed ROIs.

FIGS. 11A-E are graphs of row profiles for reconstructed ROIs of FIGS. 10A-E.

FIGS. 12A-E are graphs of column profiles for the reconstructed ROIs shown in FIGS. 10A-E.

FIGS. 13A-B are images of reconstructed images of real projection data.

FIGS. 14A-C are (A) an image of a reconstructed ROI, (B) a corresponding row profile graph, and (C) a graph of the corresponding column profile for the reconstruction.

FIGS. 15A-C are (A) an image of a reconstructed ROI, (B) a corresponding row profile graph, and (C) a graph of the corresponding column profile for the reconstruction.

FIG. 16 is a flowchart identifying work relating to the inventive subject matter.

FIGS. 17A-C are schematic diagrams demonstrating interior tomography.

FIGS. 18A-G are respectively a CT image of a ROI of a lung, a corresponding reconstruction of the ROI, a row profile and a column profile for the ROI.

FIGS. 19A-E are images for a CS-based reconstruction of a mouse chest.

FIGS. 20A-D are images demonstrating instant interior reconstruction.

FIG. 21 is a flowchart demonstrating a BLT method of the invention.

FIGS. 22A-B are schematics illustrating PA v. DA based BLT reconstruction.

FIG. 23 is a schematic diagram with photos of the components of an exemplary 1D grating based x-ray imaging platform according to an embodiment of the invention.

FIGS. 24A-C are images of 1D grating based multi-parameter x-ray imaging.

FIGS. 25A-D are a series of schematic diagrams showing an interior tomosynthesis system according to an embodiment of the invention.

FIG. 26 is a photo of a dynamic cardiac phantom.

FIG. 27A is a schematic diagram of an integrated OMT system of the invention.

FIG. 27B is a schematic of an optical surface scanning system of the invention.

FIG. 27C is a schematic diagram of an exemplary DOT system of the invention.

FIG. 27D is a schematic diagram of BLT system of the invention.

FIG. 27E is a schematic diagram of an FMT system of the invention.

FIG. 28 is a schematic diagram of an exemplary grating based phase imaging geometry according to embodiments of the invention.

FIGS. 29A1, 29A2, and 29B are schematics illustrating multi-source interior tomography systems in accordance with the invention.

FIG. 30A is a schematic showing a thick-wall ellipsoidal finite-element LV mode, with an ischemic region embedded in the wall.

FIG. 30B is a schematic demonstrating local geometric coordinates.

FIG. 30C is a schematic diagram showing local myofiber architectural axes.

FIG. 30D is a graph of LV filling pressure (in mmHg).

FIGS. 31A-C are schematic representations showing differences of epicardial displacement between ischemic and normal LV phantoms.

FIGS. 32A-C are schematic representations showing differences between dynamic and static epicardial displacement of an ischemic LV.

FIGS. 33A-B are graphs showing DCE convergent loci of various parameters for ischemic myocardia.

FIGS. 33C-D are graphs showing DCE convergent loci of various parameters for normal myocardia.

FIG. 34A is a schematic illustration of type I segmentation error.

FIGS. 34B-C are graphs showing DCE convergent loci of various parameters with type I segmentation error.

FIG. 34D is a schematic illustration of type II segmentation error.

FIGS. 34E-F are graphs showing DCE convergent loci of various parameters with type II segmentation error.

FIG. 35 is a flowchart demonstrating DCE.

FIG. 36 is a flowchart of tomography based DCE.

FIGS. 37A-C are images of compressive-sampling-based interior tomography of a mouse chest in Micro-CT.

FIG. 38A is a schematic of an exemplary inventive interior UTE-GRE sequence.

FIG. 38B is a schematic illustration of interior MRI based on UTE-GRE.

FIG. 39 is a flowchart for reconstruction of myocardial passive stiffness and active contractility.

FIG. 40 is a table showing a comparison between the real value of solution, initial guess, and dynamic/static reconstruction results for cardiac passive elastic anisotropic stiffness and active contractility.

FIG. 41 is a schematic illustration of phantom experiment.

FIG. 42 is a schematic illustration of animal experiments for evaluation.

FIG. 43 is a schematic representing an interior region for image reconstruction.

FIG. 44 is a schematic diagram of a 1D setting for interior reconstruction of radial MRI with prior knowledge.

FIGS. 45A-B are images from a simulation study of reconstruction of a ROI.

FIG. 46A-B are sinograms of a GE phantom from MRI radial data acquisition with different field of view (FOV).

FIG. 47 are images from a phantom study result concerning ROI reconstruction.

FIG. 48 is a schematic illustrating an exemplary method for acquisition of a MR projection according to embodiments of the invention.

FIGS. 49A-B are respectively a schematic diagram and an image demonstrating the wrap around effect with a fixed sampling rate and net precessional frequencies occurring at position A and position B within the FOV that have identical frequencies but different phase.

FIGS. 50A-C are scans of a GE phantom in a 4 T MR scanner using different FOVs, 40 cm, 20 cm, and 10 cm.

FIGS. 51A-C are images showing the project datasets corresponding to different zooming factors of the scans of FIGS. 50A-C.

FIG. 52A-C are images of the reconstructions of FIGS. 50A-C.

FIG. 52D is an image of interior reconstruction of the image of FIG. 50C.

FIGS. 53A-B are images demonstrating that the inventive interior MRI approach actually produced high spatial resolution.

FIGS. 54A-C are images showing normalized projection datasets.

FIGS. 55A-C are images showing the corresponding reconstruction results for the images of FIGS. 54A-C.

FIGS. 56A-C are images providing, for comparison, 512×512 images directly reconstructed from the normalized datasets of FIGS. 54A-C.

FIGS. 57A-L are images showing reconstructions with single Gaussian inclusion.

FIGS. 58A-I are images showing a comparison of boundary measurements from Gaussian sources and non-Gaussian sources.

FIGS. 59A-L are images of single-inclusion reconstructions with various shapes.

FIGS. 60A-H are images of single-inclusion reconstructions with different Gaussian noise levels.

FIGS. 61A-H are images showing single-inclusion reconstructions with different mismatch in optical background.

FIGS. 62A-C are images showing multiple-inclusion reconstructions with 5% Gaussian noise level.

FIGS. 63A-D are images showing multiple-inclusion reconstructions with 5% Gaussian noise level.

FIGS. 64A-F are images showing combinatorial optimization with the varying n for G-BLT.

FIGS. 65A-C are images showing In vivo mouse studies on Gaussian-based BLT.

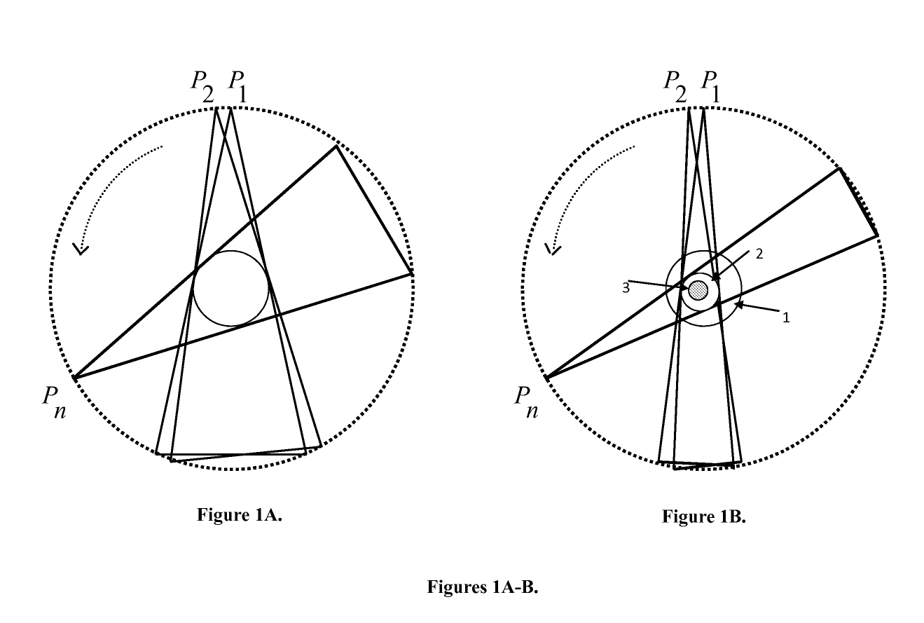

### I. COMPRESSIVE SAMPLING BASED TOMOSYNTHESIS

This compressive sampling (CS) based interior reconstruction technique can be directly applied to tomosynthesis. To demonstrate its feasibility, a mouse study was performed using a carbon nano-tube based technique.

For the study, an x-ray tube was used that is a compact and portable version of the x-ray source reported in Cao, G. H., et al. Respiratory-gated micro-CT using a carbon nanotube based micro focus field emission x-ray source—art. no. 691304, in Medical Imaging 2008 Conference, 2008, San Diego, Calif.: Spie-Int Soc Optical Engineering. The x-ray tube was operated at 1 mA peak tube current, 45 kV anode voltage, 112×152 μm effective focal spot size, and 20 msec pulse width. The x-ray exit window consists of 0.2 mm Be. No additional filtration was used in this experiment.

The x-ray detector was a CMOS flat-panel sensor with a CsI scintillator plate directly deposited on a photo diode array. It has 2400×2400 pixels with a nominal pixel size of 50 μm, giving an active area of 120×120 mm². It has a thin carbon fiber cover and allows up to 4×4 on-chip binning and 9 frames/sec high-speed imaging.

The camera was configured to run at 1 frame/sec and utilize only about ¼ of its full field-of-view (FOV) at the central region without binning, producing two-dimensional 1024×1024 projection images at 50 μm×50 μm pixel resolution. This detector configuration together with the scanner geometry give an effective FOV of 39×39 mm² and an effective digital sampling of 38.5 μm at the object plane. The gantry is driven by a digital stepping motor (Velmex, Inc., Bloomfield, N.Y.) and able to travel a full circle with a resolution of 0.001 degree.

In vivo mouse imaging experiments were performed following the protocols approved by the University of North Carolina at Chapel Hill. Several mice with an average weight of 25 grams were imaged. Animals were anesthetized with 1-2% isoflurane at a flow rate of 1.5-2 L/min from a vaporizer. The animal breathing rates after anesthetization were typically in the range of 80-100 breaths/min. A physiological monitoring system (BioVet, Spin Systems (QLD) Pty Ltd, Brisbane, Australia) was used to obtain the cardiac and respiration signals. The anesthetized animals were placed on top of the pressure sensor in the mouse sample holder and secured with adhesive restraints. The animals were put in the prone position such that the respiration sensor was approximately in the position of the abdomen to achieve maximum sensor coupling. To obtain the cardiac signals, ECG electrodes were taped to the footpads. Prior to imaging, iodinated contrast agent (Fenestra V C, Advanced Research Technologies Inc., Montreal, Canada) was infused via tail vein injection (0.02 mL/gram of mouse).

Projection images were acquired using an inventive gating approach, where the gating electronics is same as the one described in Cao, referenced above, except that in this study the physiological triggers were generated based on both respiration and cardiac gating. Physiological triggers were generated if and only if the first QRS complex of the ECG occurred within an acquisition window defined at a specific phase of the respiration cycle. For CT scans carried out in this study, 400 projections were acquired over a circular orbit of 199.5 degrees with a stepping angle of 0.5 degree at single frame acquisition. By running the detector at 1 frame/sec (camera integration time=500 ms), the scan time was 15-30 min, depending the mouse's respiration and heart rates. This scan time is critically depending on the temporal coincidence between the physiological triggers and the exposure windows, in addition to the temporal coincidence between the QRS complex of ECG and the acquisition window of the respiration signal.

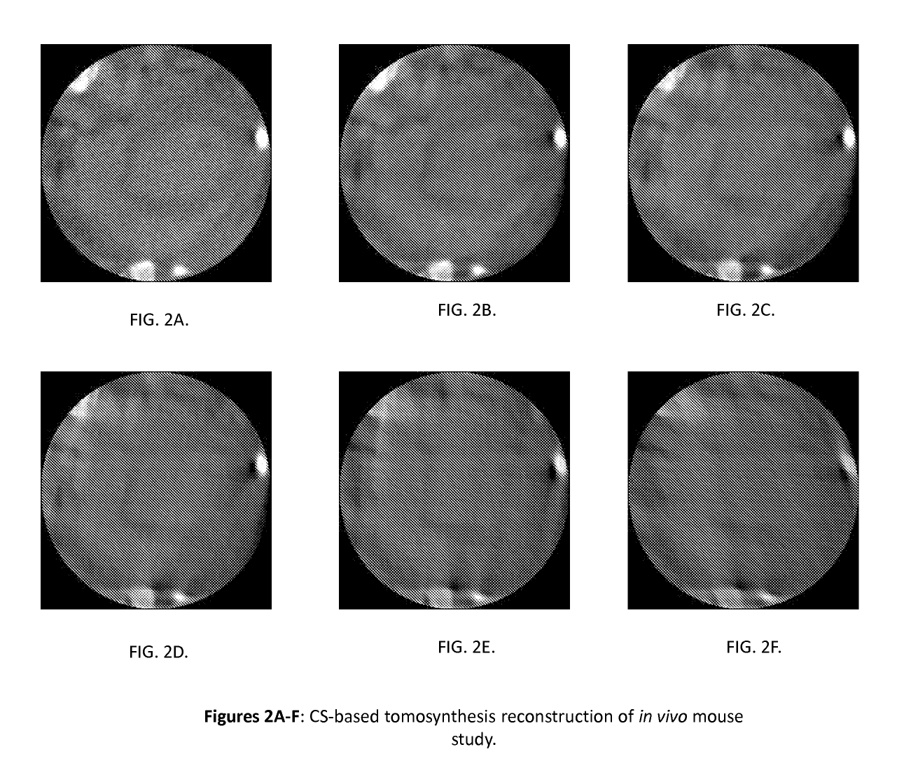

For the above acquired in vivo mouse cardiac projection datasets, we performed a CS-based interior reconstruction. Using the generalized Feldkamp algorithm, Feldkamp, L. A., L. C. Davis, and J. W. Kress, Practical cone-beam algorithm. J. Opt. Soc. Am., 1984. 1(A): p. 612-619. Wang, G., et al., A General Cone-Beam Reconstruction Algorithm. IEEE Transactions on Medical Imaging, 1993. 12(3): p. 486-496, first a volumetric image was reconstructed to serve as a global standard for the interior reconstruction. From such an image volume, a circular ROI was specified on a transverse slice to cover the contrast-enhanced beating heart. Then, a mask image was created for the ROI and a forward projection was performed to generate a mask projection. Later the mask projection was binarized to extract the projection data only through the ROI as the interior scan dataset. The interior reconstruction was performed using a CS based algorithm. Yu, H. and G. Wang, Compressed sensing based Interior tomography. Phys Med Biol, 2009. 54(9): p. 2791-2805, the disclosure of which is hereby incorporated by reference herein in its entirety. For different scanning ranges of tomosynthesis, the final reconstruction results are shown in FIGS. 2A-F.

More specifically, FIGS. 2A-F show a reconstruction from un-truncated global projections with 200 degree scanning range, which serves as a basement for the evaluation (FIG. 2A), and reconstructions from local truncated projections with 160, 140, 120, 100 and 80 degrees scanning ranges, respectively (FIGS. 2B-F).

This new method has great potential to reduce the x-ray radiation dose. The key step in the interior reconstruction is to invert a truncated Hilbert transform. Here, an improved projection onto convex sets technique is presented for interior reconstruction. To construct convex sets, several constraints are used, which include knowledge of a subregion in the ROI, Hilbert transform data within the ROI, image bounds including positivity, interior projection data through the ROI, cross-section boundary, total-variation regularization, line integral of x-rays through the ROI and scout views covering the cross-section.

Constraints for Interior Tomography in a POCS Framework. Numerical studies are performed to compare the effects of different constraints. These constrains are imposed simultaneously, selectively and individually to obtain corresponding reconstructions and evaluate relative strengths of typical constrain combinations.

Recently, this x-ray interior tomography was proposed for local applications such as cardiac imaging [1], which is a promising way to significantly reduce x-ray dose. Using such methods and systems, the scan field of view (FOV) can now be as small as the ROI and the projection data can be truncated at both ends beyond the ROI. The intensity of a sub-region with the ROI must however be known. Previously, efforts to reduce the projection data for reconstruction permitted using shorter x-ray source angular scan ranges [2-4] and also truncating projection data at one end beyond the ROI [5], none of these allowed use of a FOV completely within the object support. Also, interior tomography results have been independently reported by other research groups [6, 7].

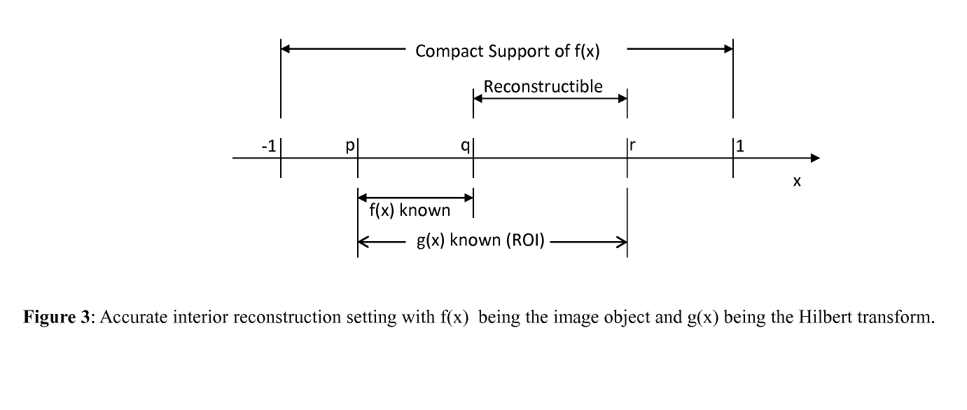

Along the direction of interior tomography, we extended its conditions to permit 3-D ROI reconstruction [8], and tested the feasibility of using blood in aorta and bone in vertebra as known sub-regions for cardiac imaging [9]. When exact information is not available, we also proposed compressive sensing based interior tomography [10] to reconstruct piece-wise continuous imaging objects. In the framework of backprojection filtration, by backprojecting the differentiated projection data we can obtain the Hilbert transform image which must be inverted to obtain the original image. However, as shown in FIG. 3, Hilbert transform gₗ(x) of a line segment within the object support with intensity fₗ(x) is only available in the FOV/ROI and thus it is truncated i.e.

$${g}_{l} ( x ) = \frac{1}{π} PV {\int }_{- 1}^{1} {f}_{l} ( y ) \frac{d y}{x - y} = {HF}_{{1}_{y}} , x ∈ ( p , r ) \qquad ( 1 )$$

where, PV represents the principle value and [−1,1] is normalized compact support. Eq. (1) can be discretized as

$${HF}_{l} = {G}_{l} , \\ where , H = [ \begin{matrix}h ( 1 , 1 ) & h ( 1 , 2 ) & … & h ( 1 , N ) \\ h ( 2 , 1 ) & h ( 2 , 2 ) & … & h ( 2 , N ) \\ ⋮ & ⋮ & ⋱ & ⋮ \\ h ( M , 1 ) & h ( M , 2 ) & … & h ( M , N )\end{matrix} ] \qquad ( 2 )$$

is the Hilbert Transform matrix for which the coefficients can be calculated as described in [11, 12], Fₗ=[f₁, f₂, . . . , fₙ, . . . , f_{N}]^{T} are the intensity values of pixels on the compact support [−1,1] and Gₗ=[g₁, g₂, . . . , gₘ, . . . , g_{M}]^{T} is a vector of known Hilbert transform corresponding to sample points on the interval [p, r].

Note the values of Fₗ are known on [p,q] and reconstructible on [q,r]. It is a non-trivial problem to invert truncated Hilbert transform. Method of projection onto convex sets (POCS) [13] is normally employed to perform the inversion operation. Inversion can also be carried out using our recently proposed truncated singular value decomposition based method [11]. Known sub-region is generally small and permits reconstruction of strip (group of lines). This reconstructed strip can be used as known sub-region to reconstruct in orthogonal direction to enable entire ROI reconstruction [9]. For this approach, the final image quality is dependent on the inversion errors of first pass. To improve the image quality, we developed a chord averaging method in which the image strips are reconstructed along various directions.

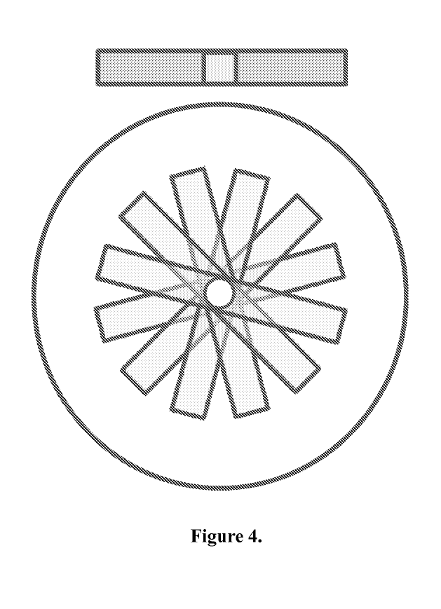

FIG. 4 illustrates the chord averaging method. The image pixels at the same position in different image strips are averaged in the final image. Inversion along each strip can be carried out with either POCS or TSVD method.

Inversion with POCS involves repetitive projection of desired variables from one convex set to another. The solution lies in the intersection set of all convex sets. The convex sets/constraints commonly employed for interior tomography applications are i) the Hilbert transform of the image along the π-lines in the FOV is equal to the backprojection of differentiated projection data, ii) integral of the image along the 77-lines is equal to the projection along that line, iii) knowledge of known sub-region within ROI, iv) maximum intensity in the image and v) image positivity. The solution set corresponding to these convex sets is broad and the reconstructed image quality has been found to be limited [5, 9]. The performance of POCS method can be improved by providing some additional information outside the ROI in the form of scout views covering the entire object support and introducing additional convex sets to more accurately implement the line integral constraint for all the rays.

Hilbert transform constraint operates one line segment (F) in the image at a time and the SART-based integral operates on 2-D image obtained as a union of these 1-D images. These constraints provide following least squares solutions

Minimize∥Fₗ∥₂ subject to HFₗ=Gₗl∈L (3)

Minimize∥F∥₂ subject to AF=P, (4)

where L is union of set of lines in all filtering directions, F is a the vector form of the image, A is the system matrix, and P is a vector corresponding to projections.

L2 norm minimization makes inherent assumption that the image is smooth and cannot provide information about the sharp features like edge in an image [14, 15]. Recently, there has rightly been an increased interest in total variation regularization. This involves minimization of a total variation function which can be written as:

Minimize∥∇F∥₁ subject to HFₗ=Gₗl∈L, AF=P, and F∈C₁∪C₂∪ . . . ∪C_{N} (5)

where ∇ is a gradient operator, C₁, C₂, . . . , C_{N} are N additional constraints.

The seminal work of Rudin et al [15] demonstrated the edge preserving properties of this method. They also pointed out the capability of Total variation methods to project the solution back to the constraint set. Due to nonlinearity these methods are computationally expensive. Vogel et al further demonstrated their advantages and developed computationally efficient iterative algorithm [16] to improve computational efficiency. In the past years, compressed sensing [17, 18] theory highlighted previously unknown capabilities of total variation methods. The theory states that sparse or approximately sparse signals can be exactly recovered for severely underdetermined system even if the measurements are inaccurate. Medical images themselves are not sparse but their gradients generally are with uniformity within the organ and variations at the boundary [19]. Total variation has already been successfully applied to diffraction tomography [20], SPECT [21], and CT [19, 22].

This invention provides an improved projection onto convex sets method and evaluates the contributions of these constraints on reconstruction image quality.

METHODS. An improvised POCS method is presented for interior tomography reconstruction. POCS involves repetitive projection onto various convex set. If P₁, . . . , P_{M}, are operator to project onto respective convex sets C₁, . . . , C_{M} then the composite operator can be written as T=P₁ P₂ . . . P_{M} and the POCS procedure can be written as fₙ=Tⁿf, where n indicates the iteration number. The convex sets used and how to impose them is presented next followed by the reconstruction algorithm for interior tomography.

Convex Sets. Hilbert Transform Constraint: Backprojection of the differentiated projection data gives the Hilbert transform of the image in the ROI as in Eq. (1). In every iteration, this constraint can be imposed by equating the Hilbert transform within the ROI with its known values and then inverting to obtain images intensities obtained after enforcing these constraints. For a line in the image this constraint can be mathematically written as

C₁=(f∈Fₗ,|HFₗ=gₗ(x),x∈(p,r)) (6).

Integral Constraint for x-rays in the ROI: Since projection for all the x-rays passing through the ROI are known, the integral of intensities along a line is known. This can be mathematically written as

C₂={f∈Fₗ,|C_{f}=∫₋₁¹fₗ(x)dx} (7).

To implement this constraint the intensity of each sample point along the line is multiplied with the ratio of estimated to real integral C_{f} along the same line.

Image Positivity: In the CT field, the image intensities represent the x-ray attenuation coefficients which are always positive. This constraint can be imposed by equating all image pixels with negative intensity to zero. This constraint can be mathematically written as

C₃={f∈Fₗ,|fₗ(x)≧0,x∈[−1,1]} (8).

Maximum Value: Generally there is some idea about what the maximum within the image would be. In non-contrast imaging of humans this may correspond to the maximum attenuation coefficient of the bones. A suitable value above the maximum value possible can be set as the maximum intensity value possible. This constraint can be imposed by equating all image pixels with the intensity above this value to it. This constraint can be mathematically written as

C₄={f∈Fₗ,fₗ(x)≦fₘₐₓ,x∈[−1,1]} (9).

Known Sub-region: This constraint can be imposed by equating the pixels for which the values are known beforehand to the corresponding values, which constraint can be written as

C₅={f∈Fₗ,|fₗ(x)=f_{known}(x),x∈(p,q)} (10).

Knowledge of Compact Support: Knowledge of the compact support may be obtained prior to performing a scan. A light source can be rotated around the object like the x-ray source and whether the light arrives at the detectors can be sensed. A sinogram-like data can then be generated by assigning a small constant value at the locations where the light does not reach detector and a value of zero at locations where it reaches the detector. These data can be differentiated, and backprojected in the horizontal and vertical filtering directions to obtain respective hilbert transform images. The sum of the absolute values of these two images provides an image with values close to zero within the boundary and high values at the boundary. From this the compact support of the object can be detected in various ways. For numerical experiments in this paper, the compact support was obtained as a region with values below a small threshold. The compact support so determined was broadened slightly by first adding 10 pixels to its boundaries along the row and then adding 10 pixels to those along the column. Let us call the set containing the pixels within the compact support as [symbol] , then this convex set can be written as

C₆={f∈F|f∈ [symbol] }U{0|f∉ [symbol] } (11).

SART-based integral constraint for x-rays passing through ROI: The SART algorithm can be used to impose the integral constraint for all the x-rays passing through the ROI. This constraint can be written as [23, 24]:

$${C}_{7} = \{ {f}_{j} ∈ F , \vert {f}_{j}^{iter + 1} = {f}_{j}^{iter} + \frac{1}{{\sum }_{i ∈ P} {a}_{ij} \frac{{L}_{i}}{{w}_{i}}} {\sum }_{i ∈ M} \frac{{a}_{ij} ( {p}_{i} - {a}_{i} {F}^{iter} )}{{\sum }_{j = 1}^{J} {a}_{ij}} \} \qquad ( 13 )$$

where iter indicates the iteration number, F^{iter} is a vector of image pixel values at current iterate, i=1 . . . l indexes the rows of the system matrix A each of which corresponds to an x-ray projection, M is a set of x-rays passing through the ROI, j=1 . . . J indexes the columns of A and the image pixels, aᵢ is the i^{th} row of A, aᵢⱼ=wᵢⱼΔx with wᵢⱼ being the weight contribution of fⱼ on the image grid to the projection pᵢ, Lᵢ is the length of the intersection between the i^{th} x-ray path and boundary of the region being reconstructed with SART, wᵢ=Σⱼ₌₁^{J}wᵢⱼ and pᵢ−aᵢF^{iter} is the i^{th} difference between the real line integral and the line integral estimated from current image F^{iter}.

SART-based integral constraint for x-rays in scout views. A scout-view contains x-rays through the entire compact-support. In clinical setting, two orthogonal scout views are normally acquired to determine the start and end points of the scan in longitudinal direction. This constraint can be written as:

$${C}_{8} = \{ {f}_{j} ∈ F , \vert {f}_{j}^{iter + 1} = {f}_{j}^{iter} + \frac{1}{{\sum }_{i ∈ N} {a}_{ij} \frac{{L}_{i}}{{w}_{i}}} {\sum }_{i ∈ N} \frac{{a}_{ij} ( {p}_{i} - {a}_{i} {F}^{iter} )}{{\sum }_{j = 1}^{J} {a}_{ij}} \} , \qquad ( 14 )$$

where, N is a set of x-rays in the scout views and description of all other parameters is the same as for Eq. (13).

Total variation regularization: The problem can be defined as:

C₉=(f∈F|min∥∇F∥₁ subject to C₁ to C₈) (15).

In image processing literature, it is well known that the gradient magnitude of an image can be written as

$$\begin{matrix}[ 25 , 26 ] & \\ \vert ∇ F ( x , y ) \vert = \sqrt{{( \frac{\partial F}{\partial x} )}^{2} + {( \frac{\partial F}{\partial y} )}^{2}} . & ( 16 )\end{matrix}$$

Equation (16) can be approximated in terms of image pixels as [19]:

|∇F(x,y)|=\sqrt{[f(x,y)−f(x−1,y)]²+[f(x,y)−f(x−1,y)]²} (17).

TV function ∥∇F∥₁ is now obtained as U=∥∇F∥₁=ΣₓΣ_{y}|∇F(x,y)| (18)

Reconstruction Algorithm. The algorithm consists of three major steps: chord averaging, SART-based integral constraint, and total variation regularization which are sequentially repeated. The compact support (C₆) constraint is imposed after each of the three steps. During the chord averaging step, in each filtering direction, the current image intensities are projected onto the convex sets (C₁-C₅) of Hilbert transform, integral constraint, minimum value, maximum value, and known-information. In the next step, an iteration of SART-based integral constraint (C₇) is performed using the x-rays passing through the ROI followed by an iteration of SART-based integral constraint (C₈) for the x-rays corresponding to the 2 scout views. Gradient descent algorithm as in references [19, 22] is used to perform total variation regularization. To use gradient descent algorithm, the gradient of the total variation function (Eq. 18) must be available with respect to the image pixels f(x,y). This gradient can be approximated as in [19, 21]:

$$V ( x , y ) = \frac{\partial U}{\partial f ( x , y )} = \frac{( f ( x , y ) - f ( x - 1 , y ) )}{\sqrt{\begin{matrix}{[ f ( x , y ) - f ( x - 1 , y ) ]}^{2} + \\ {[ f ( x - 1 , y + 1 ) - f ( x - 1 , y ) ]}^{2} + δ\end{matrix}}} + \frac{( f ( x , y ) - f ( x , y - 1 ) )}{\sqrt{\begin{matrix}{[ f ( x + 1 , y - 1 ) - f ( x , y - 1 ) ]}^{2} + \\ {[ f ( x , y ) - f ( x , y - 1 ) ]}^{2} + δ\end{matrix}}} + \frac{f ( x + 1 , y ) + f ( x , y + 1 ) - 2 f ( x , y )}{\sqrt{{[ f ( x + 1 , y ) - f ( x , y ) ]}^{2} + {[ f ( x , y + 1 ) - f ( x , y ) ]}^{2} + δ}} \qquad ( 19 )$$

where V is the gradient of the total variation function U. δ is a small number necessary to avoid denominator value from going to zero. The pseudo code of the inventive algorithm is as follows:

1) a=0.2, step_{rad}=0.95, N_{TV}=20, flag=0,

2) F=0

3) repeat main loop

4) Fₒ=F

5) Project F onto convex set C₆. Impose the compact support constraint

6) For k=1, K

7) Project F onto convex sets C₁ through C₅, i.e., impose the Hilbert transform, integral, image Positivity, image maximum and known sub-region constraints

8) End for

9) Project F onto convex set C₆. Impose the compact support constraint

10) Fᵣₑₛ=F

11) P_{M}=A_{M}F. Estimate the forward projections for the x-rays passing through the ROI.

12) Project F onto convex set C₇. Impose the SART-based integral constraint for the x-rays passing through the ROI

13) P_{N}=A_{N}F. Estimate forward projections for x-rays in the scout views.

14) Project r onto convex set C₃. Impose image positivity constraint

15) Project F onto convex set C₆. Impose the compact-support constraint.

16) Project F onto convex set c₈. Impose the SART-based integral constraint for x-rays corresponding to scout views

17) Project F onto convex set C₃. Impose image positivity constraint

18) Project r onto convex set C₆. Impose the compact support constraint

19) NonTVupdate=∥F−Fₒ∥₂

20) If (flag==0), Estimate the initial step-size

21) step=x×NonTVupdate

22) flag=1

23) End if

24) Fₒ=F

25) For out=1,N_{TV}

26) Calculate the gradient of TV function using Eq. 19 and obtain normalized descent directions D

27) F=F−step×D

28) End for

29) TVupdate=∥F−Fₒ∥₂

30) If TVupdate<step_{red}×dₚ then step=step×step_{red}.

31) Until stopping criteria are met.

NonTVupdate represents the image update due to imposition of constraints C₁ through C₈. K is the number of filtering directions used for the chord averaging step. TVupdate represents the same for gradient-descent step to impose constraint C₉.

Number of gradient descent steps taken, in each iteration, is defined by the parameter N_{TV}. The initial step-size (step) is determined by the parameter α as a small percentage of first Non-TV update due to constraints (C₁-C₈). To ensure that the change in image due to both non-TV constraints and TV constraint are similar the gradient-descent step-size is reduced by a factor step_{red} if the ratio of gradient-descent step to POCS step is greater than x_{red}. We used a fixed number of iterations, which was 1000 for this study, as the stopping criterion and Fᵣₑₛ is the resultant image obtained after chord averaging step and imposition of compact support constraint.

Numerical Results. The low-contrast Shepp-Logan phantom was used for rigorous testing of the reconstruction algorithm. In particular, 1200 views of non-truncated projection data were acquired. However, only the x-rays passing through the ROI were used for the reconstructions. Two scout views covering the entire compact support were also utilized. The source to iso-center distance was 75 cm. A linear virtual detector 84 cm in length with 1050 detector pixels was used. The reconstructed image size is 50×50 cm² with 513×513 pixels and radius of ROI was 8 cm.

Various simulation cases are described in Table 1.

TABLE 1
Description of numerical simulation cases for the Shepp-Logan phantom

| Case No. | Description |
|---|---|
| 1 (15) | All constraints, i.e. all convex sets C₁ through C₉ are utilized |
| 2 (25) | All constraints - C₂ (simple integral constraint) i.e. convex sets C₁ and C₃ |
| | through C₉ are utilized |
| 3 (39) | All constraints - C₆ (SART for integral constraint) i.e. convex sets C₁ |
| | through C₅, and C₇ through C₉ are utilized |
| 4 (17) | All constraints - C₂ (simple integral constraint) - C₅ (known-sub-region) i.e. |
| | convex sets C₁, C₃, C₄ and C₆ through C₉ are utilized |
| 5 (19) | All constraints - C₂ (simple integral constraint) - C₃ (positivity) i.e. convex |
| | sets C₁, C₄ and C₅ through C₉ are utilized |
| 6 (21) | All constraints - C₂ (simple integral constraint) - C₄ (maximum value) i.e. |
| | convex sets C₁, C₃ and C₅ through C₉ are utilized |
| 7 (27) | All constraints - C₂ (simple integral constraint) - C₇ (SART-based integral |
| | constraint for x-rays passing through ROI) i.e. convex sets C₁, C₃ through |
| | C₆, C₈, and C₉ are utilized |
| 8 (26) | All constraints - C₂ (simple integral constraint) - C₈ (SART-based integral |
| | constraint for x-rays in scout views) i.e. convex sets C₁, C₃ through C₆ and |
| | C₉ are utilized |
| 9 (28) | All constraints - C₂ (simple integral constraint) - C₉ (Total-variation |
| | regularization) i.e. convex sets C₁ and C₃ through C₈ |
| 10 (34) | All constraints - C₂ (simple integral constraint) - C₁ (Hilbert-transform |
| | constraint) i.e. convex sets C₃ through C₉ |
| 11 (36) | All constraints - C₂ (simple integral constraint) - C₆ (compact-support) i.e. |
| | convex sets C₁, C₃ through C₅, C₇ and C₈ |
| 12 (29) | Only Hilbert Transform constraint |
| 13 (30) | Only SART for integral constraint |
| 14 (31) | All-constraints - C₂ (simple integral constraint)) - C₅ (known-sub-region) |
| | i.e. convex sets C₁, C₃, C₄ and C₆ through C₈ are utilized. Only horizontal |
| | filtering direction |
| 15 (32) | All-constraints - C₂ (simple integral constraint)) - C₅ (known-sub-region) |
| | i.e. convex sets C₁, C₃, C₄ and C₆ through C₈ are utilized. Only Vertical |
| | filtering direction |
| 16 (33) | All-constraints - C₂ (simple integral constraint)) - C₅ (known-sub-region) |
| | i.e. convex sets C₁, C₃, C₄ and C₆ through C₉ are utilized. Horizontal and |
| | vertical filtering directions |
| 17 (35) | All-constraints - C₂ (simple integral constraint)) - C₅ (known-sub-region) |
| | i.e. convex sets C₁, C₃, C₄ and C₆ through C₉ are utilized. All 60 filtering |
| 18 (37) | Only the constraints C₁, and C₆ through C₈ are utilized |
| 19 (38) | Only the constraints C₁, and C₆ through C₈ are utilized. Only horizontal |
| | filtering direction |

The purpose of these simulations was to demonstrate the merits of the algorithm and understand the importance and contributions of various constraints. These cases are divided into three types to present the results in a simple and meaningful manner.

For type 1 reconstructions, simulation cases of 1 through 11 and case 18, 60 filtering directions over 180° and a combination of constraints are utilized for the chord averaging step. In each filtering direction, only pixels on the lines passing through the defined known sub-region are projected onto the convex sets used during chord averaging step, regardless of whether known-information is utilized or not.

For type 2 reconstructions, cases 12 and 13, only one constraint is utilized for reconstruction. Reconstruction for case 12 is carried out similar to that for type 1 one cases except that only Hilbert transform constraint is enforced. In case 13 only SART is used and hence there is no filtering involved.

When no known information is utilized, pixels on all the lines within ROI can be projected onto convex sets during the chord averaging step. We call these as type 3 reconstructions. Accordingly, Cases 14 through 17 and case 19 are reconstructed using one of more filtering directions.

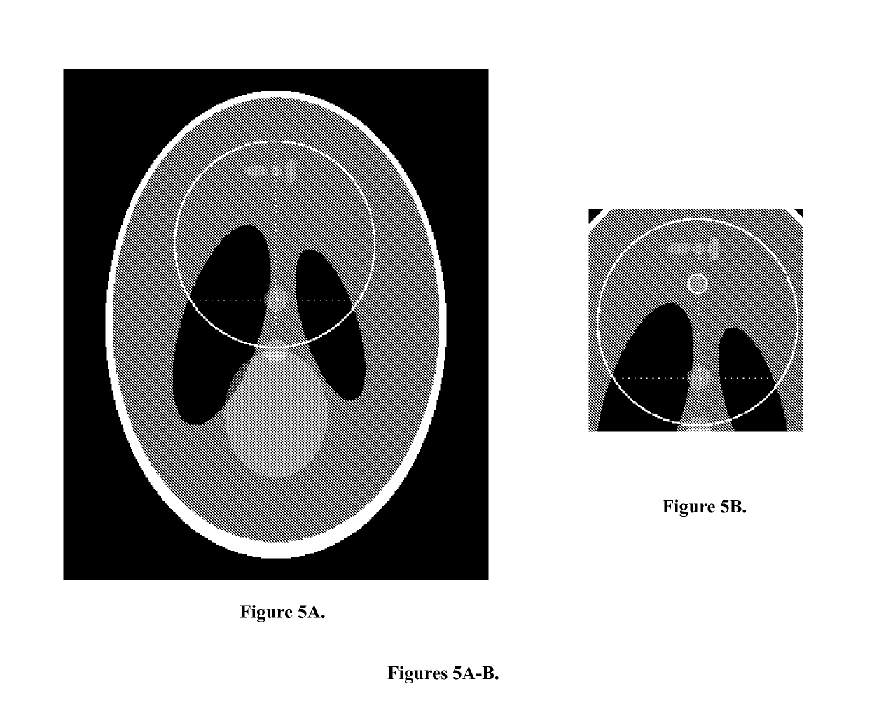

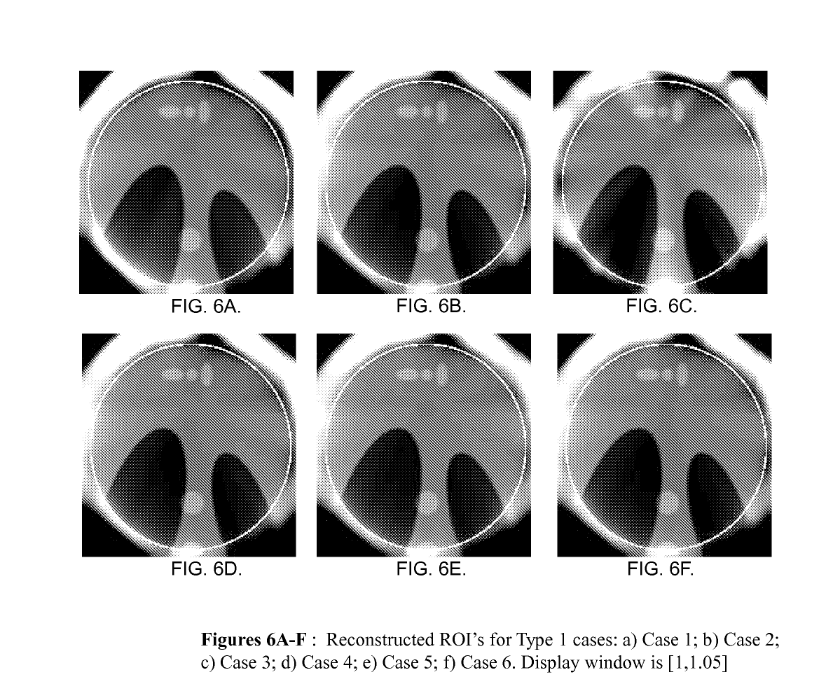

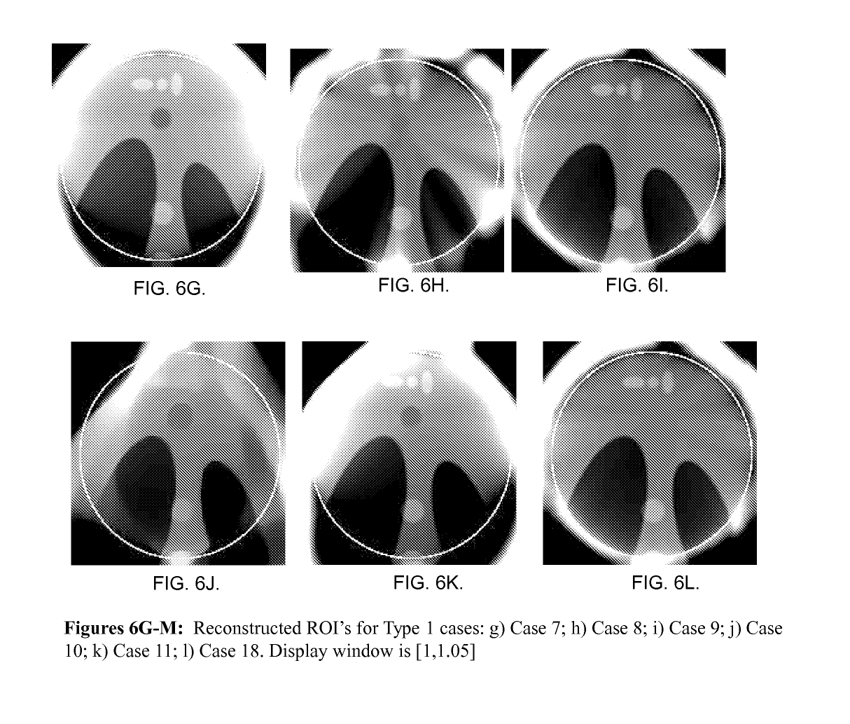

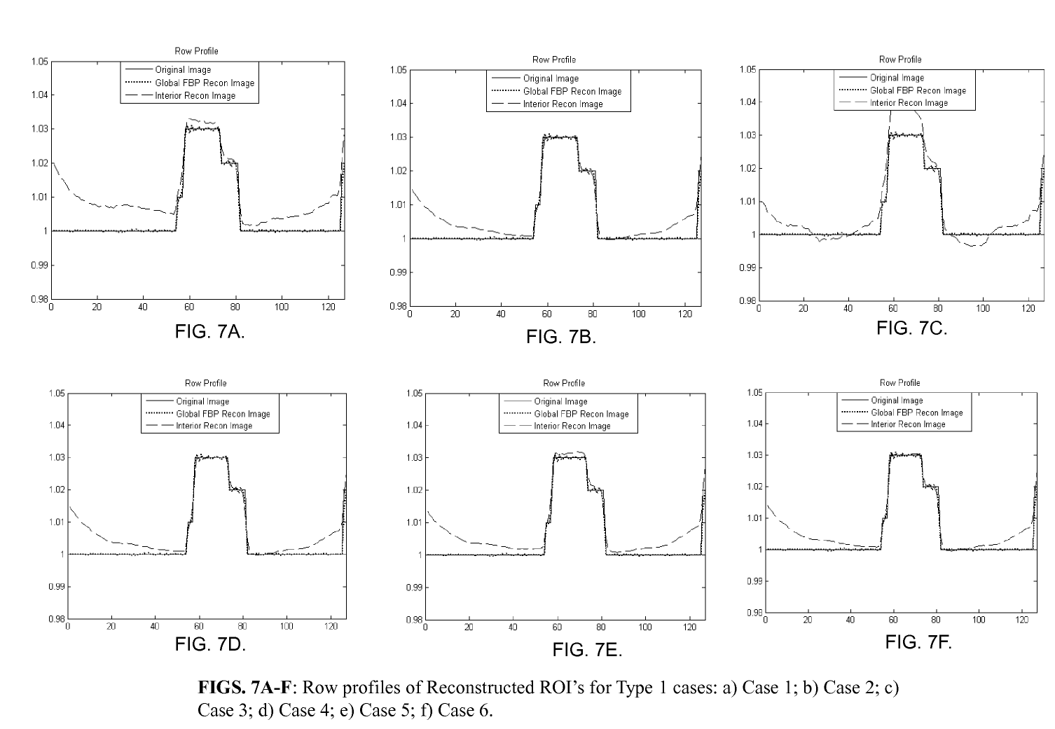

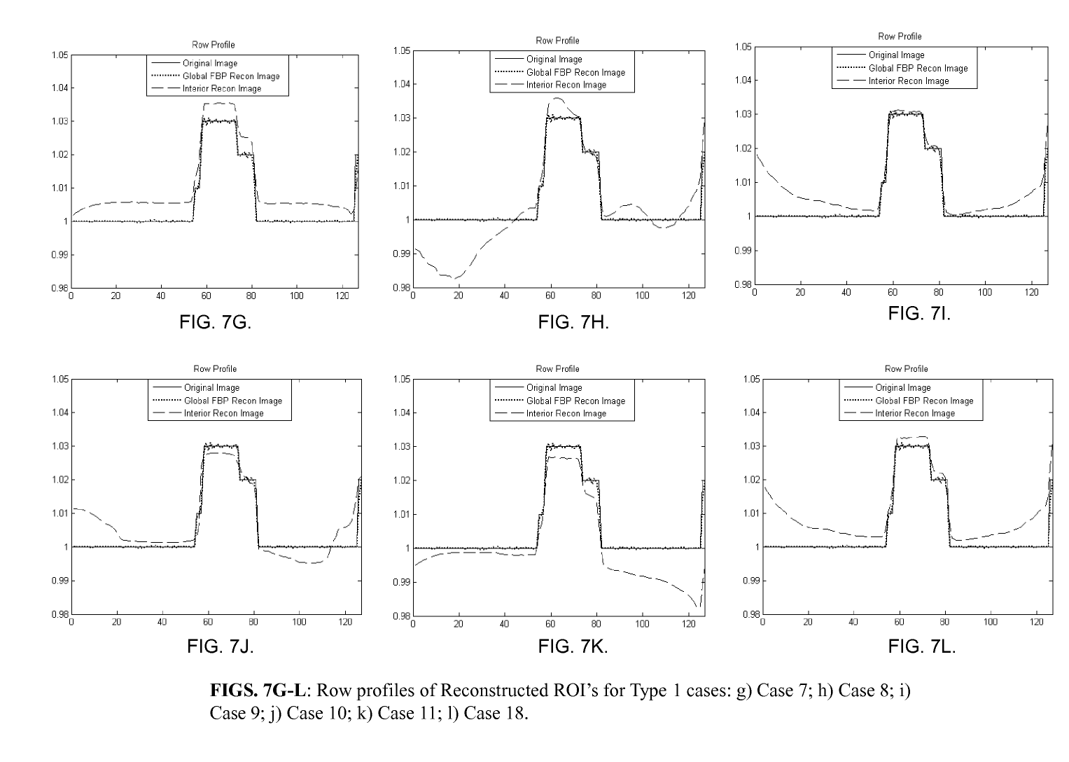

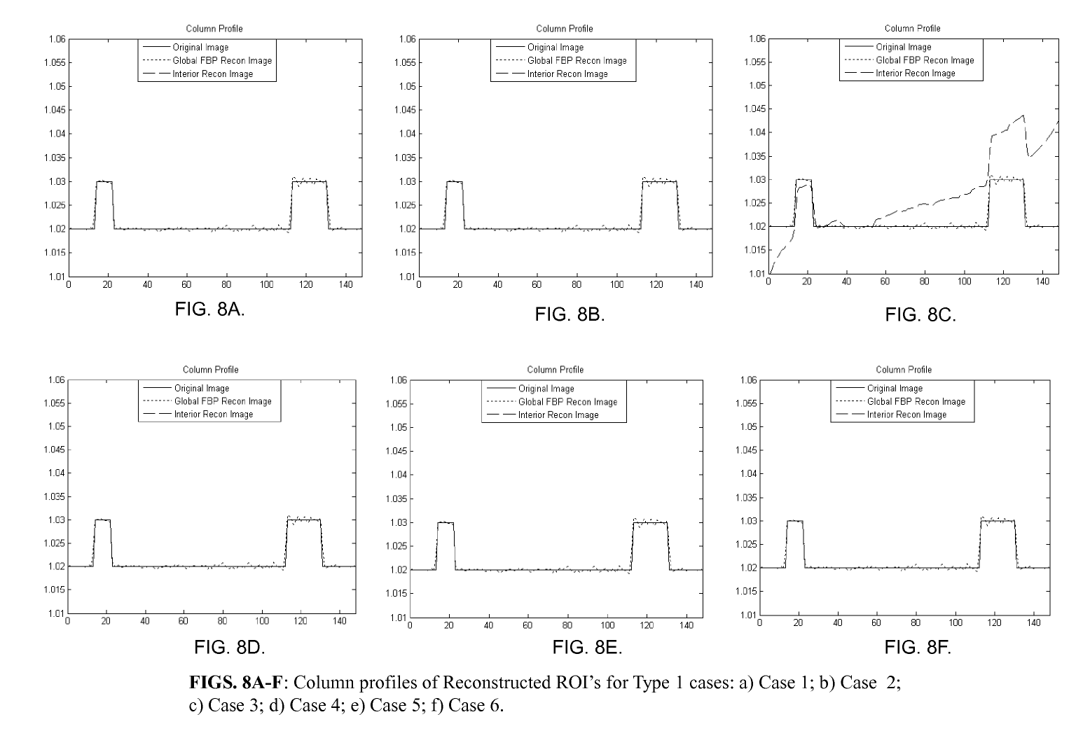

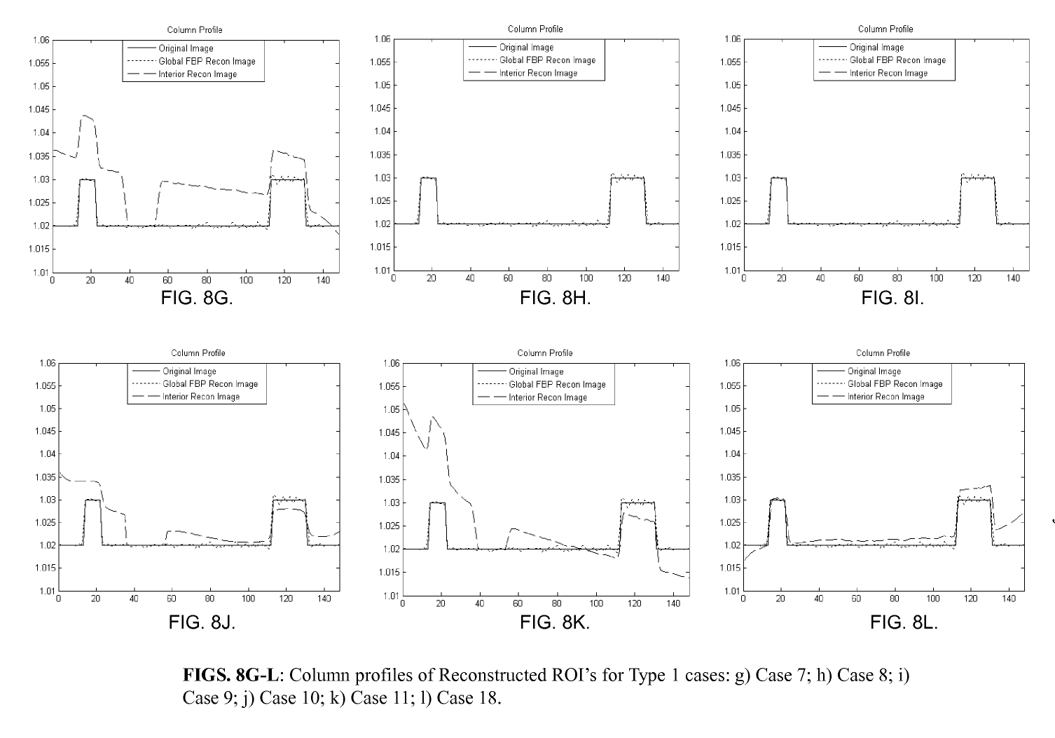

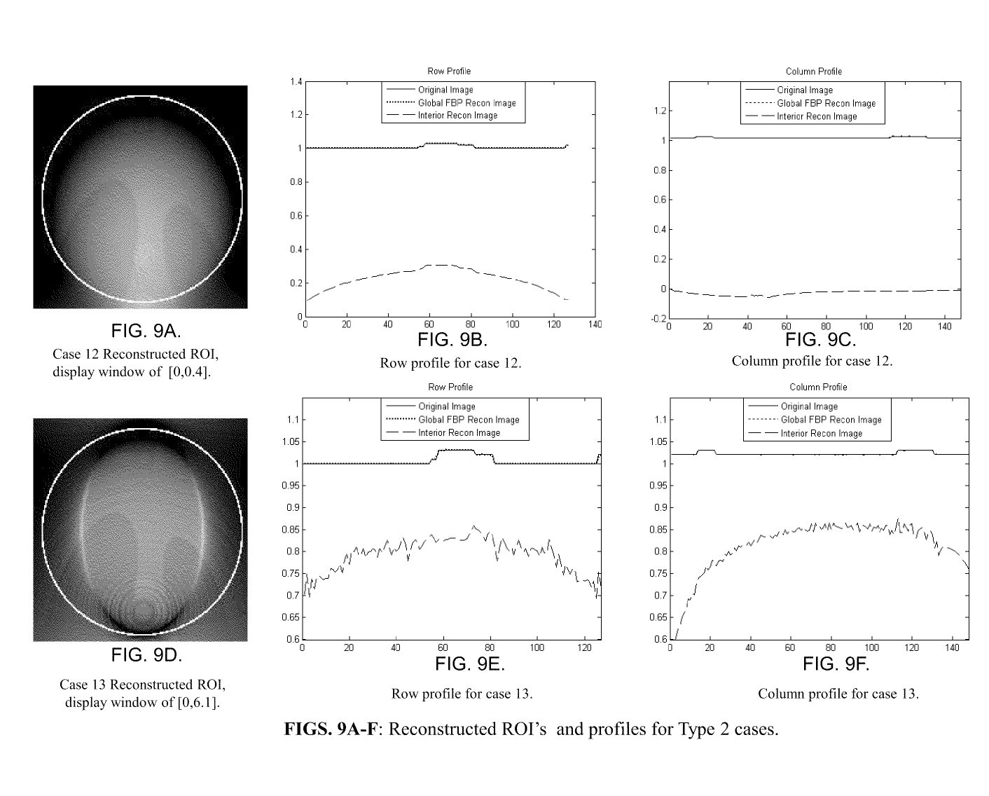

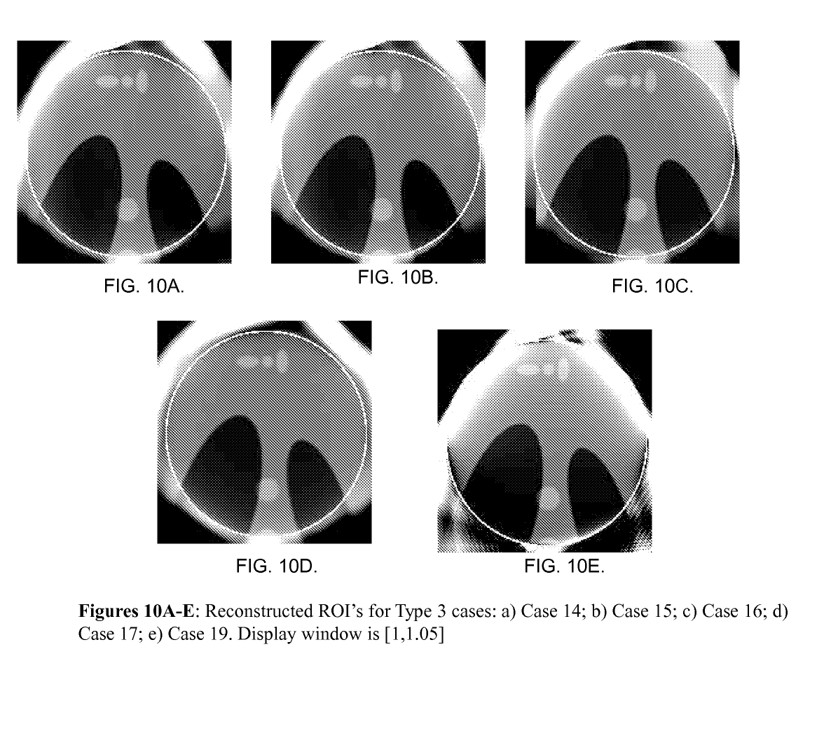

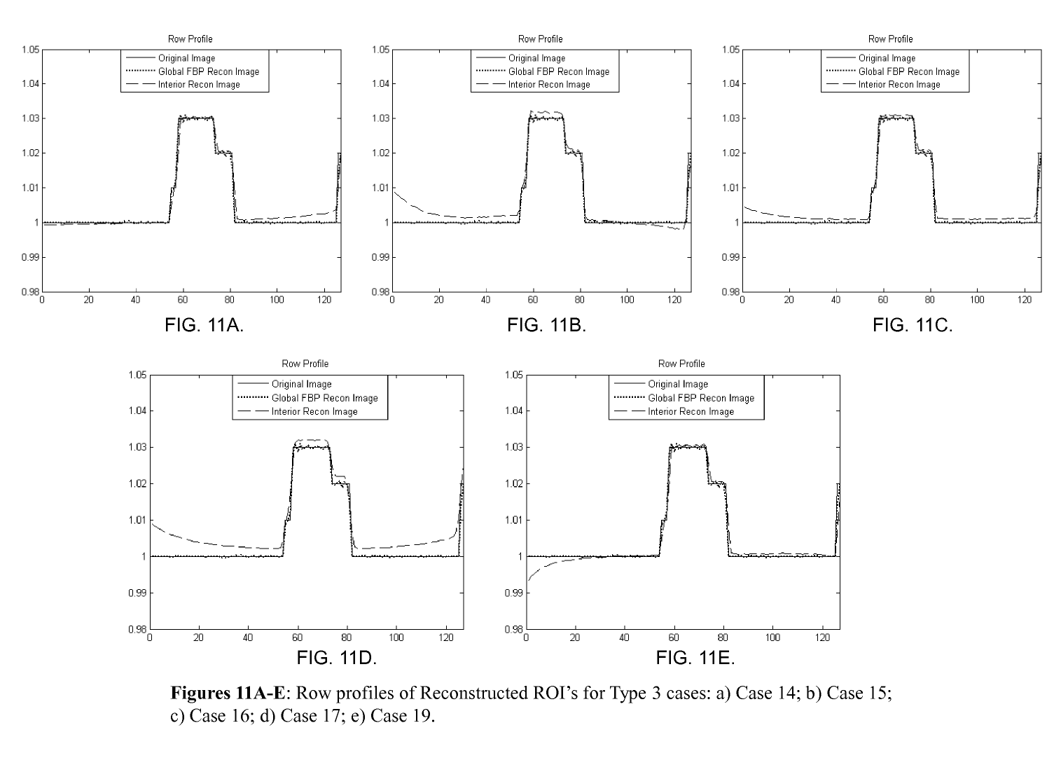

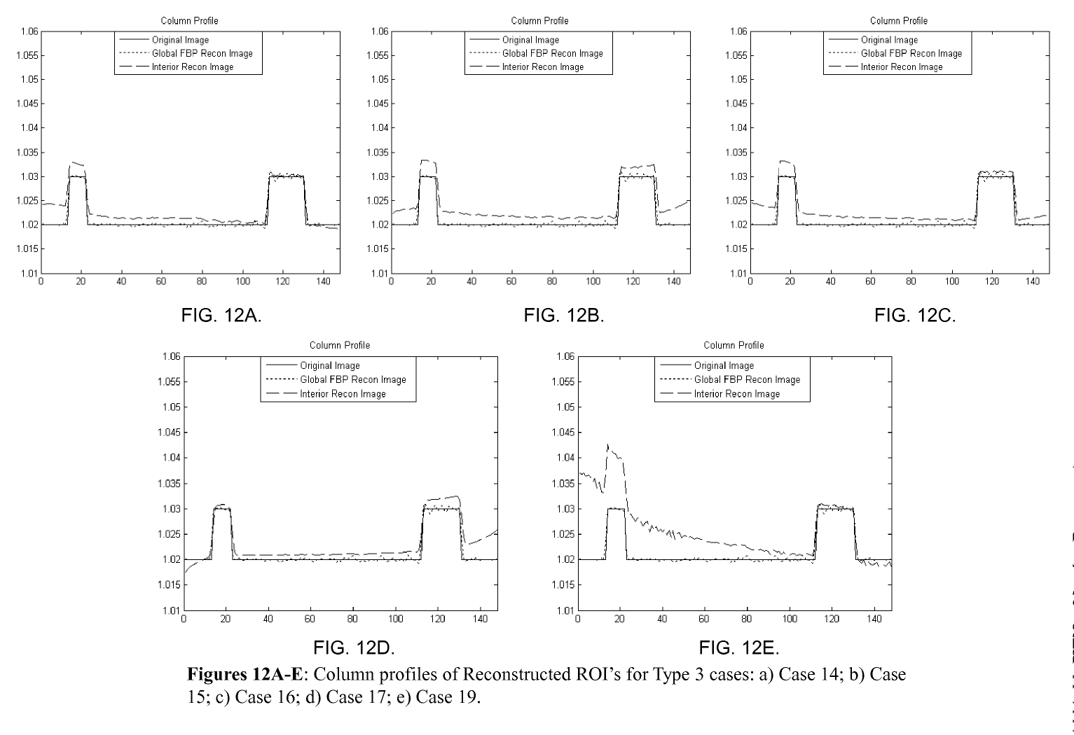

Original images, with the known information, ROI, known sub-region, and image profile locations, are shown in FIGS. 5A-B. Reconstructed images corresponding to type 1 cases are shown in FIGS. 6A-M with the corresponding row and column profiles respectively shown in FIGS. 7A-L and 8A-L. Reconstructed images corresponding to type 2 cases along with corresponding row and column profiles are shown in FIGS. 9A-F. Reconstructed images corresponding to type 3 cases are shown in FIGS. 10A-E, with the corresponding row and column profiles respectively shown in FIGS. 11A-E and 12A-E.

TABLE 2
Measured image quality parameters for various simulation cases
described in Table 1.

| | FWHM | | Mean | |
|---|---|---|---|---|
| Case | (number of pixels) | Noise | Error | Maximum Error |
| 1 | 3 | 4.7791E−4 | 0.0031 | 0.0334 |
| 2 | 3 | 2.2576E−4 | 0.0021 | 0.0216 |
| 3 | 3 | 12E−4 | 0.0030 | 0.0336 |
| 4 | 3 | 2.2863E−4 | 0.0023 | 0.0221 |
| 5 | 3 | 1.8755E−4 | 0.0029 | 0.0239 |
| 6 | 3 | 2.2798E−4 | 0.0021 | 0.0212 |
| 7 | 3 | 20.0E−4 | 0.0039 | 0.0445 |
| 8 | 3 | 5.4822E−4 | 0.0110 | 0.0396 |
| 9 | 3 | 1.9675E−4 | 0.0024 | 0.0272 |
| 10 | 2 | 5.0817E−4 | 0.0061 | 0.0471 |
| 11 | 3 | 9.6556E−4 | 0.0092 | 0.1177 |
| 12 | 3 | 120.0E−4 | −0.8693 | 0 |
| 13 | 2 | 64.0E−4 | −0.2472 | 0 |
| 14 | 3 | 2.1389E−4 | 0.0025 | 0.0226 |
| 15 | 2 | 2.6963E−4 | 0.003 | 0.0275 |
| 16 | 3 | 1.7884E−4 | 0.0031 | 0.0267 |
| 17 | 4 | 1.0094E−4 | 0.0025 | 0.0205 |
| 18 | 3 | 1.8951E−4 | 0.0034 | 0.0286 |
| 19 | 3 | 5.1024E−4 | 0.0087 | 0.1409 |

Convex sets C₂ and C₇ both impose integral constraints. Importance/or need of a particular integral constraint can be understood by comparing the results for cases 1, 2 and 3. Most accurate image is obtained both in terms of subjective and quantitative image quality for case 2. Thus, the simple integral constraint by itself, as in case 1, or even in combination with SART-based integral constraint, as in case 3, degrades the image quality. Hence, in the all the numerical simulation cases after case 3 the simple integral constraint was not utilized.

From the results for case 4, it can be seen that known-information has very small contribution in improving the image quality and hence the unavailability of known-information does not have much impact on reconstructed image quality. This is a very desirable result since the known-information may not be available in some cases. Case 5 results demonstrate that positivity constraint (C₃) helps to improve both the subjective and quantitative image quality while its absence does not significantly worsen it. Results for case 6 show that the image maximum constraint (C₄) helps in reducing the maximum error but it does not make significant contribution to final reconstructed image quality. The maximum value of 2.5 was used for our simulations which is greater than the maximum intensity of 2 in the Shepp-Logan phantom. From the results for cases 7 and 8, it can be seen that SART-based integral constraint for x-rays passing through ROI (C₇) and for x-rays in scout-views (C₈) are important constraints and absence of either of them results in poor reconstructed image quality. Case 9 results show that the TV-regularization constraint (C₉) makes a significant contribution to final reconstructed image and the absence of it leads to increased errors but it does not seem to be absolutely necessary. From the results for cases 10 and 11, it can be seen that the Hilbert transform constraint (C₁) and the Compact Support constraint (C₆) are important and their absence results in poor reconstructed image quality. Though the Hilbert transform constraint (C₁) and the SART-based integral constraint (C₇) are important constraints, the results for cases 12 and 13 show that either of them is not enough to reconstruct the image by itself.

As explained above, type 3 reconstruction becomes possible when knowledge of known-sub-region is not necessary. Case 14, a type 3 case, is very similar to case 4, a type 1 case, except that only one filtering direction was utilized for the former. The image quality for case 14 is comparable to case 4 and hence when known information is not utilized entire ROI can be reconstructed using only one filtering direction. The results for case 14, which utilizes only vertical filtering direction, indicate that more accurate reconstruction can be obtained if filtering direction is chosen in which there is less truncation within the compact-support. The results for cases 16 and 17, in which 2 and all 60 filtering directions are respectively utilized, show that use of more filtering direction decreases the error and non-uniformity but also the resolution.

From our numerical simulations for cases 1 through 13 we observed that four convex sets of Hilbert transform, compact support, SART-based integral constraint, and SART-based scout constraint are essential. Result for Case 18, a type 1 reconstruction, using only these constraints are somewhat inferior to case 2, a type 1 reconstruction, in which all other constraints except the simple integral constraint (C₂), are included. But image seems to be consisting of essential feature. So, whenever possible, other constraints should be used. Results for case 19, a type 3 reconstruction, are inferior to those for case 14, which is similar except that it uses more constraint. Note that both case 19 and case 14 do not use known information, which is the good news, since that is the only information that may not be available in some cases.

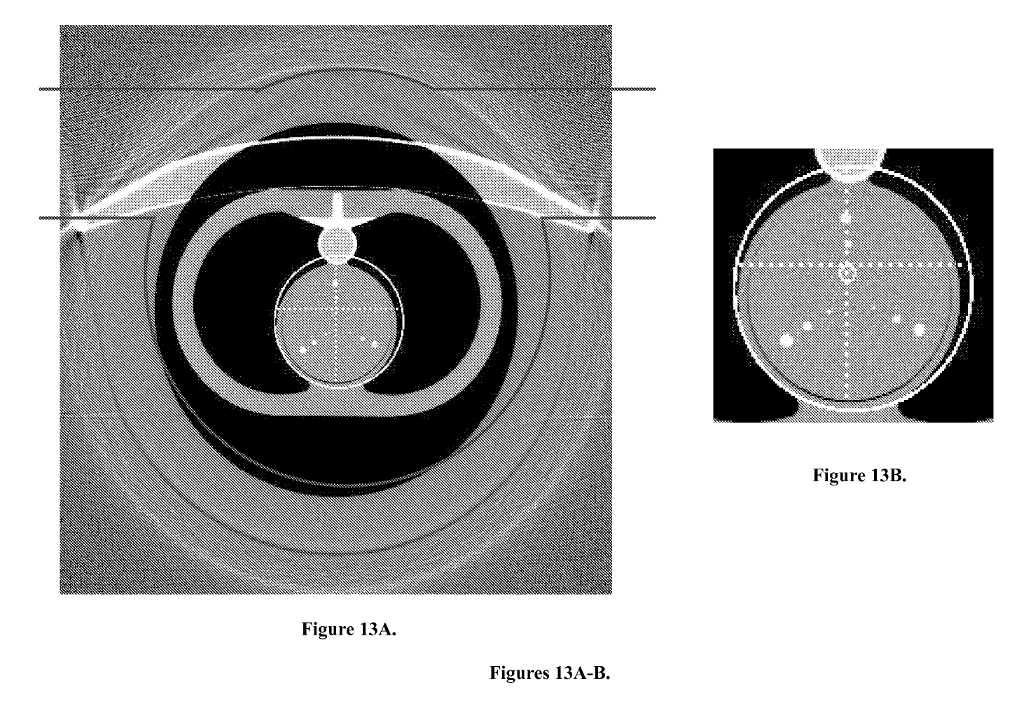

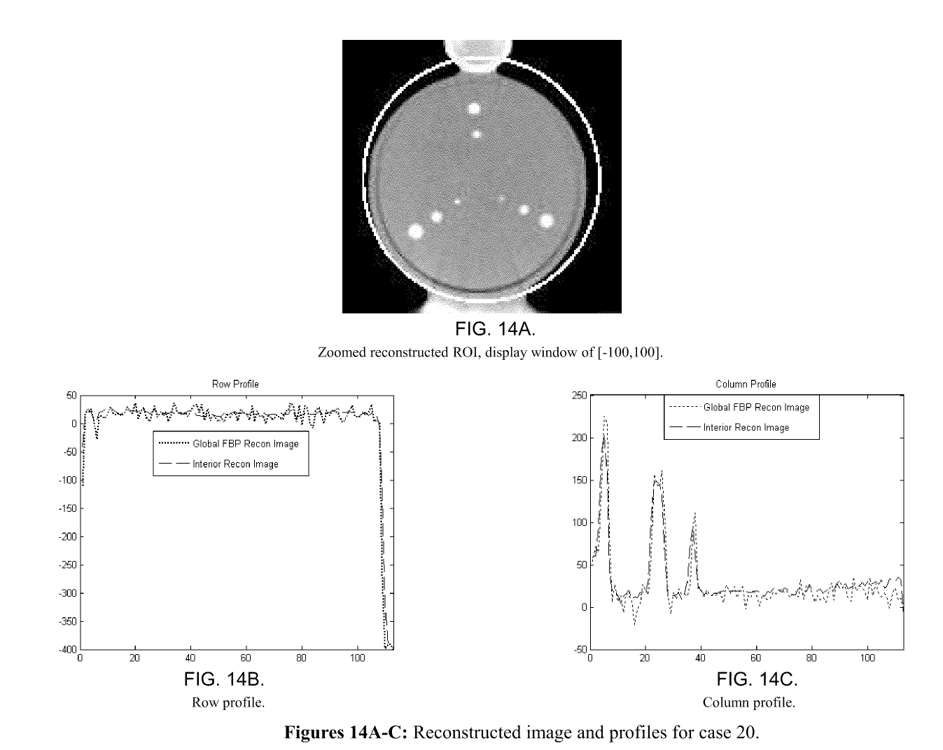

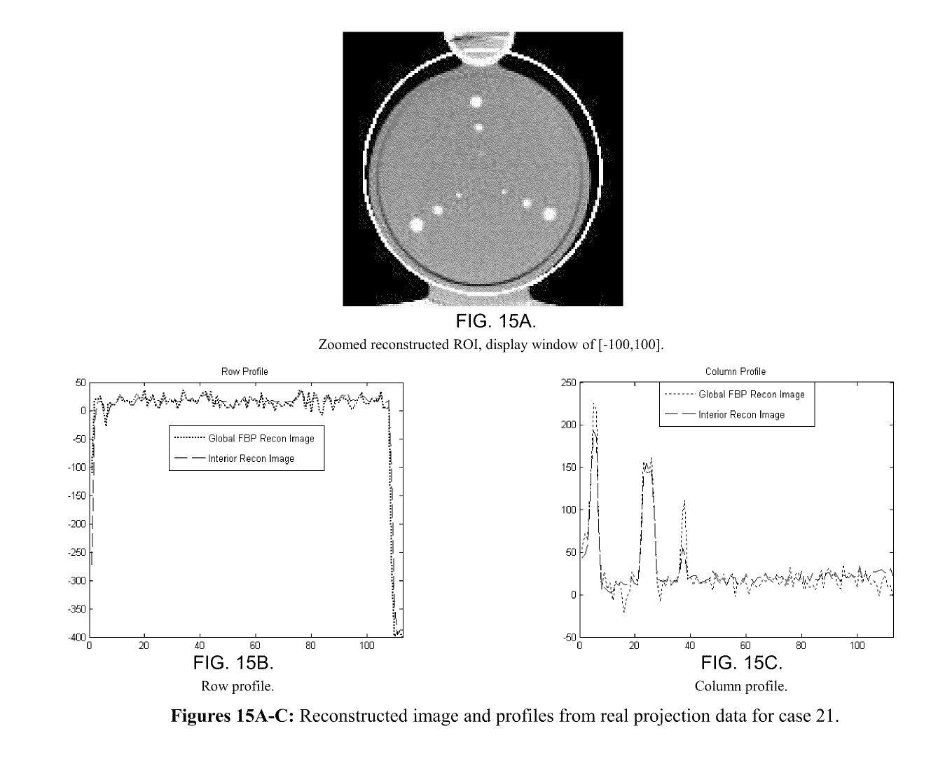

The inventive method was also applied to real projection data of anthropomorphic cardiac phantom. The FBP reconstructed image from non-truncated data, the ROI, the known-sub-region and the compact support used are shown in FIGS. 13A-B. As can be seen this compact support can easily be determined from scout views and knowledge of table even if the method described in our methods section is not used. To obtain the values outside the compact-support we averaged the values in the FBP reconstruction. We did that due to the way the projection data was processed. Note that this region corresponds to air and value of zero can normally be assumed. Again, only the projections passing through the ROI are kept for interior tomography reconstructions. To impose the image positivity constraint we used the value obtained from the average value in air calibration region of the phantom. We simulated two cases with real data, one for type one reconstruction using known information and other for type 3 reconstruction without known information. These cases are described in table 3. The reconstructed images with corresponding profiles are shown in FIGS. 14A-C and 15A-C. The image quality parameters for these simulations are presented in Table 3. The error is determined from the as from a difference between non-truncated FBP reconstructed image and interior tomography reconstructed image.

TABLE 3
Description of numerical simulation cases for the real projection data of
anthropomorphic cardiac phantom

| Case No. | Description |
|---|---|
| 20 | All constraints - C₂ (simple integral constraint) - C₄ |
| | (maximum value) i.e. convex sets C₁, C₃ and C₅ |
| | through C₉ are utilized |
| 21 | All-constraints - C₂ (simple integral constraint)) - C₅ |
| | (known-sub-region) - C₄ (maximum value) i.e. convex sets |
| | C₁, C₃ and C₆ through C₈ are utilized. |
| | Only horizontal filtering direction |

TABLE 4
Measured image quality parameters for various simulation cases
described in Table 3.

| | FWHM | | | |
|---|---|---|---|---|
| Case | (number of pixels) | Noise | Mean Error | Maximum Error |
| 20 | 4 | 2.8984 | 7.7999 | 203.5316 |
| 21 | 3 | 4.7143 | 4.8628 | 230.6326 |

The good reconstructed image quality, closely matching profiles and good image quality parameters effectively demonstrate the effectiveness of these methods. The high maximum errors are due to differences at the edges of the high contrast structures within the ROI. Low mean error and noise demonstrate accuracy of interior tomography reconstructions.

New convex sets of compact support, SART-based integral constraint for x-rays passing through the ROI, SART-based integral constraint for x-rays in scout views and total variation algorithm were introduced. Evaluation of the exemplary algorithm showed that the first three of these constraints are essential for accurate interior tomography reconstruction. While total variation regularization constraint is not necessarily required for reconstruction, its use improved image quality significantly.

As shown, the algorithm is capable of accurately reconstructing the interior ROI. An important finding is that the simple integral constraint (C₂) used in existing algorithm introduces image artifacts and degrades the image quality. Additionally, the contribution made by known-information is very small and hence the image can be accurately reconstructed even in the absence of known-information. Using this information, reconstruction of the image using only one filtering direction resulted in a reconstructed image comparable to an image reconstructed using several filtering directions and known information.

Some very minor artifacts exist due to fixed number of iterations and limitations of the algorithm itself. Simplest way to over-come these artifacts would be to add a few views which cover the entire compact support [27]. From our experience; approximately 10-15 such views will enable exact reconstruction. Acquiring these views in the form of scout-view may not be acceptable but these views can be acquired as a part of the scan. These may be incorporated into current CT scanners by simple acquisition software changes. It may also be possible to improve reconstruction image quality by using estimated projection data for a few views. These projection data can be estimated using existing methods [28, 29]. Better processing of the edges, as proposed in our compressive sensing based interior tomography article [10], may also improve image quality. These edges can be pre-determined using lambda-tomography. Additional convex sets which establish relationship between neighboring pixels can also introduced. More accurate forward projection models for SART will also reduce reconstruction errors.

### REFERENCES

1. Ye, Y., et al., A general local reconstruction approach based on truncated hilbert transfrom. International J. of Biomedical Imaging, 2007. 2007(Article ID 63634): p. 8.
2. Noo, F., R. Clackdoyle, and J. D. Pack, A two-step Hilbert transform method for 2D image reconstruction. Physics In Medicine And Biology, 2004. 49(17): p. 3903-3923.
3. Noo, F., et al., Image reconstruction from fan-beam projections on less than a short scan. Physics In Medicine And Biology, 2002. 47(14): p. 2525-2546.
4. Parker, D. L., Optimal short scan convolution reconstruction for fan beam CT. Medical Physics, 1982. 9(2): p. 254-257.
5. Defrise, M., et al., Truncated Hilbert transform and image reconstruction from limited tomographic data. Inverse Problems, 2006. 22(3): p. 1037-1053.
6. Courdurier, M., et al., Solving the interior problem of computed tomography using a priori knowledge. Inverse Problems, 2008. 24(6).
7. Kudo, H., et al., Tiny a priori knowledge solves the interior problem in computed tomography. Physics In Medicine And Biology, 2008. 53(9): p. 2207-2231.
8. Ye, Y., H. Yu, and G. Wang, Exact interior reconstruction with cone-beam CT. Journal of Biomedical Imaging, 2007. 2007(3): p. 1-5.
9. Bharkhada, D., et al., Cardiac CT radiation dose reduction using interior reconstruction algorithm with the aorta and vertebra as known information. Journal of Computer Assisted Tomography, 2007. To appear.
10. Hengyong, Y. and W. Ge, Compressed sensing based interior tomography. Physics in Medicine and Biology, 2009(13): p. 4341.
11. Yu, H., Y. Ye, and G. Wang, Interior reconstruction using the truncated Hilbert transform via singular value decomposition. Journal of X-Ray Science and Technology, 2008. 16(4): p. 243.
12. Yu, H. Y. and G. Wang, Studies on artifacts of the Katsevich algorithm for spiral conebeam CT. Developments In X-Ray Tomography Iv, 2004. 5535: p. 540-549.
13. Youla, D. C. and H. Webb, Image restoration by the method of convex projections. I. Theory. IEEE Transactions on Medical Imaging, 1982. MI-1(2): p. 81.
14. Hansen, P. C. and K. Mosegaard, Piecewise polynomial solutions without a priori breakpoints. Numerical Linear Algebra With Applications, 1996. 3(6): p. 513-524.
15. Rudin, L. I., S. Osher, and E. Fatemi, Nonlinear Total Variation Based Noise Removal Algorithms. Physica D, 1992. 60(1-4): p. 259-268.
16. Vogel, C. R. and M. E. Oman, Fast, Robust total variation-based reconstruction of noisy, blurred images. Ieee Transactions On Image Processing, 1998. 7(6): p. 813-824.
17. Candes, E. J., J. Romberg, and T. Tao, Robust uncertainty principles: Exact signal reconstruction from highly incomplete frequency information. Ieee Transactions On Information Theory, 2006. 52(2): p. 489-509.
18. Candes, E. J., J. K. Romberg, and T. Tao, Stable signal recovery from incomplete and inaccurate measurements. Communications On Pure And Applied Mathematics, 2006. 59(8): p. 1207-1223.
19. Sidky, E. Y., C. M. Kao, and X. H. Pan, Accurate image reconstruction from few-views and limited-angle data in divergent-beam CT. Journal Of X-Ray Science And Technology, 2006. 14(2): p. 119-139.
20. LaRoque, S. J., E. Y. Sidky, and X. Pan, Accurate image reconstruction from few-view and limited-angle data in diffraction tomography. Journal Of The Optical Society Of America A-Optics Image Science And Vision, 2008. 25(7): p. 1772-1782.
21. Panin, V. Y., G. L. Zeng, and G. T. Gullberg, Total variation regulated EM algorithm. Ieee Transactions On Nuclear Science, 1999. 46(6): p. 2202-2210.
22. Sidky, E. Y. and X. C. Pan, Image reconstruction in circular cone-beam computed tomography by constrained, total-variation minimization. Physics In Medicine And Biology, 2008. 53(17): p. 4777-4807.
23. Bharkhada, D., et al., Line-source based x-ray tomography. International journal of biomedical imaging, 2009. 2009(Article ID 534516): p. 8.
24. Kak, A. C. and M. Slaney, Principles of Computerized Tomographic Imaging. 2001: Society of Industrial and Applied Mathematics.
25. Sonka, M., V. Hlavac, and R. Boyle, Image processing, analysis, and machine vision. 1999, Pacific Grove, Calif.: PWS Pub.
26. Hansen, P., et al., The PP-TSVD algorithm for image restoration problems, in Methods and Applications of Inversion. 2000. p. 171.
27. Yu, H., et al. Compressive sampling based interior reconstruction for dynamic carbon nanotube micro-CT. in Fully Three-Dimensional Image Reconstruction in Radiology and Nuclear Medicine. 2009.
28. Hsieh, J., et al., A novel reconstruction algorithm to extend the CT scan field-of-view. Medical Physics, 2004. 31(9): p. 2385-2391.
29. Zamyatin, A. A. and S. Nakanishi, Extension of the reconstruction field of view and truncation correction using sinogram decomposition. Med. Phy., 2007. 34(5): p. 1593-1604.

### II. CARBON NANO-TUBE BASED INTERIOR TOMOSYNTHESIS SYSTEM

Biomedical x-ray and optical tomography explicitly or implicitly result in challenging linear inverse problems of a highly ill-posed nature, since x-ray imaging (attenuation, refraction and Raleigh scattering) and optical molecular imaging (fluorescence and bioluminescence) can be well approximated as linear systems.

An ideal solution to solve these linear inverse problems would be to collect most essential data in the shortest possible time, and yet produce the best possible images. To capitalize on these potential benefits, we need to overcome the inherent illposedness due to a limited amount of measured data. Powerful imaging models and reconstruction methods are needed that reflect fundamental relationships and constraints, utilize all prior knowledge, new insights and unconventional tools.

Fortunately, recent theories of interior tomography and compressive sensing effectively challenge the conventional wisdom in tomographic imaging and signal processing [29, 38, 39]A. While the interior problem (to reconstruct an internal region of interest (ROI) only with x-rays through the ROI) has no unique solution in general [40, 41]A, interior tomography offers an exact and stable solution, given practical prior knowledge. While the Nyquist/Shannon sampling rate has been used since the digital era, compressive sensing unlocks hidden signal sparsity and requires much less data for recovery of an underlying signal.

Also, the phase approximation (PA) model outperforms the diffusion approximation (DA) over a broad spectrum of fluorescent and bioluminescent probes with a computational complexity similar to DA. This gives us the opportunity to develop multi-spectral/probe optical molecular tomography with satisfactory performance.

Furthermore, recent technologies of carbon nanotube (CNT) based x-ray source arrays and photoacoustic tomographic (PAT) systems improve data acquisition capabilities [42-45]A. The CNT-based scheme makes it possible for the first time that many x-ray sources can be distributed and controlled arbitrarily and cost-effectively, suggesting novel x-ray imaging architectures [46]A. PAT combines high optical contrast and deep ultrasound penetration, collecting information inaccessible by purely optical means. Over years, our team and collaborators have made significant theoretical and technical progress in spiral cone-beam CT, exact cone-beam reconstruction, interior tomography, compressive sensing, multi-scale CT, dynamic spatial reconstruction, carbon nanotube based distributed x-ray source array, bioluminescence tomography and fluorescence tomography. It is all of these theories, technologies, insights and expertise that give us confidence to address these key challenges.

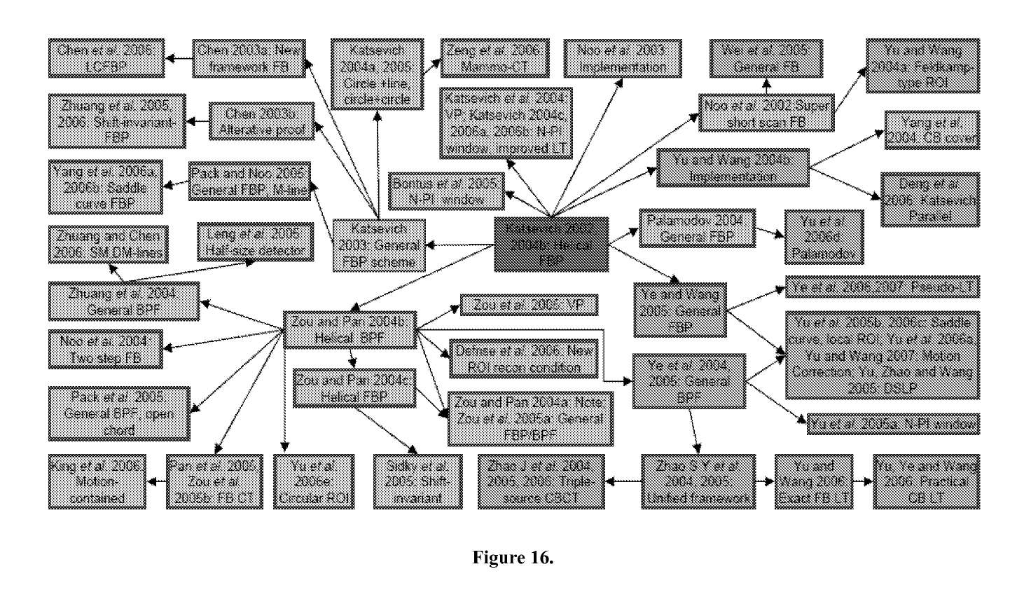

Developments in X-ray Computed Tomography. Spiral/helical cone-beam scanning and approximate algorithms have been developed to solve the long object problem since 1991[1, 47, 48]A, enabling practical implementations of area detector tomography. As remarked by Defrise et al., “To solve the long-object problem, a first level of improvement with respect to the 2D FBP algorithms was obtained by backprojecting the data in 3D along the actual measurement rays. The prototype of this approach is the algorithm of Wang et al.” [49]A. “Many advances in CB reconstruction have been made recently thanks to the quest for an attractive reconstruction method in helical CB tomography.”[50]A. This group has made numerous contributions to allow exact CB reconstruction with general trajectories (FIG. 16) [51]A. Today, spiral/helical CB scanning is widely used in medical X-ray CT imaging.

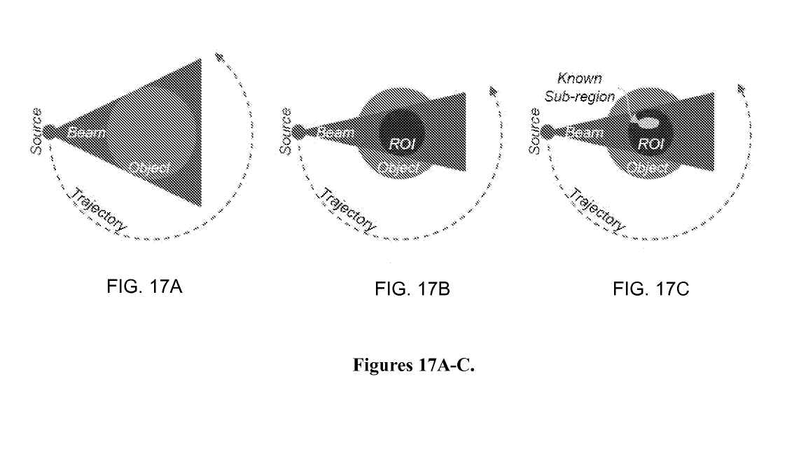

Interior tomography was recently developed by this group [26-28, 31, 52, 53]A, (which are hereby incorporated by reference in their entireties), and others [54, 55]A for exact and stable ROI reconstruction only from projection data along lines through the ROI. Our initial theory assumed exact knowledge of a subregion in a ROI, such as air in the lungs or blood in the heart as shown in FIGS. 17A-C.

In 2008, based on compressive sensing (CS) theory [38]A, we proved that an ROI can be exactly reconstructed via the total variation (TV) minimization if the ROI is piecewise constant [29, 56, 57]A, without exact subregion knowledge. Then, we have extended our theory to allow a piecewise polynomial ROI [58]A. These breakthroughs have important applications including cardiac CT, lung CT, temporal bone imaging, and intraoperative guidance to handle large objects, minimize radiation dose, suppress scattering artifacts, enhance temporal resolution, reduce system cost, and increase scanner throughput.

Example—Interior Tomography. A CT experiment was performed with a living sheep to demonstrate the feasibility of interior tomography [46]A. First, an entire cross-section was reconstructed using the popular filtered backprojection (FBP) method from complete projections. Then, a trachea (in which we had the CT number of air) was selected. Around the trachea, we specified a circular ROI and kept only the projection data through it. As expected, interior tomography produced an excellent ROI reconstruction. For comparison, we adapted the FBP algorithm and simultaneous algebraic reconstructive technique (SART) [59]A for ROI reconstruction with the optimal shift to match the air value. FIGS. 18A-G and Table 5 show interior tomography outperformed either of the competing brute-force algorithms, being in an excellent agreement with the global FBP.

An algorithm comparison for interior reconstruction in terms of the mean error ε̅ (HU), maximum error εₘₐₓ (HU), image resolution r (mm), and noise σ (HU). The errors are relative to the global FBP reconstruction is provided below in Table 5:

TABLE 5

| | ε̅ | εₘₐₓ | r | σ |
|---|---|---|---|---|
| Global FBP | NA | NA | 1.5 | 34 |
| Local FBP | 162 | 440 | 1.6 | 49 |
| Local SART | 199 | 584 | 1.5 | 57 |
| Interior | 85 | 439 | 1.5 | 21 |
| Recon | | | | |

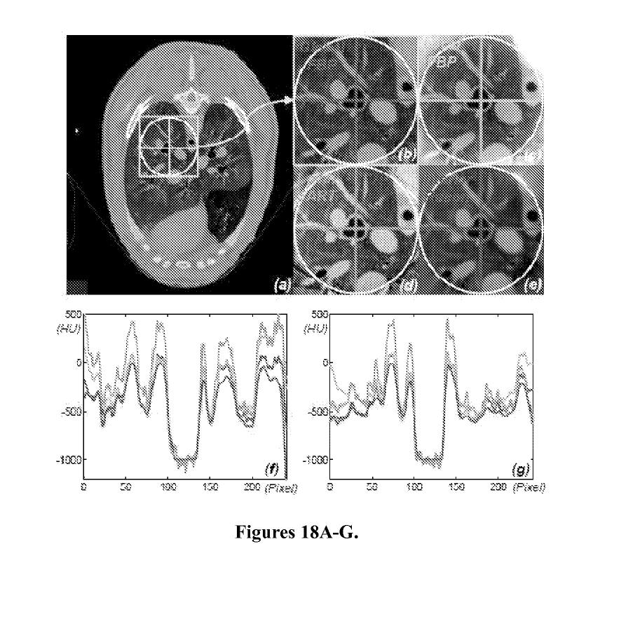

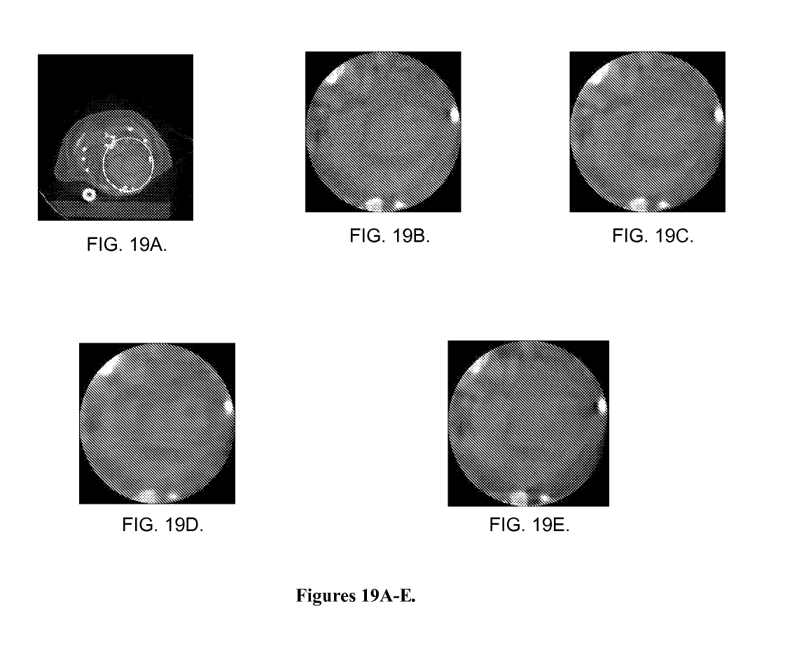

Since 2008, interior tomography has been applied on the carbon nanotube (CNT) based x-ray imaging systems [60]A. Additionally, cone-beam micro-CT systems using a single source-detector pair have been developed. Recently, a stationary digital breast tomosynthesis (DBT) scanner has been developed using a CNT-based 25-pixel source array [61, 62]A. Using the micro-CT scanner of Charybdis [45, 63]A, an in vivo mouse CT scan was performed to obtain 400 projections of 1024×1024 elements of 50 μm aperture using an inventive physiological gating technique over an angular range of 200°. This dataset was used to evaluate the CS-based interior reconstruction technique. As shown in FIGS. 19A-E to the global FBP reconstruction (FIG. 19B) the quality of the interior reconstruction was minimally compromised even with 12.5-50% of data (FIGS. 19C and D), and interior tomosynthesis is promising (FIG. 19E), which can be further improved using better algorithms and prior knowledge.

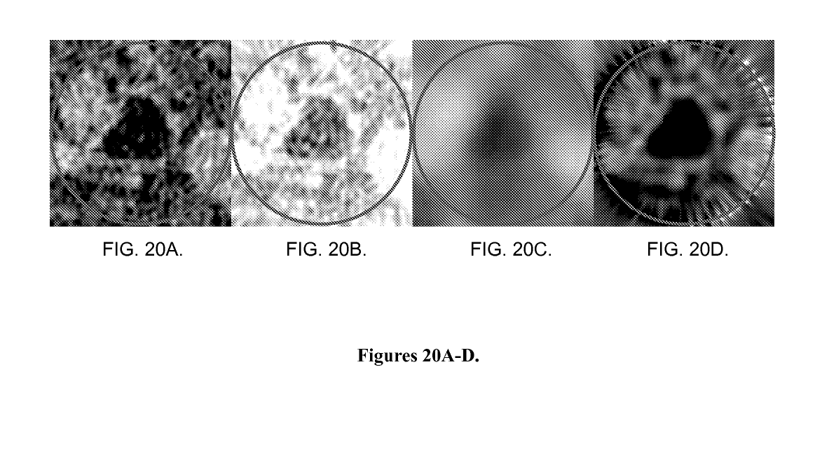

Next, let us consider an extreme case of multi-source interior tomography based on the aforementioned dataset. Suppose that the x-ray tubes take up no room on the gantry and local projections correspond to detector array segments seamlessly connected, a centralized ROI of radius 15.4 mm (the gantry is assumed to be of radius 570 mm) can be illuminated in parallel from 58 evenly distributed source positions. These projections were equi-angularly selected from the 1160 views by discarding 19 projections in every 20 projections. With the same pixel size as in the above reconstruction, the ROI was of 54 pixels in radius. Then, interior tomography of the ROI was performed on 58 groups of parallel lines, and each group included 22 uniformly distributed parallel lines. Results are shown in FIGS. 20A-D, where the SART result was produced after 200 iterations. Although the image artifacts in FIGS. 20A-D are much more evident than that in FIGS. 18A-G, the resultant reconstruction represents a nearly perfect temporal resolution.

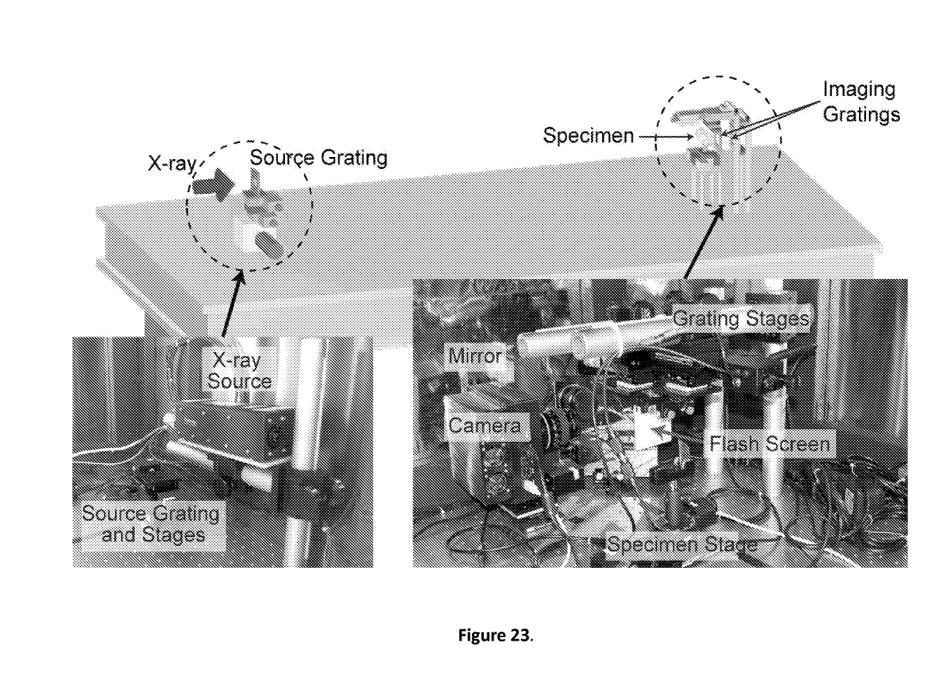

Grating-based X-ray Tomography. The invention provides a 1D grating-based x-ray imaging platform as shown in FIG. 23. The imaging platform can typically consist of four parts: (1) a conventional x-ray imaging setup including a hospital grade source, a scintillator and a CCD camera, (2) mechanical stages for translating and rotating optical components including phase gratings, (3) an x-ray optics generating diffraction images, and (4) programs controlling the imaging platform. First, for conventional x-ray imaging, the source is operated at 70 kV and 0.1 mA (PXS5-701A), the scintillator phosphor (P43) emits visible light in response to x-ray photons, and the CCD camera (FLI-1001E, 24 μm) captures an image from the phosphor screen. Then, for extraction of the phase difference induced by an object in the x-ray beam and alignment of all the gratings, high-precision multi-axis motion control techniques must be used. Currently, a 19-axis control mechanism is ready to arrange the gratings, half of which can be remotely manipulated during beam-on via a LabView interface. Sub-micrometer period silicon diffraction gratings are being made at sub-micrometer resolution. These gratings must be made of a material remarkably absorbing x-rays. We will use the silicon wafer and gold plating approach [37, 73]A. The imaging platform is preferably controlled by software on a PC.

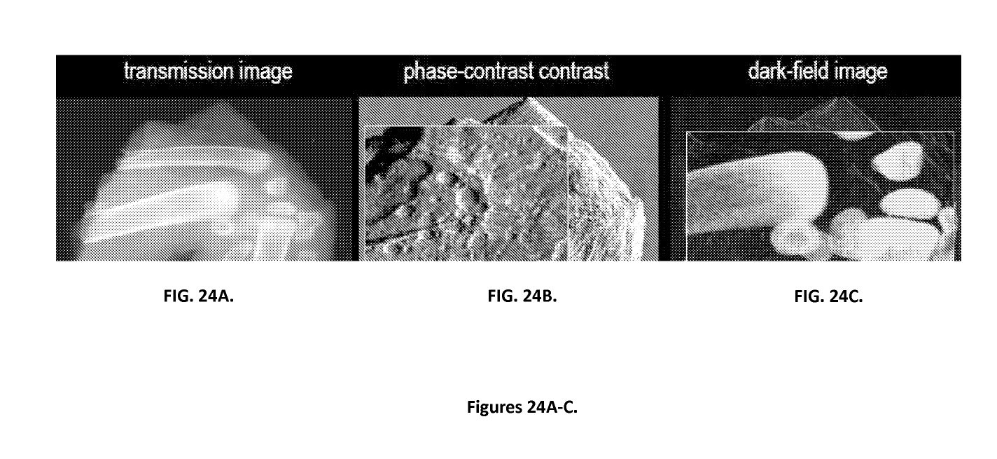

Most tissue components give rise to significantly distinct refractive and scattering characteristics and can be extracted using the 1-D-grating-based x-ray imaging system. For example, refraction and Rayleigh scattering behaviors of tumors significantly differs from that of healthy tissue [74]A. Recently, Franz Pfeiffer et al. demonstrated that 1-D-grating-based x-ray imaging is informative to reveal subtle structural variations in an object, as shown in FIG. 24 [36]A. Such x-ray phase-contrast and dark-field (Rayleigh component) imaging provides new contrast mechanisms of much higher sensitivity and specificity for biomedical applications [75]A, which complements or outperforms attenuation-based imaging [36, 76-78]A.

The images of FIG. 24, from another source, demonstrate the feasibility and potential of this technology, which will be significantly enhanced using the inventive CS-based interior tomography techniques to handle larger samples in shorter time.

Limited-angle Interior Tomography. Dynamic contrast enhancement can be studied with CT in a region-of-interest (ROI) for quantification of microvasculature function. Radiation exposure cannot be decreased with a smaller number of scans because the contrast dilution curve must be determined over time to describe the toe, peak and decay of the dilution curve. Consequently, the options are to reduce the number of projections per scan, delimit the x-ray beam to the ROI for each projection view, and develop algorithms for optimal image quality. A system is provided that is sufficiently compact and accessible to allow a broad spectrum of applications and interventions. In particular, an interior tomosynthesis system using the carbon nano-tube (CNT) based x-ray source array to quantify ROI perfusion is provided.

Interior Tomosynthesis System Prototyping. While tomosynthesis has been studied for decades, interior tomosynthesis is a new concept motivated by our recent success with interior tomography and compressive sensing. Regularized by an individualized prior CT scan, interior tomosynthesis not only reduces radiation dose, data flow and system cost simultaneously but also improves temporal resolution effectively, suggesting numerous biomedical applications. For interior tomosynthesis, a standard medical CT protocol is first executed as routinely done for a patient, which results in a volumetric image to serve as a prior knowledge for interior tomosynthesis. At the same time, an optical surface scan is performed of the patient in the same body posture. Subsequently, a tomosynthesis scan and a similar optical surface scan are conducted of the same patient. The patient position can be adjusted according to the surface models so that the ROI center coincides with the iso-center of the interior tomosynthesis system. Also, the surface models enable the registration between CT and tomosynthetic scans.

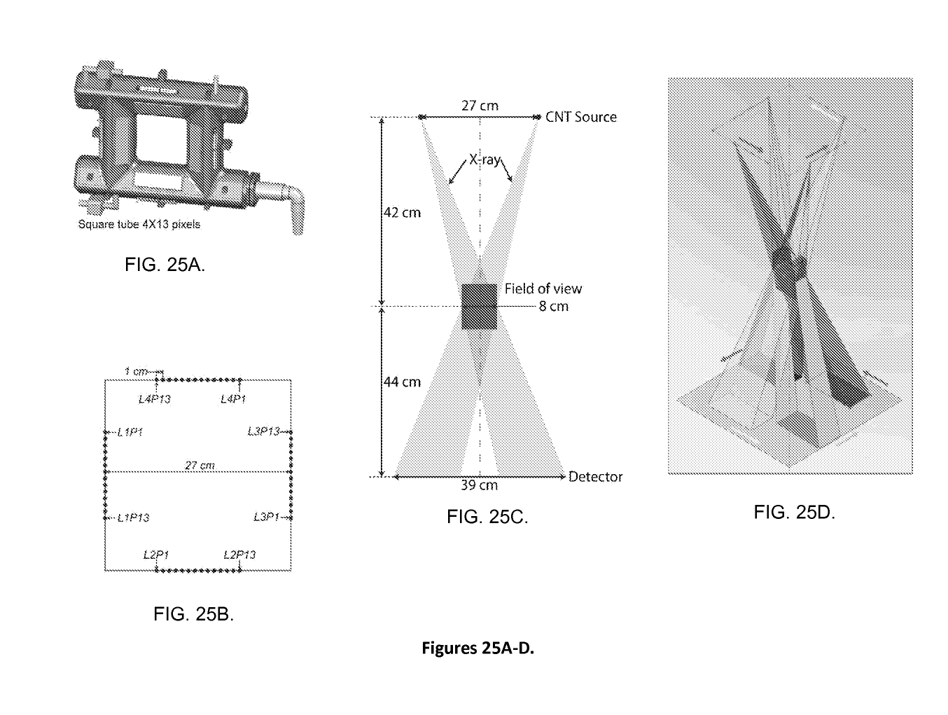

To demonstrate the merits of interior tomosynthesis, an interior tomosynthesis system using a cutting-edge CNT x-ray source array (XinRay, Research Triangle Park, N.C.) [79]A and an area detector is provided. As shown in FIGS. 25A-D, the CNT-based square source array with 52 x-ray beams can be placed over a patient table, and a commercial detector placed below the table. The interior tomosynthesis system is feasible due to the following recent CT technologies: (1) the CNT-based multi-beam x-ray source array that scans without mechanical motion, (2) interior tomography for an internal ROI to be accurately reconstructed from purely local data, and (3) compressive sensing allowing satisfactory CT reconstruction from a limited number of views. The combination of the above innovations sets the interior tomosynthesis system apart from its commercial counterparts.

Exemplary specifications of an interior tomosynthesis system in accordance with embodiments of the invention are provided in Table 6.

TABLE 6
Specifications of the interior tomosynthesis.

| Source | Technology | Square array with |
|---|---|---|
| | | 52 pixels |
| | kVp (typical) | 120 kV |
| | Anode current | 20 mA |
| | Peak tube power | 2.4 kW |
| Detector | Number | 1 |
| | Size | 40 cm × 40 cm |
| Geometry | Source level to isocenter | 42 cm |
| | Detector to isocenter | 44 cm |
| | Tomographic angle | 16° |
| Data | Projection measurement | 4 projections |
| Collection | Exposure per projection | 3 ms |
| | Number of projections | 52 |
| System Indexes | FOV | 8 cm × 4 cm |
| | Temporal resolution | 33 ms |
| | Spatial resolution | <0.5 mm* |
| | Contrast resolution | ~2%* |

*Comparable to the Dual Source Scanner.

Due to the detector size limitation, the targeted ROI at the iso-center is currently 8×4 cm². With a larger detector, the targeted ROI can be increased. Given the source array, detector, and imaging geometry, four projections can be acquired simultaneously by turning on and collimating four x-ray beams to the ROI. Such an acquisition scheme will not only efficiently utilize the detector area but also proportionally reduce the image acquisition time.

According to an exemplary method of the invention four of the 52 x-ray pixels can be turned on each time in 13 detector integration cycles. The i^{th} detector integration cycle will capture projections from the corresponding x-ray pixels (L1Pi, L2Pi, L3Pi and L4Pi, where LjPi stands for the i^{th} x-ray pixel at the j^{th} source line, as shown in Fig. C.1.1.1(c)). The detector can be operably configured to achieve the specified spatial resolution and noise level. The pre-source collimation is needed to restrict x-rays to the ROI in a high mechanical precision. The collimators can be machined out of metal blocks. Finally, the source array, collimators, and detectors can be integrated into the inventive system. In addition to the aforementioned data acquisition parts, key system components can include a high-precision mechanical framework, a geometrical calibration setup, and a host computer to control x-ray sources and detectors and manage data and images.

HOV-based Interior Algorithm Development. Based on prior results, such as that relating to prior CT regularized breast tomosynthesis [80, 81]A and lung perfusion CT [82]A, CS-based interior tomosynthesis can use an individualized prior CT scan and define an appropriate objective function. Since a smooth surface can be well approximated by a polynomial function, embodiments of the invention are capable of providing an interior tomosynthesis approach based on a piecewise polynomial image model [29, 56, 58]A. Accordingly, a high order TV (HOT) objective can be used for interior tomosynthesis, along with other constraints from the prior scan and practical knowledge.

Assume that an interior tomosynthesis scan measures a set of projection data expressed as a 1D vector Y with elements Yᵢ^{meas}, i=1, . . . , N_{Y}, where N_{Y} is the product of the number of detector elements and the number of projection views. As formulated in [83]A, each measurement is a realization of a random variable

$${Y}_{i}^{meas} = {G}_{i} {\sum }_{m = 1}^{M} {E}_{m} Poisson \{ {\sum }_{j = 1}^{{N}_{Y}} {b}_{ij} {I}_{j} {λ}_{m}^{( j )} \times exp [ - {\int }_{{L}_{j}} μ ( x , {E}_{m} ) d l ] + {s}_{m}^{( i )} \} + Gaussian \{ {d}_{i} , {σ}_{i}^{2} \} \qquad ( C .1 .1 .1 )$$

which μ(x,E) is the energy-dependent linear attenuation coefficient, sₘ⁽ⁱ⁾ the number of scattered photons, and the ith measurement not only reflects the signal from the path Lᵢ but also other paths Lⱼ, j≠i, with weight bᵢⱼ to take off-focal radiation into account. Although it is optimal to reconstruct μ(x,E) at every energy level of interest, it is generally impossible without use of strong assumptions on the material composition. In CT applications, the goal is typically to reconstruct μ(x,Eᵣ) at a reference energy Eᵣ.

Based on reasonable assumptions, Eq. (C.1.1.1) can be reduced to the discrete model (http://www.eecs.umich.edu/˜fessler/):

$${Y}_{i}^{meas} ∼ Poisson \{ {I}_{i} exp [ - {\sum }_{j = 1}^{{N}_{p}} {a}_{ij} {μ}_{j} ] + {r}_{i} \} , \qquad ( C .1 .1 .2 )$$

where an object consists of Nₚ pixels with attenuation coefficients μ=[μ₁, μ₂, . . . , μ_{N}]^{T}, aᵢⱼ denotes the length of a ray path in a pixel, and rᵢ a known constant which compensates for measurement noise and may be ignored especially in initial analyses. Preferably, the analysis is performed using Eq. (C.1.1.2), but dual-energy cases can be implemented as well. Guided by the CS theory, interior tomosynthesis can be converted to the following optimization problem:

μ̅=arg min(HOT(μ)) subject to Yₘₑₐₛ=Y(μ), (C.1.1.3)

where HOT(μ) is an objective function including the HOT and other constraints such as the prior CT scan and tomosynthetic data. The POCS technology [84]A is effective, flexible and promising for our CS-based interior tomosynthesis, which rapidly improves the objective function, and under certain conditions achieves the global convergence [85]A. POCS can be adapted to solve Eq. (C.1.1.3). Let us assume that an original image f belongs to the intersection C₀ of J closed convex sets C₁, . . . Cⱼ, . . . , C_{J}, i.e., f∈Cₒ=∩ⱼ₌₁^{J}Cⱼ. Let the projection operators onto these J convex sets be denoted as P₁, . . . , Pⱼ, . . . , P_{J}, and the composite operator as T=P₁ P₂ . . . P_{J}. The POCS can be defined as μ^{k}=T^{k}μ, where k indicates the number of iterations. Since the function μ represents the attenuation coefficients, it must be non-negative, bounded and compactly supported. Also, high-performance computing techniques can be used, if desired, to reduce the computational cost.

Validation and Optimization. An interior tomography simulator has been implemented in MatLab and C++. Several physical aspects were simplified in the simulator. Specifically, a point source and a monochromatic x-ray spectrum were assumed. It is possible to enhance the simulator with all major physical features. Using numerically synthesized phantoms with known geometric and radiographic features, image quality in representative imaging geometry and dose settings can be analyzed. Also, truncated CT scan datasets can be generated from whole scan sets and be made available for interior tomosynthesis. A few complete scans can be used to train the algorithm and protocols. Then, 30 test datasets made to contain just truncated projections can be prepared to create a blinded study. Three types of truncated scan datasets are (1) a centered chest region containing the heart in all views, (2) a cardiac region just containing the whole heart in all views, and (3) a partial cardiac region that includes just the LV wall or a coronary artery. Myocardial perfusion curves can then be calculated from interior tomosynthesis images to provide the “ultimate” test of utility for measuring functional data with the minimum exposure. Resultant results can then be systematically compared to the full reconstruction data.

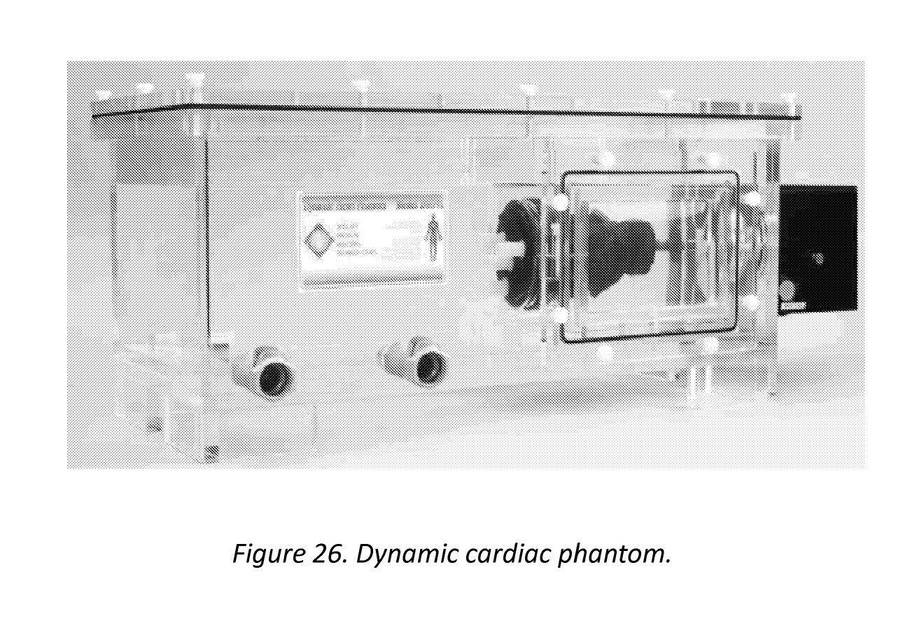

The interior tomosynthesis algorithms can be validated by a physical phantom, e.g., standard CT performance phantoms and/or a dynamic heart phantom (Shelley Medical Imaging Technologies, Ontario, Canada; www.simutec.com) as shown in FIG. 26. This phantom is made of a hydrogel material that mimics biomechanical properties of human soft tissues and incorporates left and right ventricular structures.

User-friendly software, precise dual servomotors and an actuator are connected to the heart phantom allowing for independent control of compression, stretching and torsion motion of tissues. The software allows users to execute sophisticated cardiac motion events, including RR intervals and arrhythmia. This phantom can be scanned at representative cardiac phases using a state-of-the-art CT scanner to establish the gold standard. Then, the phantom can be scanned using the inventive interior tomosynthesis system for comparison. Radiation dose associated with interior tomosynthesis scans can be measured with a thermo-luminescent dosimeter (TLD). All the results will be systematically compared and statistically analyzed. Target criteria of interior tomosynthesis systems in accordance with embodiments of the invention include: ˜50 ms temporal resolution, <0.5 mm spatial resolution, and ˜2% contrast resolution at <2.5 mSv dose.

Optical Molecular Tomography. Optical molecular probes, both fluorescent and bioluminescent, are essential tools for in vivo biological studies [15, 19, 86, 87]A. Fluorescence imaging uses active illumination and has high spatial resolution [88, 89]A. Bioluminescence imaging requires no exciting light and offers superior signal-to-noise ratio [90, 91]A. More importantly, optical probes have unique labeling capabilities [15, 19, 86, 87]A. Regenerative medicine utilizes principles of cell biology and biomaterials to develop and transplant substitute tissues and organs [92, 93]A. Since engineered tissues and organs resemble their natural counterparts, optical molecular tomography (OMT) methods are required for development of regenerative medicine.

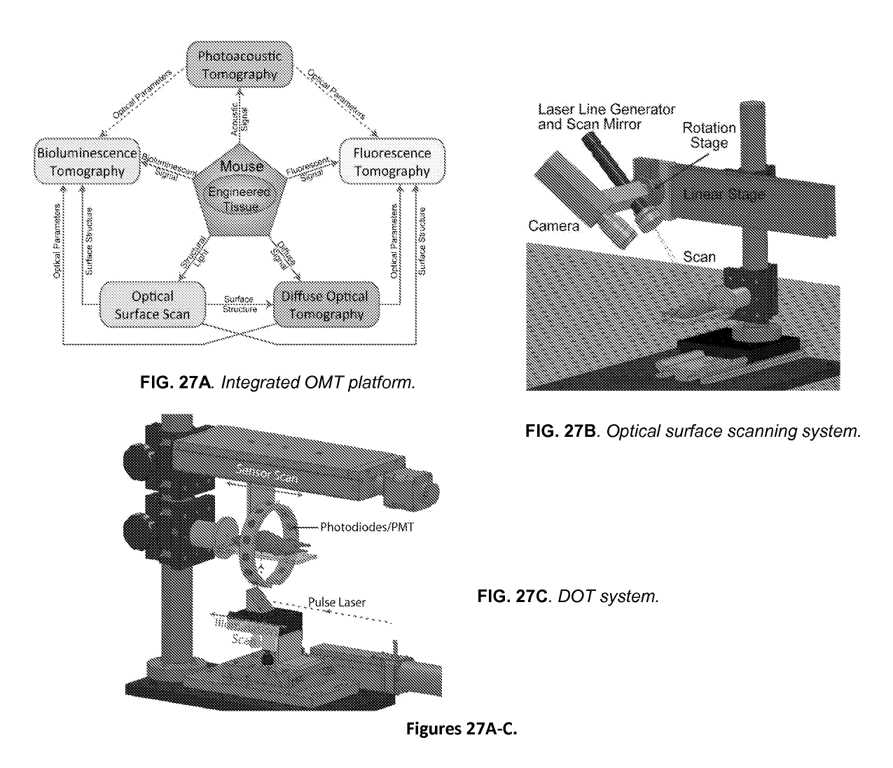

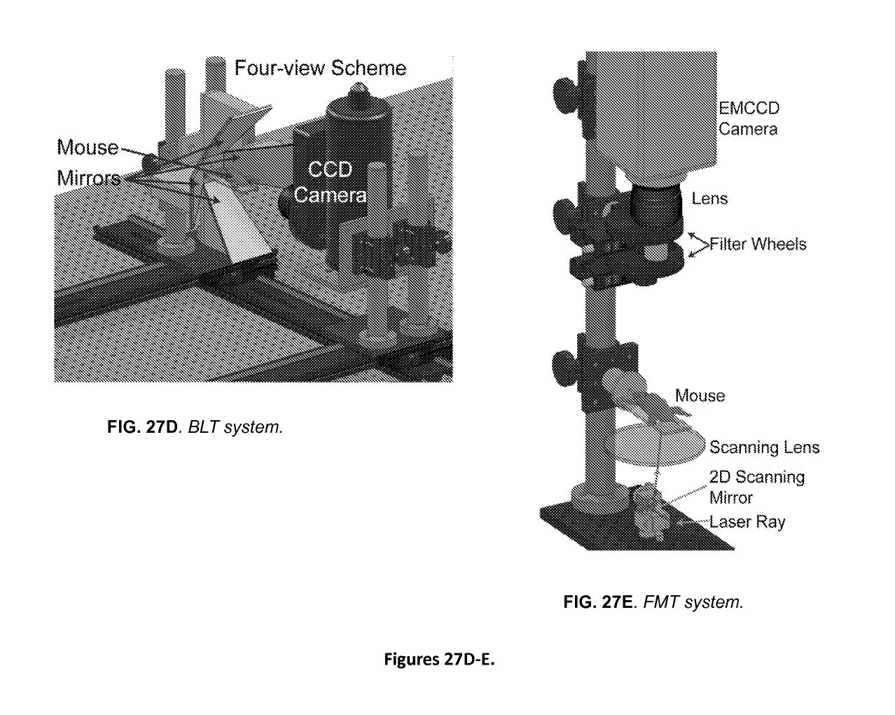

An integrated optical molecular tomography platform for mouse studies in regenerative medicine is provided by embodiments of the invention. As shown in FIG. 27A, this platform can comprise bioluminescence tomography (BLT) [67]A, fluorescence molecular tomography (FMT) [94-96]A, diffuse optical tomography (DOT) [97]A, photoacoustic tomography (PAT) [98-100]A, and optical surface scanning systems. Optical surface imaging and diffuse optical tomography provide individualized anatomical structures and their optical parameters to define the forward imaging process. Such a mouse modeling strategy can be complemented using the emerging PAT approach that combines high contrast in terms of optical absorption and deep penetration in terms of optically induced sound waves [101-103]A. Then, FMT and BLT can be respectively performed to distributions of reconstruct bioluminescent and fluorescent probes in a living mouse [67, 104, 105]A.

Innovative features of the platform include (1) novel optical imaging system designs, (2) a novel phase-approximation model for photon propagation in tissues, (3) a novel PAT-based DOT method, and (4) compressive sensing (CS) based FMT and BLT algorithms. These techniques can provide solutions to current challenges in OMT, yielding an excellent OMT performance in localizing and quantifying fluorescent and bioluminescent probes in living mice of multiple tissue engineering models.

Exemplary OMT Platform.

[Surface Scanning System] An optical surface scanner (FIG. 27B) can be constructed to facilitate DOT, BLT and FMT. A laser line generator within the system can be used to project and scan a laser line on a mouse body, and record the corresponding curve with a digital video camera, while the mouse is fixed in a holder. The resultant dataset can be processed into a surface model of the mouse body using a traditional computer vision method [106, 107]A.

[DOT System] To determine optical parameter distributions within a living mouse in a spectrally resolving manner, a time-resolved DOT system can be used [95, 96, 108]A (FIG. 27C). A tuable pulsed laser can be used to illuminate the mouse body. A mirror can reflect and scan the laser over the mouse surface. A set of high-quality photodiodes or PMT can be mounted around the mouse to collect the optical signal. For each illumination position, the detectors can be configured to scan 5 locations, for example, longitudinally (lcm apart). A high speed digital oscilloscope can be used to collect data from the photodiodes sequentially.

[BLT System] An advanced BLT system can be used to perform a multi-view multi-spectral data acquisition (FIG. 27D) [109]A. Specifically, a four-view subsystem can include a mounting plate, four triangular mirror stages and four mirrors. The mirrors are attached to the hypotenuse surfaces of the mirror stages. The four views of a mouse in the mirrors are parallel to the mounting plate surface and in the same plane for the camera to focus on. The mouse holder can be inserted through the mounting plate with a flexure stage, movable within a 5 mm range along each axis. A filter wheel can spectrally resolve bioluminescent data.

[FMT System] In the FMT system (FIG. 27E), laser light from a tunable CW or pulse laser source can be used in a 2D scanning mode. Depending on applications, the system can be configured differently to collect fluorescent signals [96, 110]A. For whole-body imaging (FIG. 27D), two filter wheels can be placed in front of the lens. One filter wheel carries notch filters to block the excitation light. The other wheel uses band-pass filters to select fluorescent data spectrally. Finally, an EMCCD camera can be used to record fluorescent views. Alternatively, a large-field microscope design is advantageous to focus on a small area on the mouse body for better resolution. It is also possible to rotate the data acquisition modulus around the mouse in a customized gantry.

[PAT System] As an enhancing feature of the inventive platform, PAT capabilities can be developed for possible improvement in DOT and FMT. First, a PAT-based DOT approach can be developed to refine optical parameter estimation. Such an approach can combine photoacoustic and optical constraints, converting the traditionally ill-posed DOT problem into a well-posed setting [101-103]A. Second, the recently proposed multispectral optoacoustic tomography (MSOT) approach [18]A can be improved using the PA model in the CS and interior tomography framework.

MSOT is based on detection of ultrasonic waves induced by characteristic absorption of pulsed light specific to various fluorophores. In this PAT/MSOT system, the body posture of a mouse is fixed in a cylindrical container. The transducer array (5 MHz central frequency) and illumination fibers are placed along a full ring of a radius 25 mm around the container. A sequence of high-energy laser pulses of 8 ns width and 30 Hz repeat frequency can be delivered towards the mouse body by the fibers. The induced ultrasound signals can be intercepted by the transducer array and collected by a high-speed digitizer. The imaging ring can be horizontally scanned to cover the mouse longitudinally.

[Platform Integration] Pertinent photogrammetric and geometric calibration procedures can be performed for each system component and their intended combinations. A user-friendly interface can be developed along with standardization and optimization of software and phantoms. The mouse can be maintained in the same holder while being moved between different imaging modes. Images from various sources will be registered.

PA-based Reconstruction. [PA Model] An appropriate light propagation model is typically desirable for tomography with visible and near-infrared light [69, 111]A. Although the radiative transfer equation (RTE) well describes the photon propagation, its high computational complexity makes it improper for various applications. As mentioned above, the diffusion approximation (DA) to RTE is a most widely used photon propagation model but it performs poorly in highly absorbing tissues, near sources, and across boundaries [69, 111, 112]A. As an alternative, recently a phase approximation (PA) model [71, 72]A has been developed, which is highly accurate over the spectral range of fluorescent and bioluminescent probes. Accordingly, PA can be used for tomographic imaging for superior performance.

[Optical Characterization] It is well known that the steady-state DOT is highly ill-posed [113]A. Here the PA-based time-resolved DOT techniques can be used to estimate in vivo optical parameters of a mouse. The characteristics of detected light signals can reveal absorption and scattering coefficients more accurately, which may be further refined using CS techniques. As alternative technique for optical characterization, photoacoustic tomography (PAT) was recently applied for visualizing light absorbing structures in a highly scattering medium [114-116]A. Using PAT, the initially generated acoustic pressure field can be analytically reconstructed in 3D from externally recorded acoustic signals, which is the product of absorption coefficient and fluence rate at every location. Based on the PA model and from this 3D pressure field constraint, the PAT-based DOT approach can reconstruct the involved optical parameters of mouse tissues in a unified fashion.

[Fluorescent/Bioluminescent Source Reconstruction] Given the structural and optical properties of a mouse, the PA model can be discretized into a linear system via finite element analysis to link an unknown source distribution inside the mouse and measured photon fluence rate data on the mouse body surface in the case of either FMT or BLT. While these inverse source problems are underdetermined, experimental data show that both fluorescent and bioluminescent probes distribute quite locally, smoothly, or in a somehow patterned manner in the mouse body, with substantial measurement noise.

Inspired by the CS theory, CS-based FMT and BLT algorithms can be used to utilize the inherent sparsity in fluorescent and bioluminescent source representations for improved FMT and BLT reconstructions. In this CS-based FMT and BLT scheme, the source reconstruction is subject to an iᵢ norm optimization, which can be equivalent to the total variation (TV) minimization [117, 118]A or the HOT minimization as discussed above. The TV minimization is a convex optimization problem, and can be solved in polynomial time, most likely allowing better outcomes than the least square reconstruction. The HOT minimization might be time-consuming but can be used for more efficient algorithms, and/or may use high-performance computing techniques.

Validation and Optimization. The current Monte Carlo simulation software can be enhanced to simulate photon propagation in biological tissues in several ways. First, the photons can be made to carry multi-spectral and time-resolved information. Second, the Monte Carlo simulator can be extended to deal with complex biological tissue structures defined in finite element geometry. Third, the computational efficiency can be improved using a multi-core workstation and GPU programming. Extensive numerical simulation can be performed to optimize the system designs and test reconstruction algorithms. Numerical phantoms can be designed to mimic mice in terms of major organ regions and soft-tissues. Bioluminescent and fluorescent sources can be specified to reflect typical locations, intensities, shapes, and spectral characteristics. A perturbation analysis can be conducted with respect to geometrical model mismatches, optical parameter errors, and measurement noise to validate the OMT techniques. Statistical analysis will access the accuracy and stability in terms of source position, power and shape. To validate the inventive OMT techniques physically, a number of heterogeneous physical mouse phantoms can be fabricated.

Such platforms can be made from various materials such as candle gel, high-density polystyrene and white nylon. White-sea foam powder and a mix of red and blue dyes can be used to vary the absorption and scattering properties in the gel. In the case of BLT, artificial diffusive light sources can be embedded in the phantoms to simulate the bioluminescent light emission in a mouse phantom. Multiple datasets can be acquired to reflect phantom geometry, source locations, intensities and spectral characteristics. These datasets can be combined or modified to test the BLT algorithms. The results can be analyzed in each simulation scenario to characterize the performance of the reconstruction techniques with a high statistical significance. The cases of FMT, DOT and PAT can be similarly handled.

Target Parameters. The OMT platform can be configured to meet one or more of the following criteria: (1) In the FMT case, ˜1 mm source localization accuracy and <15% source power estimation error; (2) In the MSOT case, improving the key parameters of FMT by ˜50%; (3) In the BLT case, systems having ˜1.5 mm source localization accuracy, >20% source power estimation error, >4 folds data acquisition speedup compared to the current sequential acquisition process; (4) In all the above cases, to outperform the diffusion approximation (DA) by >30% in terms of source localization and power estimation with computational time comparable to that required by DA.

X-ray nano-CT is a relatively new technique that offers unique capabilities stemming from its large penetration length in biological materials. To date, up to 25 μm spatial resolution has been demonstrated with sub-keV energy “soft” x-rays, and 50 nm resolution has been achieved with multi-keV “hard” x-rays. Multi-keV x-rays are used for nano-CT with a 1/e attenuation length of >0.25 mm in soft tissues and >100 μm in hard tissues such as bone. As a consequence, thick tissue or bone sections can be used with little sample preparation. Furthermore, x-ray absorption edges and characteristic emissions can be used to map the elemental composition of a sample.

While X-ray imaging is of paramount importance for clinical and pre-clinical applications, it is fundamentally restricted by the attenuation contrast mechanism. Since 2006, based on the Talbot effect our Consultant Pfeiffer et al. performed groundbreaking work on x-ray phase-contrast and dark-field tomography using the grating interferometer technology with a hospital-grade x-ray tube [34, 36, 77]A.

However, the required gratings are difficult to make and analyze, especially when the size and aspect ratio of gratings are large. Also, the grating-based imaging takes a long time, particularly when the resolution requirement is great. Supplementing attenuation-oriented images from the current multi-scale CT facility with images of refractive index and Raleigh scattering coefficient can provide an interior x-ray grating-based tomographic imaging approach in the CS framework to enhance soft tissue contrast resolution for inflammation and tissue imaging.

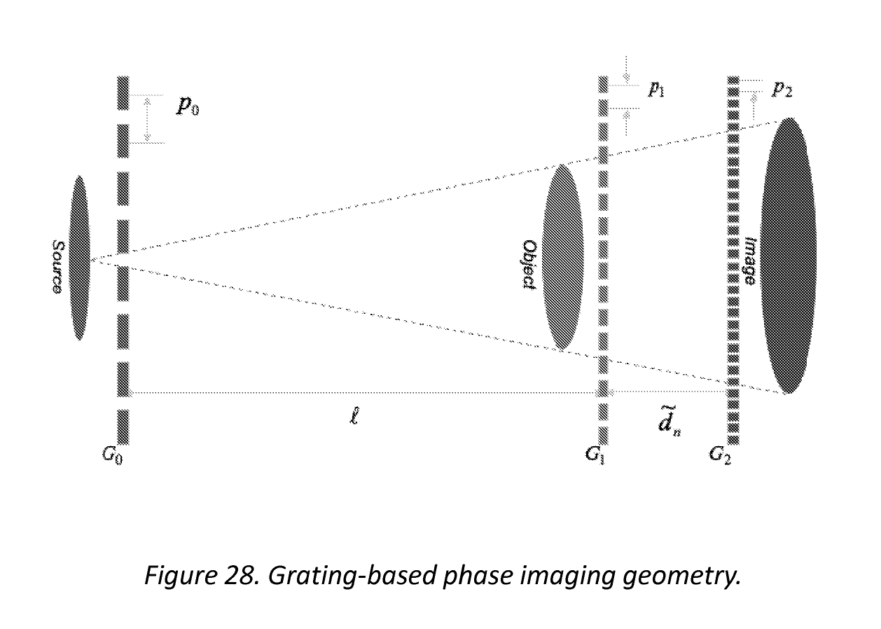

Grating-based System Prototyping. FIG. 28 illustrates the principles of grating-based x-ray phase-contrast and dark-field imaging [36, 119]A. A source grating G₀ with alternating transmission and absorption slits produces a 1D array of line sources when it is placed close to the anode of a hospital-grade x-ray source. These source beamlets are individually coherent but mutually incoherent. The wave from each beamlet propagates through a sample to generate a phase shift in the wave. This phase shift can be retrieved using a Talbot interferometer consisting of two gratings G₁ and G₂, and the phase shift/small-angle scattering signal can be detected by a CCD detector using the fringe-scanning method. The line integrals of the refractive index and Rayleigh scattering coefficient can be extracted from the measured data. Then, cross-sectional or volumetric images of refractive index and Raleigh scattering coefficient can be reconstructed, such as with the same methods as that used in the attenuation-based CT reconstruction. Embodiments of the invention include a 1D-grating-based imaging platform with all the elements except for gratings. Gratings can be fabricated according to the published procedure [34, 73, 120]A or purchased from a German company (Microworks).

Grating-based Image Reconstruction. It has been reported that underlying distributions of refractive index and Rayleigh scattering coefficient can be reconstructed using appropriate reconstruction methods [121-125]A. Grating-based image reconstruction algorithms can be used in the interior tomography and CS framework [126, 127]A. Non-paraxial formulation for spherical and Gaussian incident x-ray beams [128]A can also be considered. The modeling and analyses in these more realistic cases are complex, but feasible based on the cited references.

Multi-scale/parameter Image Registration. Interpretation, quantitative analysis, and visualization of multi-scale and multi-parameter images require that the same physical location be represented in all images, i.e., that images have spatial correspondence. Since these images may be taken using different imaging devices, at various resolution, and under diverse preparations, identifying such spatial correspondence requires image registration. The registration task is inter-modality and will require identification of both affine and small nonlinear deformations.

A set of sample holders that have a set of visible fiducials compatible with all imaging modalities made from polyacrylic materials with embedded beads of contrast inducing materials can be used to achieve this goal. This enables identification of a common coordinate system relative to the sample as it moves between the imaging modalities. ROI prescription for the interior tomography methods can be placed relative to a scout scan in which these fiducials are visible. This will allow automated detection of the fiducials and initial alignment of the sample to its other images.

To refine the registration of sample images, representative objective functions based on information theoretic measures can be evaluated and new ones defined if needed. Such measures can be combined in the group framework [129, 130]A to model image artifacts and reduce their influence on the registration quality.

Validation and Optimization. To validate the performance of the inventive grating-based imaging system, four physical phantoms can be constructed. The first phantom is for spatial resolution and made of polystyrene [131]A. The line-pairs can be made of epoxy resin as bone equivalent material with frequencies around 5 line pairs per mm, which reflects the intended spatial resolution 100 μm. The second phantom is for contrast resolution and made of polystyrene [131]A. A series of holes of varying depths and diameters can be engraved into the phantom surface. Along each row, a range of contrast values can be implemented. The third phantom is for linearity and uniformity and made of 50% Glandular and 50% Adipose Tissue [132]A. One half side of this phantom can be for uniformity, while the other side can contain a step wedge for linearity. Each step is of 2.5 mm width with a decreasing thickness 40-5 mm in 5 mm increments. The fourth phantom is for assessment of 3D reconstruction and can be configured to contain spheres of 1.5 mm diameter made of PTFE and PMMA (polymethylmethacrylate) [133]A. All the phantoms can be calibrated for geometrical accuracy using a micro-CT scanner and for diffraction properties. Each phantom can be restricted within a 40 mm³ cube to be fitted in the field of view of the system. The system can be validated in the projection domain using the first three phantoms, and also in the image domain using the fourth phantom with the edge responses for spatial resolution and differences between foreground and background as well as associated noise levels for contrast resolution. The image quality in relation to the hardware and software components can be quantified.

Target Criteria. Exemplary target criteria can include, e.g.: (1) the x-ray phase contrast/scattering imaging system can have been prototyped to yield high-quality phase-contrast and dark-field data no significant difference from previously reported results, (2) the CS-based interior reconstruction algorithms can have been developed to reconstruct refractive index and Rayleigh scattering images of comparable image quality from <50% projection data and (3) allowed sample sizes can have been increased by a factor of 2 using our interior tomography approach relative to the published imaging protocols.

### REFERENCES

1A. Wang, G., et al. Scanning cone-beam reconstruction algorithms for x-ray microtomography. in SPIE, vol. 1556, P. 99-112, 1991.
2A. Kalender, W. A., Thin-section three-dimensional spiral CT: is isotropic imaging possible? Radiology, 1995. 197(3): p. 578-80.
3A. Wang, G., H. Yu, and B. De Man, An Outlook on X-ray CT Research and Development (invited paper). Medical Physics, 2008. 35(3): p. 1051-1064.
4A. Achenbach, S., et al., Contrast-enhanced coronary artery visualization by dual-source computed tomography—Initial experience. European Journal Of Radiology, 2006. 57(3): p. 331-335.
5A. Flohr, T. G., et al., First performance evaluation of a dual-source CT (DSCT) system. European Radiology, 2006. 16(2): p. 256-268.
6A. Johnson, T. R. C., et al., Dual-source CT cardiac imaging: initial experience. European Radiology, 2006. 16(7): p. 1409-1415.
7A. Kachelriess, M., M. Knaup, and W. A. Kalender, Multithreaded cardiac CT. Medical Physics, 2006. 33(7): p. 2435-2447.
8A. Scheffel, H., et al., Accuracy of dual-source CT coronary angiography: first experience in a high pre-test probability population without heart rate control. European Radiology, 2006. 16(12): p. 2739-2747.
9A. Berrington de Gonzalez, A. and S. Darby, Risk of cancer from diagnostic X-rays: estimates for the UK and 14 other countries. Lancet, 2004. 363(9406): p. 345-351.
10A. Jaffer, F. A. and R. Weissleder, Molecular imaging in the clinical arena. Jama-Journal of the American Medical Association, 2005. 293(7): p. 855-862.
11A. Thakur, M. and B. C. Lentle, Report of a summit on molecular imaging. Radiology, 2006. 236(3): p. 753-755.
12A. Weissleder, R. and V. Ntziachristos, Shedding light onto live molecular targets. Nature Medicine, 2003. 9(1): p. 123-128.
13A. Weissleder, R., Molecular Imaging in Cancer. Sci., 2006. 312: p. 1168-1171.
14A. Contag, C. H. and M. H. Bachmann, Advances in vivo bioluminescence imaging of gene expression. Annual Review of Biomedical Engineering, 2002. 4: p. 235-260.
15A. Ntziachristos, V., et al., Looking and listening to light: the evolution of whole-body photonic imaging. Nature Biotechnology, 2005. 23(3): p. 313-320.
16A. Ray, P., A. M. Wu, and S. S. Gambhir, Optical bioluminescence and positron emission tomography imaging of a novel fusion reporter gene in tumor xenografts of living mice. Cancer Res., 2003. 63(6): p. 1160-1165.
17A. Rice, B. W., M. D. Cable, and M. B. Nelson, In vivo imaging of light-emitting probes. J Biomed Opt, 2001. 6(4): p. 432-40.
18A. Razansky, D., et al., Multispectral opto-acoustic tomography of deep-seated fluorescent proteins in vivo. Nature Photonics, 2009. 3(7): p. 412-417.
19A. Weissleder, R. and M. J. Pittet, Imaging in the era of molecular oncology. Nature, 2008. 452(7187): p. 580-589.
20A. Ntziachristos, V., Fluorescence molecular imaging. Annual Review of Biomedical Engineering, 2006. 8: p. 1-33.
21A. Wang, G., Y. Li, and M. Jiang, Uniqueness theorems in bioluminescence tomography. Medical Physics, 2004. 31(8): p. 2289-2299.
22A. Herschman, H. R., Molecular imaging: Looking at problems, seeing solutions. Science, 2003. 302(5645): p. 605-608.
23A. Keshava, N. and J. F. Mustard, Spectral unmixing. IEEE Signal Processing Magazine, 2002. 19(1): p. 44-57.
24A. Mansfield, J. R., C. A. Kerfoot, and R. M. Levenson. Multiplexing molecular markers with multispectral imaging. in Proceeding on the nexus of histochemistry and molecular genetics. 2006. Hawaii
25A. Gross, S. and D. Piwnica-Worms, Real-time imaging of ligand-induced IKK activation in intact cells and in living mice. Nature Methods, 2005. 2: p. 8.
26A. Ye, Y., et al., A general local reconstruction approach based on a truncated Hilbert transform. International Journal of Biomedical Imaging, 2007. 2007: p. Article ID: 63634, 8 pages.
27A. Ye, Y., H. Y. Yu, and G. Wang, Exact interior reconstruction from truncated limited-angle projection data. International Journal of Biomedical Imaging, 2008. 2008: p. Article ID: 427989, 6 Pages.
28A. Ye, Y., H. Yu, and G. Wang, Exact Interior Reconstruction with Cone-beam CT. International Journal of Biomedical Imaging, 2007. 2007: p. Article ID: 10693, 5 pages.
29A. Yu, H. and G. Wang, Compressed sensing based Interior tomography. Phys Med Biol, 2009. 54(9): p. 2791-2805.
30A. Yu, H., et al., Interior SPECT—Exact and Stable ROI Reconstruction from Uniformly Attenuated Local Projections. International Journal for Numerical Methods in Engineering, 2008: p. to appear.
31A. Yu, H., Y. Ye, and G. Wang, Local Reconstruction Using the Truncated Hilbert Transform via Singular Value Decomposition. Journal of X-Ray Science and Technology, 2008. 16(4): p. 243-251.
32A. Momose, A., Recent advances in X-ray phase imaging. Japanese Journal of Applied Physics Part 1-Reg. Papers Brief Comm. & Rev. Papers, 2005. 44(9A): p. 6355-6367.
33A. Momose, A., et al., Biomedical imaging by Talbot-type X-ray phase tomography, in Developments in X-Ray Tomography V, U. Bonse, Editor. 2006, SPIE-Int Society Optical Engineering Bellingham. p. T3180.
34A. Pfeiffer, F., et al., Phase retrieval and differential phase-contrast imaging with low-brilliance X-ray sources. Nature Physics, 2006. 2(4): p. 258-261.
35A. Kottler, C., et al., Grating interferometer based scanning setup for hard x-ray phase contrast imaging. Review of Scientific Instruments, 2007. 78(4): p. 043710.
36A. Pfeiffer, F., et al., Hard-X-ray dark-field imaging using a grating interferometer. Nature Materials, 2008. 7(2): p. 134-137.
37A. Matsumoto, M., et al., Fabrication of diffraction grating for X-ray Talbot interferometer. Microsystem Technologies-Micro- and Nanosystems-Information Storage and Processing Systems, 2007. 13(5-6): p. 543-546.
38A. Candes, E. J., J. Romberg, and T. Tao, Robust uncertainty principles: Exact signal reconstruction from highly incomplete frequency information. IEEETransactions on Information Theory, 2006. 52(2): p. 489-509.
39A. Donoho, D. L., Compressed sensing. IEEE Transactions on Information Theory, 2006. 52(4): p. 1289-1306.
40A. Hamaker, C., et al., The Divergent beam X-ray transform. Rocky Mountain Journal of Mathematics, 1980. 10(1): p. 253-283.
41A. Natterer, F., The Mathematics of Computerized Tomography. Classics in applied mathematics 2001, Philadelphia: Society for Industrial and Applied Mathematics.
42A. Liu, Z. J., et al., Carbon nanotube based microfocus field emission x-ray source for microcomputed tomography. Applied Physics Letters, 2006. 89(10).
43A. Zhang, J., et al., Stationary scanning x-ray source based on carbon nanotube field emitters. Applied Physics Letters, 2005. 86(18).
44A. Cao, G. H., et al. Respiratory-gated micro-CT using a carbon nanotube based micro focus field emission x-ray source—art. no. 691304. in Medical Imaging 2008 Conference. 2008. San Diego, Calif.: Spie-Int Soc Optical Engineering.
45A. Cao, G., et al., A dynamic micro-CT scanner based on a carbon nanotube field emission x-ray source. Physics in Medicine and Biology, 2009. 54 p. 2323-2340.
46A. Wang, G., H. Yu, and Y. Ye, A scheme for multi-source interior tomography. Med Phys, 2009. 36(8): p. 3575-3581.
47A. Wang, G., et al., A general cone-beam reconstruction algorithm. IEEE Trans. Med. Imaging, 1993. 12: p. 483-496.
48A. Wang, G., et al., Half-scan cone-beam x-ray microtomography formula. Journal of Scanning Microscopy 1994. 16(4): p. 216-220.
49A. Defrise, M., F. Noo, and H. Kudo, A solution to the long-object problem in helical cone-beam tomography. Phys Med Biol, 2000. 45(3): p. 623-43.
50A. Pack, J. D., F. Noo, and R. Clackdoyle, Cone-beam reconstruction using the backprojection of locally filtered projections. IEEE Transactions on Medical Imaging, 2005. 24(1): p. 70-85.
51A. Wang, G., Y. Ye, and H. Yu, Appropriate and exact cone-beam reconstruction with standard and nonstandard spiral scanning. Physics in Medicine and Biology, 2007. 52(6): p. R1-R13.
52A. Wang, G., Y. Ye, and H. Yu, General VOI/ROI Reconstruction Methods and Systems using a Truncated Hilbert Transform (Patent disclosure submitted to Virginia Tech. Intellectual Properties on May 15, 2007). 2007.
53A. Wang, G., H. Yu, and Y. Ye, A scheme for ultrafast tomography. Med Phys, 2008: p. to appear.
54A. Kudo, H., et al., Tiny a priori knowledge solves the interior problem in computed tomography. Phys. Med. Biol., 2008. 53(9): p. 2207-2231.
55A. Courdurier, M., et al., Solving the interior problem of computed tomography using a priori knowledge. Inverse Problems, 2008. 24: p. Article ID 065001, 27 pages.
56A. Yu, H., et al., Supplemental analysis on compressed sensing based interior tomography. Phys Med Biol, 2009: p. to appear.
57A. Han, W., H. Yu, and G. Wang, A total variation minimization theorem for compressed sensing based tomography. Phys Med Biol, 2009: p. under review.
58A. Yang, J., et al., High order total variation minimization for interior tomography. Inverse Problems, 2009: p. under review.
59A. Wang, G. and M. Jiang, Ordered-Subset Simultaneous Algebraic Reconstruction Techniques (OS-SART). J. of X-ray Science and Tech., 2004. 12(3): p. 169-177.
60A. Yu, H., et al., Compressive sampling based interior tomography for dynamic carbon nanotube Micro-CT. J. of X-ray Science and Tech., 2009: p. under review.
61A. Xin Qian, et al., Design and Characterization of a Spatially Distributed Multi-Beam Field Emission X-ray Source for Stationary Digital Breast Tomosynthesis.
62A. Guang Yang, et al. Stationary digital breast tomosynthesis system with a multi-beam field emission x-ray source array. in SPIE proceeding on Medical Imaging. 2008.
63A. Cao, G., et al. A dynamic micro-CT scanner with a stationary mouse bed using a compact carbon nanotube field emission x-ray tube. in SPIE-Med. Imaging 2009. 2009.
64A. Wang, G., E. A. Hoffman, and G. McLennan, Systems and methods for bioluminescent computed tomographic reconstruction. 2002, US Patent Office.
65A. Wang, G., et al., Development of the first bioluminescent CT scanner. Radiology, 2003. 229: p. 566.
66A. Cong, A. and G. Wang, A finite-element-based reconstruction method for 3D fluorescence tomography. Optics Express, 2005. 13: p. 9847-9857.
67A. Wang, G., et al., In vivo mouse studies with bioluminescence tomography. Optics Express, 2006. 14(17): p. 7801-7809.
68A. Ripoll, J., et al., Experimental determination of photon propagation in highly absorbing and scattering media. Journal of the Optical Society of America a-Optics Image Science and Vision, 2005. 22(3): p. 546-551.
69A. Klose, A. D. and E. W. Larsen, Light transport in biological tissue based on the simplified spherical harmonics equations. J. of Computational Phy., 2006. 220: p. 441-470.
70A. Cong, W., et al., Flux vector formulation for photon propagation in the biological tissue. Optics Letters, 2007. 32(19): p. 2837-2839.
71A. Cong, W., et al., Integral equations of the photon fluence rate and flux based on a generalized Delta-Eddington phase function. J. of Biomed. Opt., 2008. 13: p. 024016.
72A. Cong, W., et al., Modeling photon propagation in biological tissues using a generalized Delta-Eddington phase function. Physical Review E, 2007. 76(5): p. 051913.
73A. David, C., et al., Fabrication of diffraction gratings for hard X-ray phase contrast imaging. Microelectronic Engineering, 2007. 84(5-8): p. 1172-1177.
74A. Castro, C. R. F., et al., Coherent scattering characteristics of normal and pathological breast human tissues. Radiation Physics and Chemistry, 2004. 71(3-4): p. 649-651.
75A. Fernandez, M., et al., Small-angle x-ray scattering studies of human breast tissue samples. Physics in Medicine and Biology, 2002. 47(4): p. 577-592.
76A. Chapman, D., et al., Diffraction enhanced x-ray imaging. Physics in Medicine and Biology, 1997. 42(11): p. 2015-2025.
77A. Pfeiffer, F., et al., High-resolution brain tumor visualization using three-dimensional x-ray phase contrast tomography. Phy. in Med. and Bio. 2007. 52(23): p. 6923-6930.
78A. Momose, A., et al., Phase-contrast X-ray computed tomography for observing biological soft tissues (vol 2, pg 473, 1996). Nature Medicine, 1996. 2(5): p. 596-596.
79A. Maltz, J. S., et al., Fixed gantry tomosynthesis system for radiation therapy image guidance based on a multiple source x-ray tube with carbon nanotube cathodes. Medical Physics, 2009. 36(5): p. 1624-1636.
80A. Zeng, K., et al., Digital tomosynthesis aided by low-resolution exact CT. Journal of Computer Assisted Tomography, 2007. 31(6): p. 976-983.
81A. Zeng, K., et al. Experimental evaluation of low-resolution CT regulated tomosynthesis using a flat-panel detector. in Proc. of SPIE, Vol. 6318, PaperID: 63181X. 2006.
82A. Yu, H., et al., Ultra-Low Dose Lung CT Perfusion Regularized by a Previous Scan. Academic Radiology, 2009. 16(3): p. 363-373.
83A. La Riviere, P. J., J. G. Bian, and P. A. Vargas, Penalized-likelihood sinogram restoration for computed tomography. IEEE Trans. on Med. Imaging, 2006. 25(8): p. 1022-1036.
84A. Candes, E. and J. Romberg. Signal Recovery from Random Projections. in Computational Imaging III, Proceedings of SPIE VOL. 5764. 2005.
85A. Hero, A. O. and J. A. Fessler, Convergence in norm for alternating expectation-maximization (EM) type algorithms. Statistica Sinica, 1995. 5(1): p. 41-54.
86A. Gao, X. H., et al., In vivo cancer targeting and imaging with semiconductor quantum dots. Nature Biotechnology, 2004. 22(8): p. 969-976.
87A. Weissleder, R., et al., In vivo imaging of tumors with protease-activated near-infrared fluorescent probes. Nat. Biotechnol., 1999. 17: p. 375-378.
88A. Patterson, M. S. and B. W. Pogue, Mathematical-Model for Time-Resolved and Frequency-Domain Fluorescence Spectroscopy in Biological Tissue. Applied Optics, 1994. 33(10): p. 1963-1974.
89A. Sevick-Muraca, E. M., et al., Fluorescence lifetime spectroscopic imaging with measurements of photon migration. Advances in Optical Biopsy and Optical Mammography, 1998. 838: p. 46-57.
90A. Paroo, Z., et al., Validating Bioluminescence Imaging as a High-Throughput, Quantitative Modality for Assessing Tumor Burden. Molec. Imag., 2004. 3(2): p. 8.
91A. Rice, B. W., M. D. Cable, and M. B. Nelson, In vivo imaging of light-emitting probes. Journal of Biomedical Optics, 2001. 6(4): p. 432-440.
92A. Xu, H. H., S. F. Othman, and R. L. Magin, Monitoring Tissue Engineering Using Magnetic Resonance Imaging. J. of Bioscience and Bioeng., 2008. 106(6): p. 515-527.
93A. Solanki, A., J. D. Kim, and K. B. Lee, Nanotechnology for regenerative medicine: nanomaterials for stem cell imaging. Nanomedicine, 2008. 3(4): p. 567-578.
94A. Ntziachristos, V. and R. Weissleder, Experimental three-dimensional fluorescence reconstruction of diffuse media using a normalized Born approximation. Optics Letters, 2001. 26(12): p. 893-895.
95A. Godavarty, A., E. M. Sevick-Muraca, and M. J. Eppstein, Three-dimensional fluorescence lifetime tomography. Medical Physics, 2005. 32(4): p. 992-1000.
96A. Thompson, A. B. and E. M. Sevick-Muraca, Near-infrared fluorescence contrast-enhanced imaging with intensified charge-coupled device homodyne detection: measurement precision and accuracy. Journal of Biomedical Optics, 2003. 8(1): p. 111-120.
97A. Pogue, B. W., et al., Three-dimensional simulation of near-infrared diffusion in tissue: boundary condition and geometry analysis for finite-element image reconstruction. Applied Optics, 2001. 40(4): p. 588-600.
98A. Gamelin, J., et al., A real-time photoacoustic tomography system for small animals. Optics Express, 2009. 17(13): p. 10489-10498.
99A. Ermilov, S. A., et al., Laser optoacoustic imaging system for detection of breast cancer. Journal of Biomedical Optics, 2009. 14(2): p. -.
100A. Pramanik, M., et al., Design and evaluation of a novel breast cancer detection system combining both thermoacoustic (TA) and photoacoustic (PA) tomography. Medical Physics, 2008. 35(6): p. 2218-2223.
101A. Yuan, Z. and H. B. Jiang, Quantitative photoacoustic tomography. Philosophical Transactions of the Royal Society a-Mathematical Physical and Engineering Sciences, 2009. 367 (1900): p. 3043-3054.
102A. Cox, B. T., et al., Two-dimensional quantitative photoacoustic image reconstruction of absorption distributions in scattering media by use of a simple iterative method. Applied Optics, 2006. 45(8): p. 1866-1875.
103A. Banerjee, B., et al., Quantitative photoacoustic tomography from boundary pressure measurements: noniterative recovery of optical absorption coefficient from the reconstructed absorbed energy map. Journal of the Optical Society of America a-Optics Image Science and Vision, 2008. 25(9): p. 2347-2356.
104A. Ntziachristos, V., et al., Visualization of antitumor treatment by means of fluorescence molecular tomography with an annexin V-Cy5.5 conjugate. Proceedings of The National Academy of Sciences, 2004. 101: p. 12294-12299.
105A. Dehghani, H., et al., Spectrally resolved bioluminescence optical tomography. Optics Letters, 2006. 31(3): p. 365-367.
106A. Horn, B. P., Robot Vision. 1986: McGraw-Hill, New York.
107A. Horn, B. P. and M. J. Brooks, Shape from Shading. 1989: MIT Press, Cambridge Mass.
108A. Reynolds, J. S., et al., Imaging of spontaneous canine mammary tumors using fluorescent contrast agents. Photochemistry and Photobiology, 1999. 70(1): p. 87-94.
109A. Wang, G., et al., The first bioluminescence tomography system for simultaneous acquisition of multi-view and multi-spectral data. International Journal of Biomedical Imaging, 2006. 2006: p. Article ID 58601, 8 pages.
110A. Ntziachristos, V., et al., Fluorescence molecular tomography resolves protease activity in vivo. Nature Medicine, 2002. 8(7): p. 757-761.
111A. Kim, A. D. and J. B. Keller, Light propagation in biological tissue. J. Opt. Soc. Am. A, 2003. 20: p. 92-98.
112A. Panasyuk, G. Y., V. A. Markel, and J. C. Schotland, Superresolution and corrections to the diffusion approximation in optical tomography. Appl. Phys. Lett., 2005. 87: p. 101111.
113A. Hielscher, A. H., Optical tomographic imaging of small animals. Current Opinion in Biotechnology, 2005. 16(1): p. 79-88.
114A. Xu, M. H. and L. H. V. Wang, Photoacoustic imaging in biomedicine. Review of Scientific Instruments, 2006. 77(4): p. -.
115A. Zhang, H. F., et al., Functional photoacoustic microscopy for high-resolution and noninvasive in vivo imaging. Nature Biotechnology, 2006. 24(7): p. 848-851.
116A. Song, K. H., G. Stoica, and L. H. V. Wang, In vivo three-dimensional photoacoustic tomography of a whole mouse head. Optics Letters, 2006. 31(16): p. 2453-2455.
117A. Candes, E. J., J. Romberg, and T. Tao, Robust uncertainty principles: Exact signal reconstruction from highly incomplete frequency information. IEEE Transactions on Information Theory, 2006. 52(2): p. 489-509.
118A. Candes, E. J., J. K. Romberg, and T. Tao, Stable signal recovery from incomplete and inaccurate measurements. Communications on Pure and Applied Mathematics, 2006. 59(8): p. 1207-1223.
119A. Momose, A., et al., Demonstration of X-Ray Talbot interferometry. Japanese Journal of Applied Physics Part 2-Letters, 2003. 42(7B): p. L866-L868.
120A. Grunzweig, C., et al., Design, fabrication, and characterization of diffraction gratings for neutron phase contrast imaging. Review of Scientific Instruments, 2008. 79(5): p. 053703.
121A. Ye, Y. B. and G. Wang, Filtered backprojection formula for exact image reconstruction from cone-beam data along a general scanning curve. Medical Physics, 2005. 32(1): p. 42-48.
122A. Pack, J. and F. Noo, Cone-beam reconstruction using 1D filtering along the projection of M-lines. Inverse Problems, 2005. 21(4): p. 1105-1120.
123A. Katsevich, A., Image reconstruction for the circle and line trajectory. Physics In Medicine And Biology, 2004. 49(22): p. 5059-5072.
124A. Katsevich, A., Image reconstruction for the circle-and-arc trajectory. Physics In Medicine And Biology, 2005. 50(10): p. 2249-2265.
125A. Katsevich, A., S. Basu, and J. Hsieh, Exact filtered backprojection reconstruction for dynamic pitch helical cone beam computed tomography. Physics In Medicine And Biology, 2004. 49(14): p. 3089-3103.
126A. Candes, E. and J. Romberg, Robust signal recovery from incomplete observations. 2006 IEEE International Conference on Image Processing, ICIP 2006, Proceedings, 2006: p. 1281-1284.
127A. Yu, H. and G. Wang, Compressed sensing based interior tomography. Physics in Medicine and Biology 2009. 54: p. 2791-2806.
128A. Patorski, K., The Self-imaging phenomenon and its applications, in Progress in Optics XXVII, E. Wolf, Editor. 1989, Elsevier Science. p. 1-108.
129A. Miller, M. I. and L. Younes, Group Actions, Homeomorphisms, and Matching: A General Framework. International Journal of Computer Vision, 2001. 41: p. 61-84.
130A. Wyatt, C. L. and P. J. Laurienti, Nonrigid Registration of Images with Different Topologies using Embedded Maps. Proceedings of IEEE Engineering in Medicine and Biology Conference, 2006. August 2006.
131A. O'Connell, B. F., Image Quality of Digitally Reconstructed Radiographs. 2006, Trinity College Dublin.
132A. Smith, J. J., et al., Cystic fibrosis airway epithelia fail to kill bacteria because of abnormal airway surface fluid. Cell, 1996. 85: p. 229-236.
133A. Pfeiffer, F., et al., Phase retrieval and differential phase-contrast imaging with low-brilliance X-ray source. Nature, 2006.

Example I. Ultra-Fast Tomography. For a general CT-scan of the heart and the coronary arteries, a field of view (FOV) of ˜15 cm in diameter is preferred (apart from some very special cases where e.g. only the middle part of the right coronary artery would be of interest) and can be achieved using multi-source interior tomography by utilizing a limited number of sources to increase the ROI coverage and scanning the source-detector chains in a circular, saddle-curve or another trajectory to avoid under-sampling, cross-scattering, and other issues. In the case of 2N+1 sources, the radius r of the field of view (FOV) can be maximized by arranging the source-detector pairs equi-angularly to reach:

$$r = R sin ( \frac{π}{4 N + 2} ) , \qquad ( 3 )$$

where R is the radius of the scanning circle.

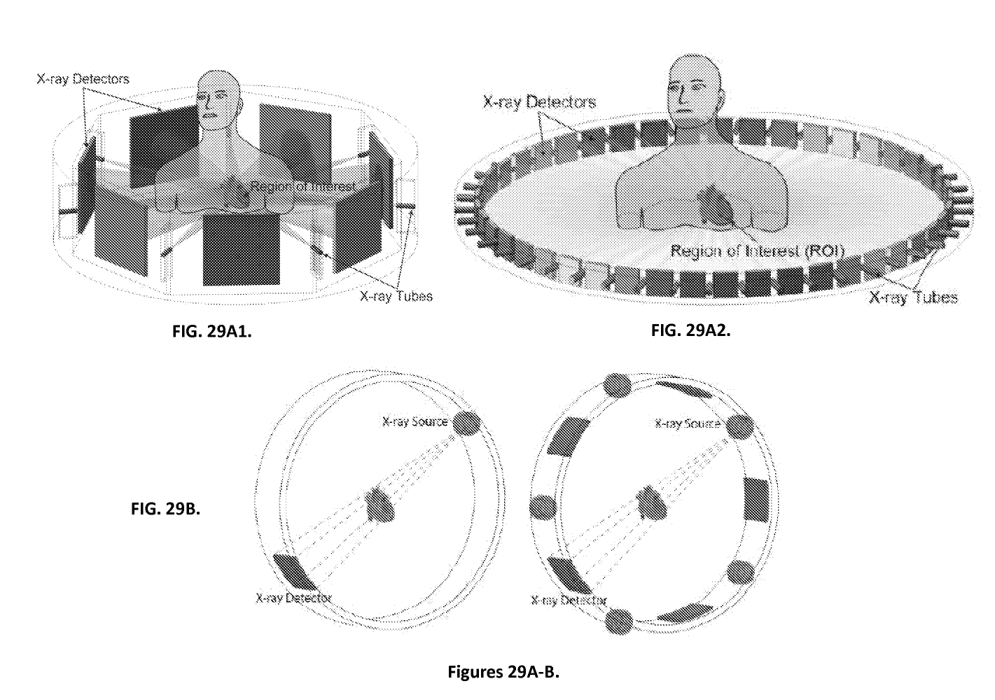

According to Eq. (3), the radius of FOV is decreased as the number of sources is increased. Specifically, we can cover an FOV of 16.2 cm or 13.4 cm in diameter with 11-source or 13-source interior tomography architectures respectively, assuming the imaging geometry R=57 cm of a Siemens CT scanner (SOMATOM Volume Zoom, Siemens Medical Systems) used in our laboratory. In these two cases, the temporal resolution will be improved by >10 and >12 folds respectively (taking into account the effect the fan-angle which is small in the interior tomography mode), while the image quality remains the same as that shown in FIGS. 18A-G. This concept is further illustrated in FIG. 29A, assuming use of 7 sources.

Currently, x-ray computed tomography (CT) requires source scanning so that projections can be collected from various orientations for black/white image reconstruction. Limited by the scanning time, temporal resolution of CT is often inadequate when rapid dynamics is involved in an object to be reconstructed. Coincidentally, the color detector was invented in recent years. Embodiments of the invention provide a system comprising electronically-controlled-source multi-detector-segment cone-beam color CT architectures and methods for better temporal resolution and contrast resolution. Specifically, a region-of-interest is irradiated in parallel with narrow x-ray beams defined by many source-color-detector pairs for data acquisition. This ROI can be then reconstructed using interior tomography described above.

Current color detector based systems are very expensive. Thus, hybrid detector systems in which a color detector segmented is embedded in a regular detector assembly. As shown in FIG. 29B, a small volume of interest (VOI) can be centered at the origin of the scanning plane. A narrow x-ray beam of sufficient brightness can be caused to transverse the VOI and reach a fine color detector plate embedded in the conventional detector assembly. A wide x-ray beam of a normal or less dose can be delivered outside the VOI and recorded on the remaining part of the hybrid detector assembly. To improve the temporal resolution, multi-source multi-detector-segment cone-beam color CT architectures can be designed as shown, for example, in FIG. 29A.

Concerning the exemplary system provided in FIG. 29A, for each pair of detector and source, the detector can be either a hybrid color detector as in FIG. 29B, or a high-resolution fine color detector. Further, multiple color detector segments can be embedded in a regular detector assembly, and data can be used for either local or global reconstruction. Second, sources can be either symmetrically or asymmetrically arranged, and can be on a compact source array that is electronically controlled, including kvp switching. Third, a traditional source-detector chain and a new color-detector-source chain can be combined such as in the Siemens Dual Source System. Fourth, compressed sensing and/or statistical reconstruction methods can be used for reconstruction, either global or local reconstruction. This technology can offer high temporal and contrast resolution color CT results, which can benefit many biomedical and non-biomedical applications.

To achieve an ultrafast tomography performance, a limited amount of projection data is an inherent problem. Nevertheless, unlike conventional tomosynthesis techniques, the inventive multi-source interior scan allows symmetric data acquisition, avoiding biases from primary viewing directions of a tomosynthetic scan [31]B. Most importantly, next generation reconstruction algorithms may produce much better image quality from a limited amount of projection data than it is possible now, shown in FIGS. 18A-G.

Compressive sensing/sampling theory (http://www.dsp.ece.rice.edu/cs) suggests, for example, that reconstruction quality may be maintained after a dramatic reduction in the number of projections [32-34]B. Interestingly, we recently proved that interior tomography can be done exactly without knowledge of a sub-region in an ROI if the ROI is piece-wise constant [35]B. This finding may be extended under wider conditions.

Exact knowledge of a sub-region can often be assumed because in many cases we already know the x-ray linear attenuation coefficients of air gaps or voids, water, blood or other liquid, or other calibrated structures such as implants and substrates; more generally, a pre-scan may often acquire such prior knowledge. It is recognized that the inflowing contrast agent changes the CT-numbers not only in the vessels but also in the myocardium and cardiac chambers. In this case, we may have to use spinal and lung features to help interior cardiac CT [36]B. Alternatively, a compressed sensing approach can be used to perform interior tomography based on some weak image model [35]B, as discussed above.

Ultrafast tomography is highly desirable in a number of disciplines. First, ultrafast tomography may improve cardiac CT. Cardiac CT has emerged as a promising tool for noninvasive coronary angiography [37]B. Electron-beam CT was the first dedicated cardiac CT modality with temporal resolution as low as 50 ms, but it is obsolete because of its major restrictions in spatial and contrast resolution. State-of-the-art medical CT scanners can achieve temporal resolution of 100 ms. However, given the rate and magnitude of the cardiac motion, temporal resolution should ideally be <10 ms for humans and <2 ms for small animals such as rats and mice [16]B. While achieving these resolutions have been extremely challenging, our ultrafast interior tomography approach can help improve temporal resolution to assess the calcium burden and vascular stenoses, to identify positive remodeling and plaque consistency, etc., especially in the cases of high/irregular heart rates.

Second, ultrafast tomography may enable clinical micro-CT such as for inner ear imaging [15]B. Two major obstacles in achieving such fine spatial resolution in vivo are physiological motion induced blurring (the finer the image resolution, the more significant the physiological motion will be, which is in an order of millimeter) and radiation dose concern (the finer the resolution, the much greater the radiation dose will be delivered to the patient). When the x-ray beam targets a small ROI and projections are acquired in parallel, the above two issues are effectively addressed at the same time, which may help derive ultrafine features of interest (image-based biomarkers) for many applications of diagnosis and therapy.

Third, ultrafast interior tomography is the ideal modality for so-called process tomography, which for example might be used for multiphase imaging of the contrast dynamics in the body [38]B, or mass flow of oil and water that is pumped from oil reservoirs [39]B.

A promising way to improve the image quality of ultrafast tomography is to average multiple instant snapshots of the same ROI after image registration (note that FIG. 18D is such an instant snapshot). The key is to acquire instant datasets independently and align them in a common coordinate system. In this context, image registration techniques will play a critical role. Another effective way to suppress image artifacts and/or increase the FOV is to use detectors in a time-sharing fashion which can also be referred to as a source-multiplexing scheme. Similar to the Hadamard multiplexing method, [40], we can arrange p×q x-ray focal spots around a subject, along with the corresponding detectors. Under the computer control, we can electronically trigger p x-ray sources simultaneously for q times to produce projection data continuously on its associated detectors. In this way, each detector will be used by q x-ray focal spots in q consecutive time slots. This method can not only improve image quality but also avoid the conflict between the ROI size and number of focal spots that are on at the same time. While this multiplexing scheme is not instant, it can acquire a complete dataset at speed 1-2 orders of magnitude faster for a relatively small ROI than that of the state-of-the-art CT scanner.

Scatter in this multi-source system is not a significant issue. Briefly speaking, the larger the number of sources (which is typically odd) we want to use, the narrower each x-ray beam (π/N) we should make, and the smaller the field of view we will have. Clearly, the scatter in the data is roughly proportional to the product of the number of simultaneously active sources and the beam width (which is proportional to the size of the field of view). Thus, the scatter to primary ratio can be controlled to be practical. Also, detector collimation can be used to reject scattered photons.

Interior tomography enables ultrafast imaging performance utilizing (1) prior knowledge on a small spot in the ROI or a weak image model such as ROI being piece-wise constant and (2) multiple narrow-beam-oriented source-detector pairs. Interior tomography is advantageous to reduce radiation dose (no x-rays go outside an ROI), suppress scattering artifacts (no cross-talk from radiation outside the ROI), refine image quality (with the new reconstruction approach and prior knowledge), and handle large objects (measurement can be localized in any direction, assuming a centralized ROI or dynamic x-ray collimation).

### REFERENCES

15B. Wang, G., et al., Design, analysis and simulation for development of the first clinical micro-CT scanner. Academic Radiology, 2005. 12(4): p. 511-525.
16B. Wang, G., et al., Top-level design and preliminary physical analysis for the first electron-beam micro-CT scanner. Journal of X-Ray Sci. and Tech., 2004. 12(4): p. 251-260.
31B. Zeng, K., et al., Digital tomosynthesis aided by low-resolution exact CT. Journal of Computer Assisted Tomography, 2007. 31(6): p. 976-983.
32B. Chen, G. H., J. Tang, and S. Leng, Prior image constrained compressed sensing (PICCS): A method to accurately reconstruct dynamic CT images from highly undersampled projection data sets. Medical Physics, 2008. 35(2): p. 660-663.
33B. Lustig, M., D. Donoho, and J. M. Pauly, Sparse MRI: The application of compressed sensing for rapid MR imaging. Magn. Reson. in Med., 2007. 58(6): p. 1182-1195.
34B. Jung, H., et al., k-t FOCUSS: A general compressed sensing framework for high resolution dynamic MRI. Magnetic Resonance in Medicine, 2008: p. to appear.
35B. Yu, H. and G. Wang, Compressed sensing based Interior tomography. Phys Med Biol, 2009: p. to appear.
36B. Bharkhada, D., et al., Cardiac CT radiation dose reduction using interior reconstruction algorithm using the aorta and vertebra as known information. Journal of Computer Assisted Tomography, 2009: p. to appear.
37B. Naghavi, M., et al., From vulnerable plaque to vulnerable patient—A call for new definitions and risk assessment strategies: Part I. Circulation, 2003. 108(14): p. 1664-1672.
38B. Wang, G., G. Schweiger, and M. W. Vannier, An iterative algorithm for X-ray CT fluoroscopy. IEEE Trans Med Imaging, 1998. 17(5): p. 853-6.
39B. Morton, E. J., et al., Development of a High Speed X-ray Tomography System for Multiphase Flow Imaging. IEEE Trans. on Nuclear Science, 1999. 46(3): p. 380-384.
40B. Zhang, J., et al. Hadamard multiplexing radiography based on carbon nanotube field emission multi-pixel x-ray technology. in Medical Imaging 2008, 69131T. 2008. Jiang Hsieh, Ehsan Samei.

### III. TOMOGRAPHY-BASED DYNAMIC CARDIAC ELASTOGRAPHY

Mechanical properties of myocardium are closely related to the histological structures that vary with age, sex, and physiological and pathological conditions in particular. For example, myocardium in the region of ischemia becomes stiffer due to loss of blood supply with the development of fibrosis. [^{32,45,54}]C Characterization of the changes in myocardial mechanical properties may help diagnose heart diseases and guide the therapies. Accurate constitutive model of myocardium is essential for cardiovascular biomechanics researches [^{3,6,15,17,19,35,52,53,55,61}]C and applications including digital heart models for cardiac surgical training, design of patient-specific cardiac equipments and artificial valves and so on.

There have been in vitro experiments to characterize the passive elastic properties of myocardium. [^{5,18,22,38,39,46,48,59}]C While providing with a wealth of knowledge of the mechanical properties, these experiments use dissected myocardium specimens, and thus are not able to address in vivo dynamic properties of myocardium, which are clinically more important.

Cardiac elastography is an emerging imaging modality to estimate the mechanical properties of myocardium based on in vivo measurements of the blood pressure and transmural displacement or strain. [^{5,14,16,33,42,43}]C Han et al.^{16C} and Gotteiner et al.^{14C} modeled the myocardium as a homogeneous and isotropic nonlinear material, and described the heart motion as quasi-static. Creswell et al.^{5C} and Moulton et al.^{33C} further took into account the material anisotropy in their two-dimensional models. Limited by the cardiac imaging techniques and computational power, these studies were not able to address the dynamic nature of the heart motion and the material heterogeneity due to impairment of myocardium. As a result, the effects of viscosity and inertia of myocardium received no attention in these works. Over the past years, significant advances have been made in cardiac imaging techniques, including the MRI dynamic imager, [^{11,24}]C MRI displacement encoding with stimulated echoes (DENSE) method [⁵⁷]C and ultrasonic phased-tracking method [²⁰]C and so on. Techniques have also been developed to quantify the three-dimensional anatomic structures [^{8,9,11,20,24}]C and myofiber architecture. [^{23,47,60}]C Incorporating new MRI measurements, Augenstein et al.^{1C} recently conducted a study to identify the nonlinear elastic parameters of a beating physical heart phantom.

While the spatial resolution of MRI has been significantly improved and is comparable with that of CT, MRI typically suffers from low temporal resolution and MR-incompatibility issues. Correspondingly, the above mentioned cardiac elastography works may not be suitable for patients with implants or when high image resolution with respect to time is required. Cardiac CT, which does not disrupt medical devices, has been developed as a high-resolution and high speed imaging modality. However, CT has not become the imaging modality associated with cardiac elastography because it does not provide displacement in the tissue unless natural or implanted makers are used. With the development of image segmentation and non-rigid registration techniques, it is now possible to obtain the displacement of some material points on epi- and endocardial surfaces. Noting that the above mentioned cardiac elastography works assumed displacement in the heart wall, it is pondered if surface displacement a sufficient measurement.

Another challenge remains for cardiac elastography regarding the algorithm for parametric identification. Because of the inevitable errors in the measurements of displacement, blood pressure, anatomic structures, myofiber architecture, practical algorithms are based on minimization method. [^{1,5,14,16,33,42,43}]C It is well accepted for minimization methods that the numerical efficiency and robustness can be significant enhanced with user-supplied gradients of the objective function.^{44C} The previous cardiac elastography algorithms, [^{1,5,14,16,33,42,43}]C however, used time-consuming direct method or inaccurate finite-difference method, which is even more time consuming, for calculating the gradients of objective functions.

Thus, the inventors have provided a tomography-based nonlinear dynamic cardiac elastography (DCE) framework. In the context of the description of this technique, ‘tomography-based’ refers to: A) the volumetric image of the heart has been segmented such that the geometry of impaired myocardium region is known. The material parameters in the normal and impaired myocardial regions are approximated uniform, respectively; B) only epi- and endocardial displacement is employed as measurement, unlike the previous works that the whole displacement field in the heart wall is used. It is note that conditions A) and B) are within the capability of cardiac CT, and reflect the fact that impaired myocardium behaves significantly different from the normal tissue. This minimization-based framework was formulated with nonlinear viscoelastic finite-element method. A nonlinear dynamic adjoint method was derived for efficient and accurate computation of the user-supplied gradients of the objective function. Phantom simulations were conducted to identify the nonlinear viscoelastic material parameters of normal and impaired myocardium based on epi- and endocardial displacements. The influences of experimental errors were investigated, as well as the necessity of utilizing dynamic information for cardiac elastography.

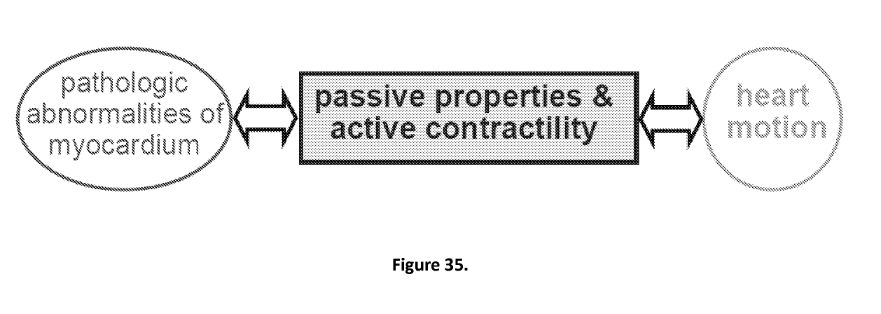

The rationale is that the impaired myocardium undergoes changes in the passive properties, typically becoming stiffer, and/or decrease in active contractility, and thus changes the deformation characteristics of the heart (FIG. 35). For example, in ischemia, there is loss of blood supply with the subsequent development of fibrosis, which may be localized or diffuse. In these situations, the cardiac muscle becomes stiff with passive properties and cardiac active contractility commonly becomes weakened. In hypertropic mycardiopathy, there is increased muscle mass development at the expense of ventricular chamber size. This also results in the stiffer passive properties of cardiac muscle in the dilatation/hypokinesis states, the cardiac contractility becomes weakened.

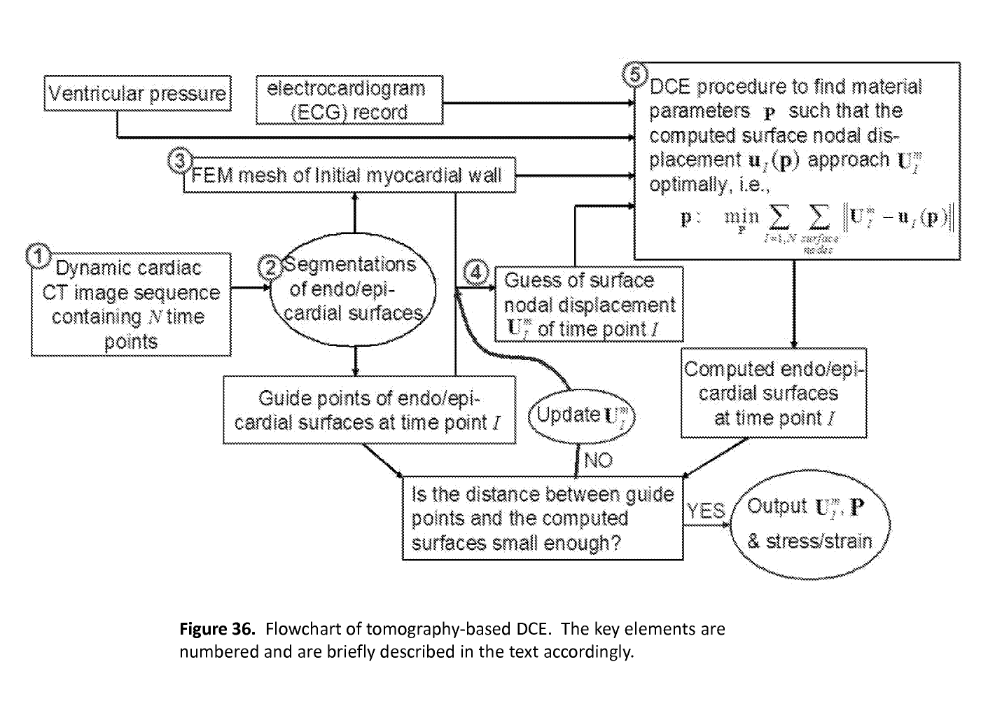

One aspect of this invention is that the parameters that describe the passive properties and active contractility can be extracted from the recorded blood pressure and the dynamic deformation of the heart, which are measured in vivo and noninvasively using well-developed cardiac imaging techniques such as ultra fast cardiac CT and MRI. For example, optimization algorithms as outlined in FIG. 36 can be used in the inventive tomography-based DCE. The key elements are numbered in the flowchart and will be briefly explained below.

Elements 1˜4 describe quantitative assessment of heart motion. The method can be implemented for any 4D data set (x, y, z, t) provided by various medical imaging scanners. We will focus on CT in this description. This involves cardiac image acquisition, segmentation of cardiac chambers throughout a cardiac cycle, reconstruction of geometric models, mesh of myocardial walls, and tracing of the material displacement of the surface nodal (vertex) points at all the time points. Element 5 is the computational kernel of this invention, where the parameters describe the passive and active properties of myocardium are optimally extracted from the obtained displacement. More details are as the following:

1. Image acquisition. 3D reconstructions over time (4D) will be obtained with CT scanner. A total number of N+1 (N=10 (every 10% phase) to 20 (every 5% phase)) time points throughout one complete cardiac cycle will be reconstructed. Each set of volume data includes approximately 200-300 images with better than 1 mm 3D isotropic resolution, covering the heart region of interest.

2. Image segmentation. Segmentation of cardiac chambers is an invariable prerequisite for measuring heart motion, which can be performed manually or using a commercial software, i.e. AnalyzeAVW. Segmentation can be further improved using contrast enhancement in CT and MRI. In practice, many clinical studies still rely on manual delineation. Dynamic geometric models are then reconstructed from the segmented data at each time point (1). The result will be recorded as N+1 sets of guide points of the endo/epi-cardial surfaces.

3. Volumetric mesh of myocardial walls. The first set of guide points of the initial state (typically selected as the end-systolic state) will be used to reconstruct an anatomically accurate finite element (FEM) model of the heart region. We will first generate a ‘standard mesh’, and then adjust the coordinate of the nodes by optimally chosen virtual deformation such that all guide points sit right on the surfaces of the FEM mesh. We prefer quadrilateral elements for its higher order of continuity, and can also generate tetrahedron elements if needed.

4. Tracing of surface nodal displacements. The surface nodes of the initial FEM mesh displace to fit the successive N sets of guide points of the endo/epicardial surfaces throughout the cardiac cycle, and yield surface nodal displacement U_{I}^{m} (I=1, 2, . . . , N). Based on expert knowledge, this surface non-rigid registration can be manually, semi-automatically or automatically, and will be updated according to the results of the following element 5. The method can be improved using markers in CT, and will be validated by MR tagging, which is able to create and track material points (points attached to a fixed location of the myocardium) during cardiac cycle. While this procedure is feasible, many implementation possibilities exist as reported in the literature, and may be further improved if needed.

5. Tomography-based DCE reconstruction. It has previously been demonstrated that the material parameters of heart tissues, denoted as set p, can be extracted from the measurement of endo/epicardial displacement U_{I}^{m}, chamber pressures and ECG record, by minimizing the overall difference between U_{I}^{m} and the computed displacement u_{I}(p) (it depends on p).

Once p is obtained, the complete dynamic strain/stress fields in the heart wall will be calculated, and the endo/epicardial surfaces at all the time points are computed. Then, the overall distance from the N sets of guide points to the computed endo/epicardial surfaces are calculated. If the distance is too large, U_{I}^{m} will be updated according to the currently computed endo/epicardial surfaces, until the criterion is met. This iterative procedure ensures that tracing of surface nodal displacements, or image registration, possesses full physical meaning

The inventive tomography-based DCE has features that distinguish it from the previous works of cardiac elastography. First, this invention employs a newly developed efficient and robust algorithm for identification of the passive and active material parameters of myocardium. With this algorithm, incorporating ventricular pressure, and image sequences of heart motion (obtained by CT and MRI etc.), our DCE has made the following improvements:

1. The dynamic deformation of the heart is fully taken account. The previous works only made quasi-static approach, and sometimes took overly-simplified static approximation.

2. The geometric nonlinearity is fully taken account, i.e., finite-strain description is employed. Most previous works employed infinitesimal-strain description, which lead to unrealistic results.

3. The passive properties of myocardium are described with anisotropic nonlinear finite-strain viscosity constitutive (strain-stress) relation. Most previous works reduced the degree of material anisotropy, and none has addressed the viscosity which is essential for biological tissues.

4. Parameters that describe the active contraction of the myocardium, healthy and in disease, will be extracted. Active contraction is an important index of myocardium pathology. None of the previous works is capable of considering the active parameters. With these advances, this invention promises a complete set of parameters that accurately describe the passive and active behaviors of myocardium, healthy and in diseases.

Second, this invention is tomography-based, i.e., it processes the displacement information on the endo/epicardial surfaces and outputs the material parameters. While the displacement inside the heart wall (volumetric displacement) should certainly benefit the inventive method, it is not essential. Unlike the previous works that rely on MRI tagging for volumetric displacement, this feature enables the use of high-resolution high-speed CT images, and thus overcomes the undesired limitations and potential risks of MRI.

Furthermore, for the first time, this invention provides image registration, namely matching physical (material) points on the endo/epi-cardial surfaces, rigorous mechanics significant. More specifically, the image registration reflects the actual mechanical deformation and material properties of the organ (heart), instead of the ad hoc assumptions being used in rigid and non-rigid image registration methods.

Significant and Potential Applications. This invention processes measurements, ventricular pressure and dynamic cardiac image sequences, which are obtained in vivo and noninvasively with today's biomedical imaging techniques; that is, no additional hardware cost is needed. The main products of DCE are accurate material parameters for describing the passive nonlinear viscoelastic properties and active contraction of myocardium in healthy and impaired heart regions. It is noted that no other methods can produce such a complete set of parameters. The potential applications include but not limit to:

The material parameters serve as quantitative indices of the abnormality of myocardium, in additional to the traditional cardiac indices. It improves diagnosis and monitoring of heart diseases.

Incorporating the material parameters, four-dimensional dynamic maps of the strain and stress in myocardium will be obtained. It is noted that without accurate material parameters obtained by this invention, the pervious works can only give approximate and sometimes mistaken stress in the hearts. These maps provide deep insight into the local physiological state of myocardium during heart beating. They reflect major physiological factors, such as the ventricular pumping performance, the energy consumption, the coronary blood flow, the vulnerability and expansion tendency of regions to infarction, remodeling of myocardium and risk of arrhythmias.

Accurate material parameters are the basis of patient-specific optimal design of surgical equipment and implants, such as pacemaker, bypass and artificial valves.

Accurate knowledge of the behavior of myocardium is basis of reliable patient-specific virtual surgical training and pre-surgery trials.

Accurate knowledge of the behavior of myocardium is basis of reliable patient-specific design of surgical procedure such as ventricle restoration and implant of pacemaker. For example, with cardiac mechanics simulation, well-designed surgery can not only restore the shape of the ventricle, but also restore the local physiological state (strain/stress) of myocardium.

Finite-element Equation of Motion. Consider a biological object undergoing dynamic viscoelastic deformation. The displacement tensor at location X and time t is denoted as u(X,t) with corresponding velocity of \dot{u} and acceleration of ü. The Green strain tensor is E=(∇u+(∇u)^{T}+(∇u)^{T}·∇u)/2 and, respectively. The 2^{nd}-PK stress tensor, Σ(X,t), is assumed to be nonlinearly dependent on E and Ė, as Equation (11):

$$Σ = ( \frac{\partial W ( E ; {C}_{P} )}{\partial E} + T ( {λ}_{F} , {C}_{a}^{+} ; {T}_{Max} ) M ⊗ M + {S}_{vis} ( E ; {C}_{vis} ) \dot{E} ) \cdot {F}^{T} = Σ ( E , \dot{E} ; p )$$

in which W is the passive nonlinear strain energy function, Sᵥᵢₛ describes the viscous stress that depend on E and Ė, and T gives the active contraction stress in the myofiber direction M due to local Calcium kinetics Cₐ⁺ and fiber stretch λ_{F}=(M·(2E+I)·M)^{1/2}.

In the last term of (11), we collect all the material parameter, and denote with p=(C_{P},Cᵥᵢₛ,T_{Max}). On a part of the boundary Γᵤ⁰, u and \dot{u} are prescribed. On the rest of the boundary Γ_{T}⁰, surface force (traction) is applied. For a heart, the surface force is approximated as zero on the epicardial surface, and is −P(X,t)N(X) on the endocardial surface with P the blood pressure and N the unit outer normal vector.

Following the standard finite-element (FE) method,^{2C} the displacement field u(X,t) is discretized as nodal displacement vector {u(t)}={u₁(t), u₂(t)}^{T}, where u₂(t) is prescribed on Γᵤ⁰, and u₁(t) is to be solved from the motion equation:

$$\{ \begin{matrix}{s}_{1} ( t ) \\ {s}_{2} ( t )\end{matrix} \} + [ \begin{matrix}{M}_{11} & {M}_{12} \\ {M}_{21} & {M}_{22}\end{matrix} ] \{ \begin{matrix}{\ddot{u}}_{1} ( t ) \\ {\ddot{u}}_{2} ( t )\end{matrix} \} - \{ \begin{matrix}{f}_{1} ( t ) \\ {f}_{2} ( t )\end{matrix} \} = \{ \begin{matrix}0 \\ 0\end{matrix} \} , \qquad ( 21 )$$

in which the internal nodal force {s}={s₁,s₂}^{T} corresponds to the stress Σ; i.e., it depends on u₁, \dot{u}₁, and material parameters p. The external nodal force f₁ corresponds to the surface force on Γ_{T}⁰, and f₂ is the unknown constraint force on Γᵤ⁰. The mass matrices M_{IJ} (I, J=1, 2) are constant.

A classic Newmark-β time integral scheme^{12C} is employed to solve Eq. (21) for u₁. Newmark-β scheme was employed to solve u₁ and w₁. Let's denote all quantities at time t with superscript “^{(t)}” and those at time τ=t−h with “^{(τ)}”. Let u₁^{(τ)}, \dot{u}₁^{(τ)} and ü₁^{(τ)} be previously obtained, u₁^{(t)} and \dot{u}₁^{(t)} are approximated as:

u₁^{(t)}=u₁^{(τ)}+h\dot{u}₁^{(τ)}+(½−β)h²ü₁^{(τ)}+βh²ü₁^{(t)}, \dot{u}₁^{(t)}=\dot{u}₁^{(τ)}+(1−γ)hü₁^{(τ)}+γhü₁^{(t)}, (A1)

where γ=½ and β= 1/12,^{12C} the acceleration is unknown.

By substituting Eq. (A1) into Eq. (21), a nonlinear equation is obtained for ü₁^{(t)}, denoted as ψ(ü₁^{(t)})=0. An iterative quasi-Newton method^{44C} was employed to solve the nonlinear equation for ü₁^{(t)}, as:

$$\begin{matrix}\{ \begin{matrix}{( {\ddot{u}}_{1}^{( t )} )}^{n + 1} = {( {\ddot{u}}_{1}^{( t )} )}^{n} + δ {a}_{1} , {K}_{eff} δ {a}_{1} = - ψ ( {( {\ddot{u}}_{1}^{( t )} )}^{n} ) , \\ {K}_{eff} = \frac{\partial ψ}{\partial {\ddot{u}}_{1}^{( t )}} {\vert}_{{( {\ddot{u}}_{1}^{( t )} )}^{n}} = β {h}^{2} {K}_{11} ( {( {u}_{1}^{( t )} )}^{n} , {( {\dot{u}}_{1}^{( t )} )}^{n} ) + γ {hC}_{11} ( {( {u}_{1}^{( t )} )}^{n} , {( {\dot{u}}_{1}^{( t )} )}^{n} ) + {M}_{11} ,\end{matrix} & ( A 2 )\end{matrix}$$

where superscript “n” denotes the nth iteration step, (u₁^{(t)})ⁿ and (\dot{u}₁^{(t)})ⁿ are calculated with (ü₁^{(t)})ⁿ by Eq. (A1).

In the last relation, the stiffness matrix K₁₁=∂s₁/∂u₁ corresponds to the tangent elastic modulus ∂σ/∂ε, and the viscosity matrix C₁₁=∂s₁/∂üᵢ corresponds to ∂σ/∂\dot{ε}. Cholesky factorization of K_{eff} is calculated for solving the linear equation of δa₁. The process is iterated until the residual value ∥ψ((ü₁^{(t)})ⁿ⁺¹)∥ is small enough.

DCE Objective Function and Gradients. In experiment, the displacement is measured at time t=t_{I} (I=1, 2, . . . , M) on a portion of the nodes that correspond to uₗ, and is denoted as U_{I}^{m}(t₁). Given trial material parameters p, u₁(t_{I};p) is solved from Eq. (21). The overall difference between u₁ and U₁^{m} is then quantified with an objective function:

$$Φ ( p ) = {\sum }_{I = 1 , M}^{ } {( {H}_{I} )}^{T} {X}_{I} {H}_{I} , \\ {H}_{I} = {u}_{1} ( {t}_{I} ; p ) - {U}_{1}^{m} ( {t}_{I} ) , \qquad ( 31 )$$

in which the weight matrix X_{I}=diag(a_{I1}, a_{I2}, . . . , a_{Ij}, . . . ), with a_{Ij}=1 when the j-th component of U₁^{m}(t_{I}) is measured, and a_{Ij}=0 otherwise. Thus DCE searches for material parameters such that Φ(p) is minimized.

Efficient and robust minimization algorithm request user-supplied gradients MoMp. The previous algorithms for cardiac elastography [^{1,5,14,16,33,42,43}]C used finite-difference method or direct method for the gradients. The direct method requests high computational expense that further increases proportionally with the number of material parameters, and becomes unaffordable for large-scale cardiac elastography involving dynamic deformation. The finite-difference method is inaccurate in nature, and is even more time-consuming. Recently, an adjoint method was introduced for computing the gradients analytically. [^{27,28,40,41,51}]C Continuum derivation of the adjoint method for nonlinear dynamic elastography was detailed by Liu et al.^{28C} A more general FE version is derived in APPENDIX B. It is shown that the gradients can be calculated conveniently with:

$$\frac{\partial Φ}{\partial {p}_{n}} = {\int }_{0}^{T} {( {w}_{1} ( t ) )}^{T} ( \frac{\partial {s}_{1}}{\partial {p}_{n}} ) d t \\ ( n = 1 , 2 , … , N ) , \qquad ( 41 )$$

where w₁(t) is an adjoint displacement solved from the following linear differential equation:

$$( {K}_{11} - {D}_{11} ) {w}_{1} - {C}_{11} {\dot{w}}_{1} + {M}_{11} {\ddot{w}}_{1} = - 2 {\sum }_{I = 1 , M} δ ( t - {t}_{I} ) {X}_{I} {H}_{I} , \qquad ( 51 )$$

in which

$${K}_{11} = \frac{\partial {s}_{1}}{\partial {u}_{1}}$$

corresponds to

$$\frac{\partial Σ}{\partial E} , \\ {C}_{11} = \frac{\partial {s}_{1}}{\partial {\dot{u}}_{1}}$$

corresponds to

$$\frac{\partial Σ}{\partial \dot{E}} ,$$

and

$${D}_{11} = ( \frac{\partial {C}_{11}}{\partial {u}_{1}} \cdot {\dot{u}}_{1} + \frac{\partial {C}_{11}}{\partial {\dot{u}}_{1}} \cdot {\ddot{u}}_{1} )$$

corresponds to

$$\frac{\partial }{\partial t} ( \frac{\partial Σ}{\partial \dot{E}} ) = \frac{{\partial }^{2} Σ}{\partial E \partial \dot{E}} : \dot{E} + \frac{{\partial }^{2} Σ}{\partial \dot{E} \partial \dot{E}} : \ddot{E} .$$

End conditions are prescribed for w₁, as w₁=0 and \dot{w}₁=0 at t=T.

A backward Newmark-β scheme can be derived for solving Eq. (51) as follows.

DYNAMIC ADJOINT METHOD. Equation (41) for the gradients ∂Φ/∂p is derived here. FE motion equation Eq. (21) has an equivalent weak form, i.e., equality

∫₀^{T}(w₁)^{T}(s₁+M₁₁ü₁+M₁₂ü₂−f₁)dt=0 (A3)

holds for arbitrary displacement w₁(t). By introducing Eq. (A3) into the objective function Φ(p) (Eq. 31), a Lagragian is obtained as:

L(u₁,w₁,p)=∫₀^{T}H^{T}×Hdt+∫₀^{T}(w₁)^{T}(S₁+M₁₁ü₁+M₁₂ü₂−f₁)dt, (A4)

where

$$H ( t ) = {\sum }_{I = 1 , M} ( {u}_{1} ( {t}_{I} ) - {U}_{1}^{m} ( {t}_{I} ) ) δ ( t - {t}_{I} ) .$$

In the functional L, the relation between u₁ and p is decoupled. It can be shown that L=Φ and δL=δΦ for arbitrary p, u₁ and w₁. The variation δL can be expressed as Equation (A5):

$$δ L = {\int }_{0}^{T} 2 δ {u}_{1}^{T} XH d t + {\int }_{0}^{T} {( {w}_{1} )}^{T} ( ( \frac{\partial {s}_{1}}{\partial {u}_{1}} - \frac{\partial {f}_{1}}{\partial {u}_{1}} ) δ {u}_{1} + ( \frac{\partial {s}_{1}}{\partial {\dot{u}}_{1}} - \frac{\partial {f}_{1}}{\partial {\dot{u}}_{1}} ) δ {\dot{u}}_{1} + {M}_{11} δ {\ddot{u}}_{1} + \frac{\partial {s}_{1}}{\partial p} δ p ) d t$$

for which δM₁₁=0, δu₂=0, and equality Eq. (A3) have been used noting that both w₁ are δw₁ are arbitrary. By integrating Eq. (A5) by part, we have Equation (A6):

$$δ L = {\int }_{0}^{T} {w}_{1}^{T} \frac{\partial {s}_{1}}{\partial p} δ p d t + {\int }_{0}^{T} {( δ {u}_{1} )}^{T} ( 2 XH + {( \frac{\partial {s}_{1}}{\partial {u}_{1}} - \frac{\partial f}{\partial {u}_{1}} )}^{T} {w}_{1} - \frac{d}{d t} ( {( \frac{\partial {s}_{1}}{\partial {\dot{u}}_{1}} - \frac{\partial {f}_{1}}{\partial {\dot{u}}_{1}} )}^{T} {w}_{1} ) + {M}_{11} {\ddot{w}}_{1} ) d t + {w}_{1}^{T} ( \frac{\partial {s}_{1}}{\partial {\dot{u}}_{1}} - \frac{\partial f}{\partial {\dot{u}}_{1}} ) δ {u}_{1} {\vert}_{t = 0}^{t = T} + {w}_{1}^{T} {M}_{11} δ {\dot{u}}_{1} {\vert}_{t = 0}^{t = T} - {\dot{w}}_{1}^{T} {M}_{11} δ {u}_{1} {\vert}_{t = 0}^{t = T}$$

Now, let the arbitrary displacement w₁ satisfy differential equation:

$${( \frac{\partial {s}_{1}}{\partial {u}_{1}} - \frac{\partial {f}_{1}}{\partial {u}_{1}} )}^{T} {w}_{1} - \frac{d}{d t} ( {( \frac{\partial {s}_{1}}{\partial {\dot{u}}_{1}} - \frac{\partial {f}_{1}}{\partial {\dot{u}}_{1}} )}^{T} {w}_{1} ) + {M}_{11} {\ddot{w}}_{1} = - 2 XH , \qquad ( A7 )$$

then, the second integral in Eq. (A6) becomes zero. Noting that u₁=0 and \dot{u}₁=0 at t=0, boundary terms in Eq. (A6) can be cancelled out by specifying end conditions w₁=0 and \dot{u}₁=0 at t=T. Now, only the first integral remains in Eq. (A6), i.e.,

$$δΦ = δ L = {\int }_{0}^{T} {w}_{1}^{T} \frac{\partial {s}_{1}}{\partial p} δ p d t , which gives Eq . ( 41 ) .$$

In the present simulations, f₁ does not depend on the deformation, i.e., ∂f₁/∂u₁=0 and of ∂f₁/∂\dot{u}₁=0, so that Eq. (A7) becomes formula Eq. (51) since matrices ∂s₁/∂u₁ and ∂s₁/∂\dot{u}₁ are symmetric.

In comparison, the direct method calculates the gradients with Equation (A7a):

$$\frac{\partial Φ}{\partial {p}_{n}} = {\sum }_{I = 1 , M} 2 {( {H}_{I} )}^{T} {X}_{I} {v}_{( n )} ,$$

where

$${v}_{n} = \frac{\partial {u}_{1}}{\partial {p}_{n}}$$

is the solution of

$$( \frac{\partial {s}_{1}}{\partial {u}_{1}} - \frac{\partial {f}_{1}}{\partial {u}_{1}} ) {v}_{( n )} + ( \frac{\partial {s}_{1}}{\partial {\dot{u}}_{1}} - \frac{\partial {f}_{1}}{\partial {\dot{u}}_{1}} ) {\dot{v}}_{( n )} + {M}_{11} {\ddot{v}}_{( n )} = 0 , \qquad ( A 7 a )$$

with initial condition v₍ₙ₎=\dot{v}₍ₙ₎=0. The finite-difference method is straight forward, as:

$$\frac{\partial Φ}{\partial {p}_{n}} \approx \frac{Φ ( p + Δ {p}_{n} ) - Φ ( p )}{Δ {p}_{n}} \qquad ( A 7 b )$$

The numerical scheme for solving Eq. (51) for the adjoint displacement w₁ includes two phases:

(i) Backward Newmark-β scheme. This is for the case that no displacement measurement is taken in the time interval between τ and t (=τ+h). Let w₁^{(t)}, \dot{w}₁^{(t)} and \ddot{w}₁^{(t)} be known at time t, w₁^{(t)} and \dot{w}₁^{(t)} are approximated as:

$$\{ \begin{matrix}{w}_{1}^{( τ )} = {w}_{1}^{( t )} - h {\dot{w}}_{1}^{( t )} + ( \frac{1}{2} - β ) {h}^{2} {\ddot{w}}_{1}^{( t )} + β {h}^{2} {\ddot{w}}_{1}^{( τ )} \\ {\dot{w}}_{1}^{( τ )} = {\dot{w}}_{1}^{( t )} - ( 1 - γ ) h {\ddot{w}}_{1}^{( t )} - γ h {\ddot{w}}_{1}^{( τ )}\end{matrix} , \qquad ( A 8 )$$

in which \ddot{w}₁^{(t)} is the solution of linear equation (A9):

(K_{eff}−βh²D₁₁)=\ddot{w}₁^{(τ)}=(w₁^{(t)}−h\dot{w}₁^{(t)}+(½−β)h²\ddot{w}₁^{(t)})(K₁₁−D₁₁)+((1−γ)h\ddot{w}₁^{(t)}−\dot{w}₁^{(t)})C₁₁

where K_{eff}, D₁₁, K₁₁ and C₁₁ are evaluated with u₁^{(t)} and \dot{u}₁^{(t)} as in Eq. (A2). For material that ∂²σ/∂\dot{ε}∂t≡0, as in our simulations, it is shown that D₁₁=0 and the solution for Eq. (A9) uses the already computed K_{eff} and its Cholesky factorization.

(ii) Response to impulsive force −2X_{I}H_{I} at t=t_{I} when measurement U₁^{m} is taken. As in Eq. (51), the difference between the computed and measured displacements at time t=t_{I}, H_{I}, acts as an impulsive force on the adjoint system. Let w₁, \dot{w}₁ and \ddot{w}₁ be known at time t_{I}⁺ (right after t_{I}), the quantities at t_{I}⁻ (right before t_{I}) are calculated with

$$\{ \begin{matrix}{w}_{1} ( {t}_{I}^{-} ) = {w}_{1}^{( t )} ( {t}_{I}^{+} ) \\ {\dot{w}}_{1} ( {t}_{I}^{-} ) = {\dot{w}}_{1} ( {t}_{I}^{+} ) + 2 {( {M}_{11} )}^{- 1} {X}_{I} {H}_{I} \\ {\ddot{w}}_{1} ( {t}_{I}^{-} ) = {\dot{w}}_{1} ( {t}_{I}^{+} ) + 2 {( {M}_{11} )}^{- 1} {{C}_{11} ( {M}_{11} )}^{- 1} {X}_{I} {H}_{I}\end{matrix} , \qquad ( A 10 )$$

for which the continuity of C₁₁ at time t_{I} has been used.

The most significant advantage of the inventive dynamic adjoint method is the minimal computational expense. The previous finite-difference method (Eq. A7b) requests solving the nonlinear differential equation Eq. (21) once for every ∂Φ/∂pₙ (n=1, 2, . . . , N). The computational cost thus increases proportionally with the number of parameters. The direct method involves solving differential equation Eq. (A7a) for the same number of times; however, it is more efficient since the equation is linear. In comparison, the inventive dynamic adjoint method needs to solve linear differential equation Eq. (51) for only one time regardless of the number of the unknown parameters. Therefore, it is particularly favorable for large-scale elastography. [^{27,28,41}]C However, there is a tradeoff: the backward adjoint differential equation Eq. (51) requires complex programming and additional computer memory to store the matrices K₁₁ D₁₁ and C₁₁ at all the time integration steps when solving Eq. (21) for u₁, as described above, for example, in the Newmark-β scheme and the backward Newmark-β scheme.

Minimization-based DCE Reconstruction Procedure. FORTRAN source codes have been developed for solving the FE motion equation and for DCE material parametric identification. The FE codes were comprehensively tested against commercial software ANSYS. The minimization-based DCE procedure is as follows: First, given trial material parameters p, displacement u₁(t;p) is solved from the forward problem Eq. (21). The objective function Φ(p) is calculated to quantify the difference between u₁ and U₁^{m} (Eq. 31). The adjoint displacement w₁(t) is then solved (Eq. 51), and the gradients ∂Φ/∂p are computed analytically (Eq. 41). The objective function and gradients are passed into a L-BFGS minimization subroutine,^{25C} where the trial material parameters p are updated. The procedure iterates until the convergent criterion ∥∂Φ/∂p∥≦δ is met, where δ is a tolerance.

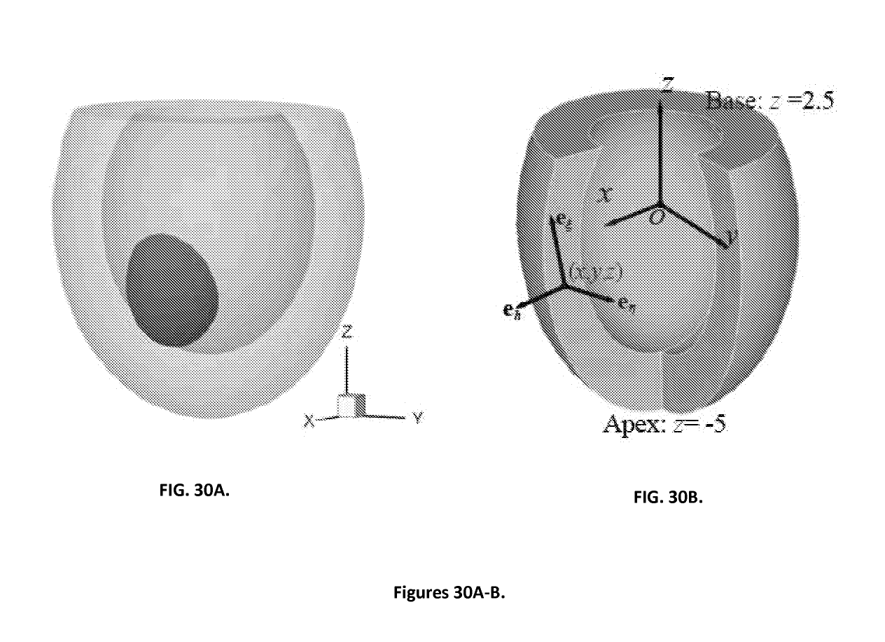

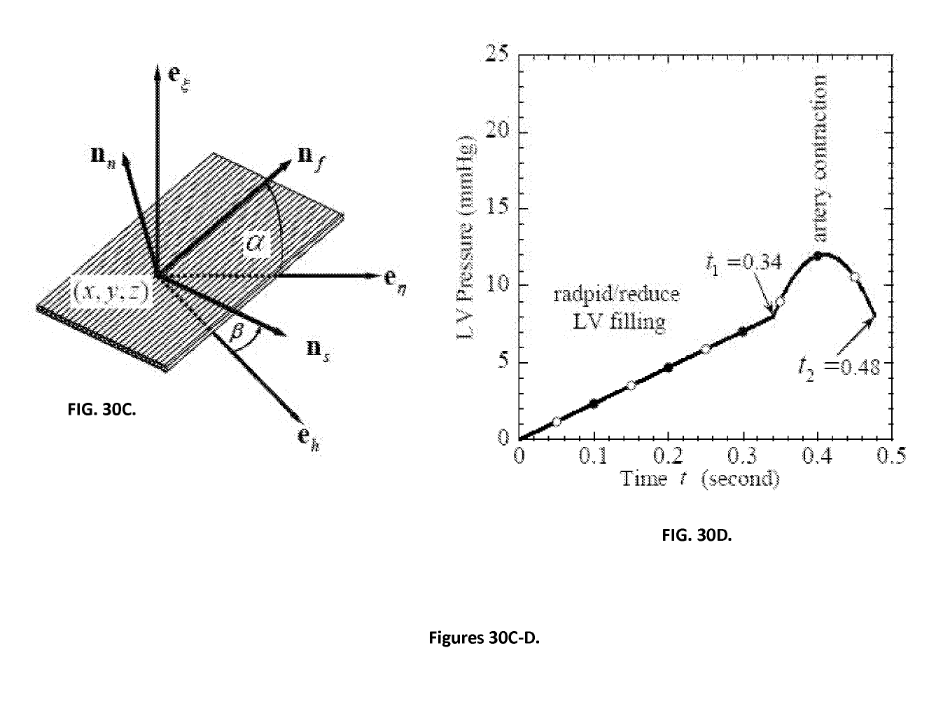

LV Phantom. A thick-wall hollow ellipsoid was used for modeling a left ventricle (LV).^{21C} Shown with FIGS. 30A-B, the epi- and endocardial surfaces are defined by (x/a)²+(y/b)²+(z/c)²=λ², where (a, b, c)=(3.6, 4.0, 5.0), λₑₚᵢ=1, λ_{endo}=0.6875. The longitudinal coordinates of the base and apex are z_{base}=2.5 and zₐₚₑₓ=−5.0 respectively. The length unit is centimeter. The red region embedded in the ventricular wall models a small piece of ischemic myocardium. Clinically, the location, size and shape of ischemic myocardium can be three-dimensionally segmented from images, such as MRI pixel density. FE mesh is shown in FIG. 30A. Ten-node tetrahedron element was used, with characteristic edge length 0.6 cm for the normal region (6613 elements) and 0.45 cm for the ischemic region (330 elements).

Myofiber Architecture. The myofiber architecture [^{23,47,60}]C was described on all the integration points by the relationship between the local geometric coordinates (eₕ, e_{η}, e_{ξ}) and myofiber architectural axes (n_{f},nₛ,nₙ) (FIGS. 30B-C). At a point (x,y,z), eₕ is in the local thickness direction (x/a², y/b², z/c²), e_{η} is in the direction (−y/b²,x/a², 0), and e_{ξ}=eₕ×e_{η}. The myofiber direction is n_{f}=cos α e_{η}+sin α e_{ξ}, where α is the fiber angle. The cross-fiber direction nₛ lies in the muscle layer and measures a sheet angle β from eₕ; i.e., nₛ=cos β eₕ+sin β(eₕ×n_{f}). Finally, nₙ=n_{f}×nₛ. According to the previous experimental measurement,^{23C} α and β were approximated as Equation (61):

$$\{ \begin{matrix}\begin{matrix}\begin{matrix}\begin{matrix}α = {α}_{endo} {λ}^{′} - {α}_{epi} ( 1 - {λ}^{′} ) , \\ β = {β}_{endo} {λ}^{′} ( 2 {λ}^{′} - 1 ) + 4 {β}_{mid} {λ}^{′} ( 1 - {λ}^{′} ) {β}_{epi} ( 1 - 2 {λ}^{′} ) ( 1 - {λ}^{′} )\end{matrix} \\ ( {α}_{epi} , {α}_{endo} , {β}_{endo} , {β}_{mid} , {β}_{epi} ) =\end{matrix} \\ ( - {40}^{°} , {80}^{°} , {10}^{°} , - {18}^{°} , - {20}^{°} ) {z}^{′} +\end{matrix} \\ ( - {65}^{°} , {60}^{°} , - {35}^{°} , {25}^{°} , {0}^{∘} ) ( 1 - {z}^{′} )\end{matrix}$$

where λ=((x/a)²+(y/b)²+(z/c)²)^{1/2}, λ′=(λ−λₑₚᵢ)/(λ_{endo}−λₑₚᵢ) is the relative wall depth, and z′=(z_{base}−z)/(z_{base}−zₐₚₑₓ) is the relative height. The angels α and β vary linearly from the basal site to the apex. In the transmural direction, α changes linearly from endocardium to epicardium, and β changes quadratically.

Constitutive Model. The passive constitutive model of myocardium was assumed to consist of an elastic stress derived from an anisotropic exponential strain energy W_{E} [^{15,52}]C and an isotropic Voigt-type viscous stress, as Equation (71)

$$σ = \frac{\partial {W}_{E}}{\partial ɛ} + cI : \dot{ɛ}$$

$${W}_{E} = γ ( exp Q - 1 ) , \\ Q = \frac{1}{2} ( {E}_{ff} {ɛ}_{ff}^{2} + {E}_{ss} {ɛ}_{ss}^{2} + {E}_{nn} {ɛ}_{nn}^{2} ) + {E}_{fs} {ɛ}_{fs}^{2} + {E}_{fn} {ɛ}_{fn}^{2} + {E}_{ns} {ɛ}_{ns}^{2}$$

where ε_{ff}=n_{f}·ε·n_{f}, ε_{fs}=n_{f}·ε·nₛ and so on. For the normal tissue, the material parameters (γ,E_{ff},Eₛₛ,Eₙₙ,Eₙₛ,E_{fn},E_{fs},c) were pₙₒᵣₘ=(0.44, 37, 7.16, 7.16, 5.6, 5.6, 5.6, 0.5), where γ is in kPa, Es are dimensionless, and c is in kPa·second. The values of γ and Es are consistent with the previous studies. [^{15,52}]C The viscous coefficient c was selected such that the computed velocity field in the LV is low at the end-diastolic state. The ischemic myocardium was modeled to be three times stiffer^{32C} but with the same material anisotropy as the normal tissue, i.e., p_{isch}=(1.32, 37, 7.16, 7.16, 5.6, 5.6, 5.6, 0.5). The mass density of myocardium was set at ρ₀=1 g/cm³.

Dynamic Deformation of LV. The basal site was assumed fixed, simulating the high rigidity of the fibrous rings to which the mitral and aortic valves anchor. The LV filling pressure P(t) was modeled as in FIG. 30D for t∈[0, 0.48] second. It linearly increases to 8.0 mmHg at t=0.34, and reaches peak value of 12.0 mmHg at t=0.405 during the artery contraction.

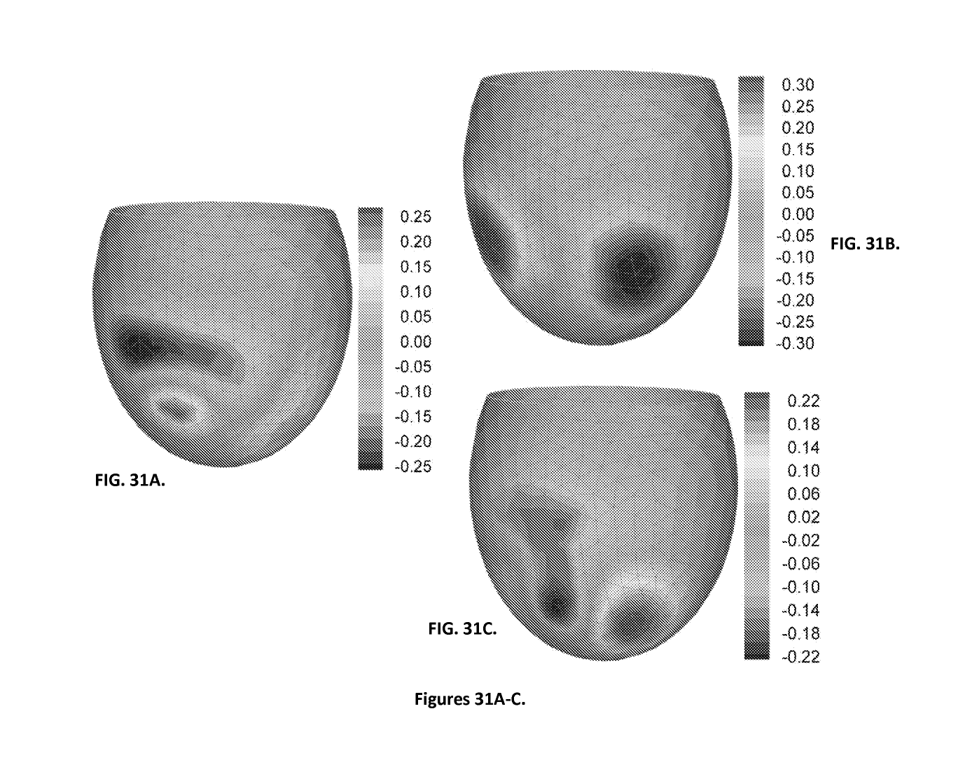

The deformed LV at t=0.4 is plotted in FIG. 31A. FIGS. 31B-D show that the stiffer ischemic region changes the displacement characteristics as compared to the normal LV. In other words, the material parameters of the normal and ischemic myocardium may be extracted from the displacement of myocardium.

Ideal DCE Reconstruction. The epi- and endocardial displacement at t=0.1, 0.2, 0.3, 0.4 FIG. 30D was used as the measurement U₁^{m}. We first conducted DCE reconstruction using exact measurements. Effects of the errors of displacement, myofiber architecture angles and geometric description were investigated in the next sections. The initial guess for pₙₒᵣₘ and p_{isch} was (0.50, 25.0, 10.0, 10.0, 5.00, 5.00, 5.00, 1.0). It was chosen close to the real pₙₒᵣₘ to prevent the reconstruction procedure from falling into a local minimum of Φ(p), where the parameters may be faraway from the exact values. In practice, the initial guess can be estimated from available database of normal myocardium. [^{15,46}]C.

The reconstruction converged after about 150 iteration steps, and yielded exact pₙₒᵣₘ and highly accurate p_{isch}, as the row “Ideal” in Table 11.

TABLE 11
Dynamic Cardiac Elastography Reconstruction Results

| | Normal Myocardium pₙₒᵣₘ | | | | | | | | Ischemic Myocardium p_{isch} | | | | | | | |
|---|---|---|---|---|---|---|---|---|---|---|---|---|---|---|---|---|
| | γ | E_{ff} | Eₛₛ | Eₙₙ | Eₙₛ | E_{fn} | E_{fs} | _{C} | γ | E_{ff} | Eₛₛ | Eₙₙ | Eₙₛ | E_{fn} | E_{fs} | _{C} |
| Real | 0.4 | 37. | 7.1 | 7.1 | 5.6 | 5.6 | 5.6 | 0.5 | 1.3 | 37. | 7.1 | 7.1 | 5.6 | 5.6 | 5.6 | 0.5 |
| | 4 | 0 | 6 | 6 | 0 | 0 | 0 | | 2 | 0 | 6 | 6 | 0 | 0 | 0 | 0 |
| Guess | 0.5 | 25. | 10. | 10. | 5.0 | 5.0 | 5.0 | 1.0 | 0.5 | 25. | 10. | 10. | 5.0 | 5.0 | 5.0 | 1.0 |
| | 0 | 0 | 0 | 0 | 0 | 0 | 0 | | 0 | 0 | 0 | 0 | 0 | 0 | 0 | 0 |
| Ideal | 0.4 | 37. | 7.1 | 7.1 | 5.6 | 5.6 | 5.6 | 0.5 | 1.3 | 37. | 7.1 | 7.1 | 5.6 | 5.6 | 5.6 | 0.5 |
| | 40 | 00 | 60 | 60 | 00 | 00 | 00 | 00 | 21 | 07 | 72 | 80 | 00 | 00 | 01 | 02 |
| Δ % | 0.00 | 0.00 | 0.00 | 0.00 | 0.00 | 0.00 | 0.00 | 0.00 | 0.08 | 0.19 | 0.17 | 0.28 | 0.00 | 0.00 | 0.02 | 0.40 |
| Error-F | 0.4 | 37. | 7.1 | 7.1 | 5.5 | 5.5 | 5.5 | 0.5 | 1.3 | 36. | 7.1 | 7.0 | 5.6 | 5.6 | 5.6 | 0.4 |
| | 40 | 01 | 60 | 56 | 98 | 99 | 96 | 00 | 25 | 99 | 68 | 85 | 00 | 19 | 03 | 94 |
| Δ % | 0.00 | 0.03 | 0.00 | - | - | - | - | 0.00 | 0.38 | - | 0.11 | - | 0.00 | 0.34 | 0.05 | - |
| | | | | 0.06 | 0.04 | 0.02 | 0.07 | | | 0.03 | | 1.05 | | | | 1.20 |
| Error-D | 0.4 | 37. | 7.2 | 7.2 | 5.6 | 5.5 | 5.6 | 0.4 | 1.2 | 38. | 7.7 | 7.1 | 5.7 | 5.7 | 5.6 | 0.5 |
| | 38 | 16 | 00 | 01 | 24 | 85 | 76 | 98 | 61 | 00 | 07 | 51 | 73 | 18 | 82 | 10 |
| Δ % | - | 0.43 | 0.56 | 0.57 | 0.43 | - | 1.36 | - | - | 2.70 | 7.64 | - | 3.09 | 2.11 | 1.46 | 2.00 |
| | 0.45 | | | | | 0.27 | | 0.40 | 4.47 | | | 0.13 | | | | |
| Error-FD | 0.4 | 37. | 7.2 | 7.2 | 5.6 | 5.5 | 5.6 | 0.4 | 1.2 | 37. | 7.7 | 7.0 | 5.7 | 5.7 | 5.6 | 0.5 |
| | 38 | 18 | 00 | 00 | 23 | 84 | 72 | 98 | 69 | 94 | 06 | 76 | 59 | 23 | 75 | 05 |
| Δ % | - | 0.49 | 0.56 | 0.56 | 0.41 | - | 1.29 | - | - | 2.54 | 7.63 | - | 2.84 | 2.20 | 1.34 | 1.00 |
| | 0.45 | | | | | 0.29 | | 0.40 | 3.86 | | | 1.17 | | | | |
| Goe-I | 0.4 | 36. | 7.0 | 7.0 | 5.5 | 5.4 | 5.5 | 0.4 | 0.6 | 40. | 8.0 | 8.2 | 5.9 | 6.2 | 6.2 | 0.5 |
| | 54 | 53 | 37 | 83 | 31 | 83 | 79 | 94 | 89 | 35 | 05 | 00 | 07 | 22 | 20 | 93 |
| Δ % | 3.18 | - | - | - | - | - | - | - | - | 9.05 | 11.8 | 14.5 | 5.48 | 11.1 | 11.0 | 18.6 |
| | | 1.27 | 1.72 | 1.08 | 1.23 | 2.09 | 0.37 | 1.16 | 47.8 | | 0 | 3 | | 1 | 7 | |
| | | | | | | | | | 0 | | | | | | | |
| Goe-II | 0.4 | 36. | 7.1 | 7.1 | 5.5 | 5.6 | 5.5 | 0.5 | 1.4 | 36. | 7.4 | 6.9 | 5.6 | 5.6 | 5.7 | 0.4 |
| | 42 | 97 | 41 | 49 | 88 | 18 | 81 | 00 | 58 | 61 | 32 | 23 | 66 | 36 | 35 | 76 |
| Δ % | 0.45 | - | - | - | - | 0.32 | - | 0.00 | 10.4 | - | 3.80 | - | 1.18 | 0.64 | 2.41 | - |
| | | 0.08 | 0.27 | 0.15 | 0.21 | | 0.34 | | 5 | 1.05 | | 3.31 | | | | 4.80 |
| All-I | 0.4 | 36. | 7.0 | 7.1 | 5.5 | 5.4 | 5.6 | 0.4 | 0.6 | 40. | 8.2 | 8.1 | 6.0 | 6.3 | 6.2 | 0.5 |
| | 52 | 71 | 77 | 25 | 53 | 44 | 43 | 92 | 75 | 81 | 62 | 80 | 11 | 38 | 59 | 91 |
| Δ % | 2.73 | - | - | - | - | - | 0.77 | - | - | 10.3 | 15.3 | 14.2 | 7.34 | 13.1 | 11.7 | 18.2 |
| | | 0.78 | 1.16 | 0.49 | 0.84 | 2.79 | | 1.60 | 48.8 | 0 | 9 | 5 | | 8 | 7 | 0 |
| | | | | | | | | | 6 | | | | | | | |
| All-II | 0.4 | 37. | 7.1 | 7.2 | 5.6 | 5.6 | 5.6 | 0.4 | 1.4 | 36. | 7.7 | 6.7 | 5.7 | 5.6 | 5.7 | 0.4 |
| | 38 | 21 | 97 | 01 | 23 | 12 | 62 | 98 | 58 | 96 | 57 | 53 | 21 | 63 | 00 | 67 |
| Δ % | - | 0.57 | 0.52 | 0.57 | 0.41 | 0.21 | 1.11 | - | 10.4 | - | 8.34 | - | 2.16 | 1.13 | 1.79 | - |
| | 0.45 | | | | | | | 0.40 | 5 | 0.11 | | 5.68 | | | | 6.60 |
| Static A | 9.5 | 4.5 | 2.4 | 6.2 | 3.4 | 1.8 | 2.4 | ---- | 18. | 1.5 | 426 | 1.3 | 0.9 | 0.1 | 0.00 | --- |
| | 53 | 15 | 17 | 74 | 68 | 12 | 81 | - | 94 | 62 | .6 | 35 | 04 | 05 | 14 | -- |
| Δ % | 207 | - | - | - | - | - | - | ----- | 133 | - | 585 | - | - | - | - | ----- |
| | 1 | 87.8 | 66.2 | 12.4 | 38.1 | 67.6 | 55.7 | | 5 | 95.8 | 8 | 81.4 | 83.9 | 98.1 | 100. | |
| | | | | | | | | | | | | | | | 0 | |
| Static B | 6.1 | 5.3 | 2.8 | 6.1 | 3.3 | 1.6 | 2.1 | ---- | 6.1 | 2.8 | 217 | 0.9 | 2.1 | 0.3 | 0.9 | ---- |
| | 32 | 85 | 94 | 45 | 28 | 76 | 59 | - | 95 | 73 | .9 | 60 | 63 | 23 | 69 | - |
| Δ % | 129 | - | - | - | - | - | - | | 369. | - | 294 | - | - | - | - | ---- |
| | 4 | 85.4 | 59.6 | 14.2 | 40.6 | 70.1 | 61.4 | ----- | 3 | 92.2 | 3 | 86.6 | 61.4 | 94.2 | 82.7 | - |

Δ % means the relative error compared to the real values. Real: exact material parameters; Guess: initial guess; Ideal: Results with exact measurements; Error-F: with myofiber error*; Error-D: with displacement error**; Error-FD: with myofiber and displacement errors; Geo-I: with Type-I geometric error; Geo-II: with Type-II geometric error; All-I: with myofiber, displacement and Type-I geometric errors; All-II: with myofiber, displacement and Type-I geometric errors; Static A: Quasi-static result with displacement measured at t = 0.4 second; Static B: Quasi-static result with displacement measured at t = 0.45 second.
*Randomly picked values between ±5° are added to the myofiber architectural angles α and β.
**Randomly generated −5% to +5% relative errors are added to the displacement measurement U₁^{m}.

The convergent loci of γ, E_{ff}, Eₛₛ, E_{fn} and c are plotted in FIGS. 31A and 31C for normal and ischemic tissues, respectively. Loci of the other parameters are similar. All parameters in pₙₒᵣₘ reached into the range of 99% to 101% of the exact values after 50 iteration-steps, and were within 99.5% to 100.5% after 100 steps. The parameters p_{isch} of ischemic myocardium converged slower. They reached within the range of 80% to 120% of the exact values after about 50 steps. At this point, the material anisotropy, defined by the ratio between Es, was well revealed. The material heterogeneity, described with γ_{isch}/γₙₒᵣₘ, was also disclosed; the ratio reached from the initial guess 1.0 to 2.4, noting that exact value was 3.0. After about 150 steps, p_{isch} reached into the range of 99% to 101% of the exact values. The slow convergence may be explained by the size effect, i.e., small size of the ischemic region weakens the effects of p_{isch} on the epi- and endocardial displacement. It is suggested that about 50 iteration steps are enough for very accurate identification of pₙₒᵣₘ and satisfactory results for p_{isch}. A few dozens more steps may be needed if higher accuracy is desired for p_{isch}.

DCE reconstruction was also conducted using displacement at t=0.05, 0.1, 0.15, . . . , 0.45 second (FIG. 30D, both solid and open dots) as measurement. Fewer iteration steps were needed, with slightly more accurate results for p_{isch} as compared to the previous reconstruction. This indicates for ideal DCE with exact measurements of displacement, blood pressure, myofiber architecture and geometric structure that the epi- and endocardial displacement acquired at a few time steps is sufficient.

Error of Myofiber Architecture. It is a challenge to measure the in vivo myofiber architecture. Recently, methods such as diffusion-tensor MRI [^{47,61}]C have been developed to estimate the myofiber orientation in beating hearts. Alternatively, the myofiber architecture can be approximated from available database, [^{22,29,37,49,50}]C based on the understanding that variation of myofiber architecture in individual hearts is relatively small after some anatomy-based mapping.

To investigate the effects of myofiber architectural error on DCE reconstruction, randomly picked values between −5° and +5° were added to the “exact” myofiber angle α and sheet angle β (Eq. 61) at the FE integration points. The results are shown as “Error-F” in Table 11. The convergent loci are very similar to the “Ideal” case, except for larger fluctuations at the first few steps. It took about 150 steps for convergence. The overall errors for pₙₒᵣₘ and p_{isch} were slightly higher as compared to the “Ideal” results. Similar reconstruction results were obtained using other ten sets of myofiber architecture data with random error between −5° and +5°. Among these eleven sets of reconstruction results, the relative error was found the highest for the ischemic viscosity coefficient, at 1.47%. When average was taken, the parameters pₙₒᵣₘ and p_{isch} reached almost the exact values. It is concluded that the DCE is not sensitive to the random error of myofiber architecture. This is explained by the concept of homogenization,^{26C} i.e., the error random at a material point is largely balanced by the random error in its neighborhood. In a solid material, the perturbation of displacement by material variation at a single point is highly localized. The deformation depends more on the overall or effective material properties. Of course, the observation and explanation are based on the current FE mesh. With a coarse FE mesh where one integration point represents a large material volume, the effect of homogenization will become less significant, and the influences of random error of myofiber architecture may become profound.

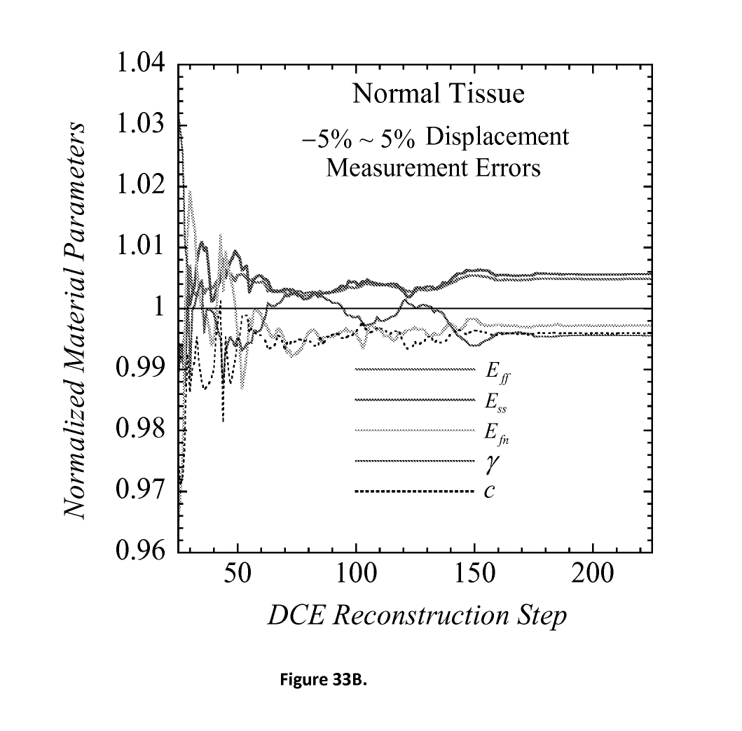

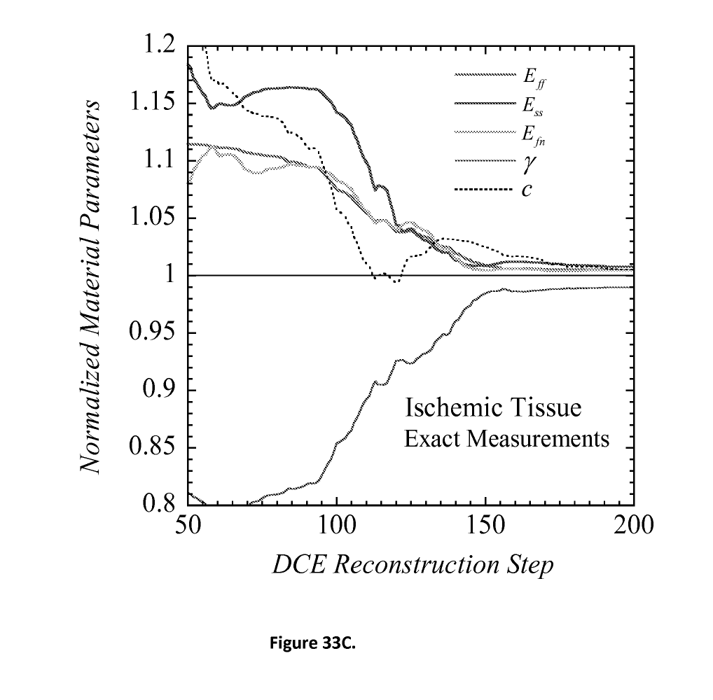

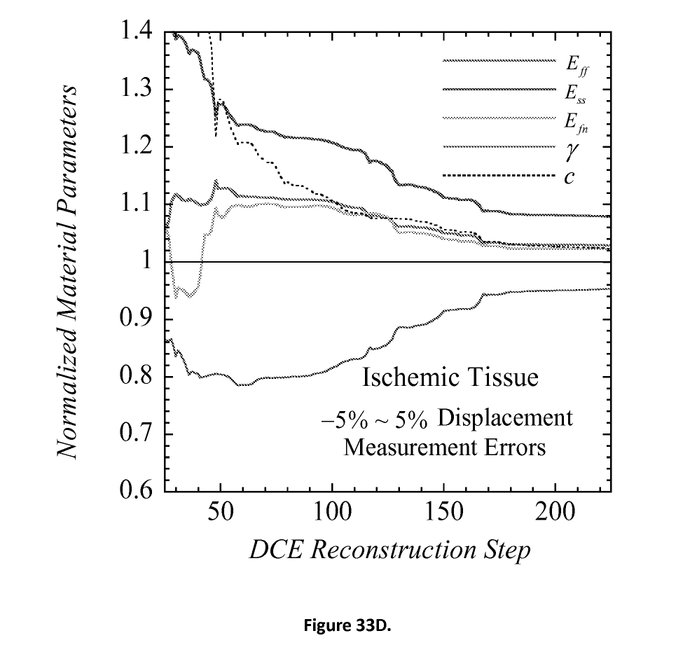

Error of Displacement Measurement. The effects of error of displacement were investigated herein. Randomly generated −5% to +5% relative error was added to the epi- and endocardial displacement measurement U₁^{m}. The results are listed as “Error-D” in Table 11, and the convergent loci are plotted in FIGS. 33B and 33D. The parameters in pₙₒᵣₘ converged stably and reached within 99% to 101% of the exact values after about 60 steps. The parameters in p_{isch} were found more sensitive to the error. They converged to the range of 90% to 110% of the exact values after about 175 steps. The material anisotropy (described by the ratios between the Es) and heterogeneity (γ_{isch}/γₙₒᵣₘ) were both well revealed. Reconstruction was conducted with other ten sets of displacement measurement with ±5% random relative error. The reconstruction results fluctuate around the exact values, with maximal relative error of 1.6% for pₙₒᵣₘ and 10% for p_{isch}.

Reconstruction was also conducted with random ±5° myofiber architectural error and ±5% displacement error (“Error-FD” in Table 11). The convergent loci are almost identical to those with displacement error only, so are the resulting material parameters. This suggests that the effects of displacement error are much more significant than that of myofiber architecture.

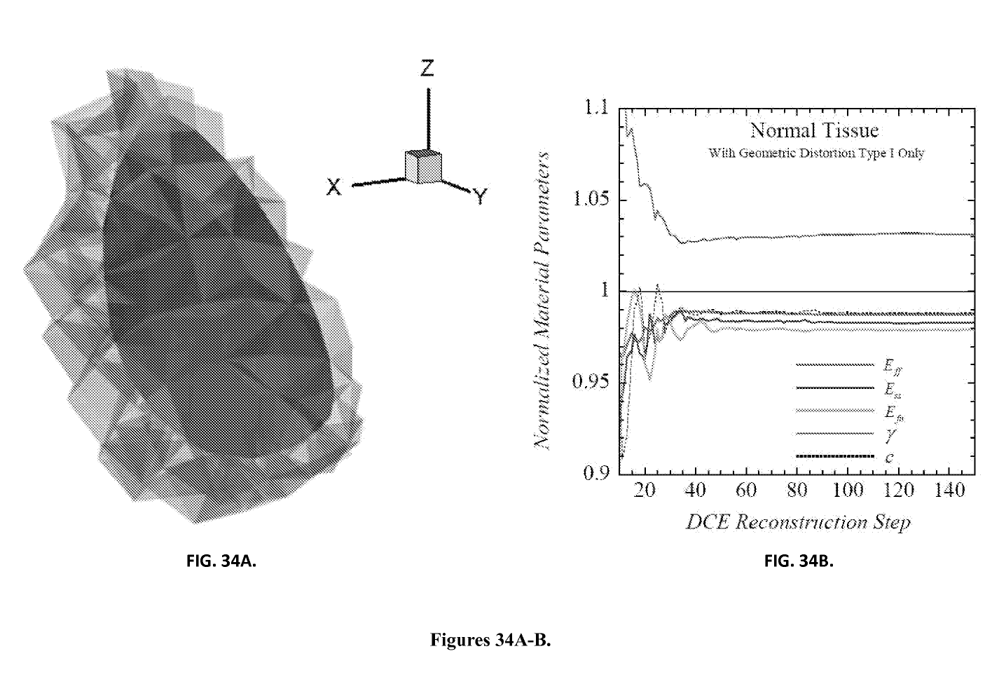

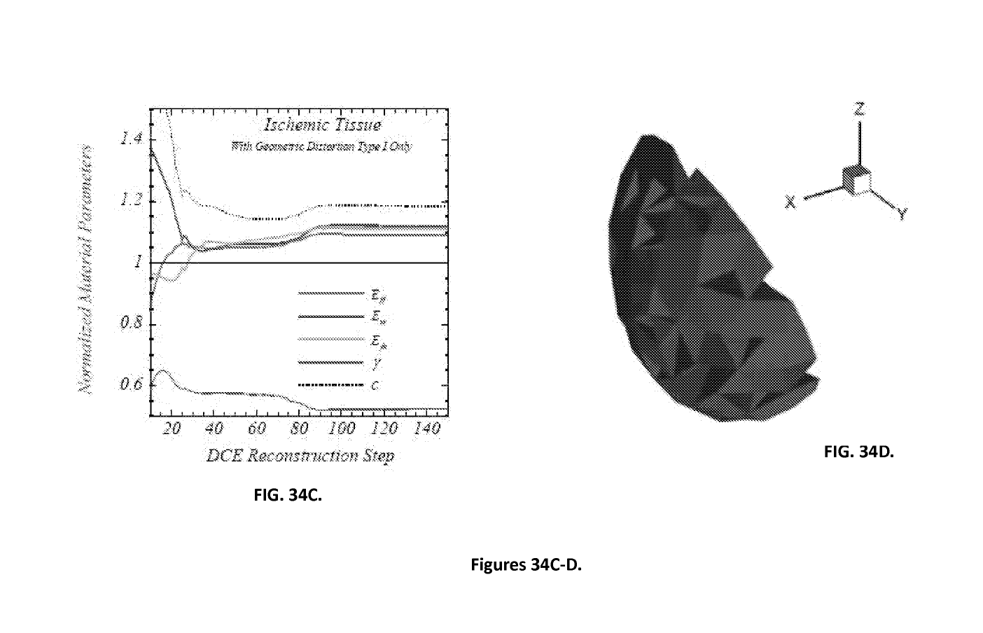

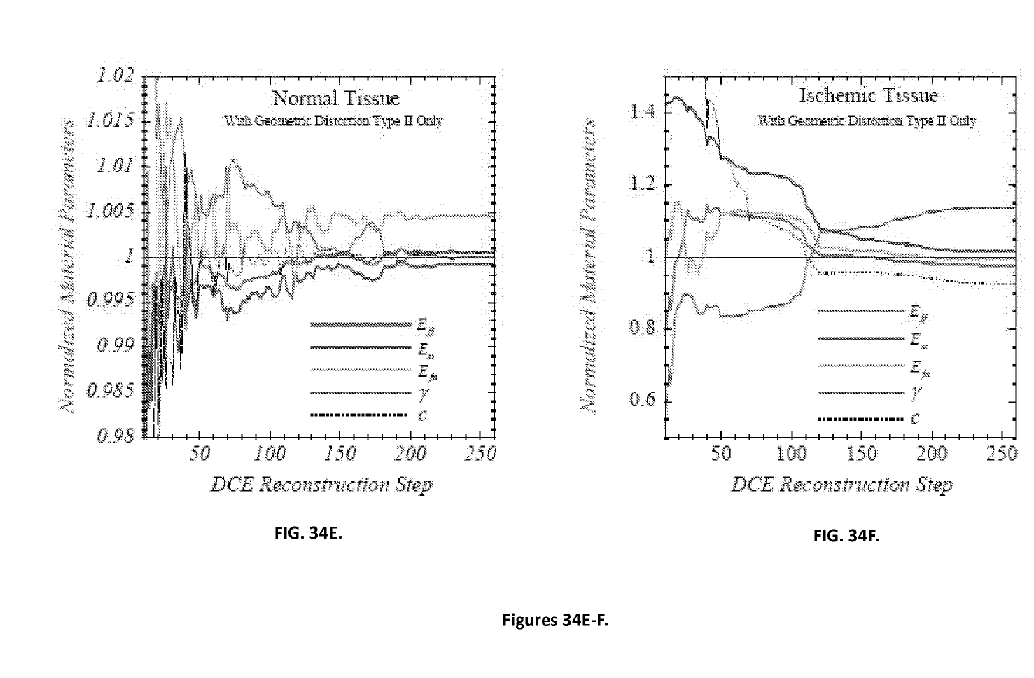

Segmentation Error. The above DCE simulations assumed that geometry of the impaired region was known, in order to compensate the lack of transmural displacement measurement. Clinically, the impaired region can be delineated using imaging technique like PET. The image segmentations are often subjective when the boundary is fuzzy. To test the DCE reconstruction with inaccurate geometric data, we used two distorted ischemic regions to represent the extreme segmentation errors. The distortions were generated by randomly changing the mesh attributes. For Type-I distortion (FIG. 34A), a layer of elements that originally had normal material properties and had at least one vertex on the interface between normal and ischemic regions were assigned with ischemic properties. Among these elements, 30% of those with only one vertex on the interface were randomly picked and were reassigned with normal properties. The thickness of this new layer of ischemic elements was about the same as that of the ischemic region itself. For Type-II distortion (FIG. 34B), 30% of the elements that originally had ischemic properties and had one vertex on the interface were assigned with normal properties.

With Type-I segmentation error, pₙₒᵣₘ and p_{isch} reached convergent values after about 100 steps (FIGS. 34C-D). As “Goe-I” in Table 1, the relative errors are within ±3.5% for pₙₒᵣₘ, and much higher for p_{isch}. The ischemic Es have errors of 5.5% to 15%, while their ratios are well maintained. The ischemic γ is about 47.8% lower than the exact value, and the viscosity coefficient c is about 18.6% higher. With Type-II distortion, the reconstruction took about 200 steps (FIGS. 34E-F). The resulting pₙₒᵣₘ are very accurate, as “Geo-II” in Table 11. The maximal error for the ischemic Es is about 3.8% (for Eₛₛ). The ischemic γ is about 10.5% higher than its exact value, while the viscosity coefficient c is about 4.8% lower. It was found that, when the ischemic region is delineated larger than the exact one such as Type-I distortion, the properties of ischemic myocardium reconstructed by DCE tend to be softer than the exact one. On the other hand, when the ischemic region is delineated smaller, the predicted properties of ischemic myocardium tend to be stiffer. These are because of a compensation mechanism, i.e., if an ischemic region is depicted larger, it must also be assigned with softer mechanical properties to ensure that the computed displacement can approach the exact measurement, and vice versa.

We then considered all the errors in DCE reconstructions, i.e., ±5° myofiber architectural error, ±5% displacement error, and Type I (“All-I” in Table 1) or Type II (“All-II” in Table 1) segmentation error, respectively. The convergent loci are very similar to “Goe-I” and “Geo-II”, respectively. It was found that the errors of displacement and myofiber architecture only led to slightly larger reconstruction errors than the segmentation error alone, with the parameters p_{isch} being more sensitive to the errors than pₙₒᵣₘ. It suggests that accurate depiction of the geometry of the ischemic region is most critical for DCE reconstruction, followed by displacement measurement.

Myocardium infarction typically spreads over a large region. We used a small ischemic region in purpose to test the feasibility of DCE. It is noted that the smaller the ischemic region is, the more difficult to identify the martial parameters, as the “size effect” we discussed.

On the Quasi-static Approximation. The previous cardiac elastography studies [^{5,14,16,33}]C made simplification that the LV filling deformation was quasi-static, and omitted the inertia and viscosity. The displacement, however, was measured of the beating heart, typically near to the highest filling blood pressure, i.e., at around t=0.4 or 0.45 second in the present pressure profile (FIG. 30D). Thus, there was a mismatch between modeling (quasi-static) and measurement (dynamic). In order to investigate how such a mismatch affects the parametric identification, we deactivated all terms related to inertia and viscosity in the DCE. The reconstruction became quasi-static, exactly as for the previous works. The displacement (outputted from dynamic FE simulation) at t=0.4 or 0.45 second was used as measurement, respectively, and the elasticity parameters γ and Es were reconstructed. The viscosity parameter c was not reconstructed in this quasi-static approach.

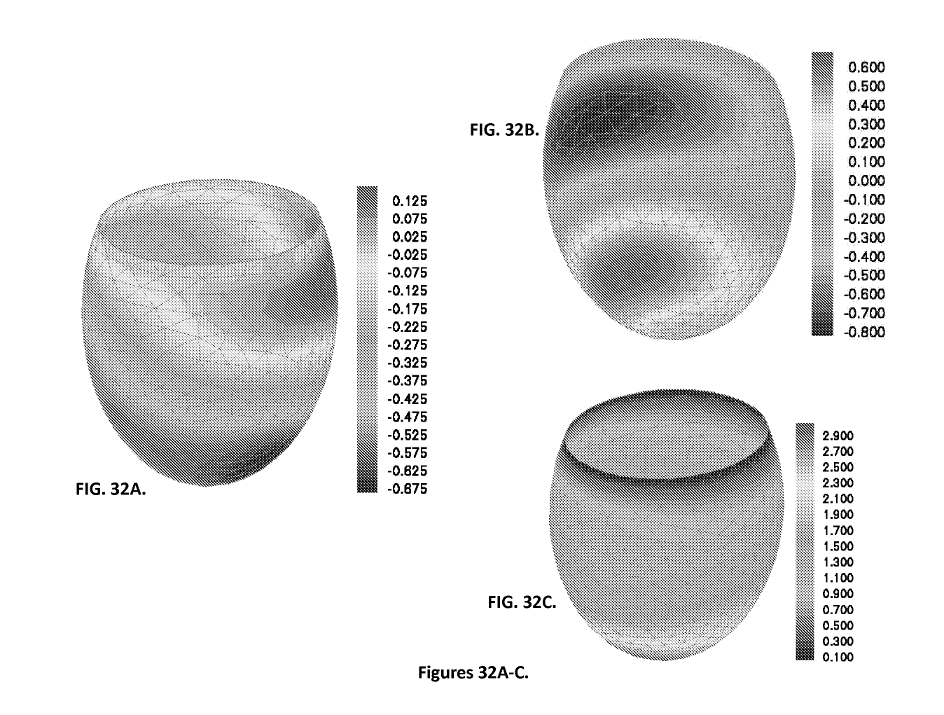

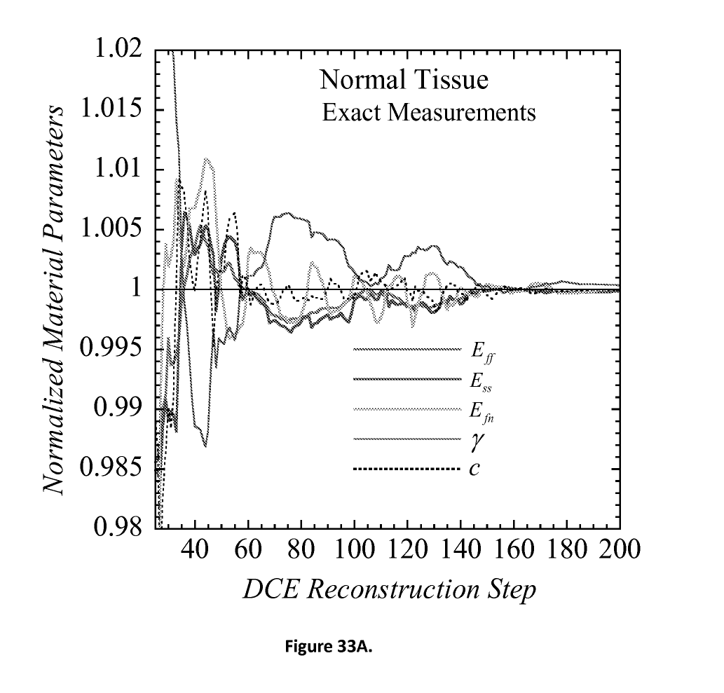

As “Static A” and “Static B” in Table 11, γ and Es were not correctly identified for normal and ischemic myocardium, neither was the material anisotropy (the ratio between Es). For instance, the parameters (γ, E_{ff}, Eₛₛ, Eₙₙ) for normal tissue were estimated as (9.553, 4.515, 2.417, 6.274) with displacement at t=0.4 second as measurement, while the exact values were (0.44, 37.0, 37.0, 7.16). It is also noted that the results “Static A” and “Static B” were very different to each other. Quasi-static reconstruction was also conducted using the exact material parameters as the initial guess, and yielded similar results to “Static A” and “Static B”. This is not surprising since the dynamic and static epicardial displacements predicted using the identical material parameters and pressure are indeed very different. FIGS. 32A-C show the difference at t=0.40 second. As compared to the localized differences due to the ischemic region (FIGS. 31A-C), the differences between dynamic and static epicardial deformations are global and more significant in magnitude, with have clear patterns. This suggests that the error due to quasi-static assumption may cover the effects of the ischemic region, and lead to inaccurate parametric identification.

In a real heart, the left ventricle dilates to the maximum chamber volume near the end-filling stage. The corresponding velocity is overall very low in the myocardium and the effect of viscosity is considered minimal. From this point of view, quasi-static elastography is probably a good approach for the elasticity parameters γ and Es, and the above unsuccessful quasi-static reconstructions was because the “real” material parameters we used did not predict nearly static state at the highest filling blood pressure. On the other hand, while the velocity may be indeed very low at the highest pressure, the dynamic displacement may be qualitatively different from prediction using quasi-static approach, because of the effect of inertia (considering the high strain rate in the heart). To see this, we use a one-dimensional spring-mass system as a simple example. When the system is loaded with a periodic external force, the maximum displacement (at zero velocity) is higher than the case loaded with a static force of the same magnitude. Therefore, quasi-static cardiac elastography needs careful evaluations when dynamic in vivo measurements are used.

Limitations and Future Studies. The present DCE simulations focused on the passive myocardial properties. The constitutive model was assumed nonlinear viscoelastic as in Eq. (71), with linear displacement-strain relationship. While this constitutive model is not exact for myocardium, the DCE framework itself is flexible to accommodate any model since the algorithm is independent of the material models (see APPENDIX B). On the other hand, appropriate constitutive model for myocardium is still an open research topic. [^{3,13,36}]C Recently, Schmid et al.^{46C} evaluated five major constitutive models by fitting ex vivo experimental data of myocardium specimens under shear deformations. The DCE provides a new platform for testing constitutive models with in vivo measurement of the dynamic displacement in the heart. The DCE can also quantify the contractility of myocardium^{28C} with appropriate model of the active stress. The parameters describing the active stress can be added directly into p (Eq. 11), without affecting the algorithm and reconstruction procedure of DCE.

DCE belongs to the class of biomedical inverse problems, whose applications highly depend on the availability and accuracy of the measurements. As we have observed, the measurement errors with displacement, myofiber architecture and geometry affect the reconstruction results to different degrees. There still needs comprehensive study on other types of error, such as non-uniform blood pressure, inaccurate displacement boundary conditions, systematic other than random error of displacement and myofiber architecture, and so on.

Uniqueness of DCE reconstruction result remains as an open topic. Mathematical theories have been developed to define the sufficient measurements that ensure unique result for various types of linear inverse problems. [^{30,31,34,56}]C However, theory for nonlinear inverse problems such as DCE has not been found in the literature. As a general principle for inverse problems, the sufficient measurement depends on the number of unknown parameters, i.e., the fewer the unknown parameters, the less measurement is needed. In this study, the epi- and endocardial displacement measured at four time steps was sufficient identification of the sixteen unknowns in pₙₒᵣₘ and p_{isch}. When the material parameters are allowed to vary arbitrarily in the entire myocardium, it becomes necessary to measure the displacement field in the LV wall with higher spatial and temporal resolution, for example, in a recent study of Augenstein et al.^{1C}

A tomography-based nonlinear dynamic cardiac elastography (DCE) framework was developed to identify the nonlinear viscoelastic parameters of myocardium, using dynamic endo-/epicardial displacement extracted from cardiac images. The scheme takes into account the myofiber architecture-induced anisotropy and heterogeneity of the material properties. The reconstruction algorithm employs a minimization procedure, with user-supplied gradients of the objective function. A nonlinear dynamic adjoint method was derived for efficient calculation of the gradients. DCE simulations were conducted to estimate the nonlinear viscoelastic parameters of the normal and ischemic myocardium in a left ventricle phantom. With exact measurements, the material parameters of the normal and ischemic tissues were accurately identified using epi- and endocardial displacement at four instants during the LV filling cycle. The effects of measurement errors were investigated. The influences of segmentation error are the most significant, followed by displacement error. Random errors of the myofiber architectural angles showed insignificant influence, probably due to the homogenization effects. A detailed comparison was made between DCE and the previous quasi-static cardiac elastography. The parameters estimated with the quasi-static approach were qualitatively incorrect, and showed large discrepancies when displacement at different time steps was used for the reconstruction. This indicates that consideration of dynamic deformation is indispensable for identification of the myocardial mechanical properties in vivo. The results support that epi- and endocardial displacement, together with geometric escription of the impaired myocardium region, are sufficient for identification of the material parameters of normal and impaired heart tissues. This suggests that cardic CT, incorporating with the inventive tomography-based DCE, is a promising imaging modality for accessing the mechanical properties of myocardium.

Throughout this application, various publications are referenced. The disclosures of each of these publications in their entireties are hereby incorporated by reference into this application in order to more fully describe the features of the invention and/or the state of the art to which this pertains. The references disclosed are also individually and specifically incorporated by reference herein for the material contained in them that is discussed in the portion of this disclosure in which the reference is relied upon.

### REFERENCES

1C. Augenstein, K. F., B. R. Cowan, I. J. LeGrice, P. M. F. Nielsen and A. A. Young. Method and apparatus for soft tissue material parameter estimation using tissue tagged magnetic resonance imaging. ASME J. Biomech. Eng. 127: 148-157, 2005.
2C. Belytschko, T., W. K. Liu and B. Moran. Nonlinear Finite Elements for Continua and Structures. New York: John Wiley & Sons, LTD, 2000.
3C. Costa, K. D., J. W. Holmes and A. D. McCulloch. Modeling cardiac mechanical properties in three dimensions. Philosophical Transactions of the Royal Society of London A. 359: 1233-1250, 2001.
4C. Costa, K. D., Y. Takayama, A. D. McCulloch and J. W. Covell. Laminar fiber architecture and three dimensional systolic mechanics in canine ventricular myocardium. Am. J. Physiol. Heart Circ. Physiol. 276: H595-H607, 1999.
5C. Creswell, L. L., M. J. Moulton, S. G. Wyers, J. S. Pirolo, D. S. Fishman, K. W. Myers, R. L. Actis, M. W. Vannier, B. A. Szabo, and M. K. Pasque. An experimental method for evaluating constitutive models of myocardium in in vivo heart. Am. J. Physiol. Heart Circ. Physiol. 267: H853-H863, 1994.
6C. Criscione, J. C., A. D. McCulloch, and W. C. Hunter. Constitutive framework optimized for myocardium and other high-strain, laminar materials with one fiber family. Journal of Mechanics and Physics of Solids. 50: 1681-1702, 2002.
7C. Demer, L. L. and F. C. P. Yin. Passive biaxial mechanical properties of isolated canine myocardium. J. Physiol. —London. 339: 615-630, 1983.
8C. Dove, E. L., K. P. Phillip, D. D. McPherson, and K. B. Chandran. Quantitative shape description of left-ventricular cine-CT image. IEEE Trans. Biomed. Eng. 38:1256-1261, 1991.
9C. Duncan, J., P. C. Shi, T. Constable, and A. Sinusas. Physical and geometrical modeling for image-based recovery of left ventricular deformation. Progress in Biophysics & Molecular Biology. 69: 333-351, 1998.
10C. Ennis, D. B., F. H. Epstein, P. Kellman, L. Fananapazir, E. R. McVeigh, and A. R. Arai. Assessment of regional systolic and diastolic dysfunction in familial hypertrophic cardiomyopathy using MR tagging. Magnetic Resonance in Medicine. 50: 638-642, 2003.
11C. Eusemann, C. D., E. L. Ritman, M. E. Bellemann, and R. A. Robb, Parametric display of myocardial function. Computerized Med. Imaging and Graphics. 25/6: 483-493, 2002.
12C. Fox, L. and E. Goodwin. Some new methods for the numerical integration of ordinary differential equations. Proc. Camb. Philos. Soc. 45: 373, 1949.
13C. Fung Y C. Biomechanics: Mechanical Properties of Living Tissues. Springer, New York, 1993.
14C. Gotteiner, N. L., G. Han, G., K. B. Chandran, M. J. Vonesh, M. Bresticker, R. Greene, J. Oba, B. J. Kane, A. Joob, and D. D. McPherson. In vivo assessment of nonlinear myocardial deformation using finite element analysis and three-dimensional echocardiographic reconstruction. Am. J. Cardiac Imag. 9: 185-194, 1995.
15C. Guccione, J. M., K. D. Costa, and A. D. McCulloch, Finite element stress analysis of left ventricular mechanics in the beating dog heart. J. Biomech. 28: 1167-1177, 1995.
16C. Han, G. J., K. B. Chandran, N. L. Gotteiner, M. J. Vonesh, A. W. Joob, R. Greene, G. M. Lanza, and D. D. McPherson. Application of finite-element analysis with optimization to assess the in vivo non-linear myocardial material properties using echocardiographic imaging. Medical & Biological Eng'g. & Computing. 31: 459-467, 1993.
17C. Humphrey, J. D. Continuum biomechanics of soft biological tissues. Proceedings of the Royal Society of London A. 459: 3-46, 2002.
18C. Humphrey, J. D. and F. C. P. Yin. On constitutive relations and finite deformations of passive cardiac tissues: I. A pseudostrain-energy function. ASME J. Biomech. Eng. 109: 298-304, 1987.
19C. Hunter, P. J., A. D. McCulloch, and H. E. D. J. ter Keurs. Modeling the mechanical properties of cardiac muscle. Prog. in Biophy. & Molec. Biology. 69: 289-331, 1998.
20C. Kanai, H., S. Katsumata, H. Honda, and Y. Koiwa. Measurement and analysis of vibration in the myocardium telescopic motion for novel echo-graphic diagnosis. Acoustical Science and Technology. 24: 17-22, 2003.
21C. Khan, M. G. Encyclopedia of Heart Diseases. Academic Press, 2005.
22C. Lanir, Y. A structural theory for the homogeneous biaxial stress-strain relationship in flat collagenous tissues. J. Biomech. 12: 423-436, 1979.
23C. LeGrice, I. J., P. J. Hunter, and B. H. Small. Laminar structure of the heart: a mathematical model. Am. J. Physiol. Heart Circ. Physiol. 272: H2466-H2476, 1997.
24C. Lin W. and R. A. Robb. Visualization of cardiac dynamics using physics-based deformable model. Proc. SPIE Medical Imaging 2000: Image Display and Visualization. 3976: 210-217, 2000.
25C. Liu, D. C. and J. Nocedal. On the limited memory BFGS method for large-scale optimization. Mathematical Programming. 45: 503-528, 1989.
26C. Liu, Y. and P. Ponte-Castaileda. Second-order estimates for the effective behavior and field fluctuations in viscoplastic polycrystals. Journal of the Mechanics and Physics of Solids. 52: 467-495, 2004.
27C. Liu, Y., L. Z. Sun, and G. Wang, Tomography-based 3-D anisotropic elastography using boundary measurements. IEEE Trans. Med. Imag. 24: 1323-1333, 2005.
28C. Liu, Y., G. Wang, and L. Z. Sun. Anisotropic elastography for local passive properties and active contractility of myocardium from dynamic heart imaging sequence. International Journal of Biomedical Imaging. 2006: 45957-1-15, 2006.
29C. Mazhari, R. and A. D. McCulloch. Integrative models for understanding the structural basis of regional mechanical dysfunction in ischemic myocardium. Ann. Biomed. Eng. 28: 979-990, 2000.
30C. Mazzucato, A. L. and L. V. Rachele. Partial Uniqueness and obstruction to uniqueness in inverse problems for anisotropic elastic media. 2003 Mathematical Sciences Research Institute (MSRI) Preprints #2003-009, electronic version of this work is available for download at http://www.msri.org/publications/preprints/2003.html.
31C. McLaughlin J. R. and J. R. Yoon. Unique identifiability of elastic parameters from time-dependent interior displacement measurement. Inverse Problems. 20: 25-45, 2004.
32C. McPherson, D. D., D. J. Skorton, S. Kodiyalam, L. Petree, M. P. Noel, R. Kieso, R. E. Kerber, S. M. Collins, and K. B. Chandran. Finite element analysis of myocardial diastolic function using three-dimensional echocardiographic reconstruction: Application of a new method for study of acute ischemia in dogs. Circ. Res. 60: 674-682, 1987.
33C. Moulton, M. J., L. L. Cresweel, R. L. Actis, K. W. Myers, M. W. Vannier, B. A. Szabo, and M. K. Pasque. An inverse approach to determining myocardial material properties. J. Biomech. 28: 935-948, 1995.
34C. Nakamura, G. and K. Tanuma. A nonuniqueness theorem for an inverse boundary value problem in elasticity. SIAM J. Appl. Math. 56: 602-610, 1996.
35C. Nash M. Mechanics and Material Properties of the Heart using an Anatomically Accurate Mathematical Model. PhD thesis, Univ. of Auckland, New Zealand, 1998.
36C. Nash, M P, Hunter P. Computational Mechanics of the Heart. J. Elasticity. 61: 113-141, 2000.
37C. Nielsen, P. M. F. I. L. Le Orrice, B. H. Smaill, and P. J. Hunterm. Mathematical model of geometry and fibrous structure of the heart. Am. J. Physiol. Heart Circ. Physiol. 260: H1365-H1378, 1991.
38C. Nielsen, P. M. F., P. J. Hunter, and B. H. Smaill. Biaxial testing of membrane biomaterials: Testing equipment and procedures. ASME J. Biomech. Eng. 113: 295-300, 1991.
39C. Novak, V. P., F. C. P. Yin, and J. D. Humphrey. Regional mechanical properties of passive myocardium. J. Biomech. 27: 403-412, 1994.
40C. Oberai, A. A., N. H. Gokhale, and G. R. Feijoo. Solution of inverse problems in elasticity imaging using the adjoint method. Inverse Problems. 19: 297-313, 2003.
41C. Oberai, A. A., N. H. Gokhale, M. M. Doyley, and J. C. Bamber. Evaluation of the adjoint equation based algorithm for elasticity imaging. Physics in Medicine and Biology. 49: 2955-2974, 2004.
42C. Omens, J. H., D. A. Mackenna, and A. D. McCulloch, Measurement of strain and analysis of stress in resting rat left ventricular myocardium. J. Biomech. 26: 665-676, 1993.
43C. Phillips, C. A. and J. S. Petrofsky. Myocardial material properties: characteristic variation of the circumferential and longitudinal systolic moduli in left ventricular dysfunction. J. Biomech. 17: 561-568, 1984.
44C. Press, W. H., S. A. Teukolsky, W. T. Vetterling, and B. P. Flannery. Numerical Recipes in Fortran 77: The Art of Scientific Computing. Cambridge University Press, 1992.
45C. Sasayama, S., H. Nonogi, S. Miyazaki, T. Sakurai, C. Kawai, S. Eiho, and M. Kuwahara. Changes in diastolic properties of the regional myocardium during pacing-induced ischemia in human subjects. Journal of the American College of Cardiology. 5: 599-606, 1985.
46C. Schmid, H., M. P. Nash, A. A. Young and P. J. Hunter. Myocardial Material Parameter Estimation—A Comparative Study for Simple Shear. ASME J. Biomech. Eng. 128: 742-750, 2006.
47C. Scollan, D. F., A. Holmes, J. Zhang, and R. L. Winslow. Reconstruction of cardiac ventricular geometry and fiber orientation using magnetic resonance imaging. Ann. Biomed. Eng. 28: 934-944, 2000.
48C. Shacklock, A. J. Biaxial Testing of Cardiac Tissues. Master Thesis, University of Auckland, New Zealand, 1987.
49C. Streeter, D. D. and W. T. Hanna. Engineering mechanics for successive states in canine cardiac ventricular myocardium. I. Cavity and wall geometry. Circ. Res. 33: 639-655, 1973.
50C. Streeter, D. D. and W. T. Hanna. Engineering mechanics for successive states in canine cardiac ventricular myocardium. II. Fiber angles and sarcomere length. Circ. Res. 33: 656-664. 1973.
51C. Tardieu, N. and A. Constantinescu. On the determination of elastic coefficients from indentation experiments. Inverse Problems. 16: 577-588, 2000.
52C. Usyk, T. P., R. Mazhari, and A. D. McCulloch. Effect of laminar orthotropic myofiber architecture on regional stress and strain in the canine left. Journal of Elasticity, 61: 143-164, 2000.
53C. Vis M A, Sipkema P, Westerhof N. Modeling pressure-area relations of coronary blood vessels embedded in cardiac muscle in diastole and systole. Am. J. Physiol. Heart Circ. Physiol. 268: H2531-H2543, 1995.
54C. Visner, M. S., C. E. Arentzen, D. G. Parrish, E. V. Larson, M. J. O'Connor, A. J. Crumbley, R. J. Bache, and R. W. Anderson. Effects of global ischemia on the diastolic properties of the left ventricle in the conscious dog. Circulation. 71: 610-619, 1985.
55C. Waldman, L. K., Y. C. Fung, and J. W. Covell, Transmural myocardial deformation in the canine left ventricle: Normal in vivo three-dimensional finite strains. Circ. Res. 57: 152-163, 1985.
56C. Wang, G., Y. Li, and M. Jiang, Uniqueness theorems in bioluminescence tomography. Medical Physics. 31: 2289-2299, 2004.
57C. Wen H. Mapping the velocity vector onto the spin vector: two-dimensional velocity-selective spin excitation for MR flow imaging. Magn. Reson. Med. 46: 767-72, 2001.
58C. Westerhof N, Boer C, Lamberts R R, Sipkema P. Cross-talk between cardiac muscle and coronary vasculature. Physiol. Rev. 86: 1263-1308, 2006.
59C. Yin, F. C. P., R. K. Strumpf, P. H. Chew, and S. L. Zeger. Quantification of the mechanical properties of noncontracting canine myocardium under simultaneous biaxial loading. J. Biomech. 20: 577-589, 1987.
60C. Zamir, E. A., S. Sheth, J. M. Guccione, K. D. Costa, and L. A. Taber. A remodeling algorithm for development of transmural cardiac fiber angle distribution. 1999 ASME Summer Bioengineering Conference. Big Sky, Mont.
61C. Zhukov L, Barr A. Heart-Muscle Fiber Reconstruction from Diffusion Tensor MRI. IEEE Visualization 2003, Proceedings of Visualization 2003 597-602, 2003.

### IV. CARDIAC ELASTODYNAMIC BIOMARKERS FROM INTERIOR MR IMAGING

Myocardial elastodynamic properties are the phenomenological manifestation of underlying cellular activity and connectivity. Clinical evaluation of these elastodynamic properties may offer important insight into risk assessment of heart diseases, and therefore serve as biomarkers for screening, diagnosis and treatment. To date, this line of investigation has been limited by the lack of noninvasive methods.

Stiffness of the small arteries has been identified as an early marker of vascular diseases [1]E. The method of arterial waveform analysis has been approved by FDA to market for early detection and prevention of vascular diseases such as hypertension. Mechanical and functional behaviors of diseased myocardial tissue are different from that in normal tissue. Adult human cardiac myocytes are terminally differentiated cells with little or no capacity to proliferate. The inability to generate functional myocytes means that an overloaded heart can only enlarge existing myocytes. Each myocyte contains myofibrils, which are long chains of sarcomeres, the contractile units of the cell. Elastodynamic properties of myocardial tissue are the phenomenological manifestation of the underlying cellular activity and connectivity. Thus, disease-related changes at the cellular level can be assessed by detecting and analyzing myocardial elastic dynamic characteristics.

Imaging techniques play a significant role in the prevention, diagnosis, and treatment of cardiac diseases. Several imaging modalities such as CT, nuclear cardiology, echocardiography, and MRI are currently used for evaluation of the cardiac anatomy and function including ejection fraction, myocardial strain and stress, and myocardial perfusion. However, echocardiography suffers from sub-optimal visualization of cardiac segments and operator dependency in interpretation of the artifact-rich images. CT and nuclear cardiology use ionizing radiation. The long scan time and inferior spatial resolution of MRI limit its applications. Furthermore, none of them is capable of mapping elastrodynamic features of myocardium, which, due to complex heart anatomy, large deformation and active force during heart contraction, are extremely challenging to be detected. In the absence of elastic dynamic characteristics of myocardium, false treatment may be initiated for suspected patients with one or more symptoms, meanwhile treatment may be neglected for some patients with developing heart disease without exhibiting any symptoms thus likely leading to sudden death or heart failure. What is needed is an imaging modality to extract cardiac elastodynamic characteristics for critical diagnostic information previously unavailable.

As a screening tool for prevention of cardiac disease, an elastodynamic imaging modality in accordance with embodiments of the invention can rely on MRI, because it has been well accepted as a safe, non-invasive, and high tissue contrast imaging technique, with a potential to become a one-stop cardiac imaging modality. To extract elastodynamic biomarkers using MRI, an interior MR imaging based elastodynamic reconstruction framework can be used. Compared to the existing cardiac MR imaging sequences, interior MRI allows much less scan time yet significantly improves spatial and contrast resolution. Also, this approach is based on a dynamic nonlinear model for accurate quantification of nonlinear elastic passive stiffness and dynamic active contractility of myocardium. In contrast, the conventional parametric extraction methods make strong approximations including small deformation, linear strain, quasi-static deformation and isotropic properties of myocardium, which may well lead to inaccurate and even misleading description of myocardium, because the physiologic and pathological process is highly nonlinear, anisotropic and dynamic, involving active contraction of myocardium.

Methods, systems, and devices of the invention potentially can have a major impact on cardiac imaging as well as prevention and treatment of cardiac diseases. The impact is broad in the studies of cardiovascular disease as well as in the cancer studies and functional MRI, since the interior MR imaging can be directly extended to those areas and beyond.

Interior MR Imaging of the Heart. The invention provides for interior MR imaging of the heart with significantly improved temporal, spatial and contrast resolution. MRI is more appropriate compared to other imaging modalities such as CT, in which radiation is of major concern. MRI has been gaining recognition as a safe, non-invasive, and superior imaging technique, which has the potential to become a versatile cardiac imaging modality. However, the application of MRI in imaging the heart is significantly limited by its long examination time and inferior spatial resolution, compared to those of cardiac CT. This makes MRI unsuitable for unstable patients and for the evaluation of small structures. For extraction of elastodynamic biomarkers of the heart, we rely on significantly higher temporal and spatial resolution than those currently available. Therefore, what is needed is the development of powerful imaging methods that reflect fundamental relationships and constraints, utilizing all prior knowledge, new insights and unconventional tools. One solution is to provide interior MR imaging of the heart in the compressed sensing framework.

Interior MR imaging of the heart is a linear inverse problems of a highly ill-posed nature. An ideal solution to solve such a linear inverse problems would be to collect most essential data in the shortest possible time, and yet produce the best possible images. To capitalize these potential benefits, we need to overcome the inherent illposedness due to a limited amount of measured data.

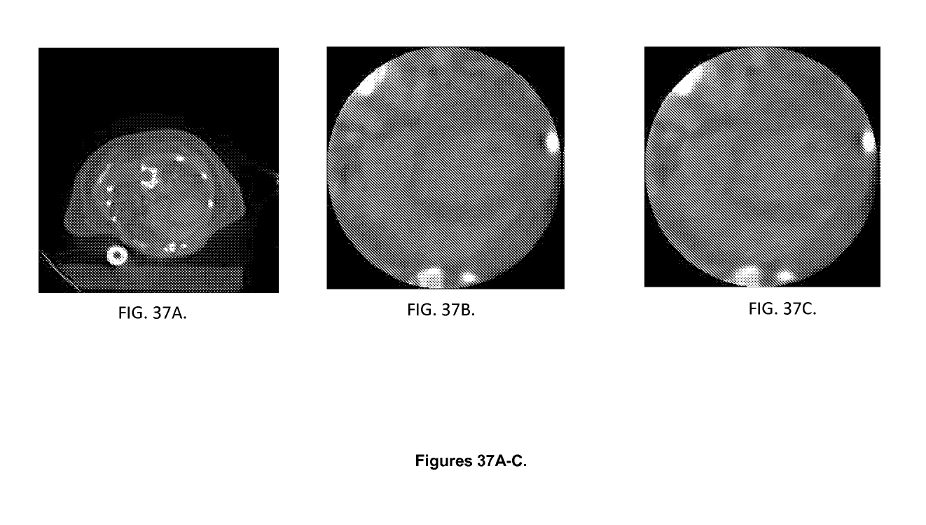

Recent theories of interior tomography and compressed sensing effectively challenge the conventional wisdom in tomographic imaging and signal processing. While the interior problem has no unique solution in general, interior tomography offers an exact and stable solution, given practical prior knowledge [6-7]E. While the Nyquist/Shannon sampling rate has been used since the first day of the digital era, compressed sensing unlocks hidden signal sparsity and requires much less data for recovery of an underlying signal [4-5]E. Recently our group successfully tested the feasibility of compressive-sampling-based interior tomography in micro-CT [10]E. The results show that the number of projections for image reconstruction can be significantly reduced (4-8 times) while keeping comparable image quality (FIGS. 37A-C).

To accomplish interior MRI, time-domain signals (k-space) are preferably acquired in a radial manner. The UTE-GRE is ideal for development of interior MRI. In addition, appealing features of UTE-GRE include its ease of implementation (e.g., without hardware modification) and its apparent tolerance to experimental imperfections (e.g., gradient delays and eddy currents). In UTE-GRE, MRI signal from water molecules is produced by a short radiofrequency pulse (−200 μs), and following a very short delay (called TE), a projection of the object is rapidly acquired using a broad acquisition bandwidth. After an incremental change in the orientation of the gradient field, this process is repeated. A 3D image is reconstructed after a sufficient number of radial projections have been acquired to satisfy spatial resolution and signal-to-noise (SNR) requirements. By permitting very short TE (<400 μs), UTE-GRE can achieve short repetition time (TR), and thus allows rapid 3D imaging.

For example, with standard MRI hardware, TR=1.35 ms is readily achievable, in which case, 32,000 projections can be acquired in just 43 seconds. Because the new technique acquires k-space data in a radial manner, view sharing is permitted to capture more cardiac phases than the standard Cartesian acquisition. Furthermore, the short TE of UTE-GRE minimizes motion sensitivity-a critical advantage for cardiac applications. Finally, with its ability to attain very short TE, UTE-GRE has potential to image fibrotic myocardial infarction.

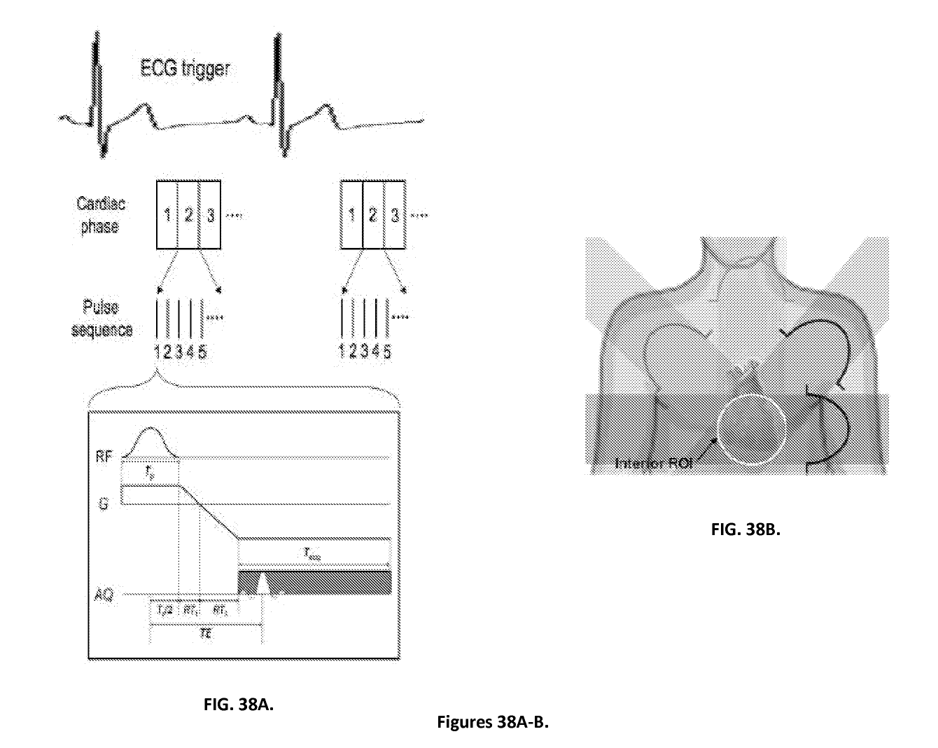

The inventive interior UTE-GRE sequence (FIG. 38A) can be implemented and evaluated using a 3 Tesla human scanner equipped with cardiac array receiver coils. UTE-GRE can be optimized for interior MRI by evaluating one or more of the following metrics: 1) SNR of the interior ROI, 2) spatial resolution in the ROI, 3) suppression factor achieved in exterior regions, and 4) artifact level. Interior SNR and image artifacts can also be assessed from experiments on a human torso phantom containing saline and a small amount of Gd-DTPA (to shorten relaxation times). Spatial resolution can be evaluated from interior images of a standard MRI resolution phantom. The dependencies of these metrics on ROI size, imaging time and reconstruction steps can be explored in numerical simulations and phantom experiments.

Based on preliminary results in micro-CT, the interior MRI approach can meet the requirements for high-quality cardiac imaging in terms of SNR, spatial and temporal resolution, artifacts, and exterior signal suppression, for an ROI of diameter ≧25 cm (typical imaging FOV for cardiac MR studies). From preliminary studies, the acquisition parameters that can be achieved include: RF pulse length=200 μs, TR=1.35 ms, TE=0.366 ms, acquisition bandwidth=175 kHz, matrix size (after gridding)=256³, which can yield a nominal isotropic resolution of 1 mm. As illustrated in FIG. 38B, the width of the band excited by the selective RF pulse will be equal to the desired interior ROI diameter. Further, the SNR, resolutions, and artifact levels can also be compared to those using clinical cardiac cine MR sequences.

Interior MRI Testing on Normal Human Subjects. UTE-GRE can be used to accomplish interior MR imaging of the normal human heart. An exemplary acquisition protocol, including ECG triggering, is shown in FIG. 38B. With the acquisition parameters described above, ˜16 cardiac phases can be acquired. Accordingly, in each cardiac cycle, ˜45 radial projections per phase can be acquired. This is significantly faster than what is possible with conventional 3D MRI techniques. For example, in a 20 second breathhold, ˜900 projections per 3D image can be acquired, which typically would be more than adequate to yield 16 frames of high-quality 3D images of the heart with negligible under-sampling artifacts.

Interior MRI is feasible for dynamic 3D imaging of the heart, in short scan time and with high spatial resolution. Scan time is expected to be reduced by half or more as compared with that using conventional sequences (based on the assumption that the heart size is half or less than the thorax). Spatial resolution can also be improved with reduced scan times (due to reduced motion blurring). In addition, with UTE-GRE tissue water that is normally difficult to detect due to its short T2* (e.g. fibrosis in chronic myocardial infarction) can be enhanced. Using the methods, systems, and devices of the invention, interior MRI can offer high SNR, reduced partial volume effect, and minimized motion artifacts. For extraction of elastodynamic biomarkers, such a superior imaging performance of myocardium is desirable.

A potential limitation may be the SNR of the high resolution images. Because the voxel size of interior MRI is smaller than that of full FOV imaging (i.e., the nominal voxel width=FOV/256), low SNR could become a limiting factor on image quality in some applications, despite the compressed sensing approach that inherently suppresses image noise. If this happens, SNR will be increased using signal averaging (e.g., by acquiring multiple breathholds, instead of just one) or by using a MRI scanner with higher magnetic field (e.g., a 7 Tesla human scanner).

Compressed Sensing Based Extraction of Cardiac Elastodynamic Biomarkers. It is well recognized that impaired myocardium changes in passive stiffness and active contractility, and exhibits different deformation characteristics [11-12]E. Thus, material parameters that describe passive stiffness and active contractility are clinically informative. These features can be extracted from time-varying cardiac image sequences of the heart. Conventional elastographic imaging methods make rather strong approximations including quasi-static deformation and linear isotropic elastic properties of myocardium [13-17]E, which frequently lead to inaccurate and sometimes misleading description of myocardium, because the real process is highly nonlinear, anisotropic, and dynamic, in particular involving the active contraction of myocardium [18]E. Embodiments of the invention can provide a comprehensive and realistic elastodynamic reconstruction framework to depict dynamic elasticity changes in myocardium and extract elastodynamic biomarkers for diagnosis and treatment of cardiac diseases. The elastodynamic biomarkers include both passive stiffness and active contractility, which are intrinsic to cardiac muscles and their functionalities. This can be accomplished using a sophisticated nonlinear approach based on large strain deformation of myocardium throughout the entire cardiac cycle. The non-uniqueness and instability due to the nonlinear large strain and dynamic active force can be mitigated by the use of compressed sensing technique, especially the minimization of the total variation (TV) in the desired mechanical parametric distribution. The elastodynamic reconstruction framework is expected to enable global and regional dynamic characterization of myocardium for both short-term diagnosis and long-term prognosis.

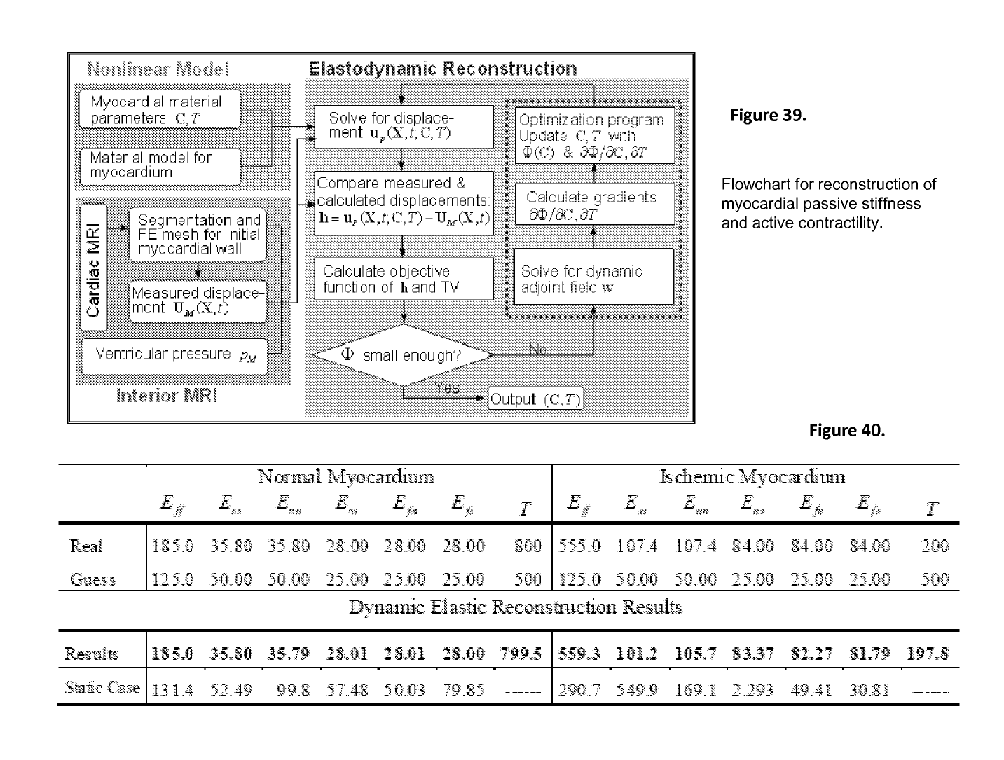

An elastodynamic framework for reconstruction of passive stiffness and active contractility of myocardium from nonlinear large deformation can be constructed. The general flowchart for an exemplary elastodynamic reconstruction framework according to embodiments of the invention is given in FIG. 39. The myocardium is assumed undergoing nonlinear, dynamic deformation, involving active contraction stress. An objective function includes the discrepancy between measured and computed displacements in a cardiac cycle and a weighted TV term to penalize roughness of the parametric distribution. A dynamic adjoint method can be employed, which uses analytical gradients of the objective function with respect to the material parameters. The adjoint method has been used by the inventors previously in their elastographic work for its numerical efficiency.

Under this framework, the inventors have developed a simplified cardiac elastodynamic algorithm based on small deformation and successfully identified passive elastic stiffness E's and active contractility Tin a previous simulation study (FIG. 40, [18]E). It is shown clearly that the quasi-static case does not yield accurate material parameters for either the normal or the ischemic myocardium. This may indicate the necessity of dynamic description for cardiac elastography. Based on this, it is possible to develop the compressed and realistic elastodynamic reconstruction framework to extract passive stiffness and active contractility of myocardium based on large deformation throughout the cardiac cycle. The large deformation is physiologically necessary in the study of myocardial elastodynamic properties.

For the large deformation, the nonlinear partial differential equations (PDEs) have potential issues. Primarily, we are subject to the so-called dimensionality curse. In other words, there are too many unknowns to fit into a quite limited amount of measured data, giving too many solutions with numerical instability. To solve this problem, compressed sensing can be employed to utilize the underlying sparsity of the desired parametric distribution, as reflected in the TV minimization term of the aforementioned objective function. The dynamic deformation of myocardium can be described with the nonlinear PDEs of:

D(u(X,t))=∇·P−ρ₀ü(X,t)=0, (EQUATION BM-1)

where u(X,t) is the displacement field (deformation) (X: spatial coordinates, t: time, and ρ₀ mass density). The time-varying blood pressure in the ventricles serves as part of the boundary conditions. The nominal stress P in the myocardium can be calculated from the Lagrangian strain tensor E and deformation gradient F by way of the tissue constitutive relation [19]e of:

P=[∂W(E;C)/∂E+T(λ_{F},Cₐ⁺;T_{Max})M [symbol] M]·F^{T} (EQUATION BM-2)

where the nonlinear potential energy W describes the passive elastic properties, and the additional tensile force T along the local fiber direction M can be modeled as a superposition of finitely many harmonic terms.

To solve this inverse-problem, the passive stiffness parameters C in W are to be reconstructed from biomedical imaging measurements. Furthermore, the active contractility T is controlled by the dynamics of calcium concentration Cₐ⁺(X,t), and T is affected by the stretch of the sarcomere denoted with λ_{F}=(M·(2E+I)·M)^{1/2}. Due to the complexity of anatomic structures, and nonlinearity, anisotropy, and inhomogeneity of the cardiac muscle, an optimization-based method combined with the technique of compressed sensing is appropriate for such reconstruction. To find distribution C, T such that the computed displacement uₚ(X,t;C,T) matches the best with the displacement measurement U_{M}(X,t) taken with MR imaging techniques subject to the minimization of the weighted TV [w·TV(c)] in the parameter distribution; i.e., minimize the objective function (EQUATION BM-3), is one goal:

Φ(C)=∫₀^{τ}(∫_{V}h·χ(X,t)·hdV)dt+w·TV(C); h=h(X,t;C)=uₚ(X,t;C)−U_{M}(X,t),

where the time interval [0,τ] typically represents one cardiac cycle. The weight function χ(X,t) equals zero if the displacement is not measured at point X and t.

Once the measurements are obtained on the displacement u_{M}(x,t) in part of the myocardial ROI, and on the chamber blood pressure p_{M} (X,t), inverse computation can be performed to reconstruct the passive stiffness C and active contractility T of myocardium.

Implementation of the Elastodynamic Reconstruction Framework Via FEA.

Gradients ∂Φ/(∂C,∂T) on a discrete grid[20]E can be computed. For cardiac elastodynamics involving nonlinearity and dynamic deformation, an explicit formula of ∂Φ/∂C [19]E has been derived by the inventors. Due to the complex anatomic structures and their nonlinearity, the governing PDEs and the adjoint PDEs can be put into the finite element (FE) format and solved accordingly. To achieve high accuracy with relatively small number of elements, Hermite-type high-order shape functions can be employed. Discretization of the time domain will follow the standard Newmark-β scheme. For clinical applications incorporating MR imaging, measurement of both surface and interior displacements can be included in U_{M}(X,t).

The reconstruction framework for extraction of cardiac elastodynamic biomarkers can be systematically evaluated and validated in numerical and phantom studies, demonstrating that it is accurate and robust in identifying both passive and active parameters, by utilizing dynamic, large myocardial strain deformation. Quantitatively, it is possible to achieve 1 mm spatial resolution and <10% error in phantom experiments, giving confidence in use of the biomarkers in clinically relevant analysis.

For some applications, a potential problem is that the PC's computing power may not be sufficient to give a practical reconstruction speed due to the complexity of dynamics and nonlinearity. An alternative approach is to employ the parallel processing technique to speed up the 3D reconstruction and extraction of elastodynamic biomarkers. For example, a multiple-node PC cluster can be used in this regard, if desired.

Objective and Sample Size Consideration. The inventive imaging modality can be validated on its ability to extract elastodynamic biomarkers of heart muscle based on controlled phantom experiments and in vivo animal and human studies. Determining sample size can be based on obtaining reasonable estimates of the elastodynamic biomarkers of the imaging techniques, rather than to power for certain elastodynamic biomarkers at certain p values. Based on historical experience, for animal study, a minimum of 10 datasets should be collected. For human clinical study, twenty subjects in each group (healthy, chronic myocardial infarction (MI) and hypertrophic cardiomyopathy (HCM) groups) should provide relatively stable group proportions for demonstrating the potential of the imaging modality.

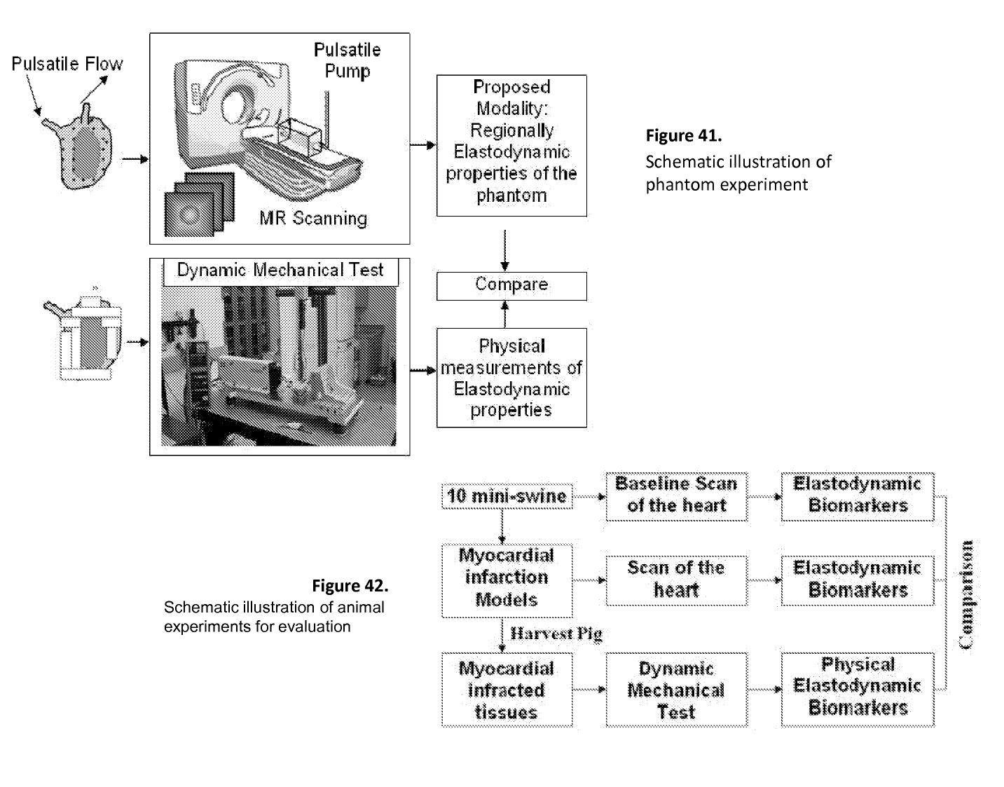

Phantom study. A ventricular phantom with controlled variations in the walls can be constructed for obtaining dynamic imaging data on its deformation under pulsatile flow, applying the interior MR imaging technique to scan the phantom, and extracting elastodynamic properties and performing dynamic mechanical test for comparison (See FIG. 41).

The phantom can be fabricated with silicone replicas of patient-specific left ventricle and with realistic wall compliance (wall elastic properties). The Harvard pulsatile blood pump can be used to accurately simulate the ventricular action of the heart. This can be conducted using a 4.7 T, 40 cm bore MRI system.

Such a phantom study can satisfy two purposes: First, it can be used to verify the image registration/segmentation method. The embedded MR markers can be employed in the silicone model to provide a true point-to-point correspondence of the ventricular surface as the model heart changes its configurations throughout the cardiac cycle. Second, it is possible to apply the biomechanical testing system to perform uniaxial and multiaxial tests of cut specimens from various marked regions of the silicone phantoms to obtain their material properties. The regional properties predicted by the modality can then be compared with the material properties determined from mechanical testing.

Animal study. Juvenile Sinclair mini swine (5 months of age, ˜20 kg) can be used as a model of MI. Besides considerations of the cost and facility acceptance, the rationale for the pig model is its anatomic similarity to the human hearts especially for the microscopic anatomic attributes. This species has been selected for two reasons. First, the pig is of sufficient size to allow the instrumentation necessary to perform the measurements needed to complete this protocol. Second, a large body of information describing the cardiovascular system in the pig already exists[21]E.

Closed-chest mini-pig model of MI can be established by a coronary angiography via the carotid artery performed using a guiding catheter [22]E. Under fluoroscopy, after insertion of a percutaneous transluminal coronary angioplasty (PTCA) guide wire and catheter system into the LAD distal to the 2¹¹″ diagonal branch, a vessel-size flexible foreign body can be advanced into the coronary artery to occlude the target artery for 60 minutes. Sinclair swine are anesthetized with intravenous sodium pentobarbital (30 mg/kg, i.v.). Alternatively, the closed-chest mini-pig model may be established by intracoronary injection of thrombogenic agents. Any open-chest models will not be considered since they may change the imaging conditions for the imaging techniques.

Tests can be performed on groups of subjects, for example, in ten mini swine. An exemplary validation procedure is illustrated in FIG. 42. Animal MRI studies can be performed with a 40-cm 4.7 T magnet interfaced to a research MRI system. To obtain baseline measurements, the hearts of 10 normal mini swine can be scanned first using the inventive interior MR imaging technique and the corresponding elastodynamic biomarkers can be extracted. Then, post-infarction models can be established in Sinclair swine and the mini-pig models can be immediately scanned using the same technique. Cardiac elastodynamic biomarkers relevant to the infarcted heart can be extracted. Finally Sinclair swine can be sacrificed and the whole harvested heart can be subjected to dynamic mechanical testing. The tested locations can be focused on both the infarcted area and adjacent peri-infarct myocardium.

in vivo Human Study. The diagnostic utility of this novel imaging method can be demonstrated in at least two types of heart diseases: chronic MI and HCM. Both MI and HCM result in myocardial fibrosis and changes in the dynamic mechanical characteristics of the heart. With the imaging modality of embodiments of the invention, is expected to compensate for the T2-induced signal loss in the fibrosis due to the decreased T1 and T2 relaxation time by improving the SNR and yielding superior contrast resolution. In the setting of chronic MI, the fibrosis is manifested in a thinned portion of the infracted myocardium. HCM is strikingly different from myocardial infarction. In this disease process the myocardium is abnormally thickened, often with accompanying fibrosis. The thickened portion of the muscle is subject to alteration in elastic mechanical forces during cardiac cycle. Additionally, the fibrotic foci are often the source of electrical disturbances in the hearts conduction system which can lead to arrhythmias. Elastodynamic biomarkers can be used as an early predictor for HCM. The improved SNR and contrast resolution of embodiments of the invention can aid in the identification of fibrotic changes which may allow appropriate patients to be treated with implantable defibrilators for the prevention of sudden death due to arrhythmia.

A comparison can be performed using 20 patients for each type of heart disease and 20 healthy volunteers as baseline. Interior MRI can be used to image the hearts of the recruited patients in a 3 T clinical MR scanner. Cardiac elastodynamic biomarkers can be extracted. The healthy group can be scanned using both clinical cine MR sequence and the inventive imaging techniques.

With the cardiac images from 60 subjects using clinical cine MR sequences and the inventive imaging technique, it is possible to evaluate the quality of cardiac images using the inventive modality by comparing to those acquired with clinical cardiac MR sequences, especially for portions of myocardium affected by infarction. Receiver operating characteristic (ROC) can be used for comparison. The inventive imaging modality is capable of providing superior information especially for the MI areas. Furthermore, scan acquisition time/spatial resolution, SNR, and contrast can be compared. Less scan time and improved SNR and spatial and contrast resolution are typically expected. Finally elastodynamic biomarkers can be correlated with selected heart diseases. It is expected that a different relationship between cardiac elastodynamic features and MI tissues or HCM can be identified.

### REFERENCES

1E. Cohn J. N., McVeigh G., Morgan D., LeMay L., Robinson J., Mock J., Noninvasive pulse wave analysis for the early detection of vascular disease. Hypertension, 1995 26: p. 503-508
2E. Park, J. Y., Moeller S., Chamberlain R., Garwood M., A new short TE 3D radial sampling sequence: SWIFT-LiTE, in 17th International Society for Magnetic Resonance in Medicine. 2009: Hawaii. p. 253.
3E. Park, J.-Y., et al., A new short te 3d radial mri sequence: Swift-lite, in Advances in Musculoskeletal Magnetic Resonance Imaging (ISMRM workshop series). 2009: San Francisco.
4E. Candes, E. J., Romberg J., and Tao T., Robust uncertainty principles: Exact signal reconstruction from highly incomplete frequency information. Ieee Transactions on Information Theory, 2006. 52(2): p. 489-509.
5E. Donoho, D. L., Compressed sensing. IEEE Transactions on Information Theory, 2006. 52(4): p. 1289-1306.
6E. Yu, H. Y. and Wang G., Compressed sensing based interior tomography. Physics in Medicine and Biology, 2009. 54(9): p. 2791-2805.
7E. Yu, H. Y., Ye Y. B., and Wang G., Interior reconstruction using the truncated Hilbert transform via singular value decomposition. Journal of X-Ray Science and Technology, 2008. 16(4): p. 243-251.
8E. Zhang, J., et al. Exact and Stable Interior ROI Reconstruction for Radial MRI. in Med. Imag. 2009: Phys. of Medical Imaging, Proc. of SPIE Vol. 7258 72585G-1. 2009.
9E. Jung, H., et al., Radial k-t FOCUSS for high-resolution cardiac cine MRI. Magnetic Resonance in Medicine, 2010. 63: p. 68-78.
10E. Yu, H. Y., et al., Compressive sampling based interior reconstruction for dynamic carbon nanotube micro-CT. Journal of X-Ray Sci. and Tech., 2009. 17(4): p. 295-303.
11E. Sasayama, S., Nonogi, H., Miyazaki, S., Sakurai, T., Kawai, C., Eiho, S., Kuwahara, M., Changes in diastolic properties of the regional myocardium during pacing-induced ischemia in human subjects. J. Am. Coll. Cardiol., 1985. 5: p. 599-606.
12E. Pandit, A. L., Wang X., Kassab C., G S, Biaxial elastic material properties of porcine coronary media and adventitia. American Journal of Physiology-Heart and Circulatory Physiology, 2005. 288(6): p. H2581-H2587.
13E. Gotteiner N. L., H., G., Chandran K. B., Vonesh M. J., Bresticker M, Greene R., Oba J., Kane B. J., Joob A., and McPherson D. D., In vivo assessment of nonlinear myocardial deformation using finite element analysis and three-dimensional echocardiographic reconstruction. Am. J. Cardiac Imaging, 1995. 9 p. 185-194.
14E. Moulton, M. J., L. L. Cresweel, R. L. Actis, K. W. Myers, M. W. Vannier, B. A. Szabo, and M. K. Pasque, An inverse approach to determining myocardial material properties. J. Biomech., 1995. 28: p. 935-948.
15E. Robert, B., Sinkus, R., Gennisson, J. L., Fink, M, Application of DENSE-MR-Elastography to the human heart. Magnetic Resonance in Med., 2009. 62(5): p. 1155-1163.
16E. Sack, I., Rump, J., Elgeti, T., Samani, A., Braun, J., MR Elastography of the human heart: noninvasive assessment of myocardial elasticity changes by shear wave amplitude variations. Magnetic Resonance in Medicine, 2009. 61(3): p. 668-677.
17E. Varghese, T. Z., J A; Rahko, P; Breburda, C S, Ultrasonic imaging of myocardial strain using cardiac etastography. Ultrasonic Imaging 2003. 25(1): p. 1-16.
18E. Liu, Y., Wang, G., Sun, L. Z., Anisotropic Elastography for Local Passive Properties and Active Contractility of Myocardium from Dynamic Heart Imaging Sequence. Inter. J. Biomed. Imaging, 2006. 45957-1-15.
19E. Wang, G., Liu, Y., Zhang, J., Sun, L. Z., Tomography-based Dynamic Cardiac Elastography for in vivo Identification of Passive Properties and Active Contractility of Myocardium. Patent Pending, 2009. UC Case Number 2009-141-1.
20E. Liu, Y., Sun, L. Z., Wang, G, Tomography-based 3-D anisotropic elastography using boundary measurements. IEEE Trans. on Med. Imag., 2005.24: p. 1323-1333.
21E. Jameel M N, L. Q., Mansoor A., Qiang X., Sarver A., Wang X., Swingen C., Zhang J., Long term functional improvement and gene expression changes after bone marrow derived multipotent progenitor cell transplantation in myocardial infarction. American Journal of Physiology, 2010. in press.
22E. Wang J, B. H., Meng X, Wu Y, Bao Y, Li Y., A simple and fast experimental model of myocardial infarction in the mouse. Tex Heart Inst J., 2006. 33(3): p. 290-293.
23E. Borlaug, B. A., et al., Contractility and ventricular systolic stiffening in hypertensive heart Disease: insights into the pathogenesis of peart failure with preserved ejection fraction. Journal of the American College of Cardiology, 2009. 54(5): p. 410-418.

### V. EXACT AND STABLE INTERIOR ROI RECONSTRUCTION FOR RADIAL MRI

MRI applications often require high spatial and/or temporal resolution within a region of interest (ROI) such as for perfusion studies. In theory, both spatial resolution and temporal resolution can be significantly improved using a ROI-focused MRI data acquisition scheme. However, in radial MRI, there is no such acquisition-based solution available. Traditional reconstruction methods to image the ROI by reducing the field of view produce aliasing artifacts when the dataset becomes truncated.

Embodiments of the invention provide a ROI-focused radial MRI data acquisition scheme, aided by a dedicated digital filter. Such methods can be implemented in a 4 T 90 cm bore Oxford magnet with a GE phantom and a transceiver TEM head coil. Further parameters can include 4 gauss/cm sonata gradients, 5 mm slice thickness, TE=30 ms, TR=200 ms, FOVs of 40 cm and 12 cm respectively. Methods and systems of the invention can provide for interior MRI methods that exactly reconstruct a ROI with increased spatial resolution (−4 fold) while keeping the same temporal resolution. The image artifacts from truncated projections are effectively eliminated. No crosstalk with the outside ROI region is involved using the inventive method. Such interior radial MRI methods can be used for zoomed-in and fast views of a particular ROI, which can be translated into significant advantages in clinical and pre-clinical applications of many types.

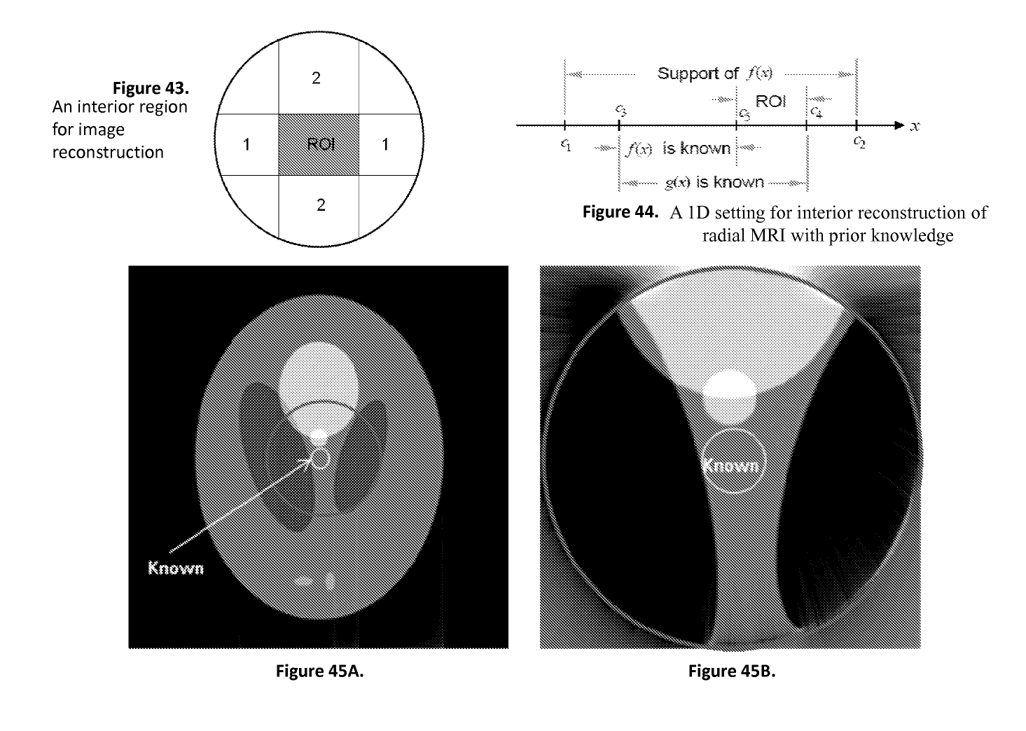

In radial MRI, to image an interior ROI (FIG. 43, shaded square inside the circle) by reducing FOV, the typical method is to increase the amplitude of the frequency encoding gradient, based on the relationship between the sampling frequency bandwidth (F), the amplitude of the frequency-encoding gradient (G_{f}), the voxel dimension (Δx), and number of samples (N_{f}) F=(γ/2π)·G_{f}·N_{f}·Δx if the bandwidth and number of samples are kept constant (increase spatial resolution of the ROI). However, protons outside the ROI are also excited. Therefore, the key issue to image the ROI is to remove the contribution from the surrounding areas (region 1 s and 2 s) in the radial projections. The wrap-around signal generated by region 1 s (or 2 s, depending on the frequency-encoding direction) can be eliminated using a digital filter during data acquisition [13D]. Then the issue becomes how to remove the signal from region 2 s. Traditionally there is no unique mathematical solution for such a problem.

The interior tomography methods, systems, and devices for CT imaging described above and as disclosed in U.S. Provisional Application No. 61/225,708, filed Oct. 28, 2009, which is incorporated by reference herein in its entirety, provide an exact and stable solution to this long-standing problem [12D]. In the description to follow, it is described how to extend this method to a ROI-focused data acquisition scheme for interior reconstruction of MRI.

While classic CT theory targets exact reconstruction of a whole cross-section or an entire object from complete projections, in practical applications such as nano-CT applications, we often need to focus on much smaller internal ROIs. Current CT theory cannot exactly reconstruct an internal ROI only from truncated projections associated with x-rays through the ROI because this interior problem does not have a unique solution [14D]. When applying traditional CT algorithms for interior reconstruction from truncated projection data, features outside the ROI may create artifacts overlapping inside features, rendering the images inaccurate or useless. On the other hand, over past decades lambda tomography has been developed into a branch of applied mathematics that merely recovers gradient-like features within a ROI from localized data [15-20D]. When applying lambda tomography techniques, the outcomes are not most appealing because of their non-quantitative nature. Recently, great advancement has been made for exact cone-beam reconstruction from truncated data collected in spiral/helical or saddle-curve scanning mode [21D].

The importance of performing exact image reconstruction from the minimum amount of data was recognized for a long time. The first landmark achievement is the fan-beam half-scan formula [22D]. A recent milestone is the two-step Hilbert transform method developed by Noo et al. [23D]. In 2006, Defrise et al. [24D] proposed an enhanced data completeness condition that the image on a chord in the FOV can be exactly reconstructed if one end of the chord on the compact object support is covered by the FOV. By the analytic continuation, in 2007, Wang's group published mathematical analysis and numerical results demonstrating for the first time that the interior problem can be solved in a theoretically exact and numerically stable fashion if a small sub-region within a ROI is known [12, 25-27]D; these results were then also independently reported by other researchers [28, 29]D.

Because these results are reconstruction schemes that only use projection data associated with lines through a region of interest (ROI) or volume of interest (VOI) to be reconstructed, they are called interior tomography. Given the fact that the MRI radial signal has the same mathematical model after digital filter and Fourier transform, this interior tomography technique of CT can be directly used for radial MRI.

Interior reconstruction of MRI. Let μ(\vec{r}) be a smooth function on a compact support Ω⊂R², with \vec{r}=(r₁,r₂) and R² denoting the two-dimensional (2D) real space. In the MRI application, the function μ(\vec{r}) is the spin amplitude under a magnetic field. For a given direction φ, we can acquire an array of frequency data F(sₙ,φ), n=1, 2, . . . N_{f}. Using the digital filter technique and Fourier transform, we obtain the spatial signal \tilde{p}(sₙ,φ), which only involves the data along the magnetic field direction. For example, when \tilde{p}(sₙ,φ) are measured along the direction of regions 2 and ROI as indicated in FIG. 44, they are irrelevant to the regions 1. Because each of the data \tilde{p}(sₙ,φ) represents the total protons received along the magnetic field direction, we normalize it by dividing the voxel dimension Δx, that is p(sₙ,φ)=\tilde{p}(sₙ,φ)/Δx.

For simple of statement, we denote the discrete p(sₙ,φ) as p(s,φ) in continuous domain which has the same mathematical model as CT in terms of Radon transform:

$$p ( s , φ ) = {\int }_{R} μ ( s \vec{u} ( φ ) + t {\vec{u}}^{⊥} ( φ ) ) d t \\ for s ∈ R and 0 \leq φ < π , \\ where \vec{u} ( φ ) = ( cos φ , sin φ ) and \\ {\vec{u}}^{⊥} ( φ ) = ( - sin φ , cos φ ) \cdot p ( s , φ ) \qquad ( EQUATION MRI \text{-} 1 )$$

can be extended to φ∈R with p(s,φ+π)=p(−s,φ). For a fixed φ₀, by Noo et al. [10D], the backprojection of differential data:

$$b ( {\vec{r}}_{0} ) = - \frac{1}{2 π} {\int }_{{φ}_{0}}^{{φ}_{0} + π} \frac{\partial p ( s , φ )}{\partial s} {\vert}_{s = {\vec{r}}_{0} \cdot \vec{u} ( φ )} d φ \qquad ( EQUATION MRI \text{-} 2 )$$

can be expressed as the Hilbert transform of μ along the line L through \vec{r}₀ which is parallel to \vec{n}=(−sin φ₀, cos φ₀):

$$b ( {\vec{r}}_{0} ) = \frac{1}{π} PV {\int }_{R} μ ( {\vec{r}}_{0} - t \vec{n} ) \frac{dt}{t} = ( {H}_{L} μ ) ( {\vec{r}}_{0} ) , \qquad ( EQUATION MRI \text{-} 3 )$$

where “PV” indicates the Cauchy principal value, and H_{L} the Hilbert Transform along the line L.

Let us denote the 2D μ(\vec{r}) on a line L as f(x) and b(\vec{r}₀) as g(x) where x is the one-dimensional (1D) coordinate along the line L. Assume the intersection of the compact support and the line L is the interval (c₁,c₂) with c₁<c₂, which imply that f(x)=0 for x∉0 (c₁,c₂). Also, let us assume that the backprojection of differential data can be exactly obtained from the original projection data through the interval (c₃,c₄) with c₃<c₄. All the intervals (c₃,c₄) form a sub-region inside the compact support of μ(\vec{r}). This sub-region usually is called the region-of-interest (ROI) or field of view (FOV). Recovering the object function inside the ROI is generally called interior reconstruction. Using the above notations, EQUATION MRI-3 can be rewritten as:

$$g ( x ) = \frac{1}{π} PV {\int }_{{c}_{1}}^{{c}_{2}} f ( y ) \frac{dy}{x - y} = ( {H}_{L} f ) ( x ) , \\ x ∈ ( {c}_{3} , {c}_{4} ) . \qquad ( EQUATION MRI \text{-} 4 )$$

We call g(x) on the interval (c₃,c₄) as the truncated Hilbert Transform (THT). By Tricomi [30D], f(x) can be recovered from its Hilbert transform g(x) by:

$$\begin{matrix}\sqrt{( {c}_{2} - x ) ( x - {c}_{1} )} f ( x ) = {C}_{f} + \frac{1}{π} PV {\int }_{{c}_{1}}^{{c}_{2}} g ( y ) \sqrt{( {c}_{2} - y ) ( y - {c}_{1} )} \frac{dy}{y - x} , & ( EQUATION MRI \text{-} 5 ) \\ where {C}_{f} = \frac{1}{π} {\int }_{{c}_{1}}^{{c}_{2}} f ( x ) dx & ( EQUATION MRI \text{-} 6 )\end{matrix}$$

is a known quantity. Because the radial MRI data EQUATION MRI-1 is a typical Radon transform, the exact and stable interior reconstruction of radial MRI is immediately available by the following theorem 2.1[12D]:

Theorem 2.1: c₁,c₂,c₃,c₄,c₅ are five real numbers with c₁<c₃<c₅<c₄<c₂ (see FIG. 44). A function f(x) supported on [c₁,c₂] can be exactly reconstructed on [c₅,c₄) if (i) f(x) is known on (c₃,c₅); (ii) g(x) is known on (c₃,c₄), and (iii) the constant C_{f} is known.

The key technique to prove Theorem 2.1 is the co-called analytic continuation theory and only the analytic property of g(x) has been used. It should be pointed out the THT g(x) in EQUATION MRI-4 can be exactly computed from p(sₙ,φ) via Eq. (2), where necessary interpolation method will be used. That is, b(\vec{r}₀) is computed only from the projection data whose paths go through the point \vec{r}₀. To exactly reconstruct the interior images of radial MRI from the constraints of EQUATION MRI-4, both projection onto convex set (POCS) algorithm [12D] and singular value decomposition (SVD) technique [27D] can be directly used.

Both numerical simulation and phantom experiment were performed to validate the interior reconstruction technique for radial MRI. The simulation study verified the correctness of the generalized reconstruction framework. The phantom experiment demonstrates the feasibility of the method in practical settings.

More particularly, the numerical simulation was implemented in MatLab (Mathworks Inc, MA, USA) on a regular PC (1.0 G memory, 2.8 G CPU). A modified Shepp-Logan phantom inside a circular support Ω of radius 10 cm (FIG. 45A) was employed. In parallel-beam geometry, 360 view-angles were uniformly sampled for an angle range [0,π] to simulate the MRI acquisition geometry. For each view-angle, there were a total of 300 detector elements uniformly distributed along a 6.0 cm linear detector array, which covered a disk-shaped ROI of radius 3.0 cm (red circle in FIG. 45A. We assumed that a sub-region (the region within the white circle in FIG. 45A inside the ROI was known. The radius of the sub-region was 0.5 cm. The interior tomography of the ROI was performed on 90 groups of parallel lines through the known sub-region. These groups of parallel lines were uniformly distributed along the full scan range [0, 2π]. The data in the range [π,2π] were obtained using p(s,φ+π)=p(−s,φ). Each group included a set of uniformly distributed parallel lines. On each line, we converted the reconstruction problem into a regularization problem in the framework of a truncated Hilbert transform and determined the solution by the singular value decomposition (SVD) [27D]. Finally, the redundant reconstruction results were averaged to optimize the image quality. Note that each of the parallel lines in the 90 groups serves as the chord under reconstruction, on which a full-resolution backprojection and filtration (or full-resolution backprojection of differential data) were performed and averaged at each point in the ROI. The result is shown in FIG. 45B.

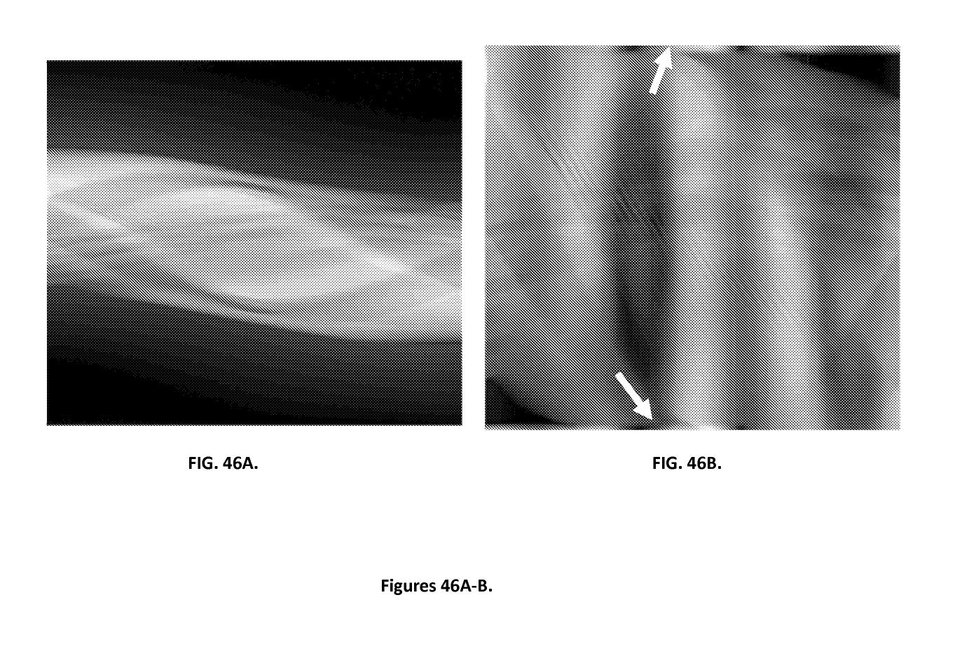

Phantom Experiment. In the phantom study, radial acquisition was implemented on a 4 Tesla 90 cm bore Oxford magnet using a GE phantom with a quadrature transceiver TEM head coil and Varian NOVA console. The acquisition parameters were: Siemens 4 gauss/cm sonata gradients, 5 mm slice (one slice only), centered echo with echo time TE=30 ms, repetition time TR=200 ms. The FOV were 40, and 12 cm, respectively. For each FOV, 512 projections over 180 degrees were obtained, as shown in FIGS. 46A-B. The digital receiver (DR) operated at a constant 72 kHz bandwidth. However, the actual Varian bandwidth varied slightly. This means that the projection width is not exact (but close) in the DR data. The cutoff near the edge of the FOV is very sharp. The small band at ends of the sinogram (FIG. 46B arrow) was due to the bandwidth of the digital receiver not being the same as the Varian readout bandwidth (the DR is fixed at 72 kHz, the Varian readout bandwidths were 72 kHz for FOV of 40 cm, and 64 kHz for FOV of 12 cm, respectively).

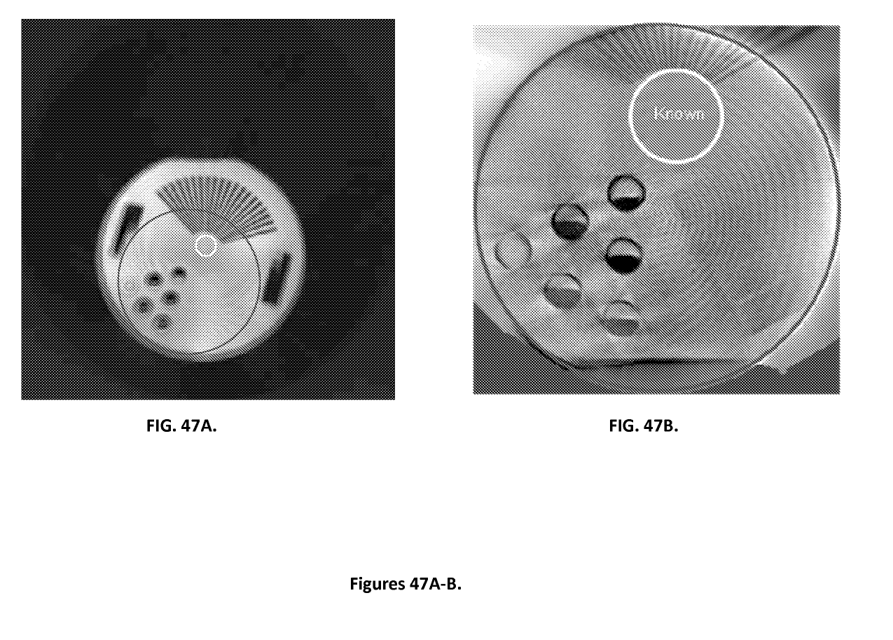

A full FOV (40 cm) image was first reconstructed using the classical FBP method, as shown in FIG. 47A. ROI (the region within the red circle, 12 cm in diameter) was then reconstructed using the inventive method, as shown in FIG. 47B. The known sub-region required for ROI reconstruction was obtained from the full FOV image. All image size are 256×256. FIG. 47B shows the inventive interior tomography significantly improves spatial resolution (approximately 4 folds), while keeping the same temporal resolution.

This showed the feasibility of an interior reconstruction of radial MRI by extending the recently developed interior tomography technique for CT. Both numerical simulation and phantom experiment show that the MRI imaging technique is able to image ROI with high spatial resolution. This method can be used to improve temporal resolution without changing spatial-resolution or both of them simultaneously.

A sub-region inside ROI needs to be known to obtain an exact and stable solution. This assumption is acceptable for most MRI applications. Different from CT where radiation is of concern, a full FOV low-resolution MR image can be obtained to provide the sub-region information before a high spatial and/or spatial resolution ROI is imaged.

The method can be used to reconstruct a two-dimensional MR image. The same or similar techniques can be applied for exact reconstruction of a volume of interest (VOI) of three-dimensional image, even though the projection data remain truly truncated. Clinical evaluation of the utility of this technique appears warranted. This interior radial MRI method can be translated into significant advantages in many clinical and pre-clinical applications.

### REFERENCES

1D. Mansfield P. Multi-planar image formation using NMR spin echoes. J Phys 1977; C10:L55-L58.
2D. Hennig J, Nauerth A, Friedburg H. RARE imaging: fast imaging method for clinical MRI. Magn Reson Med 1986; 3:823-833.
3D. Oshio K, Friedburg H. GRASE (gradient and spin-echo) imaging: a novel fast MRI technique. Magn Reson Med 1991; 10:344-349.
4D. Idiyatullin D, Comm C, Park J Y, Garwood M, Fast and quiet MRI using a swept radiofrequency, J. Magn. Reson., 2006; 182: 342-349.
5D. Feinberg D A, Hale J D, Watts J C, Kaufman L, Mark A., Halving MR imaging time by conjugation: demonstration at 3.5 kg. Radiology 1986; 161:527-531.
6D. Brummer M E, et al., Composite k-space windows (keyhole technique) to improve temporal resolution in a dynamic series of images following contrast administration. In: Proceedings of the llth Annual Meeting of ISMRM, Berlin, Germany, 1992.
7D. Wright R C, et al., Real-time MR fluoroscopic data acquisition and image reconstruction. Magn Reson Med 1989; 12:407-415.
8D. X. Hu, T. Parrish, Reduction of field of view for dynamic imaging, Magn. Reson. Med., 1994; 31:691-594.
9D. L. Zhao, B. Madore, Panych L. P., Reduced field-of-view MRI with two-dimensional spatially-selective RF excitation and UNFOLD, Magn. Reson. Med. 53 (2005): 1118-1125.
10D. Weib S and Rasche V, Projection-reconstruction reduces FOV imaging, Magn Reson Imaging, 1999; 17(4): 517-525.
11D. Mistretta C A, Wieben O, Velikina J, Block W, Perry J, Wu Y, Johnson K, and Wu Y, Highly constrained backprojection for time-resolved MRI, Magn. Reson. Med. 2006 (55): 30-40.
12D. Ye Y, Yu Y H., Wei Y, Wang G, A general local reconstruction approach based on a truncated Hilbert transform, International J Biomed Imaging, 2007. ID 63634, 8 pages.
13D. Andersen P, Rosen M, Erhard P, Adriany G, Strupp J, Salmi R, and Ugurbil K, Proc. Int. Soc. Magnetic Resonance Medicine, April 1996, 1403.
14D. Natterer, F., The Mathematics of Computerized Tomography. Classics in applied mathematics 2001, Philadelphia: Society for Industrial and Applied Mathematics.
15D. Faridani, A., et al., Local tomography II. SIAM J. Appl. Math., 1997. 57(4): 1095-1127.
16D. Faridani, A., Ritman E. L., and Smith K. T., Local tomography. SIAM J. Appl. Math., 1992. 52: 459-484.
17D. Ramm, A. G. and Katsevich A. I., The Randon Transform and Local Tomography. 1996, Boca Raton: CRC Press.
18D. Yu, H. Y., et al., Lambda tomography with discontinuous scanning trajectories. Phys. Med. Biol. 2007. 52(14): 4331-4344.
19D. Quinto, E. T., Local algorithms in exterior tomography. Journal of Computational and Applied Mathematics, 2007 199(1): 141-148.
20D. Quinto, E. T. and O. Oktem, Local tomography in electron microscopy. Siam Journal on Applied Mathematics, 2007. 68(5): 1282-1303.
21D. Wang, G., Ye Y., and Yu H., Appropriate and exact cone-beam reconstruction with standard and nonstandard spiral scanning. Phys. Med. Biol., 2007. 52(6): R1-R13.
22D. Parker, D. L., Optimal short scan convolution reconstruction for fanbeam CT. Med. Phys., 1982. 9(2): 254-257.
23D. Noo, F., Clackdoyle R., and Pack J. D., A two-step Hilbert transform method for 2D image reconstruction. Physics In Medicine And Biology, 2004. 49(17): 3903-3923.
24D. Defrise, M., et al., Truncated Hilbert transform and image reconstruction from limited tomographic data. Inverse Problems, 2006. 22(3): 1037-1053.
25D. Ye, Y., Yu H., and Wang G., Exact Interior Reconstruction with Cone-beam CT. International Journal of Biomedical Imaging, 2007: Article ID: 10693, 5 pages.
26D. Ye, Y., Yu H. Y., and Wang G., Exact Interior Reconstruction from truncated limited-angle projection data, International Journal of Biomedical Imaging, 2008: Article ID: 427989, 6 Pages.
27D. Yu, H., Ye Y., and Wang G., Local Reconstruction Using the Truncated Hilbert Transform via Singular Value Decomposition. Journal of X-Ray Science and Technology, 2008. 16(4): 243-251.
28D. Kudo, H., et al., Tiny a priori knowledge solves the interior problem in computed tomography. Phys. Med. Biol., 2008. 53(9): 2207-2231.
29D. Courdurier, M., et al., Solving the interior problem of computed tomography using a priori knowledge. Inverse Problems, 2008. 24: Article ID 065001, 27 pages.
30D. Tricomi, F. G., On the finite Hilbert Transform Quarterly Journal of Mathematics 1951. 2(1): 199-211.

Interior MRI Example.

In MRI, a spatial projection of an object is created by summing the signal amplitude along a column of the tissue; the width of the column is defined by the sampling aperture (pixel), and the thickness is governed by the slice select gradient strength.

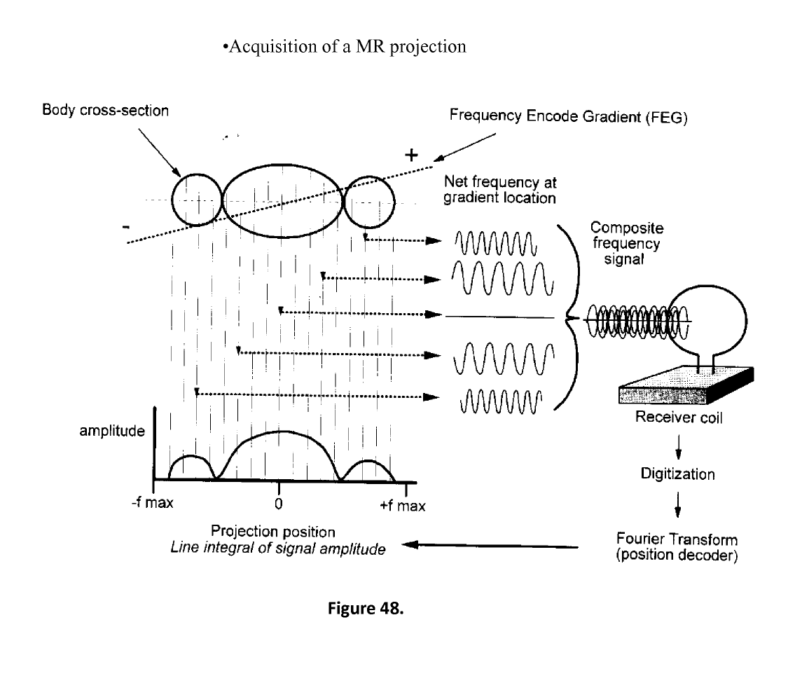

To obtain a projection, as shown in FIG. 48, a frequency encode gradient (FEG) is applied in an orthogonal direction to the slice selection gradient (SSG) and confers a spatially dependent variation in the processional frequencies of the protons. Acting only on those spins from the slice encode excitation, the composite signal is acquired, digitized, demodulated (Larmor frequency removal), and Fourier transformed into frequency and amplitude information. A one-dimensional array represents a projection of the slice of tissue at a specific angle. Demodulation into net frequencies occurs after detection by the receiver coil, which is shown in FIG. 48 for clarity only.

To reduce the FOV to the ROI in the projection readout direction, the typical method is to increase the amplitude of the frequency encoding gradient, based on the relationship between the sampling frequency bandwidth (F), the amplitude of the frequency-encoding gradient (G_{f}), the pixel dimension (Δx), and number of samples F=(γ/2π)·G_{f}·N_{f}·Δx if the bandwidth and number of samples are kept constant (increase spatial resolution of the ROI). However, protons outside the ROI are also excited, although their resonance frequency is above the bandwidth.

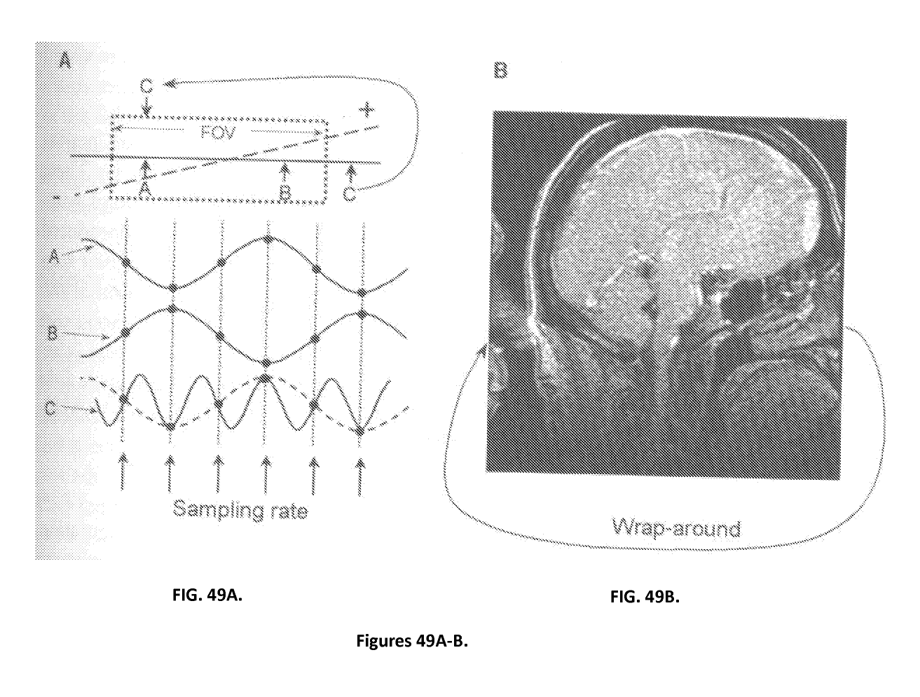

Wraparound artifacts are caused by aliasing. Shown in FIGS. 49A and 49B is a fixed sampling rate and net precessional frequencies occurring at position A and position B within the FOV that have identical frequencies but different phase. If signal from position C is at twice the frequency of B but insufficiently sampled, the same frequency and phase will be assigned to C as that assigned to A, and therefore will appear at that location. B: A wraparound artifact example displaces anatomy from one side of the image (or outside of the FOV) to the other side. This wrap-around signal can be eliminated using a digital receiver.

Physical Phantom Data. In the phantom study, radial acquisition was implemented on a 4 Tesla 90 cm bore Oxford magnet using a phantom with a quadrature transceiver TEM head coil and Varian NOVA console. The acquisition parameters were: Siemens 4 gauss/cm sonata gradients, 5 mm slice (one slice only), centered echo with echo time TE=30 ms, repetition time TR=200 ms. The field of view (FOV) are 40, 20, 10 cm, respectively. For each FOV, 512 projections over 180 degrees were obtained. The digital receiver operated at a constant 72 kHz bandwidth. However, the actual Varian bandwidth varied slightly. This means that the projection width is not exact (but close) in the DR data. The cutoff near the edge of the FOV is very sharp. The small band at ends of the sinogram are due to the bandwidth of the digital receiver not being the same as the Varian readout bandwidth (the DR is fixed at 72 kHz, the Varian readout bandwidths were 72 kHz for FOV of 40 cm, 69 kHz for FOV of 20 cm, and 64 kHz for FOV of 10 cm, respectively).

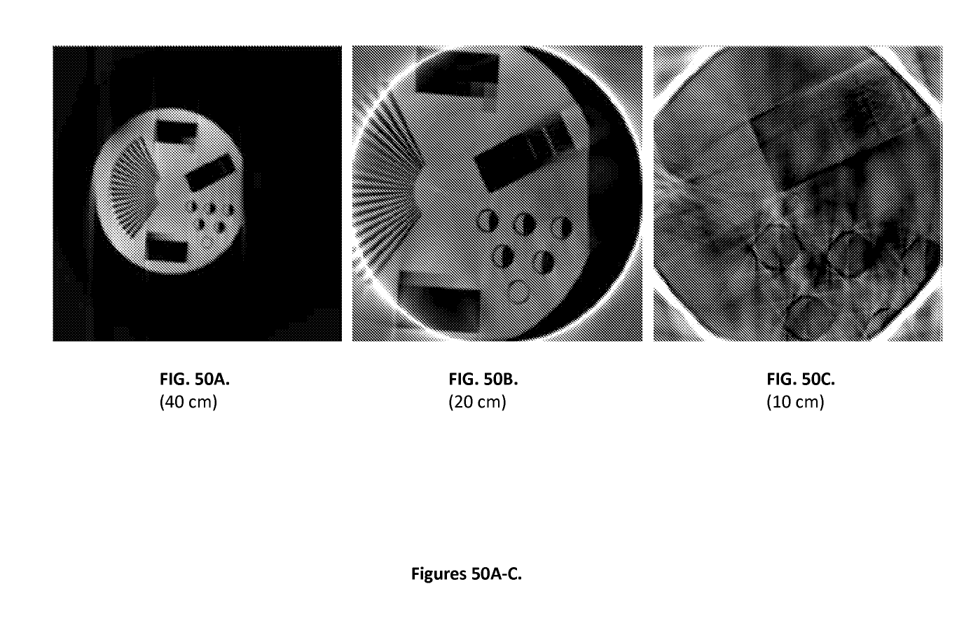

We scanned a GE phantom in a 4 T MR scanner using different FOVs, 40 cm, 20 cm, and 10 cm, as shown in the FIG. 50A-C. The files for the corresponding sinograms are GE40.mat, GE20.mat, and GE10.mat, which can be read in MatLab. For each set of data, there are 512 projections from a 180 degree scan. The spatial resolution is increased with the decrease of FOV, which are called a “zoom in” image. The sampling points are approximately the same for each projection of three FOVs. The small difference is caused by variation in the BW.

For the FOVs of 20 cm and 10 cm, at the each side of sinograms, “wrap around” signals still can be seen. However, they only influence a few edge points. For image reconstruction, this part can be ignored. In theory, the wrap around signal can be filtered out perfectly during data collecting. We are learning how to control the BW more precisely in order to solve this problem.

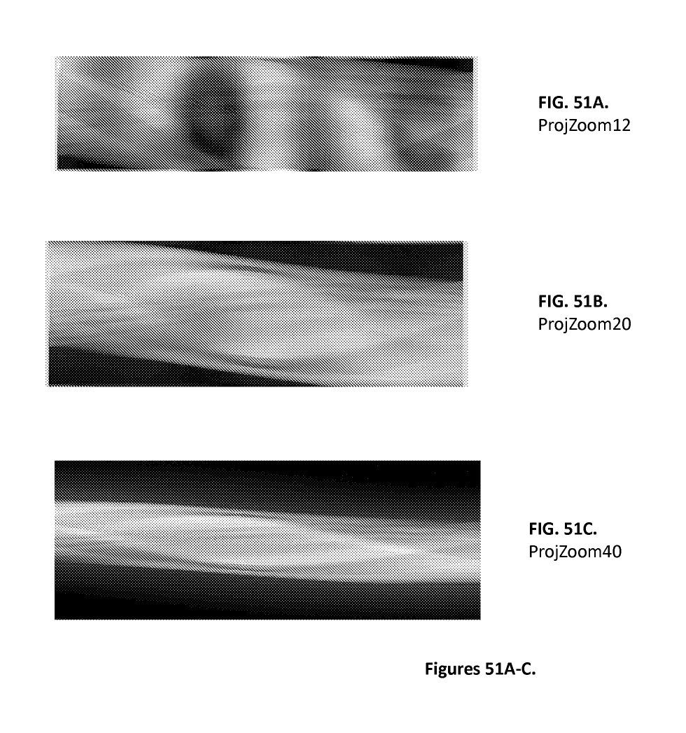

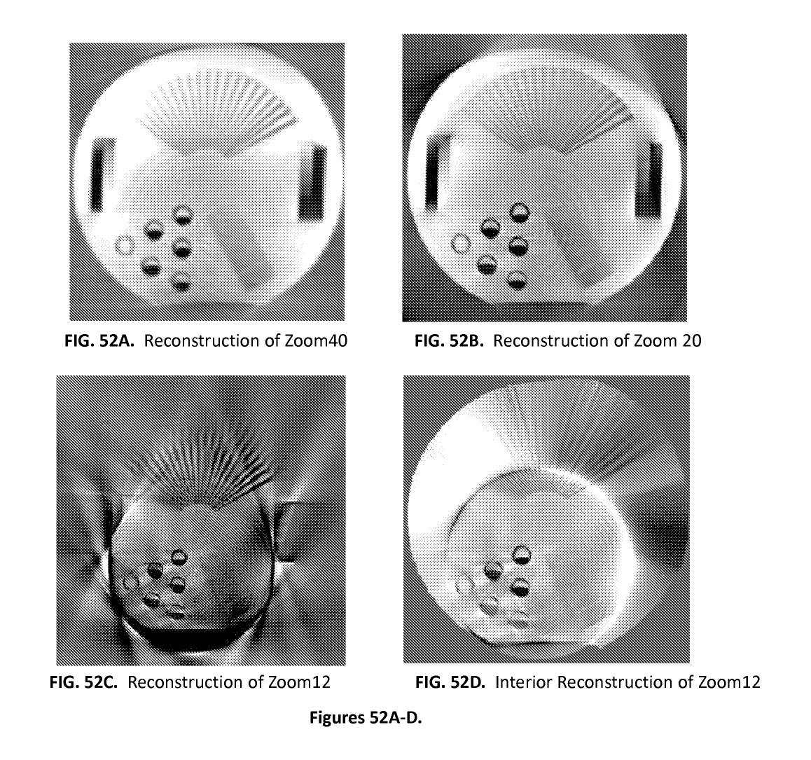

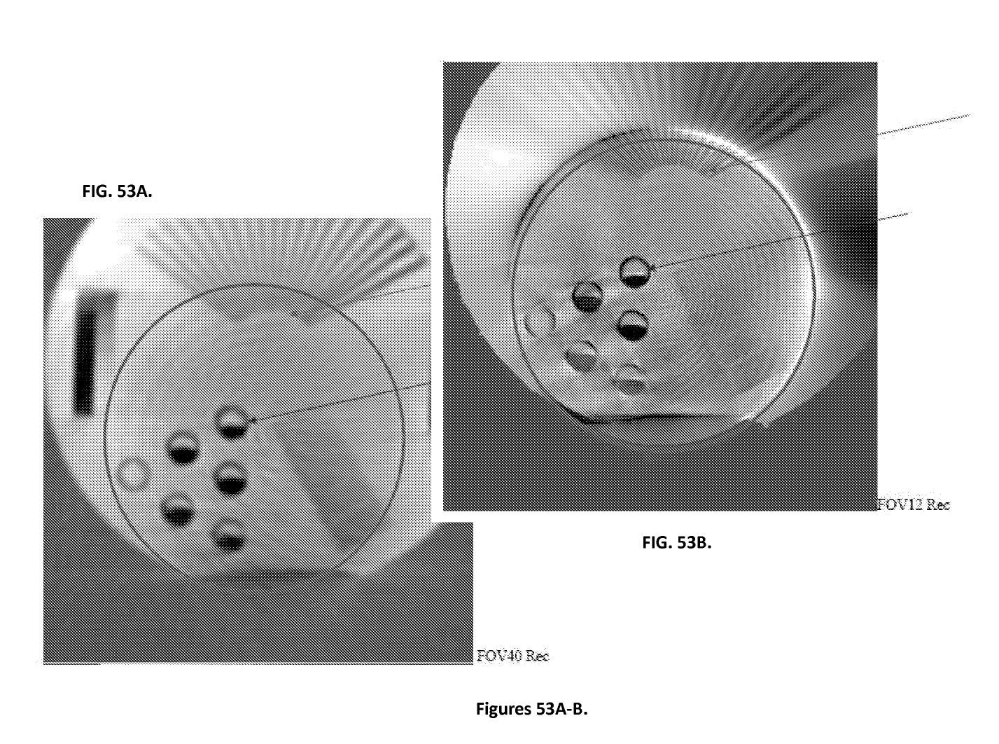

Experimental Results. Corresponding to different zooming factors, the project datasets are displayed in FIGS. 51A-C. Then, our interior tomography algorithm developed for x-ray CT was adapted to the MRI case and produced the following improved reconstructed (highlighted in red) as compared to the conventional MRI reconstructions (labeled in black), as shown in FIGS. 52A-D. The interior MRI approach actually produced high spatial resolution as shown in FIGS. 53A-B.

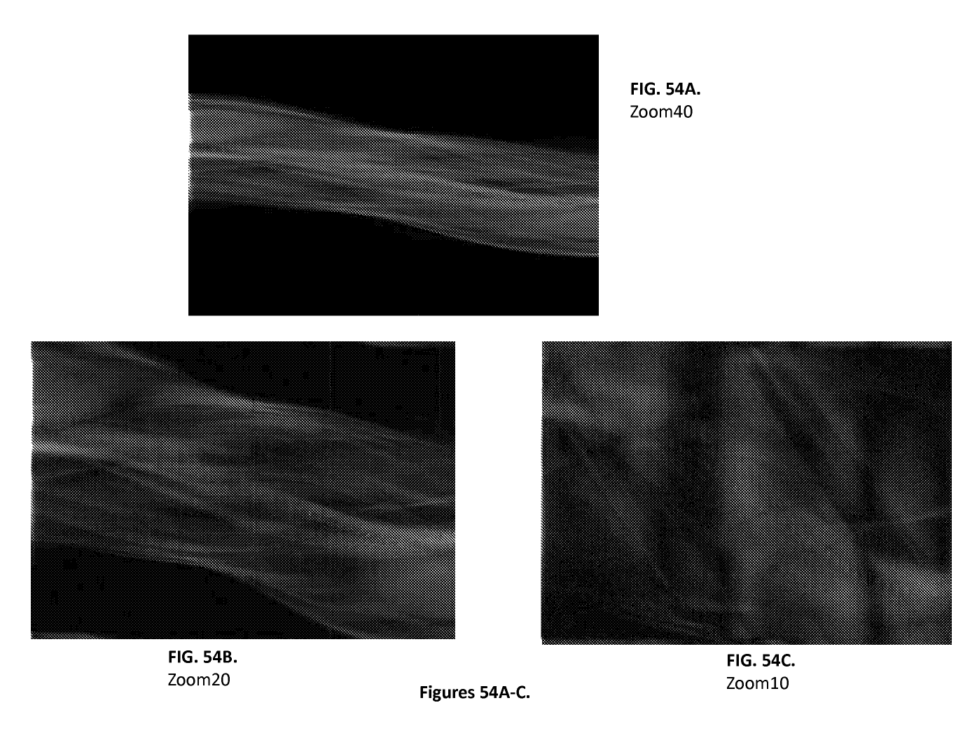

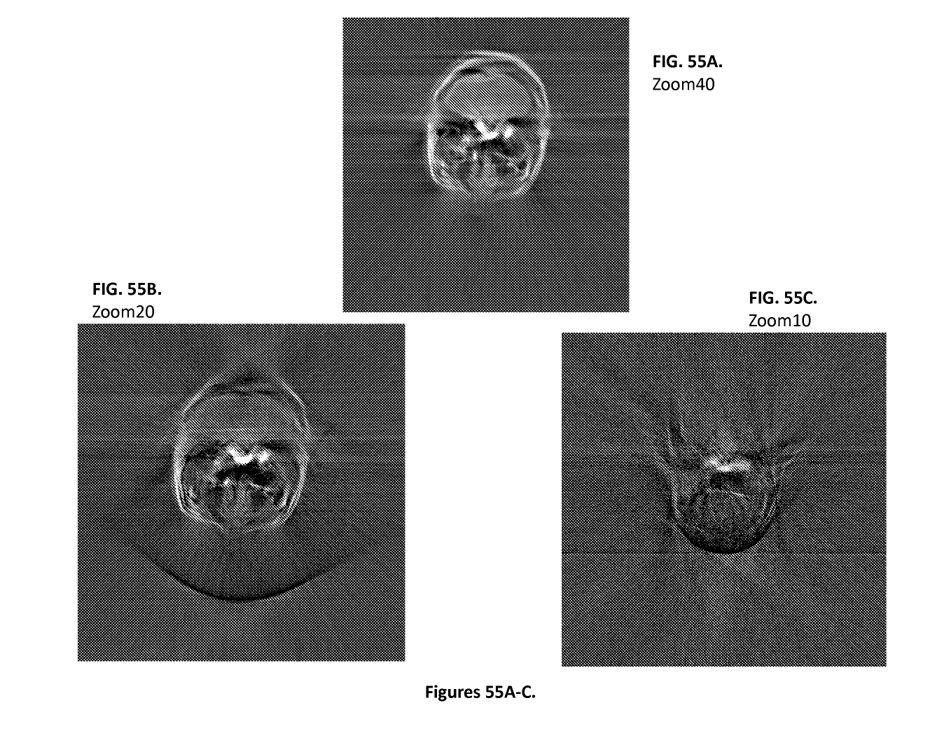

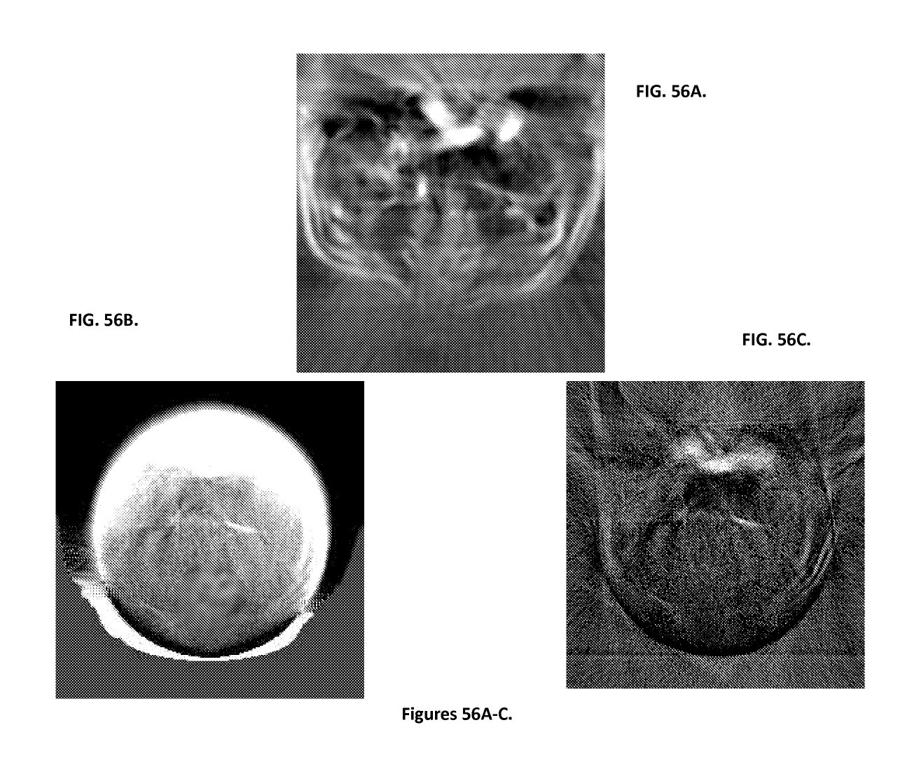

Preliminary Patient Study. Normalized projection datasets within the same display window are provided in FIGS. 54A-C. The corresponding reconstruction results are shown in FIGS. 55A-C. For comparison, 512×512 images were directly reconstructed from the normalized datasets are displayed within the 30 cm FOV in the same display window, as shown in FIGS. 56A-C.

### VI. OPTICAL MOLECULAR TOMOGRAPHY

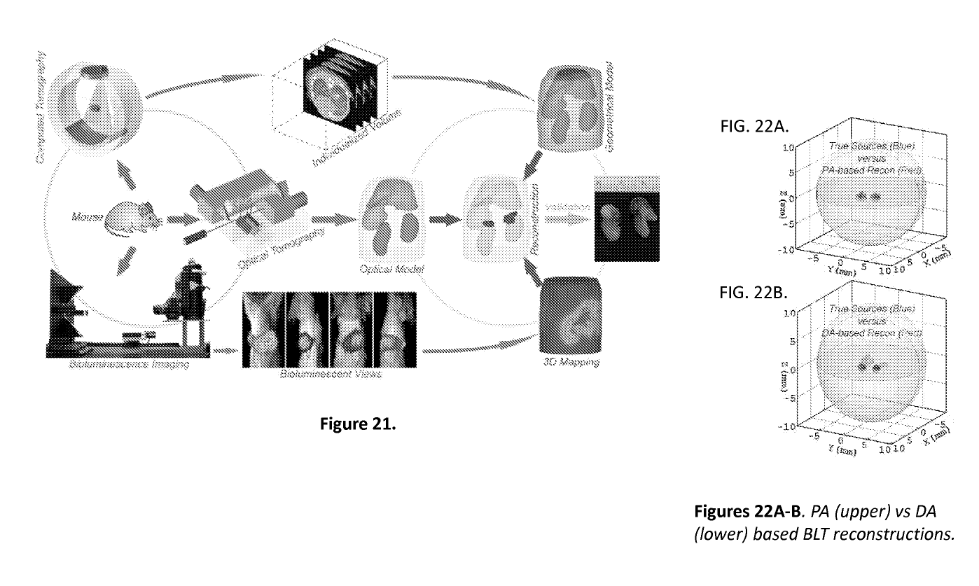

Bioluminescence tomography (BLT) was introduced in 2002 by the PI's group [21, 64, 65]A. At the same time, our efforts also include improvement of fluorescence molecular tomography (FMT) [66]A. As the two branches of optical molecular tomography (MOT), both BLT and FMT are studied using the modality fusion approach. For example, a mouse is imaged in a light-tight setting (FIG. 21) to capture external luminescent views in a tomographic apparatus to reconstruct an anatomical volume, and in an optical mode to estimate optical parameters of each component. A linear imaging model is built between the measurement and source, and inverted for 3D localization and quantitative analysis of the underlying molecular/cellular activities. To validate BLT, we generated a mouse model of prostate cancer metastasis [67]A. In this model, luciferase-expressing tumor cells were introduced into the arterial circulation. This allowed seeding of tumor cells in bone, liver, adrenal glands, and other sites. A key limitation of this model used to be that precise anatomical localization cannot be ascertained from conventional bioluminescence imaging. Hence, we used BLT to localize the sources. In FIG. 21, the stronger source had a power of 39.8 nano Watts, and the smaller one had 1.5 nano Watts [67]A. Post-mortem analysis indicated that the tumor locations were in excellent agreement with BLT.

Despite its popularity, the diffusion-approximation (DA) model cannot produce satisfactory OMT performance for multi-spectral/probe imaging [68, 69]A. Thus, we recently developed a phase-approximation (PA) model, first used it in the forward modeling processes, and generated very favorable results compared to the DA model [70-72]A. Then, we compared the reconstructions of light sources based on the PA and DA models, respectively. First, applying the Monte Carlo method, we computed the anisotropy weight f in the phase approximation model based on a spherical phantom of radius 10 mm. The optical parameters of absorption coefficient μₐ=0.20 mm⁻¹, scattering coefficient μₛ=14.5 mm⁻¹, anisotropic coefficient g=0.9, and the relative refractive index of 1.37 were assigned to the spherical phantom. The anisotropy weight in the phase approximation model was estimated through fitting the simulated measurement data generated from the Monte Carlo simulation. Then, two spherical light sources of radius 0.6 mm were embedded into the spherical phantom. The centers of the two light sources were located at (−3.5, 0.0, 0.0) and (2.5, 2.5, 0.0), respectively. A power of 10 nW was set for both light sources. The Monte Carlo simulation with the Henyey-Greenstein phase function was performed to generate the measurement data on the phantom surface. PA- and DA-based reconstructions were then performed respectively in an identical setting. As a result, the localization errors of the reconstructed light sources were <0.2 mm with the PA-based reconstruction, and >2.3 mm with the DA-based reconstruction. Source strength estimation errors were ˜5% with PA and up to 25% with DA (FIG. 22), demonstrating the great potential of PA for optical imaging.

Example—Bioluminescence Tomography with Gaussian Prior.

Parameterizing the bioluminescent source globally in Gaussians provides several advantages over voxel representation in bioluminescence tomography. It is mathematically unique to recover Gaussians [3F] and practically sufficient to approximate various shapes by Gaussians in diffusive medium. The computational burden is significantly reduced since much fewer unknowns are required. Besides, there are physiological evidences that the source can be modeled by Gaussians. The inventive model and algorithm significantly improve accuracy and stability in the presence of Gaussian or non-Gaussian sources, noisy data or the optical background mismatch, which has been validated through simulation and in vivo data.

Bioluminescence tomography (BLT) [1-3]F is an emerging molecular imaging modality, which can be used to monitor physiological and pathological activities at molecular levels, specially visualize primary tumor growth and tumor cell metastasis. In BLT [4-13]F, one attempts to recover both location and intensity of bioluminescent sources from boundary measurements.

Conventionally the bioluminescent source is represented in voxels. For example, in a triangulation {τᵢ,i≦N} of the domain Q, the source in piecewise constants is:

$$q = {\sum }_{i = 1}^{N} {q}_{i} {1}_{{τ}_{i}} , \qquad ( EQUATION BLT \text{-} 1 )$$

where 1ᵢ is the basis function supported on the subdomain τᵢ that is 1 on τᵢ, and 0 otherwise, and qᵢ is the average intensity value on τᵢ to be recovered.

The accurate source reconstruction in voxels is highly challenging, which intrinsically comes from its non-uniqueness and severe illposedness [3]F. For example, even with a large number of boundary data, which is practically much less than the number of voxels, the recovery of deeply embedded objects still has a poor resolution. An attempt to achieve the high-resolution reconstruction in the voxel-based BLT was made through the modeling by radiative transfer equation (RTE) and the use of angularly-resolved data in the medium of a few mean free paths [14, 15]F, although it may take quite an effort to acquire the angularly-resolved data in practice. The popular diffusion approximation (DA) cannot model the angularly-resolved measures.

Instead of voxel representation, we model the source in Gaussians in reconstructions. A motivation is that because the light of interest is highly diffusive, a localized bioluminescent tumor does look like a Gaussian at a sufficiently large distance. Therefore it is practically sufficient to model various shapes as Gaussians in the diffusive medium, especially those deeply embedded objects. With this new representation, the reconstruction itself is unique [3]F and the BLT is reduced to the problem with a few parameters. Moreover, the new model can be justified from physiological reasons.

The outcome of the Gaussian model is formulated as a minimization problem with respect to the number of Gaussians, intensity, the center, the radius and the aligned direction of each Gaussian.

Although the number of Gaussians may be fixed in a specific reconstruction process, the exact number of actual Gaussian sources is not assumed. If the number of Gaussians in reconstruction is larger than the actual number, the source can still be recovered; otherwise, the actual number can be approached from a smaller initial guess in a combinatorial fashion through minimizing the data discrepancy. This can be illustrated in the following example.

Suppose there are three Gaussians. In the reconstruction, we can set the number of Gaussians to four. Using the inventive reconstruction algorithm, three recovered Gaussians would correspond to actual ones while the other one has the zero or nearly zero intensity values. On the other hand, if the assumed number is smaller than the actual number, e.g., only one Gaussian, the data discrepancy cannot be effectively reduced, and in this case the problem can be formulated as combinatorial optimization problem in which the number of Gaussians is increased iteratively until three so that data discrepancy can be reduced to the desired tolerance. On the other hand, a rough estimate of the actual number of Gaussians does improve both accuracy and efficiency of the reconstruction. In summary, the actual number of Gaussians is not assumed and it is practically sufficient to fix the number of Gaussians in reconstructions since the sources are localized and limited in quantity.

In reference [16]F on diffuse optical imaging, modeling the absorption coefficient as a single Gaussian, the authors also demonstrated the reconstruction improvement when using a priori information from ultrasound images for the center of the Gaussian. In this work, we do not assume a priori information from other imaging modalities although it can be used for further improvement. For example, we do not assume the center of Gaussians that is to be recovered. However, we do impose some geometric constraints to avoid the apparent non-uniqueness of geometric parameterization. For example, we constrain on the distance between any two Gaussians so that they do not overlap, or use the size of the phantom as the bound of the center. Last, although we model the source in Gaussians in the reconstruction, the actual source distribution in simulations is not necessarily Gaussian. However the reconstruction is better if the actual source is in Gaussians as well.

Forward Modeling.

RTE is the most accurate among realistic models for light propagation in tissue [17, 18]F. However, due to its large dimensionality, an efficient solver of RTE is non-trivial [19]F. Many efforts have been devoted in the development of RTE solver. Please see [20]F and references therein for numerical methods for solving the deterministic RTE, and [21]F and references therein for stochastic approaches by Monte Carlo method. The alternative modeling strategy is to simplify RTE into appropriate approximation according to particular optical regimes of interest [17, 22, 23]F. Among all the approximate models, the most popular one is DA, which is valid in the scattering dominant regime. For simplicity, we will use DA in this proof-of-concept study. Please note that the modeling error in practice comes from not only the chosen model, but also the approximation of optical properties for the underlying medium.

In the following DA with Robin boundary condition, we use φ for the light intensity, q for the bioluminescent source, μₐ for the absorption coefficient, μₛ′ for the reduced scattering coefficient, D for the diffusion coefficient, i.e., D=1/[3(μₐ+μₛ′)], \hat{n} for the outgoing normal at the medium boundary, A for the boundary constant [24]F.

−∇·(D∇φ)+μₐφ=q

φ+2AD∇φ·\hat{n}=0 (EQUATION BLT-2)

Here we choose piecewise linear finite element method (FEM) to solve Eq. (2). After discretization, Eq. (2) is reduced to a linear system with the discretized light intensity Φ, the discretized source Q, and the system matrix F dependent on μₐ and D, i.e.,

FΦ=Q (EQUATION BLT-3)

We refer the readers to [24]F for the details of FEM solution of Eq. (2). After solving Eq. (3), we have the following boundary fluxes

f=−D∇φ·\hat{n}=φ/2A. (EQUATION BLT-4)

Source Representation by Gaussians.

As a quantitative imaging method, BLT is expected to provide the source intensity or power accurately. However, there are some intrinsic aforementioned difficulties in achieving high-resolution reconstruction with the voxel-based BLT. Therefore, instead of local voxel representation of the bioluminescent source, we consider the global representation by characteristic shapes of the tumor, e.g., the Gaussians in this study. A motivation is that because the light of interest is highly diffusive, a localized bioluminescent tumor does look like a Gaussian if it is sufficiently distant from the boundary. It turns out that this new representation with significantly reduced degrees of freedom is more robust than the voxel-based representation.

Mathematically, it was proven in [3]F: the solution of BLT is non-unique without the incorporation of effective a priori knowledge on the source distribution; in particular the uniqueness can be established when source is assumed to be composed of solid balls with the known intensities. However, using solid balls is not effective in representing general source distribution, especially features like anisotropy and fast decay of source intensity which are quite common in practice. Summation of Gaussians can be used to model general source distribution. This structural representation is flexible and improves the reconstruction stability for BLT. In particular the anisotropic Gaussian representation is an effective mathematical approximation in the sense that it parameterizes the major quantitative information of interest, such as the intensity, the center and the size of the source.

Physiologically, the Gaussian shape is indeed a natural choice. According to http://www.humpath.com/tumorigenesis, tumorigenesis is a collection of complex genetic diseases characterized by multiple defects in the homeostatic mechanisms that regulate cell growth, proliferation and differentiation. Cancer is caused by uncontrolled proliferation and the inappropriate survival of damaged cells, which results in tumor formation. Cells have developed several safeguards to ensure that cell division, differentiation and death occur correctly and in a coordinated fashion, both during development and in the adult body. Many regulatory factors switch on or off genes that direct cellular proliferation and differentiation. Damage to these genes, which are referred as tumor-suppressor genes and oncogenes, is selected for in cancer. Most tumor-suppressor genes and oncogenes are first transcribed from DNA into RNA, and are then translated into protein to exert their effects. Recent evidence indicates that small non-protein-coding RNA molecules, called microRNAs (miRNAs), might also function as tumor suppressors and oncogenes. Therefore, in the tumorigenesis stage, cancerous cells are localized, limited in quantity, irregular in shape, and with some decaying behavior away from the center. As a result, they can be modeled effectively as Gaussian sources after they are bioluminescently labeled. Other inflammation foci can be similarly modeled at earlier stages.

Therefore we represent the source q as the summation of Gaussians with the intensity ρ, the center (x_{c}, y_{c}, z_{c}), anisotropic radius (rₓ, r_{y}, r_{z}) and Euler angles (φ, φ, θ), i.e.,

$$q ( x , y , z ) = {\sum }_{i = 1}^{n} {ρ}_{i} Exp ( - {X}_{i}^{T} {R}_{i}^{T} {Σ}_{i} {R}_{i} {X}_{i} ) . \\ where \\ {X}_{i} = [ \begin{matrix}x - {x}_{c , i} \\ y - {y}_{c , i} \\ z - {z}_{c , i}\end{matrix} ] , \\ {Σ}_{i} = [ \begin{matrix}1 / {r}_{x , i}^{2} & 0 & 0 \\ 0 & 1 / {r}_{y , i}^{2} & 0 \\ 0 & 0 & 1 / {r}_{z , i}^{2}\end{matrix} ] \\ and {R}_{i} = {R}_{i}^{θ} {R}_{i}^{ϕ} {R}_{i}^{φ} with \\ {R}_{i}^{θ} = [ \begin{matrix}cos {θ}_{i} & sin {θ}_{i} & 0 \\ - sin {θ}_{i} & cos {θ}_{i} & 0 \\ 0 & 0 & 1\end{matrix} ] \\ {R}_{i}^{ϕ} = [ \begin{matrix}1 & 0 & 0 \\ 0 & cos {ϕ}_{i} & sin {ϕ}_{i} \\ 0 & - sin {ϕ}_{i} & cos {ϕ}_{i}\end{matrix} ] and \\ {R}_{i}^{φ} = [ \begin{matrix}cos {φ}_{i} & 0 & - sin {φ}_{i} \\ 0 & 1 & 0 \\ sin {φ}_{i} & 0 & cos {φ}_{i}\end{matrix} ] . \qquad ( EQUATION BLT \text{-} 5 )$$

For simplicity, we restrict the discussion on the rotation variables in 2D, which is simplified to θ only, i.e.,

$${R}_{i} = [ \begin{matrix}cos {θ}_{i} & sin {θ}_{i} \\ - sin {θ}_{i} & cos {θ}_{i}\end{matrix} ] .$$

Computationally, the Gaussian source representation Eq. (5) reduces the burden significantly since we solve BLT with at most n×(1+d)(2+d)/2 unknowns in d dimensions, which is in general much smaller than that from voxel representation, e.g., N (total number of voxels) unknowns for Eq. (1).

Gaussian-Based BLT.

Modeling bioluminescent source in Gaussians, we formulate BLT as the minimization problem with respect to variables X^{G}={pⱼ, x_{c,j}, y_{c,j}, z_{c,j}, r_{x,j}, r_{y,j}, r_{z,j}, φⱼ, φⱼ, θⱼ, j≦n},

$${X}^{G} = {argmin}_{{X}^{G}} \frac{1}{2} {\sum }_{i = 1}^{M} {[ {P}_{i}^{T} φ ( {X}^{G} ) - {f}_{i} ]}^{2} + R ( {X}^{G} ) . \qquad ( EQUATION BLT \text{-} 6 )$$

Here we use the set {fᵢ, i≦M} for the measured data, the set {Pᵢ, i≦M} of column vectors for the discretized measuring operator, and geometric constraints R on X^{G}, which can be regarded as the regularization term. Note that φ is now nonlinearly dependent on X^{G} in this new formulation, although it linearly depends on q in Eq. (1) in the voxel-based representation.

In Eq. (6), we do not treat n as a variable, mainly because there is generally no practical need for that since the tumors are usually localized and limited in quantity. We can just assign a practical estimate to n that is larger enough than or comparable with the actual number.

However, in the case that such an estimate is unavailable, we formulate Eq. (6) as a combinatorial optimization problem with respect to the variable n. That is we start from an initial guess nₒ of n, which can be smaller than the actual number, and solve Eq. (6) iteratively until the data discrepancy d reaches certain tolerances. Here the update of n is simply nₖ₊₁=nₖ+1. For the notation convenience, we will use X for X^{G} whenever it is appropriate.

Then we have the following algorithm:

Algorithm 1: Combinatorial optimization

Given: initial guess n₀ and ε=0.05.
Repeat: 1. Computing Xₖ through Eq. (6) with the fixed nₖ

2. d=∥fₖ(Xₖ)−f∥/∥f∥;
3. Stopping criterion: Quit if d <ε.
4. nₖ₊₁=nₖ+1

In Algorithm 1, ε=0.05 is an empirical number that can identify those n's that are sufficient for the reconstruction; fₖ denotes the measurements with the source Xₖ; ∥·∥ can be the simple summation of the absolute values.

Next, we turn to the geometric constraints R, which can be imposed naturally from the known geometry of the medium. Please note that we do not assume any a priori knowledge on the anatomical structure of the medium, e.g., from other imaging modalities, although they can be easily incorporated into the scheme to improve the reconstruction. All the geometric constraints are either from the shape of the medium or from some commonsense assumptions on the shape of the source to avoid some non-uniqueness in geometric representation.

The first type of constraints is the min-max constraint, the minimum and maximum for each variable of X^{G}. For example, we can use the size of the medium as the min-max constraint for the center, and realistic values for anisotropic radius or intensity such as zeros as the lower bounds. That is:

Xₘᵢₙ^{G}<x<Xₘₐₓ^{G}. (EQUATION BLT-7-1)

Notice that although we constraint the rotation angles, e.g., 0°≦θ<180°, the representation of ellipsoid is not unique, e.g., by simultaneously exchanging rₓ and r_{y} and considering the supplementary angle of θ in 2D. This does not affect the reconstruction result.

Secondly, we restrict the shape variation along different directions so that the source is not too “narrow”, which is physiologically reasonable, i.e.,

rₓ<c_{xy}r_{y},r_{y}<c_{yz}r_{z},r_{z}<c_{zx}rₓ. (EQUATION BLT-7-2)

Here the parameter c_{xy}, c_{yz} and c_{zx} control the size difference between any two directions for each source.

In the case with multiple Gaussians, it is important to impose the following type of constraints, minimal-separation constaints, on centers and radiuses between any two Gaussians so that they will not overlap or get too close to each other. That is for any two Gaussian i and j, in (EQUATION BLT-7-3):

cₓ(r_{x,i}+r_{x,j})²+c_{y}(r_{y,i}+r_{y,j})²+c_{z}(r_{z,i}+r_{z,j})²<(xᵢ−xⱼ)²+(yᵢ−yⱼ)²+(zᵢ−zⱼ)².

Here cₓ, c_{y} and c_{z} are the control parameters, which can for example be set to ln 2, corresponding to full width at half maximum (FWHM). Without using constraints from Eq. (7-3), multiple inclusions may not be separated. An example is given in the result section.

All the above constraints Eq. (7) can be represented by the following abstract inequalities:

gₖ(X^{G})<0. (EQUATION BLT-8)

Here we use the popular logarithmic penalty functions to enforce those constraints, i.e.,

$$R ( {X}^{G} ) = - {\sum }_{k} ln [ - {g}_{k} ( {X}^{G} ) ] . \qquad ( EQUATION BLT \text{-} 9 )$$

Combining Eq. (6) and (9), the BLT with Gaussian representation is formulated as the minimization of the sum of the data fidelity and the logarithmic penalty functions of geometric constraints. In the next section we will develop the algorithm for solving Eq. (6) via the popular barrier method.

Note that when anatomical priors are available from other imaging modalities, such as X-ray CT or MRI, they can be incorporated naturally into the scheme Eq. (6). For example, the min-max constraints Eq. (7-1) can be tightened for centers or radiuses with the measured values from anatomical images; more accurate constraints can be imposed by assigning the appropriate constants in Eq. (7-2) and Eq. (7-3). In contrast, it is difficult to impose those global geometric features locally in the voxel-based BLT. On the other hand, the straightforward co-registration of the images from X-ray CT or MRI may not improve BLT satisfactorily since there is usually no simple one-to-one anatomical correspondence between them due to the fundamentally distinct imaging mechanisms.

Minimization by Barrier Method.

As the standard approach for minimizing nonlinear least squares, we linearize the first term (the data fidelity) in Eq. (6), and solve for the incremental change δX iteratively via the following outer loop of iterations in (EQUATION BLT-10):

$${X}^{n + 1} = {X}^{n} + {argmin}_{δ X} \frac{1}{2} {‖ J δ X - ( f - {f}^{n} ) ‖}_{2}^{2} + R ( {X}^{n} + δ X ) .$$

Here fⁿ is the simulated data with Xⁿ, J is the Jacobian coming from the linearization, which depends on Xⁿ, and the detail for the computation of J is given in the next section for the algorithm implementation.

During each iteration in the outer loop for Eq. (10), we minimize the following with b=f−fⁿ and x=δX

$$x = {argmin}_{x} \frac{1}{2} {‖ Jx - b ‖}_{2}^{2} + R ( {X}^{n} + x ) . \qquad ( EQUATION BLT \text{-} 11 )$$

Here we choose the popular barrier method [25] to enforce the constraint term R. That is we solve a sequence of the following minimization problems:

$${min}_{x} L ( x , t ) = {min}_{x} \frac{1}{2} {‖ Jx - b ‖}_{2}^{2} - \frac{1}{t} {\sum }_{k} ln [ - {g}_{k} ( {X}^{n} + x ) ] . \qquad ( EQUATION BLT \text{-} 12 )$$

Minimizing Eq. (12) strictly enforces the geometric constraint R since the value of logarithmic penalty functions would otherwise become infinitely large. During each step the solution xⁿ is no more than K/t-suboptimal with K as the total number of constraints. This implies xⁿ converges to the optimal point of Eq. (11) such that Jx=b with strictly enforced geometry constraints as t→∞. The Eq. (12) can be minimized with Newton's method via the following inner loop:

∇ₓ²L(xⁿ,tⁿ)δx=−∇ₓL(xⁿ,tⁿ)

xⁿ⁺¹=xⁿ+sδx

tⁿ⁺¹=μtⁿ (EQUATION BLT-13)

In each iterative step by Eq. (13), we compute the descent direction (Fix, find the moving step s through the backtracking line search, and then update x and t for the next iteration until the stopping criterion is satisfied. That is we solve a sequence of t-subproblems via Eq. (13) with the increasing t.

Algorithm Implementation.

The flowchart of the algorithm for solving Eq. (6) is as follow: the outer loop comes from the linearization Eq. (10) of the data fidelity term while the inner loop solves each linearization step using barrier method via Eq. (13).

In this flowchart, we use the ratio difference of the total source power E=∫qdΩ as the stopping criterion for the outer loop, i.e., assuming that the total power E is stable when the algorithm converges. As the stopping criterion for the inner loop, we use the sub-optimal ratio K/t, which naturally measures the difference between the iterative solution of Eq. (12) and the original solution with strictly enforced constraints. We set εᵢ empirically to 0.0001 t⁰. Please note that the formula for t⁰ is for balancing the linearized data fidelity and the penalty function.

Next, we give the details of computing Jacobian and the descent direction in Algorithm 2 for the completeness.

Algorithm 2: minimizing BLT Eq. (6) with Gaussian representation

Outer loop: Linearization of the data fidelity via Eq. (10)
Given: initial guess X⁰ and εₒ=0.01.
Repeat: 1. Compute Jacobian J from Xⁿ.

2. Inner loop: solve x=δX using barrier method via Eq.

(13)

Given: t⁰=−2R(Xⁿ)/∥b∥², μ=2, initial guess x⁰=0.
Repeat: 2.1. Compute the descent direction δx;

2.2. Compute the moving step s via

backtracking line search;

```
  Given: α=0.01, s=1, β=0.5.
  While: L(xⁿ+sδx)>L(xⁿ)+ α(∇Lₓ)^{T}·(sδx)
```

s=βs.

2.3. Update xⁿ⁺¹ =xⁿ+sδx and tⁿ⁺¹ = μtⁿ.

Let us start with the computation of Jacobian J={Jᵢⱼ, i≦M, j≦n}, which can be derived from the Jacobian J₀={J_{0,ij}, i≦M, j≦N} with respect to the piecewise-constant voxel representation via Eq. (1). The connection between J and J₀ is through the following coordinate transformation:

$$\begin{matrix}{J}_{ij} = \frac{\partial {P}_{i}^{T} φ}{\partial {x}_{j}} \\ = {\sum }_{k = 1}^{N} \frac{\partial {q}_{k}}{\partial {x}_{j}} \frac{\partial {P}_{i}^{T} φ}{\partial {q}_{k}} \\ = {\sum }_{k = 1}^{N} \frac{\partial {q}_{k}}{\partial {x}_{j}} {J}_{0 , ik} ,\end{matrix} \qquad ( EQUATION BLT \text{-} 14 )$$

where qₖ represents the kth voxel value in Eq. (1), xⱼ is the jth parameter in global representation by Gaussians in Eq. (5).

An efficient way to compute J₀ is through the adjoint method [24]F. After computing J₀, J follows immediately from (14). However, noticing that there are only a few parameters in the new source representation by Gaussians, i.e., n M N, we directly compute J without computing J₀ via the direct method as follow.

From Eq. (3), we have F(∂φ/∂qₖ)=∂Q/∂qₖ, then

$$\begin{matrix}{J}_{ij} = {P}_{i}^{T} ( {\sum }_{k = 1}^{N} \frac{\partial {q}_{k}}{\partial {x}_{j}} \frac{\partial φ}{\partial {q}_{k}} ) \\ = {P}_{i}^{T} {\sum }_{k = 1}^{N} \frac{\partial {q}_{k}}{\partial {x}_{j}} [ {F}^{- 1} ( \frac{\partial Q}{\partial {q}_{k}} ) ] \\ = {P}_{i}^{T} [ {F}^{- 1} ( {\sum }_{k = 1}^{N} \frac{\partial {q}_{k}}{\partial {x}_{j}} \frac{\partial Q}{\partial {q}_{k}} ) ]\end{matrix} \qquad ( EQ . BLT \text{-} 15 )$$

Through Eq. (15), we only need to compute the forward solver n times, which would be at least M times if we compute J₀ first via Eq. (14). Note that ∂Q/∂qₖ is a sparse vector, which is nonzero only at the nodes in the kth voxel; on the other hand ∂qₖ/∂xⱼ can be analytically derived from Eq. (5). Therefore, we can now compute the Jacobian J merely by computing n forward solvers, which is much more efficient than that in the voxel-based BLT. The trade-off is that we need to compute the Jacobian more than once due to the nonlinear dependence of J on X^{G}, which needs to be computed only once in the voxel-based BLT due to the linear dependence of J₀ on X. However, since n M, we still achieve a considerable gain in speed, since the new algorithm usually converges in less than 20 iterations while the ratio M/n is usually at least about a hundred. That is we usually achieve at least 5 gains in speed on the computation of Jacobians.

In the rare cases when n>M, the adjoint method is preferred, i.e.:

$${J}_{ij} = {[ {( {F}^{T} )}^{- 1} {P}_{i} ]}^{T} ( {\sum }_{k = 1}^{N} \frac{\partial {q}_{k}}{\partial {x}_{j}} \frac{\partial Q}{\partial {q}_{k}} ) . \qquad ( EQUATION BLT \text{-} 16 )$$

That is we compute M forward solvers instead.

Next we compute the first and second derivatives of logarithmic penalty functions for each geometric constraint gₖ(X^{G}) as in Eq. (7), i.e., Rₖ=−ln [−gₖ(X^{G})]. From the straightforward computation, we have the following simple formula:

∇²Rₖ=(∇Rₖ)^{T}·(∇Rₖ). (EQUATION BLT-17)

Therefore, we have

$$\begin{matrix}{∇}_{x} L ( x , t ) = {J}^{T} b + \frac{1}{t} {\sum }_{k} ∇ {R}_{k} \\ {∇}_{x}^{2} L ( x , t ) = {J}^{T} J + \frac{1}{t} {\sum }_{k} {( ∇ {R}_{k} )}^{T} \cdot ( ∇ {R}_{k} )\end{matrix} . \qquad ( EQUATION BLT \text{-} 18 )$$

Note that each constraint Rₖ is evaluated at Xⁿ+x rather than x.

The overall algorithm for BLT with Gaussian representation is more efficient than voxel-based BLT, mainly because the minimization is now with respect to only a few parameters of Gaussians instead of at least thousands of voxels in the conventional voxel-based BLT. For the current BLT algorithm with new model by Gaussians, minimization through barrier method in Step 2 is extremely fast although the algorithm seems complicated, which is understandable due to the significantly reduced number of variables; the major computation cost comes from the Jacobian J in Step 1, although it takes less computational time than that in voxel-based BLT, which is again due to the reduced number of unknowns.

The performance of Gaussian-based BLT, “G-BLT”, is compared with that of the conventional voxel-based BLT, “V-BLT”, through simulated data in single-inclusion and multiple-inclusion cases, and then validate the proposed method in mouse study.

Reconstruction with Single Inclusion.

We first evaluate the inventive algorithm with single anisotropic Gaussian inclusion, and then perform the single-inclusion reconstructions with various shapes, different noise levels, and different approximation errors in optical background to compare the performance of G-BLT and V-BLT. For the presentation purpose, we only show 2D comparisons. The results and the conclusions are similar for the 3D case. In particular, 3D results will be demonstrated with in vivo data.

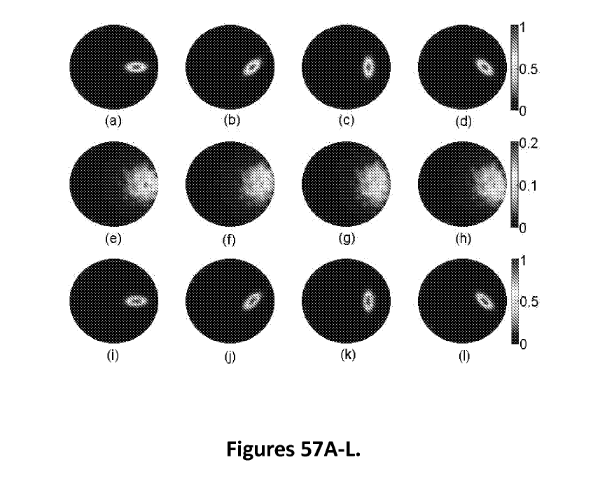

All the 2D reconstructions are performed on a circular phantom with the diameter of 20 millimeters. 120 data are collected all around the phantom at the boundary with equal angular distance in between. The reconstruction mesh has 2162 triangular elements and 1130 nodes. To avoid the inverse crime, the data are generated with different meshes that are about four times as large as the reconstruction mesh. For example, there are 8664 triangular elements and 4425 nodes for the case with circular inclusion as shown in FIG. 57A.

We assume the homogeneous optical background with μₐ=0.01 mm⁻¹ and μₛ′=1 mm⁻¹. Without further mentioning, we use mm as the unit for the length, mm⁻¹ as the unit for absorption or scattering coefficients, nano Watts (nW) as the unit for the total source power, and nW/mm², nW/mm³ as the unit for the source intensity in 2D and 3D respectively. The unit of angle is in degree.

In G-BLT, as the initial guess, for simplicity we assume there is one Gaussian inclusion with ρ=0.1, x_{c}=0, y_{c}=0, rₓ=1, r_{y}=1 and θ=90°. The reconstruction with multiple inclusions as the initial guess will be considered in the next section. Please notice that the nonzero value has to be assigned for ρ, otherwise the Jacobian with respect to other parameters will be zero according to Eq. (14). For the constraint variables, we set ρₘₐₓ=10, ρₘᵢₙ=0.01, xₘₐₓ=yₘₐₓ=10, xₘᵢₙ=yₘᵢₙ=−10, r_{x,max}=r_{y,max}=5, r_{x,min}=r_{y,min}=0.1, θₘₐₓ=180°, θₘᵢₙ=0°, and c_{xy}=5.

For the V-BLT, we solve the problem via the standard Levenberg-Marquardt method with L₂ regularization [24]F. That is to minimize:

$$X = {argmin}_{X} \frac{1}{2} {‖ {J}_{0} X - f ‖}_{2}^{2} + λ {‖ X ‖}_{2}^{2} . \qquad ( EQUATION BLT \text{-} 19 )$$

where the Jacobian J₀ is with respect to the piecewise-constant voxel representation by Eq. (1), and λ is the regularization parameter.

Note that one may optimize the choice of regularization term in Eq. (19). However we found out that the results did not improve drastically when using other regularization strategies [14, 15]F, which may be due to the severely illposed nature of the inverse problem in the optical regime modeled by diffusion approximation Eq. (2). In the following, we restrict our discussion based on L2 regularization as in Eq. (19).

Inclusions with Gaussian Shapes.

Since it is physiologically reasonable to approximate the bioluminescence sources by Gaussians, we first consider reconstructions where we assume the source is a single Gaussian. All the tests have the same Gaussian up to a rotation, with parameters specified in Table 1. The reconstructed results with both G-BLT and V-BLT are plotted in FIGS. 57A-L and the recovered parameter values are in Table 1 as well.

From FIGS. 57A-L, in all tests G-BLT can recover the Gaussian phantom when using the representation of source in Gaussians while V-BLT gives relatively much poorer results. Moreover, G-BLT is quantitatively better than V-BLT in the sense it gives more accurate total power E and maximal intensity as documented in Table 1F.

TABLE 1F
Tests with single Gaussian source. The Gaussian phantom has ρ = 1,
x_{c} = 5, y_{c} = 0, rₓ = 2, r_{y} = 1. The rotation angles are 0°, of the
45°, 90°, 135°respectively for Test 1-4. In all tests, the total energy
phantom E is approximately 6.285. Please notice that the
result from Case 2 can be understood according to the non-unique
representation of the Gaussian.

Test

| | | 1 | 2 | 3 | 4 |
|---|---|---|---|---|---|
| G- | E | 6.295 | 6.296 | 6.295 | 6.295 |
| BLT | ρ | 1.225 | 1.231 | 1.237 | 1.229 |
| | x_{c} | 4.997 | 4.995 | 4.999 | 4.997 |
| | rₓ | 1.906 | 0.846 | 1.919 | 1.913 |
| | y_{c} | 0.000 | −0.001 | 0.002 | 0.000 |
| | r_{y} | 0.856 | 1.917 | 0.843 | 0.852 |
| | θ | 1.541 | 135.161 | 89.760 | 134.910 |
| V- | E | 5.461 | 5.464 | 5.464 | 5.463 |
| BLT | ρ | 0.202 | 0.191 | 0.183 | 0.200 |

Inclusions with Various Shapes.

TABLE 2F
The parameters for single-object simulations with inclusions of various
shapes. E is the total source energy; ρ is the maximal source intensity;
x_{c} and y_{c} are x- and y-coordinate of the center of the inclusion;
rₓ and r_{y} are maximum distances from the center to the
boundary along x and y direction respectively.

| Inclusion | Circle | Square | Triangle | Rectangle |
|---|---|---|---|---|
| E | 3.121 | 4 | 2 | 8 |
| ρ | 1 | 1 | 1 | 1 |
| x_{c} | 5 | 5 | 5 | 5 |
| rₓ | 1 | 1 | 1 | 1 |
| y_{c} | 0 | 0 | −0.333 | 0 |
| r_{y} | 1 | 1 | 1.333 | 2 |

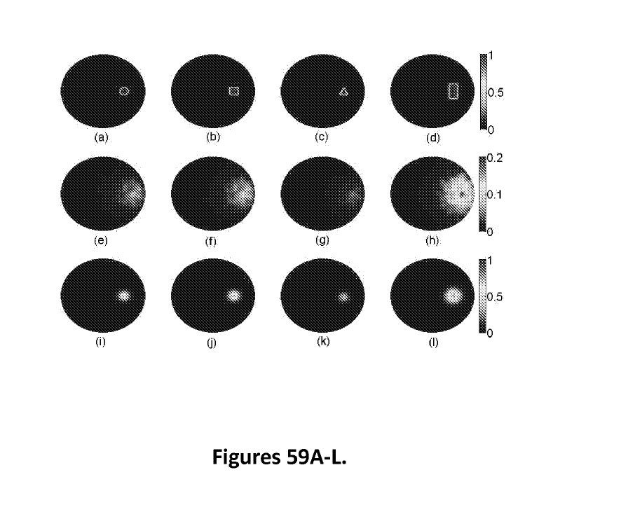

We evaluate the algorithm through the simulated data with single inclusions of various shapes. The parameters for various single inclusions are specified in Table 2F. The reconstructed results with both G-BLT and V-BLT are plotted in FIGS. 59A-L and the parameter values are in Table 3F.

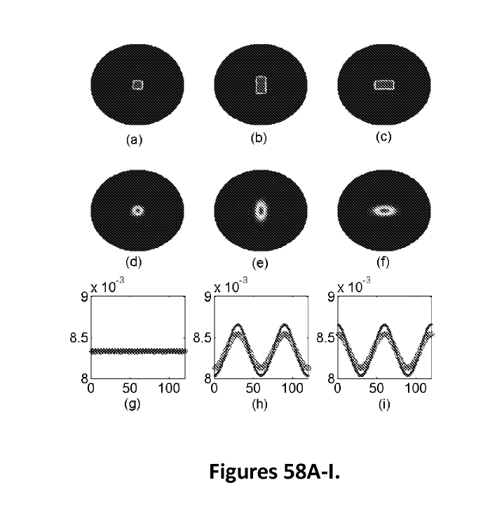

Before doing the reconstruction, we simply compare the measurements from Gaussian and non-Gaussian sources as shown in FIGS. 58A-I. Here we embed inclusions deeply at the center of the medium. The plotted measurements are normalized with the absolute sum 1. The figure shows that the measurement profiles from Gaussian sources are almost the same as those from the non-Gaussian ones. It suggests that various shapes can be characterized by anisotropic Gaussians when the sources are deeply embedded into the diffusive medium.

TABLE 3F
The reconstructed parameters for single-object simulations with
inclusions of various shapes. Please see Table 2F for the corresponding
true values.

| | Inclusion | Circle | Square | Triangle | Rectangle |
|---|---|---|---|---|---|
| G- | E | 3.135 | 4.019 | 2.008 | 8.002 |
| BLT | ρ | 0.628 | 0.799 | 0.407 | 0.808 |
| | x_{c} | 4.976 | 4.978 | 4.977 | 4.977 |
| | rₓ | 1.259 | 1.265 | 1.251 | 1.752 |
| | y_{c} | 0.000449 | 0.00113 | −0.332 | −0.0000795 |
| | r_{y} | 1.259 | 1.265 | 1.252 | 1.797 |
| V- | E | 2.668 | 3.422 | 1.708 | 6.895 |
| BLT | ρ | 0.0946 | 0.121 | 0.0626 | 0.236 |

From FIGS. 59A-L, visually we can tell that G-BLT is consistently better in localizing the inclusions than V-BLT. Moreover, G-BLT is quantitatively better than V-BLT in the sense it gives more accurate total power E and maximal intensity as documented in Table 3F.

One minor issue regarding G-BLT is that the reconstructed radiuses along x- and y-axis seem not to match those in true phantoms, whish is possibly due to the Gaussian approximation error of non-Gaussian phantom. For example, with rectangular inclusion, the recovered rₓ=1.752 and r_{y}=1.797, while the true rₓ=1 and r_{y}=2. Although rₓ<r_{y} in the reconstruction, this scale difference is much smaller than the true difference.

Notice that in this section and the rest of reconstructions for non-Gaussian sources, we did not consider 9 as reconstruction variable. G-BLT does not recover the shapes for non-Gaussian sources as exactly as for Gaussian sources even with rotation.

Different Noise Level.

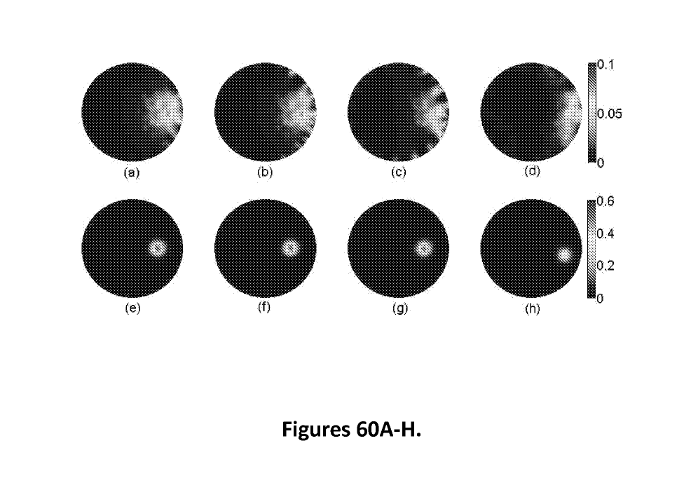

We evaluate the algorithm with respect to different noise level. 5%, 10%, 20%, 30% percentage of Gaussian noise is added to the measurements f respectively, e.g., f(1+5% Randn), where Randn represents the random Gaussian distribution with zero mean and unit variance. The reconstructed results with both G-BLT and V-BLT are plotted in FIGS. 60A-H and the parameter values are in Table 4F. Here the simulations are performed on the same circular phantom with single circular inclusion as in FIG. 59A.

Again, from FIGS. 60A-H, visually G-BLT localizes much better than V-BLT. In particular, the result from G-BLT changes a little for the noise up to 20%. On the other hand, it is difficult to tell even the center of object in V-BLT when the noise is increased beyond 10%. Moreover, from Table 4F, G-BLT gives more accurate quantitative information than V-BLT.

TABLE 4F
The reconstructed parameters for single-circular-object simulations
with different Gaussian noise levels. See Table 2F for the corresponding
true values.

| | Noise | | | | |
|---|---|---|---|---|---|
| | Level | 5% | 10% | 20% | 30% |
| G- | E | 3.115 | 3.052 | 2.944 | 1.961 |
| BLT | ρ | 0.624 | 0.612 | 0.591 | 0.398 |
| | x_{c} | 4.993 | 4.955 | 5.038 | 6.585 |
| | rₓ | 1.260 | 1.258 | 1.253 | 1.216 |
| | y_{c} | −0.00135 | 0.0507 | −0.0357 | −1.342 |
| | r_{y} | 1.258 | 1.260 | 1.263 | 1.291 |
| V- | E | 2.715 | 2.725 | 2.744 | 2.307 |
| BLT | ρ | 0.0956 | 1.321 | 0.151 | 0.0937 |

Mismatch of Optical Background.

We evaluate the algorithm with different mismatch in optical background. The background is perturbed with ±10%, ±30%, ±50%, ±70% percentage of error respectively, e.g., μₐ(1+10%) and μₛ′(1+10%). Notice that we either increase or decrease both absorption and scattering coefficients since empirically we find that the mismatch may cancel if one is increased while the other is decreased. Therefore, we change both in the same direction to simulate the worst-case errors. Note that the reconstruction results with V-BLT are not presented since it does not localize the inclusion satisfactorily even in the case without optical background error.

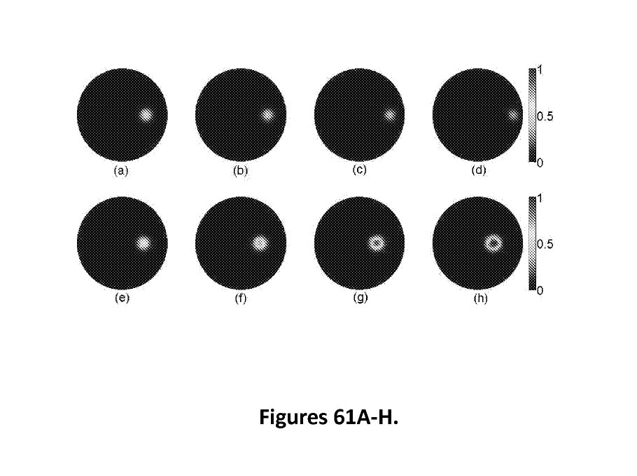

The results from G-BLT are presented in FIGS. 61A-H and Table 5F, which show that G-BLT is robust to the mismatch error of optical background in the sense that the inclusion can still be localized well despite of the shifting of centers due to the systematic discrepancy between the true values and the values used in the reconstruction.

TABLE 5
Gaussian-based BLT for single-circular-object simulations with different
mismatch in optical background. Please see Table 2F for the
corresponding true values

| Error | −10% | −30% | −50% | −70% |
|---|---|---|---|---|
| E | 2.834 | 2.351 | 1.983 | 1.639 |
| ρ | 0.569 | 0.475 | 0.402 | 0.334 |
| x_{c} | 5.263 | 5.918 | 6.736 | 7.871 |
| rₓ | 1.254 | 1.244 | 1.235 | 1.234 |
| y_{c} | −0.0000524 | −0.00233 | −0.00473 | −0.00454 |
| r_{y} | 1.262 | 1.266 | 1.271 | 1.276 |
| Error | +10% | +30% | +50% | +70% |
| E | 3.485 | 4.368 | 5.559 | 7.163 |
| P | 0.697 | 0.868 | 1.096 | 1.395 |
| x_{c} | 4.709 | 4.234 | 3.827 | 3.479 |
| rₓ | 1.265 | 1.277 | 1.292 | 1.310 |
| y_{c} | 0.000587 | 0.000275 | −0.000247 | −0.000724 |
| r_{y} | 1.257 | 1.253 | 1.249 | 1.248 |

Reconstruction with Multiple Inclusions.

Now we evaluate the algorithm in the presence of multiple inclusions by considering first Gaussian inclusions and then non-Gaussian shapes.

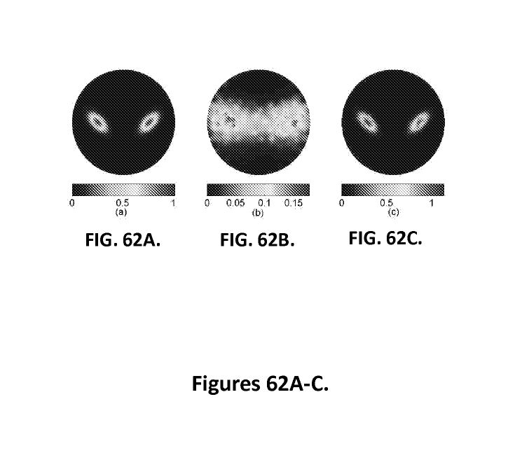

Despite of the fact that there are two inclusions in the test on Gaussian sources (FIGS. 62A-C) and three inclusions in the test on non-Gaussian sources (FIGS. 62A-C), we assume four inclusions as the initial guess in G-BLT, since the exact number of inclusions is usually not known in practice unless the correct anatomical priors are available from other imaging modalities. However, since the bioluminescent source is localized and limited in quantity as discussed previously, we only need to set the number of sources n to a reasonable larger value than the actual number, in order to faithfully reconstruct the source distribution without considering n as an independent variable. Particularly, as the initial guess, we assume there are four Gaussian inclusions, i.e., n=4, with ρ₁=ρ₂=ρ₃=ρ₄=0.1, x_{1,c}=5, y_{1,c}=5, x_{2,c}=5, y_{2,c}=−5, x_{3,c}=−5, y_{3,c}=−5, x_{4,c}=−5, y_{4,c}=−5, r_{1,x}=r_{2,x}=r_{3,x}=r_{4,x}=1, r_{1,y}=r_{2,y}=r_{3,y}=r_{4,y}=1 and θ₁=θ₂=θ₃=θ₄=90°. Notice that for the same reason mentioned above, we do not consider θ as reconstruction variable for non-Gaussian sources for simplicity.

The same constants as in the single-inclusion simulations are used. In order to separate the multiple objects, we find out the minimal-separation constraints are usually necessary. This is also intuitively correct since the source representation may otherwise be non-unique, given the severely illposed nature of BLT. Here we set cₓ=c_{y}=ln 2, corresponding to that the minimal distance between any two objects is at least the average of FWHM.

Inclusions with Gaussian Shapes.

TABLE 6F
Multiple-Gaussian-inclusion simulation with Inclusion 1 (the left ellipse
in FIG. 62A) and Inclusion 2 (the right ellipse in FIG. 62A). The total
energy E of the phantom is 12.570; the recovered total energy from
G-BLT is 12.596 while that from V-BLT is 11.582.

| | |
|---|---|
| Inclusion 1 | Inclusion 2 |

| | Phantom | G-BLT | Phantom | G-BLT |
|---|---|---|---|---|
| ρ | 1.000 | 1.243 | 1.000 | 1.236 |
| x_{c} | 5.000 | −5.005 | 5.000 | 4.988 |
| rₓ | 2.000 | 1.915 | 2.000 | 1.916 |
| y_{c} | 0.000 | 0.001 | 0.000 | 0.001 |
| r_{y} | 1.000 | 0.843 | 1.000 | 0.845 |
| θ | 45.000 | 44.448 | 135.000 | 134.760 |

The detailed setting is given in Table 6F and FIG. 62A. The results are plotted in FIGS. 62A-C, which clearly shows that G-BLT is able to accurately recover the values of intensity, centers, radiuses and rotation angle. On the other hand, neither shapes nor locations of inclusions can be not be captured from V-BLT.

Inclusions with Non-Gaussian Shapes.

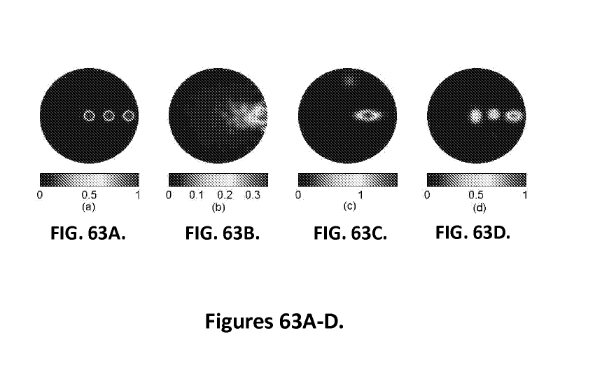

The detailed setting is given in Table 7F and FIGS. 63A-D. The results are plotted in FIGS. 63A-D, which clearly shows that G-BLT with proper constraints is able to separate the inclusions while V-BLT fails. The parameter values are documented in Table 7F, which are quite consistent with the true values. One minor issue is that the recovered center is not as accurate as one from the single-inclusion cases, which is understandable due to mutual effect of inclusions and the illposedness of the problem.

TABLE 7F
Multiple-inclusion simulations. Three circular inclusions of 1 mm
diameter are located at (0, 0), (4, 0) and (8, 0) respectively with the
unit source intensity. The total energy E is 9.364; the recovered total
energy from G-BLT is 9.290 while that from V-BLT is 8.282. Please
note that the presented values are from G-BLT with minimal-separation
constraints as in Eq. (7-3). Please also notice that three inclusions are
assumed in the initial guess for the reconstruction with G-BLT although
there are actually three inclusions. After the reconstruction, 3 out of 4
inclusions have distinguished peak values.

| | Inclusion 1 | Inclusion 2 | Inclusion 3 | Inclusion 4 |
|---|---|---|---|---|
| ρ | 1.069 | 0.878 | 0.831 | 0.0391 |
| x_{c} | 7.572 | 3.460 | −0.141 | 3.673 |
| rₓ | 1.383 | 0.925 | 0.921 | 1.076 |
| y_{c} | −0.0135 | 0.326 | −0.0397 | −4.132 |
| r_{y} | 0.839 | 0.907 | 1.240 | 0.945 |

Combinatorial Optimization.

In this section, we give one example of combinatorial optimization (Algorithm 1) with the number of Gaussians n as a variable.

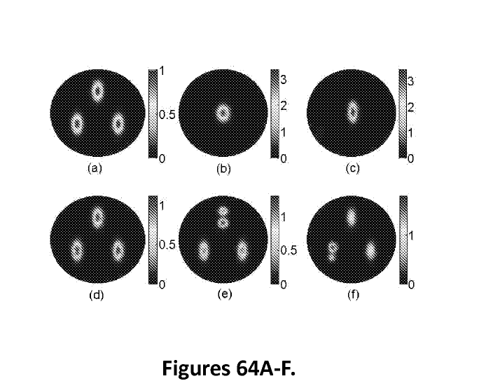

In the phantom (FIG. 64A), there are three Gaussians with the parameters specified in Table 8. In the reconstruction, we start with the initial guess nₒ=1, and continue the combinatorial process until the data discrepancy d reaches the tolerance. Please notice that the process should have terminated at n=3. For illustration purpose, we run until n=5.

The detailed setting and the recovered parameters are given in Table 8F. FIGS. 64A-F show that this combinatorial process is able to reconstruct the source even the initial guess is smaller than the actual number, e.g., the results from n=1 and n=2 fail to give a satisfactory reconstruction while those from n=3, n=4 and n=5 all successfully recover the desired distribution.

It is interesting to notice that although the reconstruction with more than or equal to the actual number of Gaussians is able to recover the actual number of Gaussians, the reconstruction with more Gaussians than the actual number may degrade the image quality due to the apparent non-unique representation of the geometry. For example, two recovered sources in FIG. 64E constitute the top Gaussian in FIG. 64A when using n=4 and two recovered sources in FIG. 64F constitute the left Gaussian in FIG. 64A when using n=5.

TABLE 8
Combinatorial optimization with the varying n for G-BLT. Three
Gaussian inclusions are located at (0, 5), (4.33, −2.5) and
(−4.33, −2.5) respectively with ρ = 1, rₓ = 1 and r_{y} = 2. The number of
Gaussians n is treated as a variable in this combinatorialproblem. The
value of n in the reconstruction is set to 1 as the initial guess and
iteratively increased until the solution converges. The following table
records the reconstructed values for n = 1, 2, 3, 4 and 5. Please
notice that the reconstruction should have terminated at n = 3
according to the given criterion if it were not for illustration purpose.
The total energy E is 18.843; the recovered total energy is 21.164,
20.861, 18.879, 18.908 and 18.912 respectively. The measurement
difference d is 0.167, 0.132, 0.00315, 0.00322 and 0.00327 respectively.

| K | | Inclusion | Inclusion | Inclusion | Inclusion | Inclusion |
|---|---|---|---|---|---|---|
| n | | 1 | 2 | 3 | 4 | 5 |
| 1 | ρ | 3.593 | — | — | — | — |
| | x_{c} | −0.000228 | — | — | — | — |
| | rₓ | 1.178 | — | — | — | — |
| | y_{c} | −0.0342 | — | — | — | — |
| | r_{y} | 1.592 | — | — | — | — |
| 2 | ρ | 0.194 | 3.893 | — | — | — |
| | x_{c} | −6.975 | 0.323 | — | — | — |
| | rₓ | 1.149 | 0.824 | — | — | — |
| | y_{c} | −4.254 | 0.209 | — | — | — |
| | r_{y} | 1.588 | 1.964 | — | — | — |
| 3 | ρ | 1.224 | 1.254 | 1.235 | — | — |
| | x_{c} | 0.00101 | −4.329 | 4.314 | — | — |
| | rₓ | 0.863 | 0.833 | 0.855 | — | — |
| | y_{c} | 5.023 | −2.491 | −.2498 | — | — |
| | r_{y} | 1.889 | 1.922 | 1.905 | — | — |
| 4 | ρ | 1.712 | 1.189 | 1.211 | 1.211 | — |
| | x_{c} | −0.0207 | 0.0135 | −4.337 | 4.321 | — |
| | rₓ | 0.838 | 0.856 | 0.860 | 0.870 | — |
| | y_{c} | 3.774 | 6.464 | −2.522 | −2.521 | — |
| | r_{y} | 0.840 | 0.832 | 1.900 | 1.889 | — |
| 5 | ρ | 0.0276 | 1.236 | 2.388 | 1.057 | 1.235 |
| | x_{c} | 5.992 | 0.00485 | −4.171 | −4.429 | 4.337 |
| | rₓ | 0.887 | 0.857 | 0.703 | 0.706 | 0.859 |
| | y_{c} | 1.150 | 5.029 | −1.771 | −4.129 | −2.566 |
| | r_{y} | 0.921 | 1.879 | 0.867 | 0.793 | 1.846 |

In Vivo Validation.

After evaluating the propose G-BLT in 2D with various settings, we have established the superiority of G-BLT over V-BLT. Now we validate G-BLT in 3D with in vivo experimental data. The details of experimental setups and mouse experiments are given in [4]F. We also refer the readers to the above reference for the reconstruction parameters, such as the used mesh and the values for optical parameters.

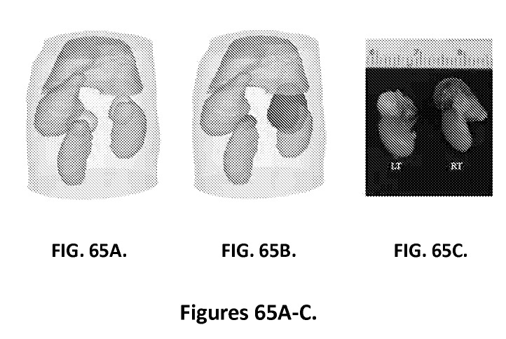

In the previous voxel-based reconstruction [4]F, with a permissible region selected according to the high value clusters in the data, two sources were localized with a stronger one of the power 39.8 nW/mm³ (right) and a smaller one of the power 1.5 nW/mm³ (left). When the mouse was dissected after the experiment, two tumors were found on both adrenal glands, respectively, as shown in FIG. 65C. The volume of tumor tissues as measured by Vernier calipers was 468 mm³ for the tumor (right) 275 mm³ for the tumor (left).

Now we use G-BLT, Gaussian-based BLT, to reconstruct instead of V-BLT. Please note that we do not select the permissible region.

As the initial guess, we assume there are four Gaussian inclusions, i.e., n=4, with ρ₁=ρ₂=ρ₃=ρ₄=10, x_{1,c}=x_{2,c}=x_{3,c}=X_{4,c}=0, y_{1,c}=y_{2,c}=y_{3,c}=y_{4,c}=0, z_{1,c}=5, z_{2,c}=10, z_{3,c}=15, z_{4,c}=20, r_{1,x}=r_{2,x}=r_{3,x}=r_{4,x}=1, r_{1,y}=r_{2,y}=r_{3,y}=r_{4,y}=1 and r_{1,z}=r_{2,z}=r_{3,z}=r_{4,z}=1.

The constants in the geometric constraints are: ρₘₐₓ=1000, ρₘᵢₙ=0.1, xₘₐₓ=yₘₐₓ=12, xₘᵢₙ=yₘᵢₙ=−12, zₘₐₓ=27, zₘᵢₙ=0, r_{x,max}=r_{y,max}=6, r_{x,min}=r_{y,min}=0.5, and c_{xy}=c_{yz}=c_{zx}=5, cₓ=c_{y}=c_{z}=ln 2. Here the min-max values on the geometry correspond to the physical size of the domain; the maximum of the intensity is estimated from the data, which is roughly 50 times of the maximal value in the data.

TABLE 9F
In vivo study using Gaussian-based BLT. Please also notice that four
inclusions are assumed in the reconstruction although there are actually
two tumors from the histological verification. The reconstructed result
also shows exactly two inclusions with the distinguished values, i.e.
Inclusion 1 and 2 in the following table.

| | Inclusion 1 | Inclusion 2 | Inclusion 3 | Inclusion 4 |
|---|---|---|---|---|
| ρ | 16.593 | 7.692 | 0.625 | 0.525 |
| x_{c} | 3.517 | −1.598 | 6.377 | 0.280 |
| rₓ | 3.960 | 4.789 | 3.447 | 4.901 |
| y_{c} | −4.907 | 1.570 | −0.527 | 0.778 |
| r_{y} | 3.220 | 4.980 | 4.898 | 4.977 |
| z_{c} | 12.391 | 15.455 | 17.384 | 5.713 |
| r_{z} | 4.959 | 4.725 | 4.957 | 2.825 |

As documented in Table 9F, 2 out of 4 recovered inclusions, with the locations just corresponding to the kidneys, have significantly larger values, i.e., the one with the peak intensity of 16.593 nW/mm³ (right) and the other one with the peak intensity of 7.692 nW/mm³ (left). In addition, the peak intensity of the other 2 inclusions (Inclusion 3 and 4) is less than 5% of the maximum (Inclusion 1), which can be from experimental or numerical noise. The reconstructed bioluminescent volumes (2rₓ·2r_{y}·2r_{y}) are 506 mm³ (right) and 901 mm³ (left) respectively. The discrepancy between the reconstructed volumes and the measured ones is not surprising since the anatomical volume may not correspond to the bioluminescent volume.

Thus, the inventors introduce a stable way to recover bioluminescent source through novel source representation by Gaussians. It is mathematically unique and computationally cheap. There are strong physiological evidences that the actual bioluminescent sources can be modeled by Gaussians, which will be further studied in the future work. The resultant problem with the fixed number of Gaussians is formulated as a nonlinear least-square minimization with appropriate geometric constraints, which is solved in turn by barrier method; on the other hand, the problem with the varying number of Gaussians can be formulated as a combinatorial optimization problem. The superiority of the proposed method has been established through simulations and in vivo experimental data. In particular, when the source itself can be approximated by Gaussians, the inventive method is able to accurately recover the intensity, centers, radiuses and rotation angles of the Gaussians.

Due to the significantly reduced number of variables, the inventive method is robust to the measurement noise and the mismatch in optical background; the computational burden is also reduced to the minimization problem with respect to a few parameters instead of at least thousands of parameters in the conventional voxel-based BLT.

It is also possible to incorporate RTE for more accurate modeling, simplified representation for optical heterogeneity, such as piecewise constants, to be simultaneously reconstructed for correcting optical background, and multi-spectral data for better stability.

Although the source is represented as Gaussians in this study, other shape functions may be appropriate for other purposes. An interesting topic to pursue is the multi-modality imaging since the structural priors can be easily incorporated into the proposed method for more accurate quantitative estimation.

### REFERENCES

1.F C. H. Contag and B. D. Ross, “It's not just about anatomy: in vivo bioluminescence imaging as an eyepiece into biology,” Journal of Magnetic Resonance Imaging 16, 378-387 (2002).
2F. G. Wang, E. A. Hoffman, G. McLennan, L. V. Wang, M. Suter, and J. Meinel, “Development of the first bioluminescent CT scanner,” Radiology 566 (2003).
3F. G. Wang, Y. Li, and M. Jiang, “Uniqueness theorems in bioluminescence tomography,” Med. Phys. 31, 2289-2299 (2004).
4F. G. Wang, W. Cong, K. Durairaj, X. Qian, H. Shen, P. Sinn, E. Hoffman, G. McLennan, and M. Henry, “In vivo mouse studies with bioluminescence tomography,” Opt. Express 14, 7801-7809 (2006).
5F. W. Cong, G. Wang, D. Kumar, Y. Liu, M. Jiang, L. Wang, E. Hoffman, G. McLennan, P. McCray, J. Zabner, and A. Cong, “Practical reconstruction method for bioluminescence tomography,” Opt. Express 13, 6756-6771 (2005).
6F. G. Wang, X. Qian, W. Cong, H. Shen, Y. Li, W. Han, K. Durairaj, M. Jiang, T. Zhou, and J. Cheng, “Recent development in bioluminescence tomography,” Current Medical Imaging Reviews 2, 453-457 (2006).
7F. G. Wang, H. Shen, K. Durairaj, X. Qian, and W. Cong, “The first bioluminescence tomography system for simultaneous acquisition of multi-view and multi-spectral data,” International Journal of Biomedical Imaging 1-8 (2006).
8F. X. Gu, Q. Zhang, L. Larcom, and H. Jiang, “Three-dimensional bioluminescence tomography with model-based reconstruction,” Opt. Express 12, 3996-4000 (2004).
9F. A. J. Chaudhari, F. Darvas, J. R. Bading, R. A. Moats, P. S. Conti, D. J. Smith, S. R. Cherry, and R. M. Leahy, “Hyperspectral and multispectral bioluminescence optical tomography for small animal imaging,” Phys. Med. Biol. 50, 5421-5441 (2005).
10F. H. Dehghani, S. C. Davis, S. Jiang, B. W. Pogue, K. D. Paulsen, and M. S. Patterson, “Spectrally resolved bioluminescence optical tomography,” Opt. Lett. 31, 365-367 (2006).
11F. C. Kuo, O. Coquoz, T. Troy, D. Zwarg, and B. Rice, “Bioluminescent tomography for in vivo localization and quantification of luminescent sources from a multiple-view imaging system,” Molecular Imaging 4, 370 (2005).
12F. G. Alexandrakis, F. R. Rannou, and A. F. Chatziioannou, “Tomographic bioluminescence imaging by use of a combined optical-PET (OPET) system: a computer simulation feasibility study,” Phys. Med. Biol. 50, 4225-4241 (2005).
13F. Y. Lv, J. Tian, W. Cong, and G. Wang, “Experimental study on bioluminescence tomography with multimodality fusion,” Int. J. Biomed. Imag. 2007, 86741 (2007).
14F. H. Gao and H. K. Zhao, “Multilevel bioluminescence tomography based on radiative transfer equation Part 1: 11 regularization,” Optics Express 18, 1854-1871 (2010).
15F. H. Gao and H. K. Zhao, “Multilevel bioluminescence tomography based on radiative transfer equation Part 2: total variation and 11 data fidelity,” Optics Express 18, 2894-2912 (2010).
16F. J. Liu, A. Li, A. E. Cerussi and B. J. Tromberg, “Parametric diffuse optical imaging in reflectance geometry,” IEEE Selected Topics in Quantum Elec. 16, 555-564 (2010).
17F. K. M. Case and P. F. PF Zweifel, Linear Transport Theory (Addison-Wesley Educational Publishers Inc., 1967).
18F. A. Ishimaru, Wave Propagation and Scattering in Random Media (Academic Press, 1978).
19F. E. E. Lewis and W. F. Miller, Computational Methods of Neutron Transport (Wiley, 1984).
20F. H. Gao and H. K. Zhao, “A fast forward solver of radiative transfer equation,” Transport Theory and Statistical Physics 38, 149-192 (2009).
21F. H. Shen and G. Wang, “A tetrahedron-based inhomogeneous Monte Carlo optical simulator,” Physics in Medicine and Biology 55, 947-962 (2010).
22F. W. Cong, H. Shen, A. Cong, Y. Wang and G. Wang, “Modeling photon propagation in biological tissues using generalized Delta-Eddington phase function,” Physical Review E 76, 051913 (2007).
23F. A. D. Klose and E. W. Larsen, “Light transport in biological tissue based on the simplified spherical harmonics equations,” J. of Computational Phy. 220, 441-470 (2006).
24F. A. R. Arridge, “Optical tomography in medical imaging,” Inverse Problems 15, R41-93 (1999).
25F. S. Boyd and L. Vandenberghe, Convex Optimization (Cambridge Univ. press, 2004).

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. It is intended that the specification and examples be considered as exemplary in nature and that variations that do not depart from the essence of the invention are intended to be within the scope of the invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

Throughout this application, various publications are referenced. The disclosures of these publications in their entireties are hereby incorporated by reference into this application in order to more fully describe the features of the invention and/or the state of the art to which this pertains. The references disclosed are also individually and specifically incorporated by reference herein for the material contained in them that is discussed in the portion of this disclosure in which the reference is relied upon.

1. A system for interior tomography reconstruction comprising:
a processing module operably configured for:
receiving information relating to a region of interest (ROI) of a scanned object;
reconstructing the ROI into an image by performing projection onto one or more convex sets (POCS) to generate image data according to:
fₙ=TⁿF,
where n indicates an iteration number;
T=P₁P₂ . . . P_{M};
P₁, . . . , P_{M} are operator to project onto respective convex sets C₁, . . . , C_{M};
and wherein the convex sets are chosen from Hilbert transform, integral constraint, minimum value, maximum value, and known-information convex sets;
and comprising a processor for executing the processing module.

2. The system of claim 1, wherein the convex sets are chosen from Hilbert transform, integral constraint, and minimum value.

3. The system of claim 2, wherein the processing module is further operably configured for performing simultaneous algebraic reconstructive technique based (SART-based) integral constraint.

4. The system of claim 3, wherein the processing module is further operably configured for performing total variation regularization.

5. The system of claim 4, wherein the processing module is further operably configured for sequentially repeating one or more its functions.

6. A multi-source interior tomography system comprising:
1) a processing module operably configured for:
a) analyzing an individualized prior CT scan of a subject; and
b) defining a corresponding high order TV (HOT) objective using a set of projection data measured in the CT scan and expressed as:
a 1D vector Y with elements, Yᵢ^{meas}, i=1, . . . , N_{Y}, where N_{Y} is the product of the number of detector elements and the number of projection views;
wherein each measurement is a realization of a random variable:
$${Y}_{i}^{meas} = {G}_{i} {\sum }_{m = 1}^{M} {E}_{m} Poisson \{ {\sum }_{j = 1}^{{N}_{Y}} {b}_{ij} {I}_{j} {λ}_{m}^{( j )} \times exp [ - {\int }_{{L}_{j}} μ ( x , {E}_{m} ) d l ] + {s}_{m}^{( i )} \} + Gaussian \{ {d}_{i} {σ}_{i}^{2} \}$$
wherein:
μ(x,E) is the energy-dependent linear attenuation coefficient;
sₘ⁽ⁱ⁾ the number of scattered photons, and
the ith measurement not only reflects the signal from the path Lᵢ but also other paths Lⱼ, j≠i, with weight bᵢⱼ to take off-focal radiation into account to reconstruct μ(x,Eᵣ) at a reference energy Eᵣ;
c) reducing to a discrete model:
$${Y}_{i}^{meas} ∼ Poisson \{ {I}_{i} exp [ - {\sum }_{j = 1}^{{N}_{p}} {a}_{ij} {μ}_{j} ] + {r}_{i} \} ,$$
where an object consists of Nₚ pixels with attenuation coefficients μ=[μ₁, μ₂, . . . , μ_{N}]^{T}, aᵢⱼ denotes the length of a ray path in a pixel, and rᵢ a known constant which compensates for measurement noise and may be ignored especially in initial analyses;
d) converting to an optimization problem:
μ̅=arg min(HOT(μ)) subject to Y^{meas}=Y(μ),
where HOT(μ) is an objective function including the HOT and other constraints such as the prior CT scan and tomosynthetic data;
2) and comprising a processor for executing the processing module.

7. An ultra-fast tomography system comprising:
1) a processing module operably configured for:
aligning and averaging multiple independently acquired datasets of the same ROI, after image registration, in a common coordinate system;
2) and comprising a processor for executing the processing module.

8. The system of claim 7, wherein the processing module is further operably configured for processing datasets acquired by way of symmetric data acquisition.

9. The system of claim 7, wherein the processing module is further operably configured for processing datasets acquired using source-multiplexing.
